(19) United States
(12) Patent Application Publication
(10) Pub. No.: US 2017/0330250 A1
(43) Pub. Date: Nov. 16, 2017

(54) Machine/Article/Composition/Process State(s) for Tracking Philanthropic And/or Other Efforts

(71) Applicant: Elwha LLC, Bellevue, WA (US)

(72) Inventors: Ali Arjomand, Yarrow Point, WA (US); Kim Cameron, Seattle, WA (US); William Gates, Medina, WA (US); Roderick A. Hyde, Redmond, WA (US); Muriel Y. Ishikawa, Livermore, CA (US); Jordin T. Kare, San Jose, CA (US); Max R. Levchin, San Francisco, CA (US); Nathan P. Myhrvold, Medina, WA (US); Tony S. Pan, Bellevue, WA (US); Aaron Sparks, Bellevue, WA (US); Russ Stein, Bellevue, WA (US); Clarence T. Tegreene, Mercer Island, WA (US); Maurizio Vecchione, Pacific Palisades, CA (US); Lowell L. Wood, JR., Bellevue, WA (US); Victoria Y.H. Wood, Livermore, CA (US)

(73) Assignee: Elwha, LLC, Bellevue, WA (US)

(21) Appl. No.: 15/331,949

(22) Filed: Oct. 24, 2016

Related U.S. Application Data
(63) Continuation-in-part of application No. 15/055,515, filed on Feb. 26, 2016.
Application No. 15/055,515 is a continuation-in-part of application No. PCT/US16/35360, filed on Jun. 1, 2016.
Application No. PCT/US16/35360 is a continuation-in-part of application No. PCT/US16/35505, filed on Jun. 2, 2016.
Application No. PCT/US16/35505 is a continuation-in-part of application No. 15/055,515, filed on Feb. 26, 2016.
Application No. 15/055,515 is a continuation-in-part of application No. PCT/US16/35360, filed on Jun. 1, 2016.
(60) Provisional application No. 62/170,127, filed on Jun. 2, 2015.

(51) Int. Cl. G06Q 30/02; G06Q 20/06; G06Q 20/02; G06Q 20/38; G06Q 40/00

(52) U.S. Cl. CPC G06Q 30/0279; G06Q 20/389; G06Q 40/12; G06Q 20/027; G06Q 20/0658

(57) ABSTRACT

Machines, Processes, compositions of matter, and articles that include at least one input acceptance machine and at least one track data presentation device. In addition to the foregoing, other aspects are described in the claims, drawings, and text.

### CROSS-REFERENCE TO RELATED APPLICATIONS

Unless specifically excepted, all subject matter of the herein listed application(s) and of any and all parent, grandparent, great-grandparent, etc. applications of the herein listed applications, including any priority claims, is incorporated herein by reference to the extent such subject matter is not inconsistent herewith.

Unless specifically excepted, the present application is related to and/or claims the benefit of the earliest available effective filing date(s) from/through the application(s) if any, listed herein (e.g., claims earliest available priority dates for other than provisional patent applications, or claims benefits under 35 USC §119(e) for provisional patent applications, for any and all parent, grandparent, great-grandparent, etc. applications of the listed applications.

### 1. Prior Applications

A. For purposes of the USPTO extra-statutory requirements, the present application claims benefit of priority of U.S. Provisional Patent Application No. 62/170,127, naming William Gates, Max R. Levchin, Nathan P. Myhrvold, Clarence T. Tegreene, and Lowell L. Wood, Jr. as inventors, filed 2 Jun. 2015, which was filed within the twelve months preceding the filing date of the present application or is an application of which a currently co-pending application is entitled to the benefit of the filing date, such as:
(1) U.S. Utility patent application Ser. No. 15/055,515, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 26 Feb. 2016, which is currently co-pending or is an application of which a currently co-pending application is entitled to the benefit of the filing date.

B. For purposes of the USPTO extra-statutory requirements, the present application claims benefit of priority of U.S. Provisional Patent Application No. 62/188,277, naming William Gates, Max R. Levchin, Nathan P. Myhrvold, Clarence T. Tegreene, and Lowell L. Wood, Jr. as inventors, filed 2 Jul. 2015, which was filed within the twelve months preceding the filing date of the present application or is an application of which a currently co-pending application is entitled to the benefit of the filing date, such as:
(1) U.S. Utility patent application Ser. No. 15/055,515, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 26 Feb. 2016, which is currently co-pending or is an application of which a currently co-pending application is entitled to the benefit of the filing date.

C. For purposes of the USPTO extra-statutory requirements, the present application claims benefit of priority of U.S. Provisional Patent Application No. 62/233,248, naming Clarence T. Tegreene as inventor, filed 25 Sep. 2015, which was filed within the twelve months preceding the filing date of the present application or is an application of which a currently co-pending application is entitled to the benefit of the filing date, such as:
(1) U.S. Utility patent application Ser. No. 15/055,515, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 26 Feb. 2016, which is currently co-pending or is an application of which a currently co-pending application is entitled to the benefit of the filing date.

D. For purposes of the USPTO extra-statutory requirements, the present application claims benefit of priority of U.S. Provisional Patent Application No. 62/235,459, naming Clarence T. Tegreene as inventor, filed 30 Sep. 2015, which was filed within the twelve months preceding the filing date of the present application or is an application of which a currently co-pending application is entitled to the benefit of the filing date, such as:
(1) U.S. Utility patent application Ser. No. 15/055,515, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 26 Feb. 2016, which is currently co-pending or is an application of which a currently co-pending application is entitled to the benefit of the filing date.

E. For purposes of the USPTO extra-statutory requirements, the present application claims benefit of priority of U.S. Provisional Patent Application No. 62/239,816, naming Clarence T. Tegreene as inventor, filed 9 Oct. 2015, which was filed within the twelve months preceding the filing date of the present application or is an application of which a currently co-pending application is entitled to the benefit of the filing date, such as
(1) U.S. Utility patent application Ser. No. 15/190,155, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 22 Jun. 2016, which is currently co-pending or is an application of which a currently co-pending application is entitled to the benefit of the filing date.

F. For purposes of the USPTO extra-statutory requirements, the present application claims benefit of priority of U.S. Provisional Patent Application No. 62/241,730, naming Clarence T. Tegreene as inventor, filed 14 Oct. 2015, which was filed within the twelve months preceding the filing date of the present application or is an application of which a currently co-pending application is entitled to the benefit of the filing date, such as
(1) U.S. Utility patent application Ser. No. 15/190,155, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 22 Jun. 2016, which is currently co-pending or is an application of which a currently co-pending application is entitled to the benefit of the filing date.

G. For purposes of the USPTO extra-statutory requirements, the present application claims benefit of priority of U.S. Provisional Patent Application No. 62/265,941, naming Clarence T. Tegreene as inventor, filed 10 Dec. 2015, which was filed within the twelve months preceding the filing date of the present application or is an application of which a currently co-pending application is entitled to the benefit of the filing date.

H. For purposes of the USPTO extra-statutory requirements, the present application constitutes a continuation-in-part of International Application No. PCT/US16/35360, titled “Machine/Article/Composition/Process State for Tracking Philanthropic And/or Other Efforts,” and naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 1 Jun. 2016 and designating the United States, with Attorney Docket No. 0115-003-001-PCT001, and which is currently co-pending or is an application of which a currently co-pending application is entitled to the benefit of the filing date, such as
(1) U.S. Utility patent application Ser. No. 15/190,155, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 22 Jun. 2016, which is currently co-pending or is an application of which a currently co-pending application is entitled to the benefit of the filing date.

I. For purposes of the USPTO extra-statutory requirements, the present application constitutes a continuation-in-part of International Application No. PCT/US16/35505, titled “Machine/Article/Composition/Process State for Tracking Philanthropic And/or Other Efforts,” and naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 2 Jun. 2016 and designating the United States, with Attorney Docket No. 0115-003-001-PCT002 (coded at the USPTO as 01150301PCT1), and which is currently co-pending or is an application of which a currently co-pending application is entitled to the benefit of the filing date, such as
(1) U.S. Utility patent application Ser. No. 15/190,155, entitled MACHINE/ARTICLE/COMPOSITION/PROCESS STATE(S) FOR TRACKING PHILANTHROPIC AND/OR OTHER EFFORTS, naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 22 Jun. 2016, which is currently co-pending or is an application of which a currently co-pending application is entitled to the benefit of the filing date.

J. For purposes of the USPTO extra-statutory requirements, the present application constitutes a continuation-in-part of U.S. application Ser. No. 15/055,515, titled “Machine/Article/Composition/Process State for Tracking Philanthropic And/or Other Efforts,” and naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 26 Feb. 2016, and which is currently co-pending or is an application of which a currently co-pending application is entitled to the benefit of the filing date.

K. For purposes of the USPTO extra-statutory requirements, the present application constitutes a continuation-in-part of U.S. application Ser. No. 15/190,155, titled “Machine/Article/Composition/Process State(s) for Tracking Philanthropic And/or Other Efforts,” and naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 22 Jun. 2016, and which is currently co-pending or is an application of which a currently co-pending application is entitled to the benefit of the filing date.

L. For purposes of the USPTO extra-statutory requirements, the present application constitutes a continuation-in-part of International Application No. PCT/US16/050453, titled “Machine/Article/Composition/Process State for Tracking Philanthropic And/or Other Efforts,” and naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 6 Sep. 2016 and designating the United States, with Attorney Docket No. 0115-003-001-PCT003 (coded at the USPTO as 01150301PCT3), and which is currently co-pending or is an application of which a currently co-pending application is entitled to the benefit of the filing date.

M. For purposes of the USPTO extra-statutory requirements, the present application constitutes a continuation-in-part of U.S. Patent Application No. [TO BE ASSIGNED], titled “Machine/Article/Composition/Process State for Tracking Philanthropic And/or Other Efforts,” and naming Ali Arjomand, Kim Cameron, William Gates, Roderick A. Hyde, Muriel Y. Ishikawa, Jordin Kare, Max R. Levchin, Nathan P. Myhrvold, Tony S. Pan, Aaron Sparks, Russ Stein, Clarence T. Tegreene, Maurizio Vecchione, Lowell L. Wood, Jr., and Victoria Y. H. Wood as inventors, filed 24 Oct. 2016 and designating the United States, with Attorney Docket No. 0115-003-003-000000, and which is currently co-pending or is an application of which a currently co-pending application is entitled to the benefit of the filing date.

### 2. Application Data Sheets (ADS)

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. Lawyer (and Applicant, through dint of an Oath or Declaration, which has been or will be executed by at least one inventor to the best of Lawyer's knowledge), has provided above a specific reference to the application(s) from which priority is being claimed as recited by statute. Lawyer understands that the statute is unambiguous in its specific reference language and does not require either a serial number or any characterization, such as “continuation” or “continuation-in-part,” for claiming priority to U.S. patent applications. Notwithstanding the foregoing, Lawyer understands that the USPTO's computer programs have certain data entry requirements, and hence Lawyer has provided designation(s) of a relationship between the present application and its parent application(s) as set forth both above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### 3. Rights/Reservations/No Waiver/No Admissions/Saving Language

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. Lawyer has provided above a specific reference to the application(s) from which priority is being claimed as recited by statute. Lawyer understands that the statute is unambiguous in its specific reference language and does not require either a serial number or any characterization, such as “continuation” or “continuation-in-part,” for claiming priority to U.S. patent applications. Notwithstanding the foregoing, Lawyer understands that the USPTO's computer programs have certain data entry requirements, and hence Lawyer has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

United States case law is replete with patent applicants losing rights via clerical errors that appeared to have resulted from unintended errors which judges have held have broken the priority chains, and it seems likely that such breaks are a consequence of the non-statutory rules regarding priority claiming which have been imposed for the administrative convenience of the PTO. There should be a way for the drafting attorney to craft language to “fail safe” on this point, and that is what is intended herein. Specifically, Lawyer hereby gives public notice that priority is being claimed for the earliest priority that could be achieved under the Statutes through the herein listed applications, and further through any parents, grandparents, great-grandparents, etc. of the herein listed applications. Furthermore, Lawyer hereby gives public notice that incorporation by reference is made for the most inclusive subject matter that could be achieved under the Statutes through the herein listed applications, and further through any parents, grandparents, great-grandparents, etc. of the herein listed applications.

### BACKGROUND

This application is related to attribution of trackable items, e.g., currency, goods, and/or services, which may be used in philanthropic and/or other non-philanthropic efforts, and which may be directed to geographically diverse locations.

### SUMMARY

In one or more various aspects, a method includes but is not limited to that which is illustrated in the drawings. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1-A through 1-L, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1-A through 1-L are stitched together in the manner shown in the below table, which is reproduced below in table format.

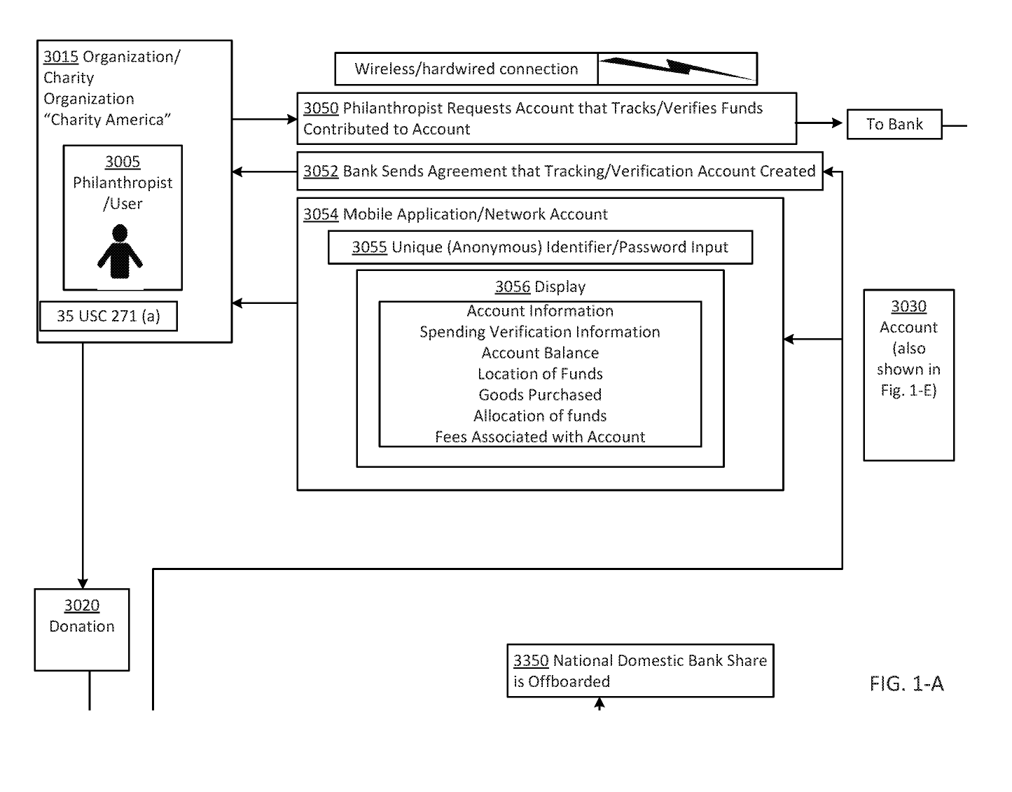

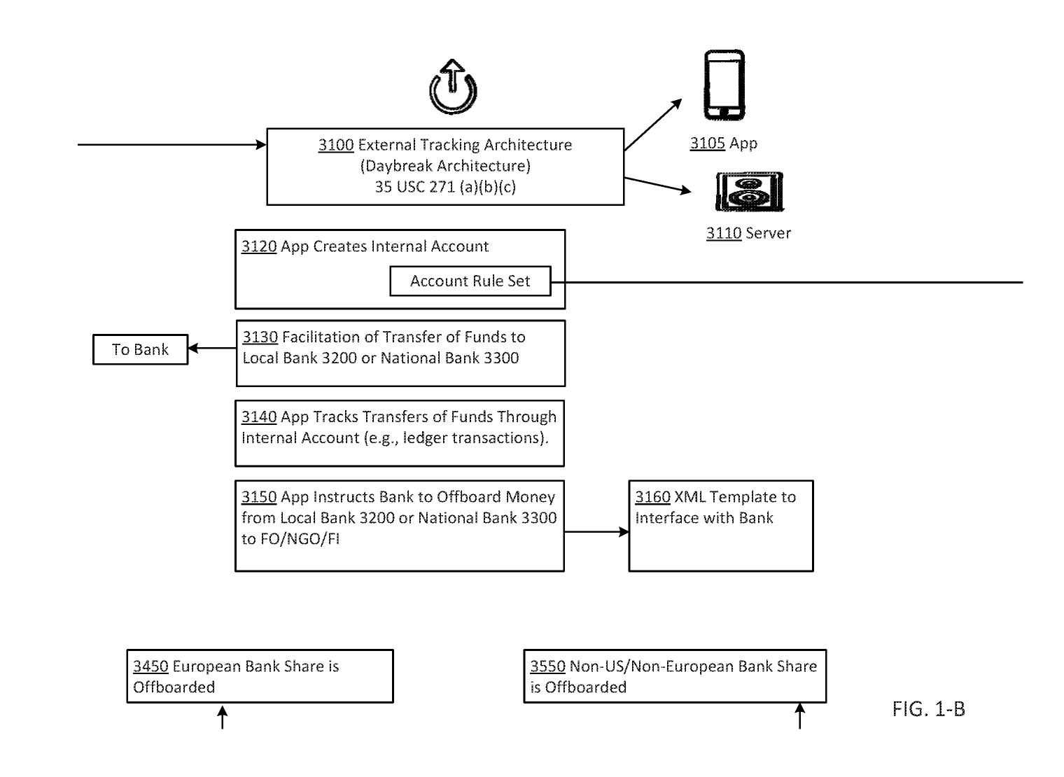

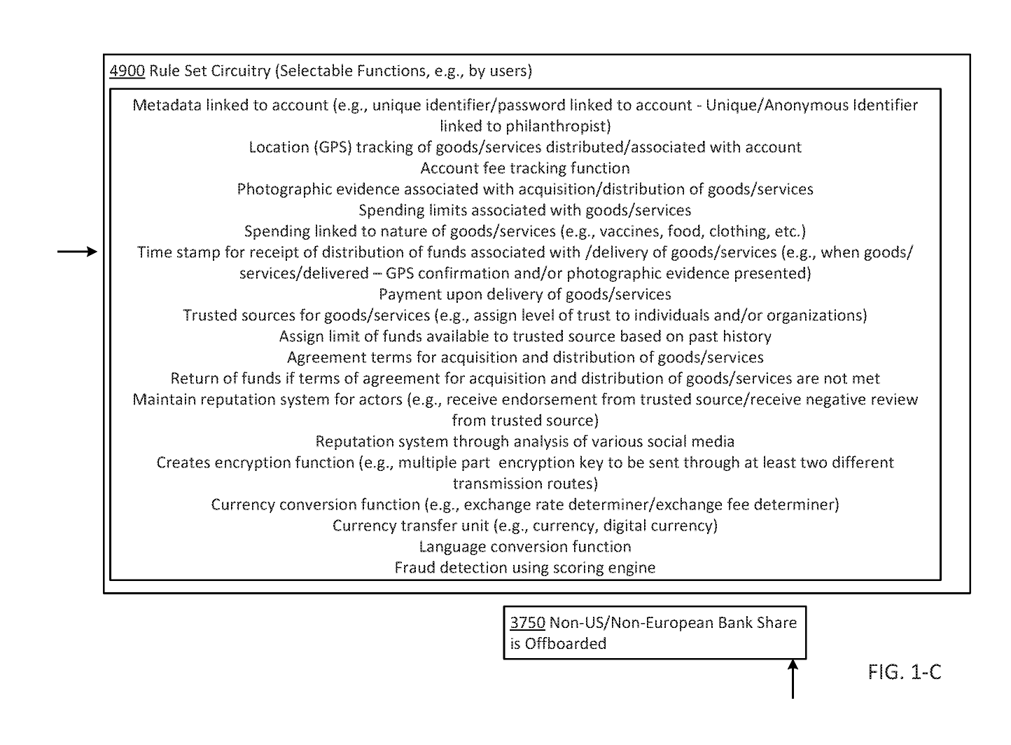

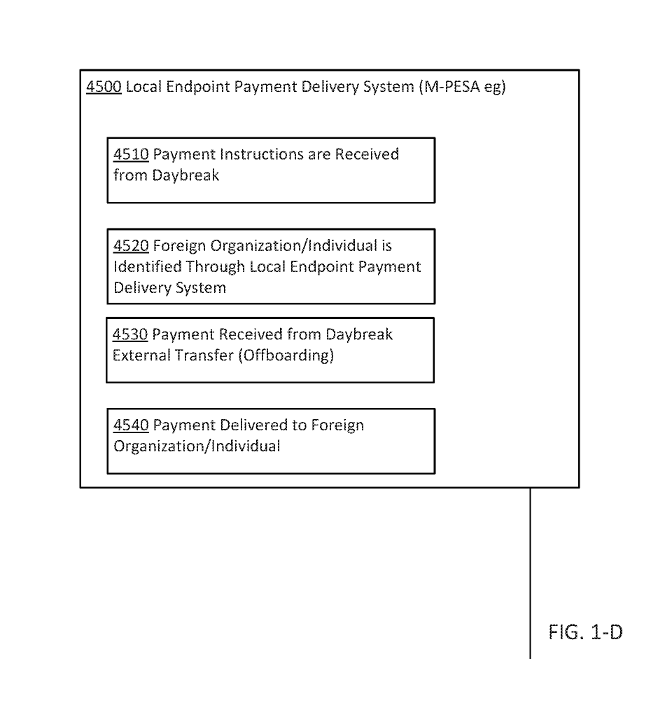

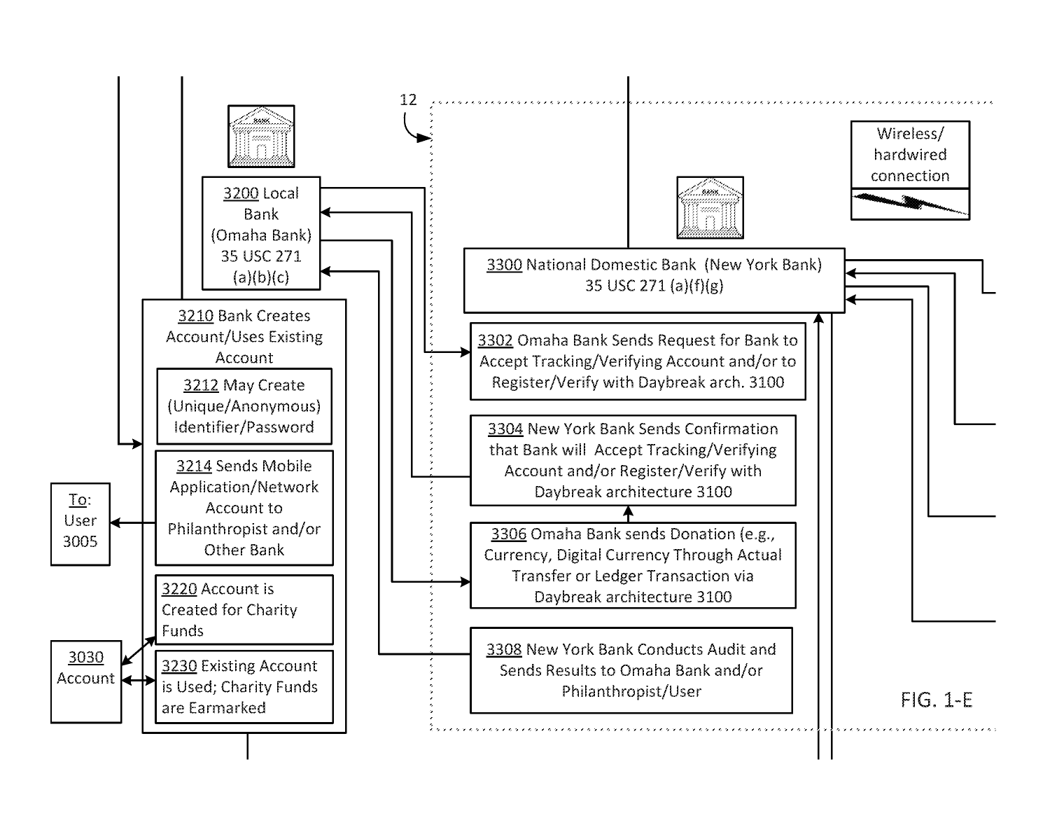

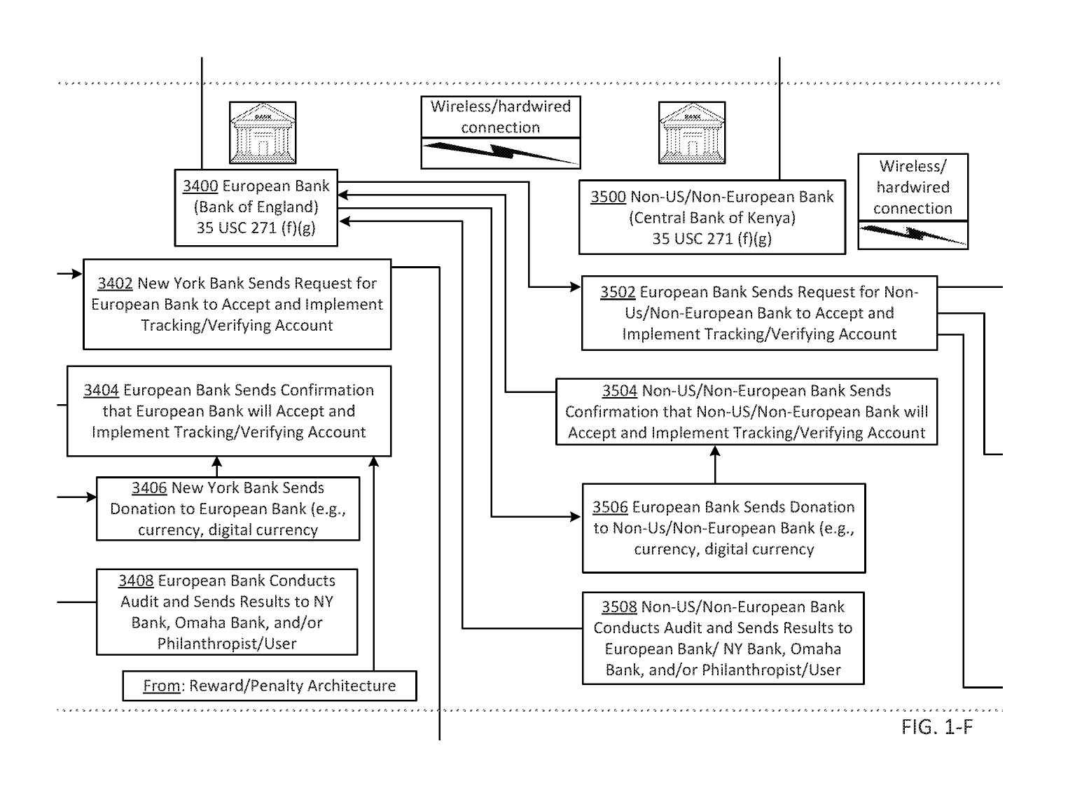

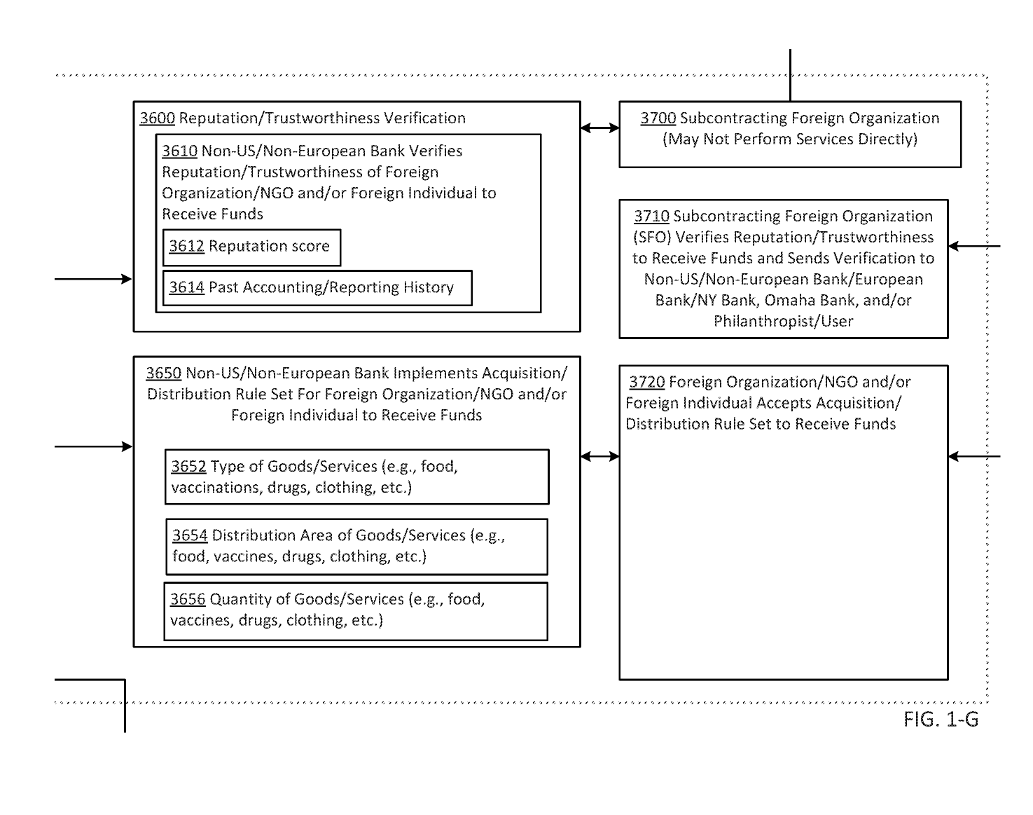

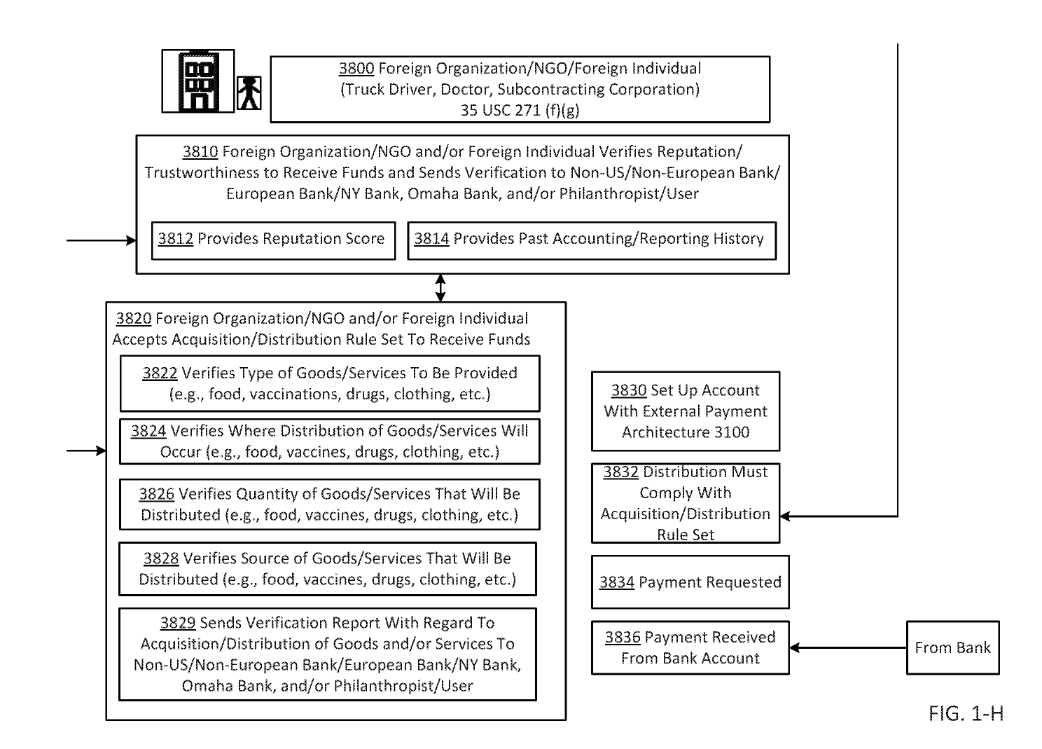

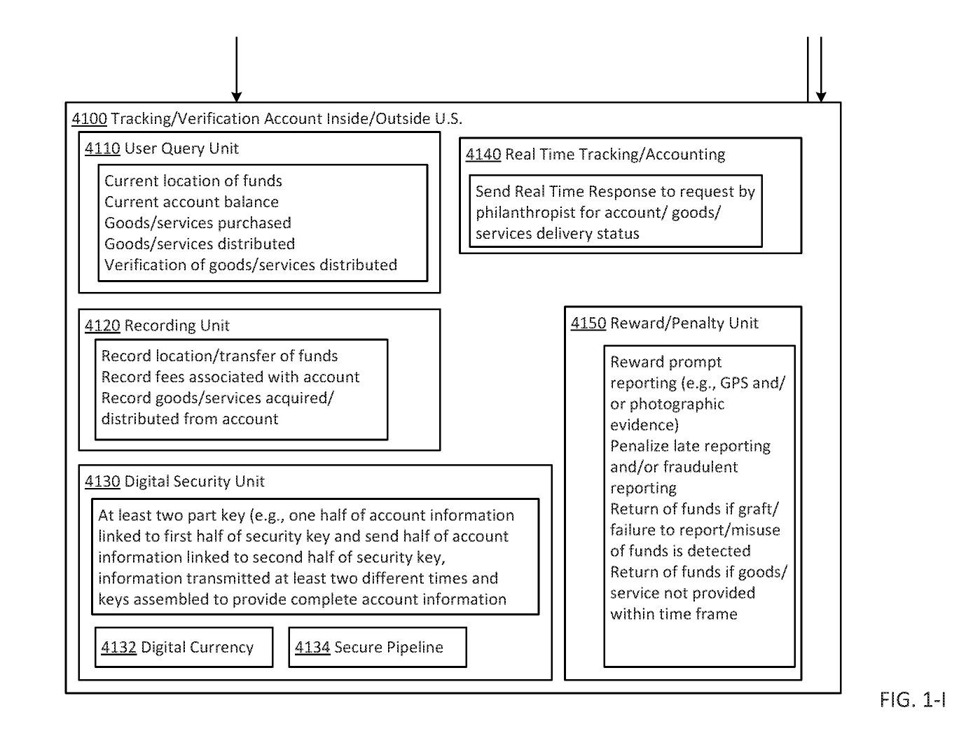

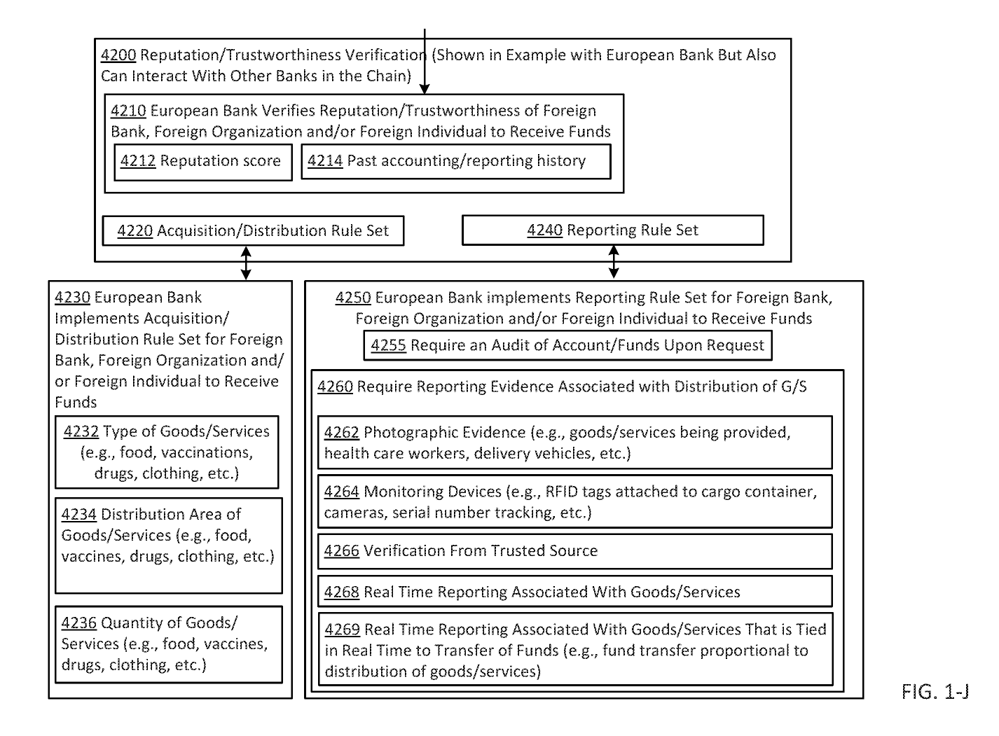

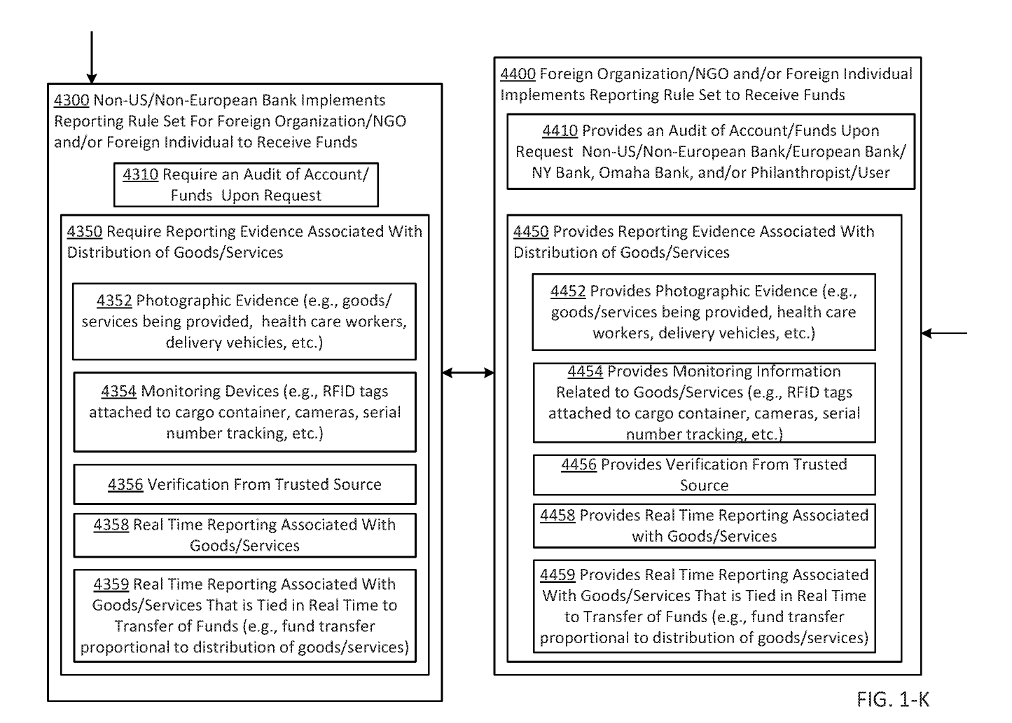

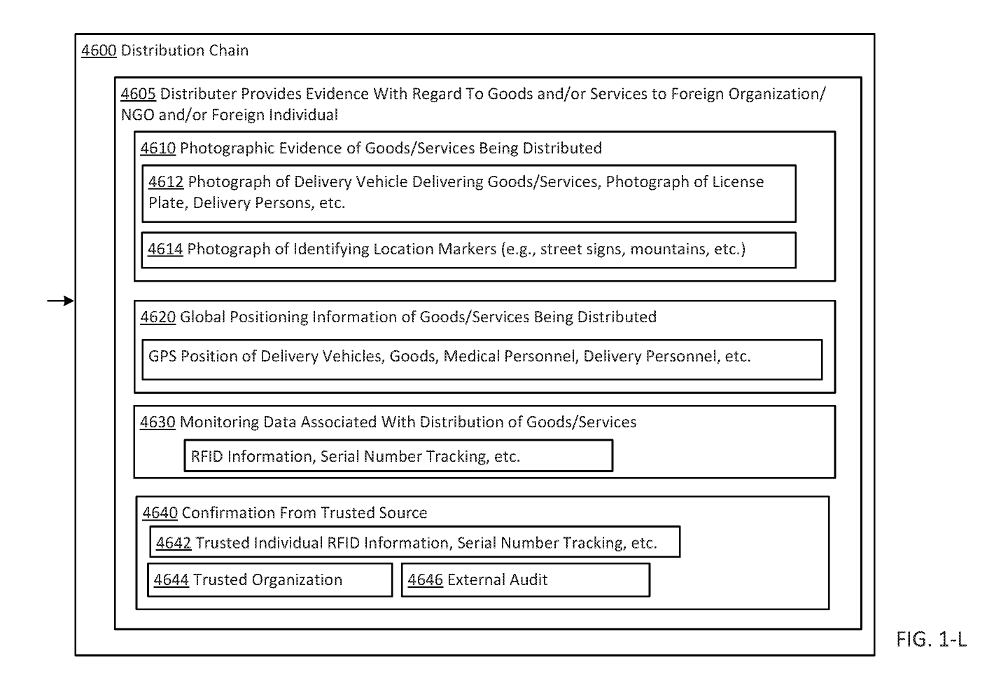

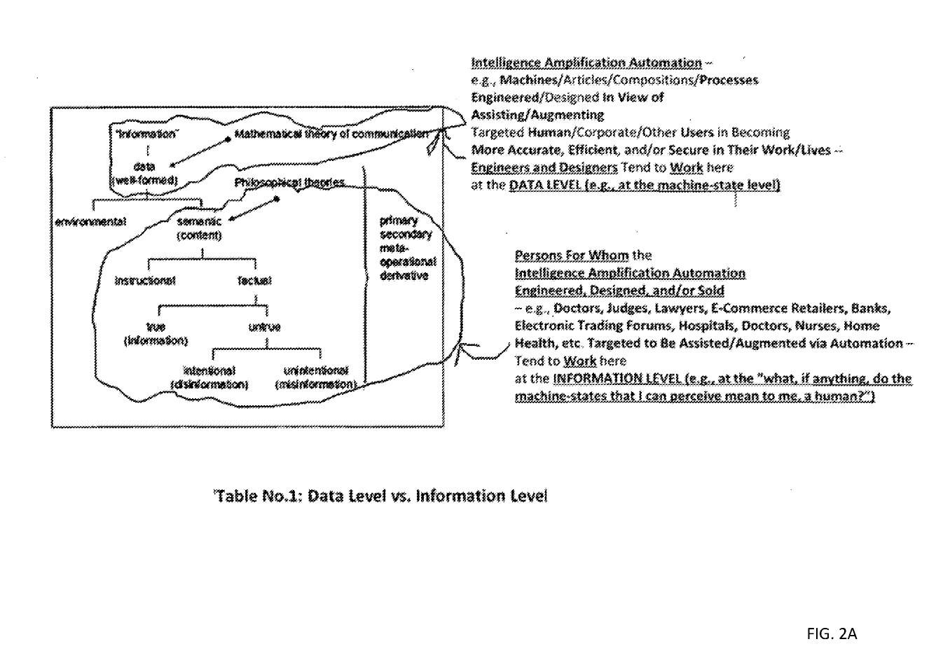

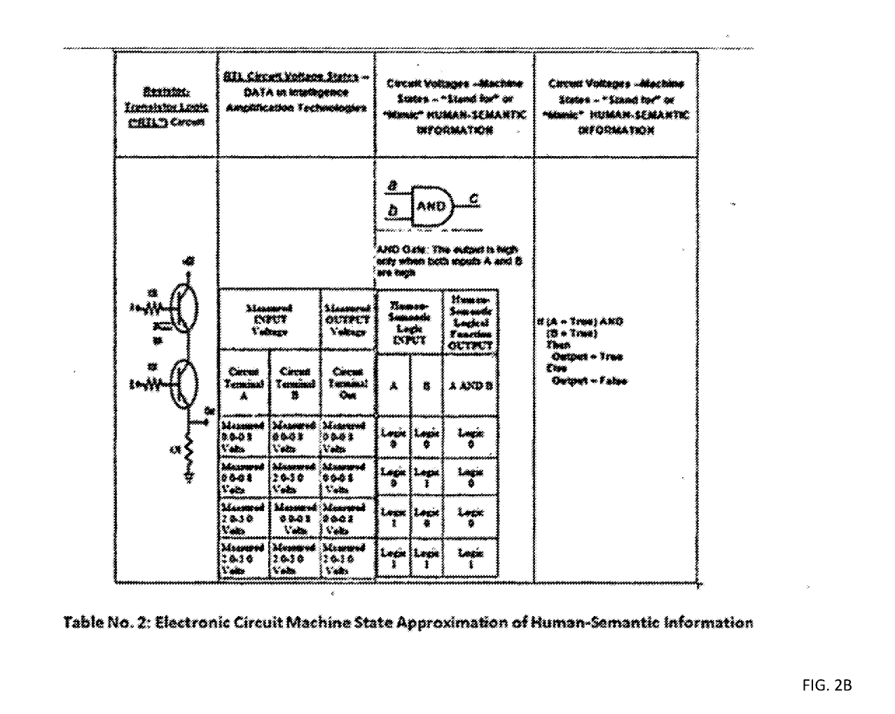

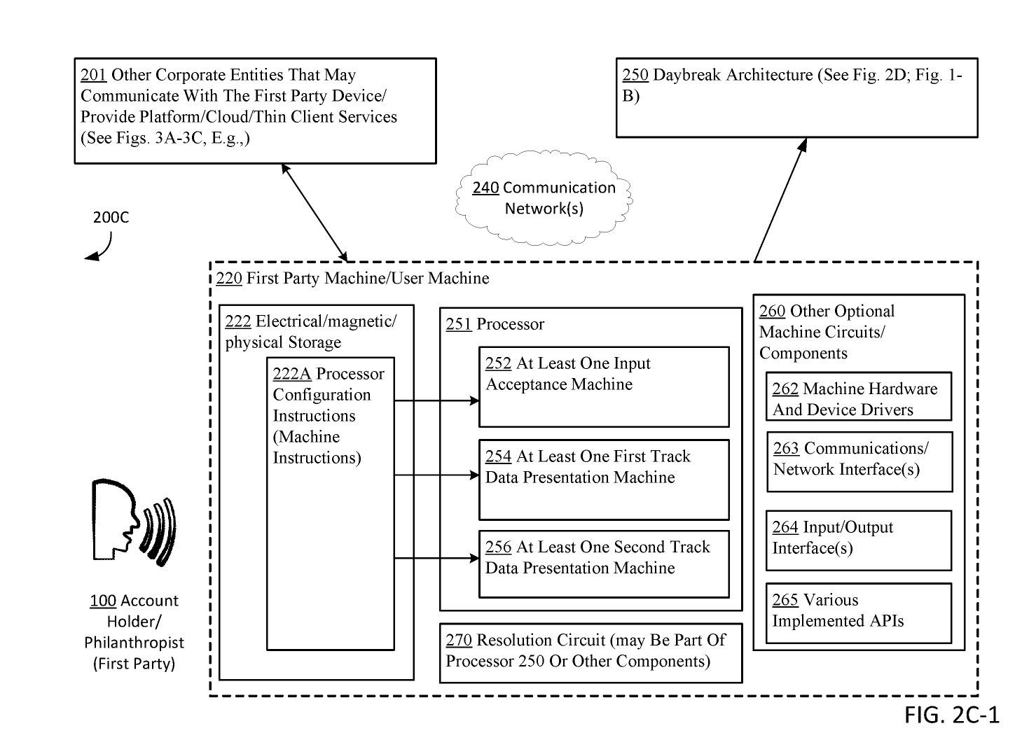

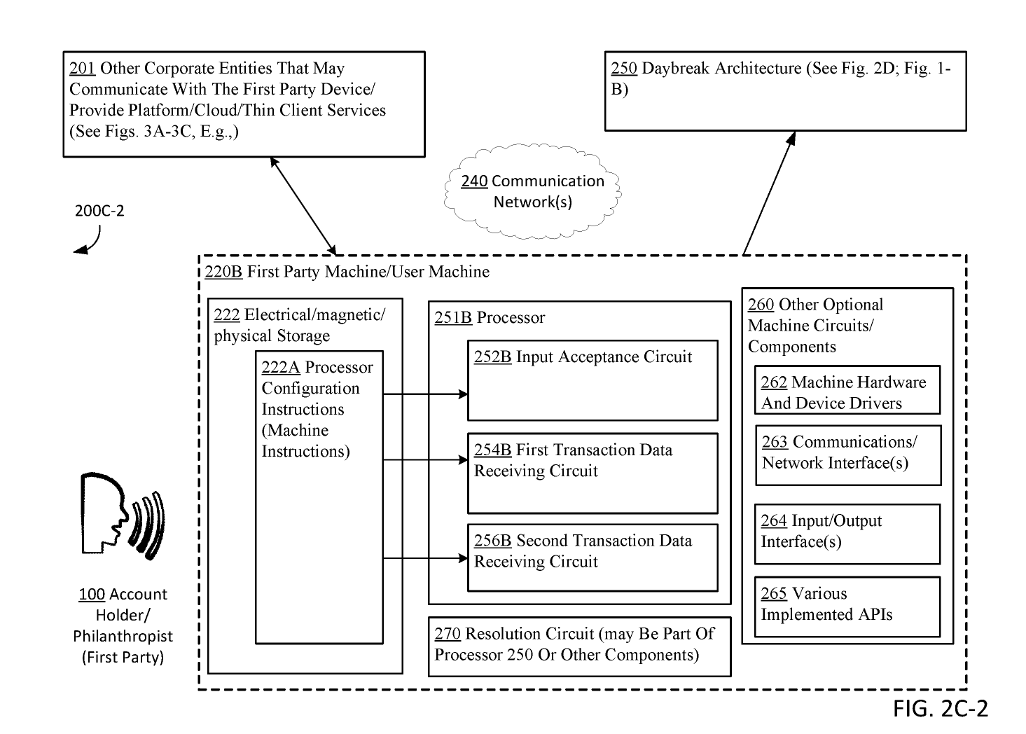

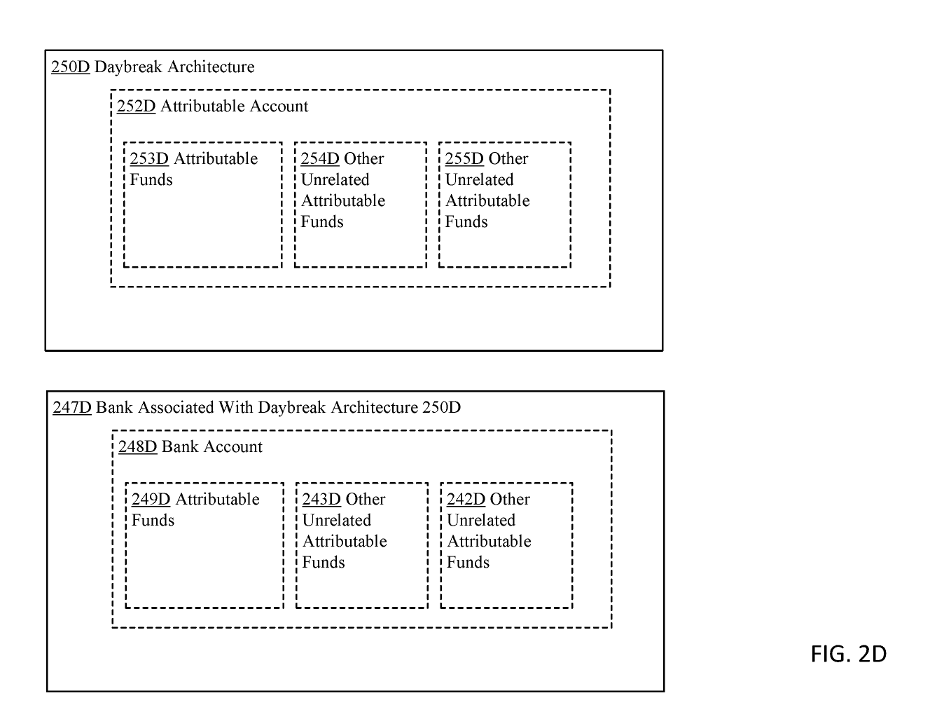

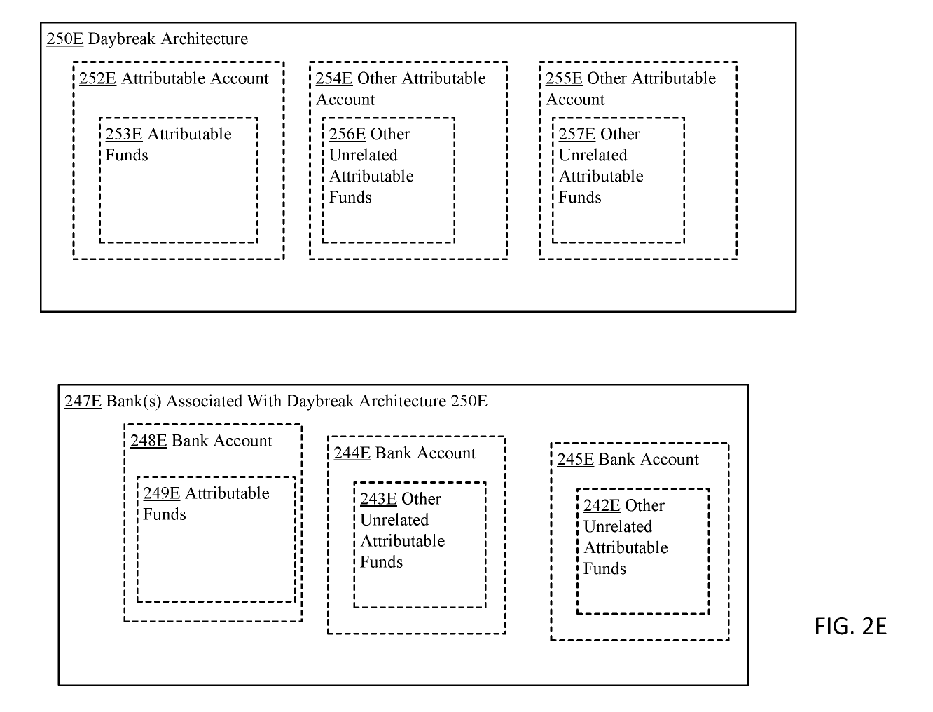

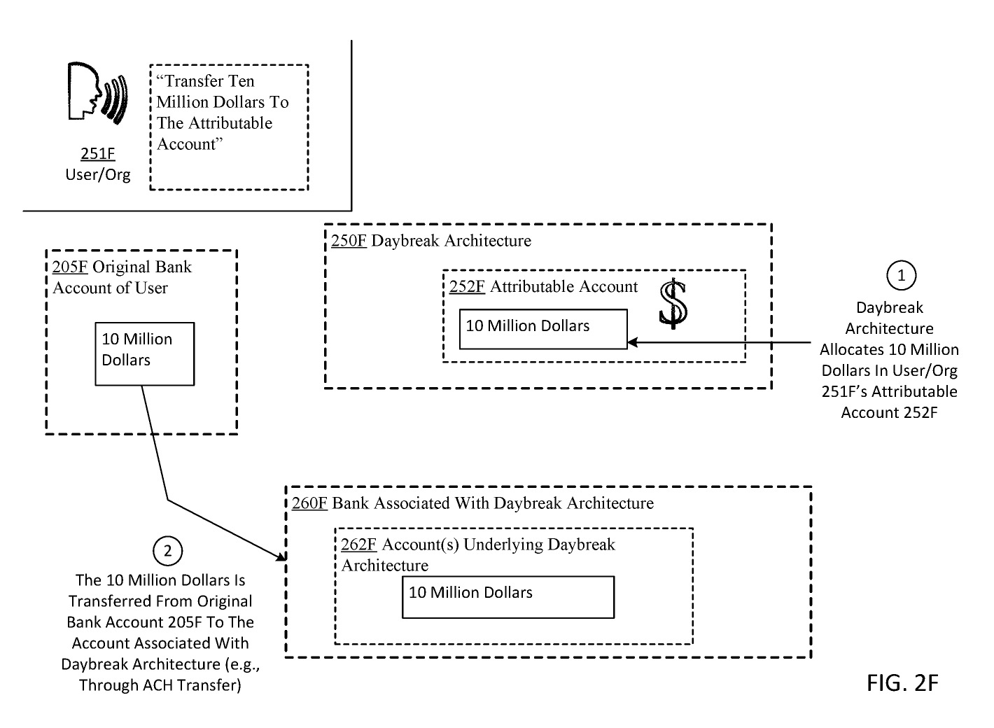

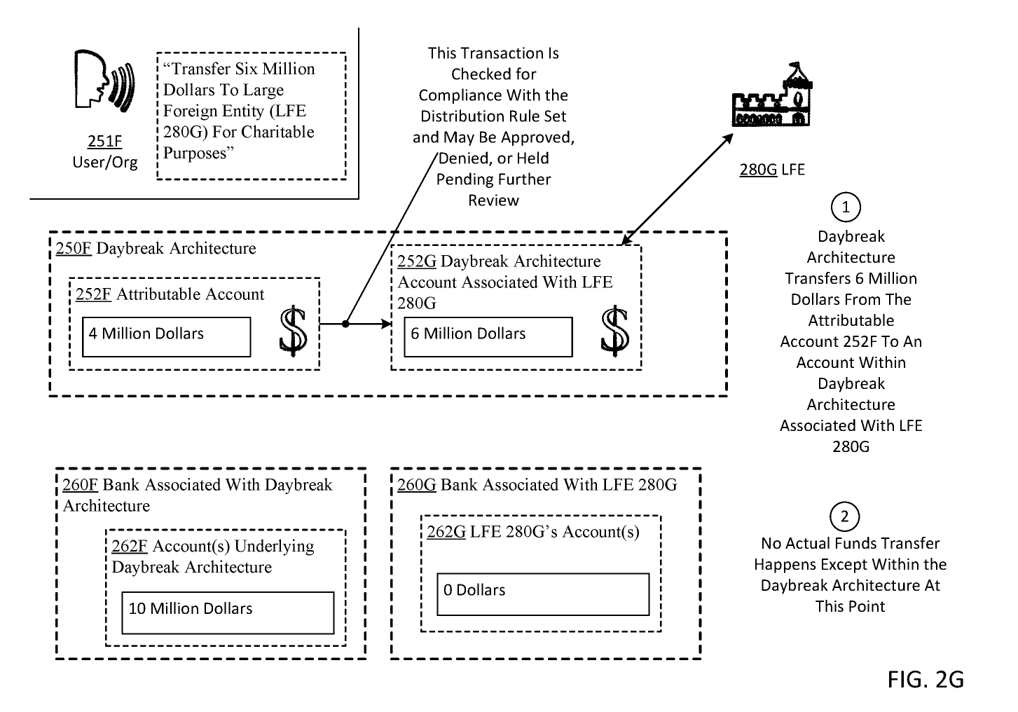

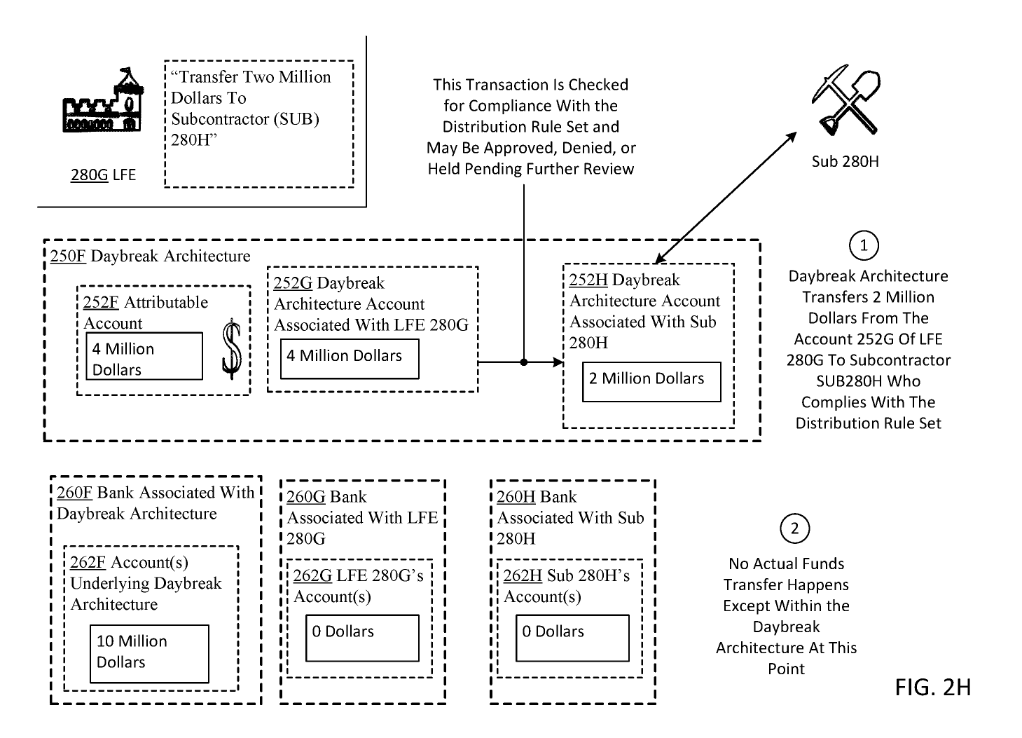

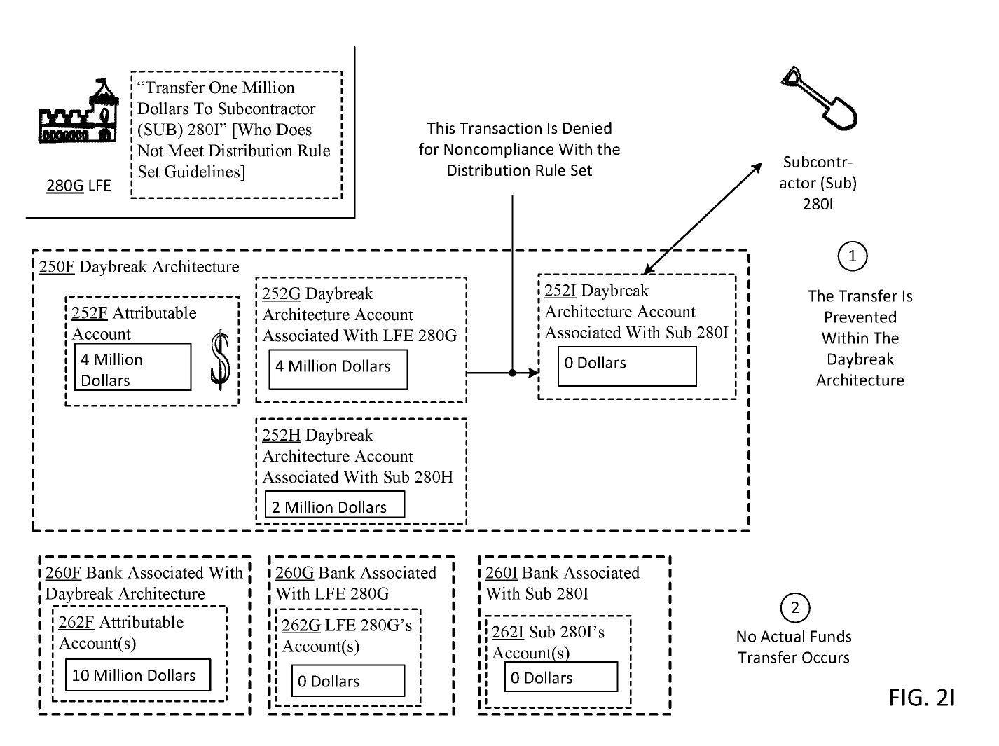

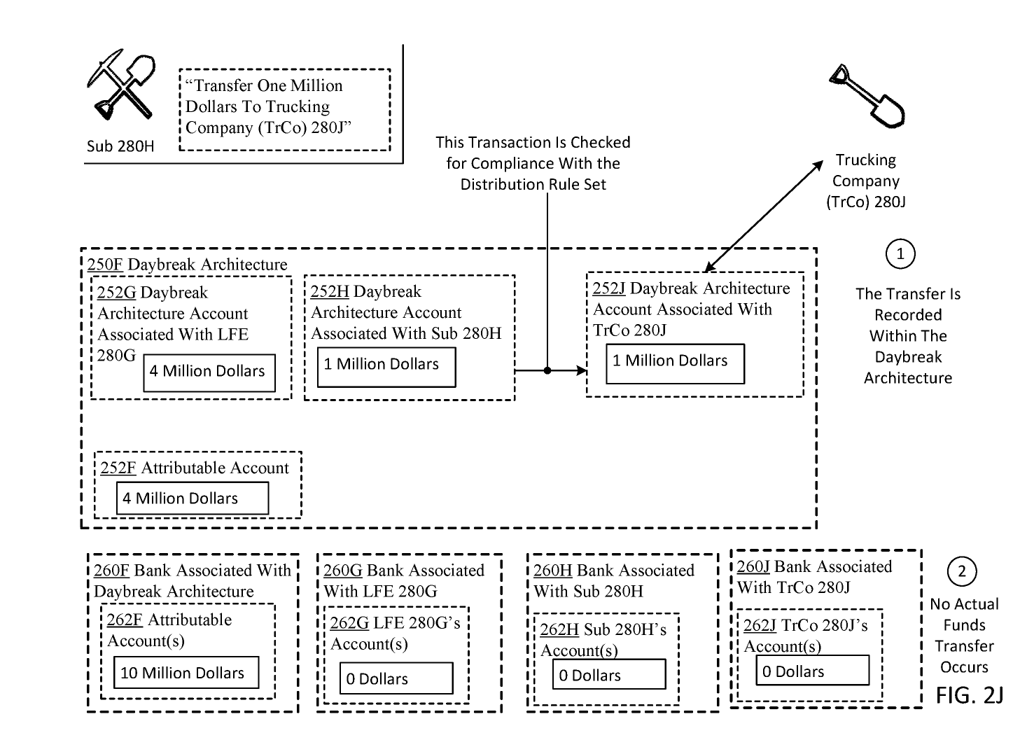

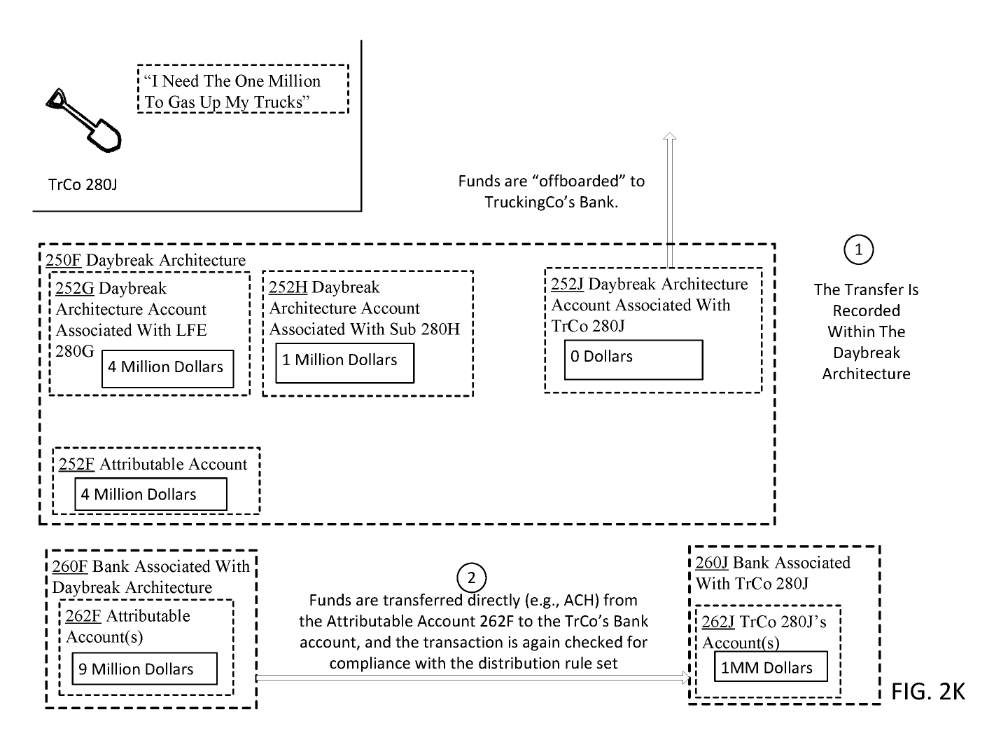

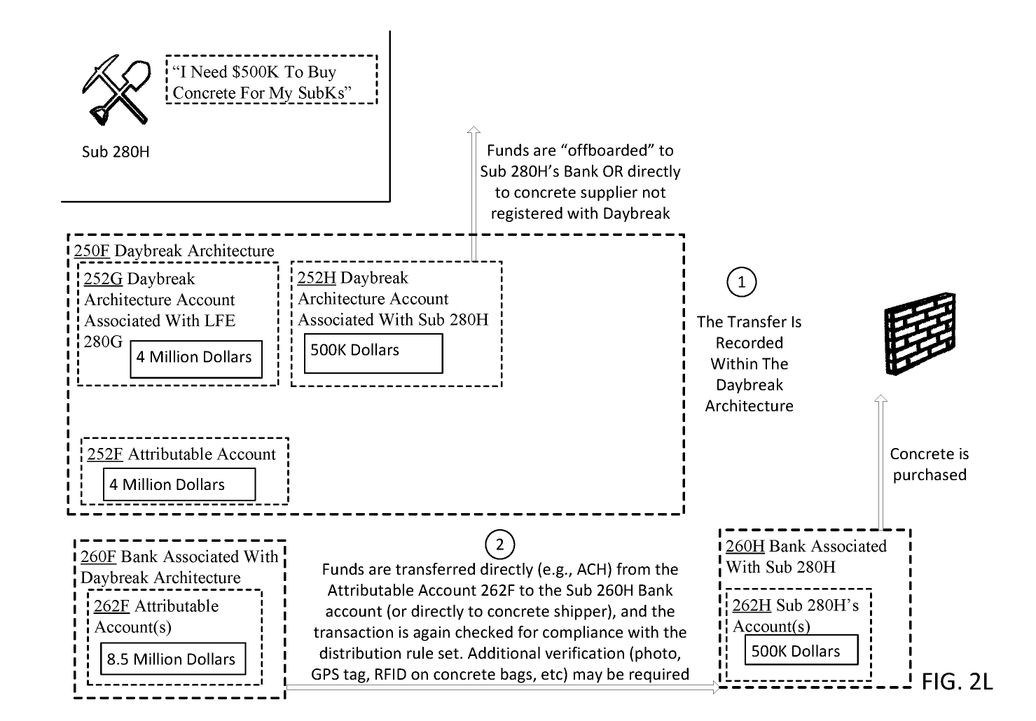

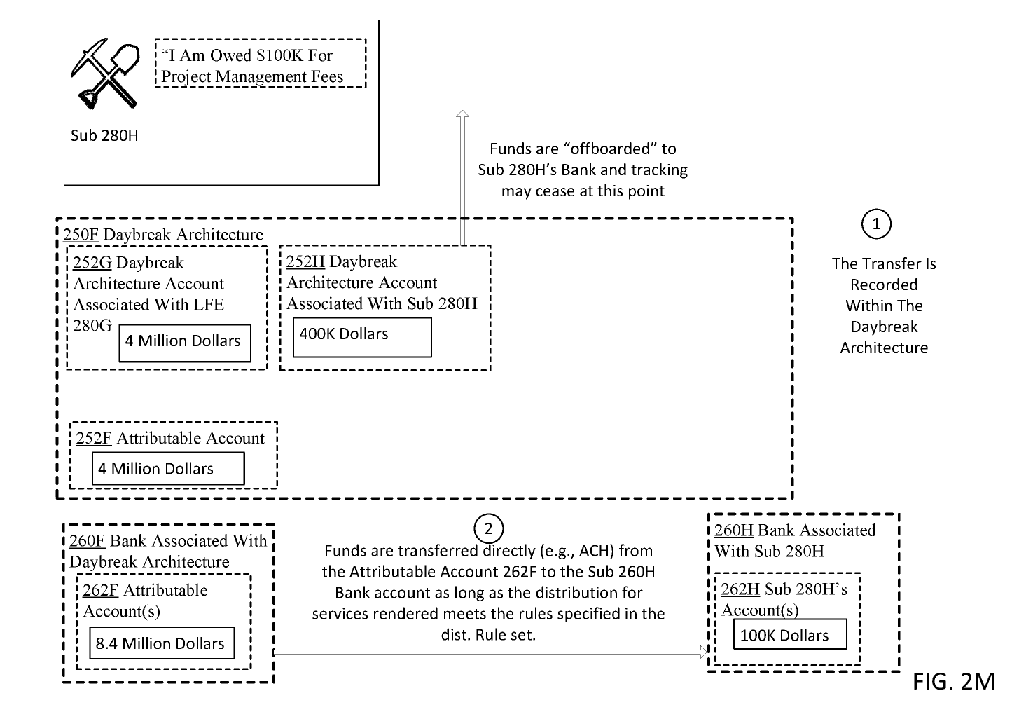

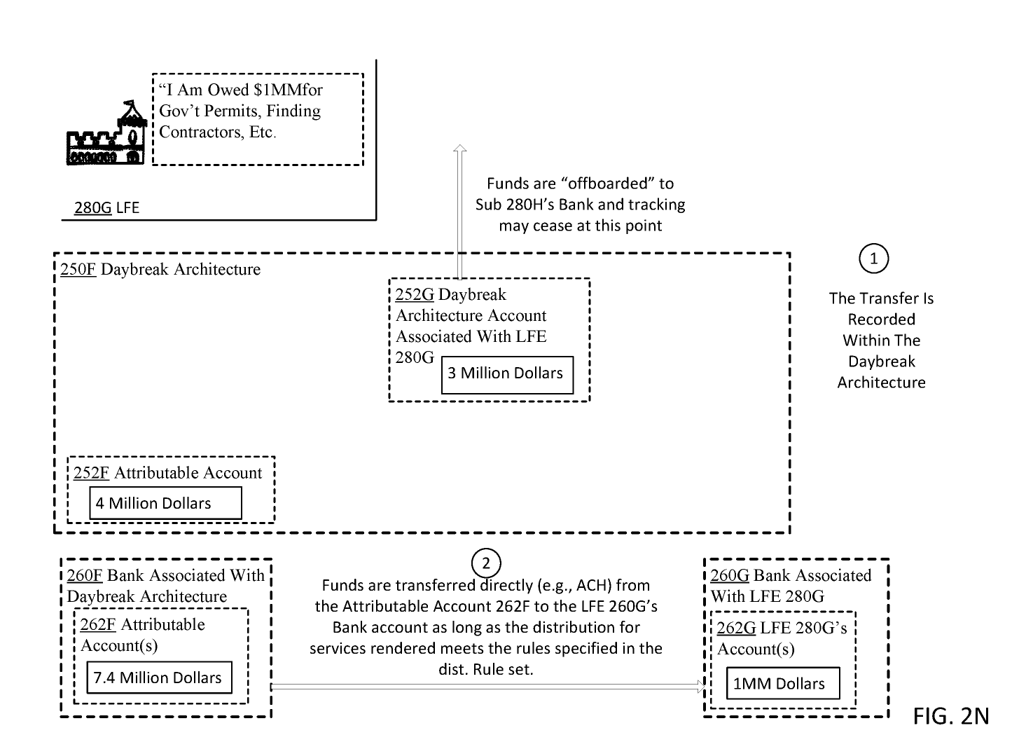

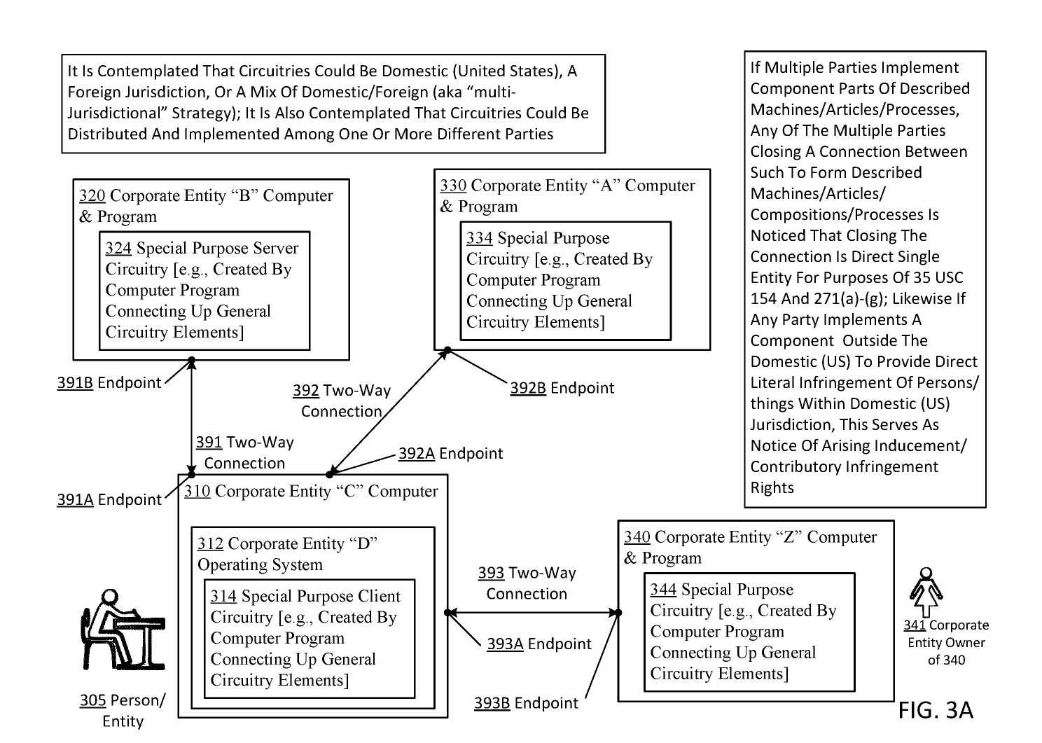

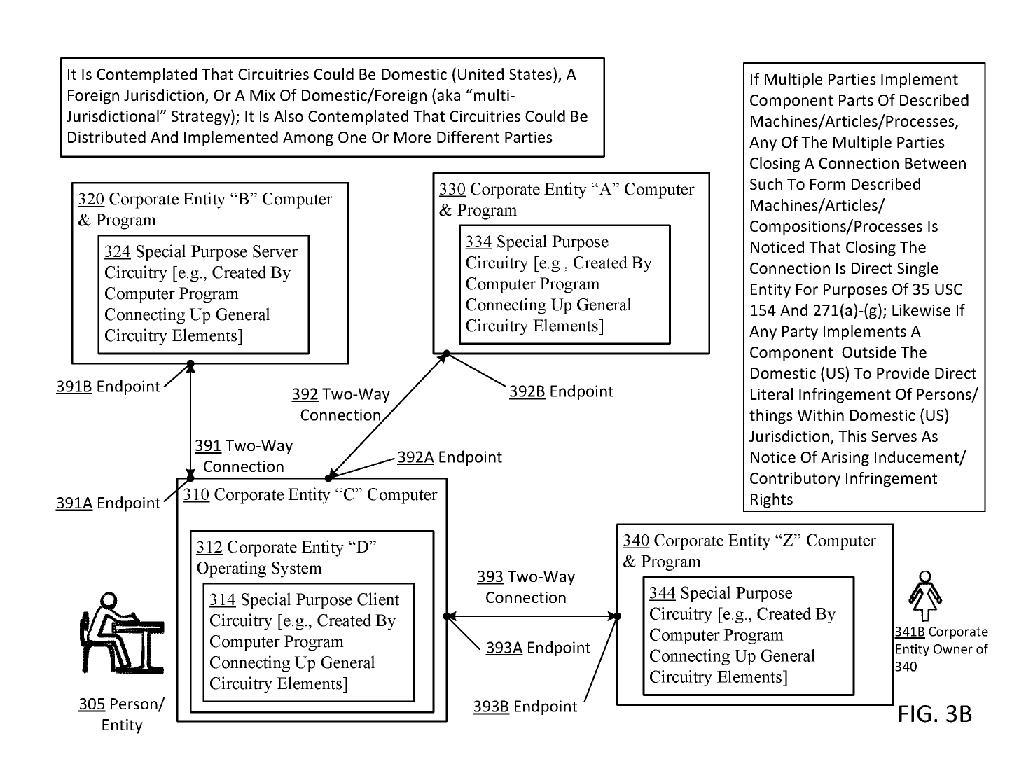

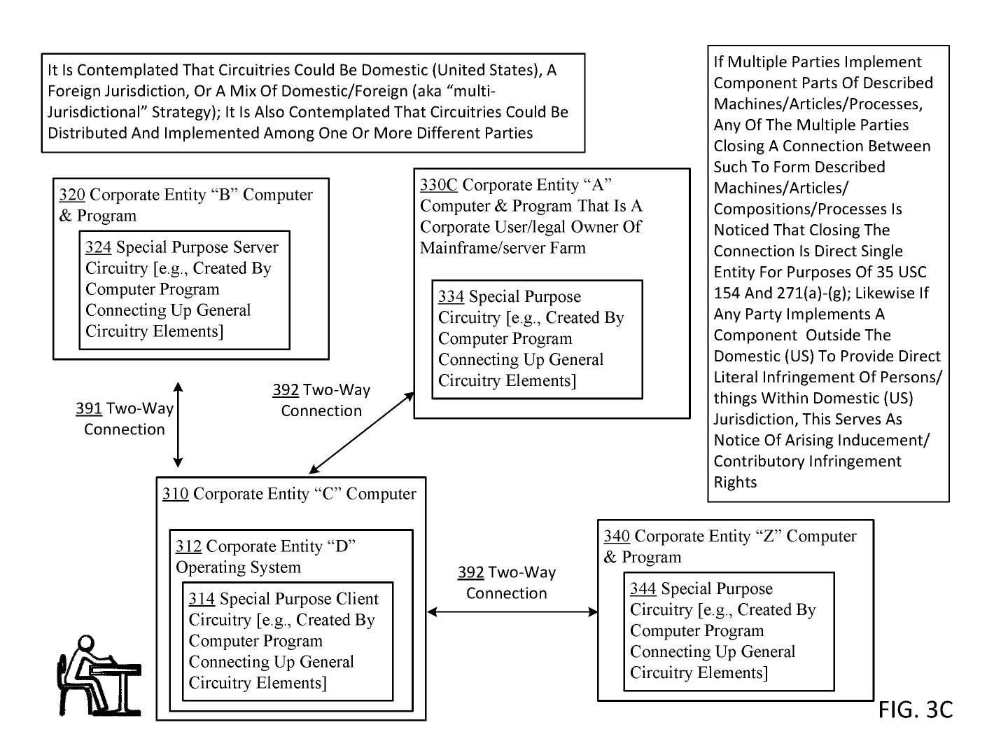

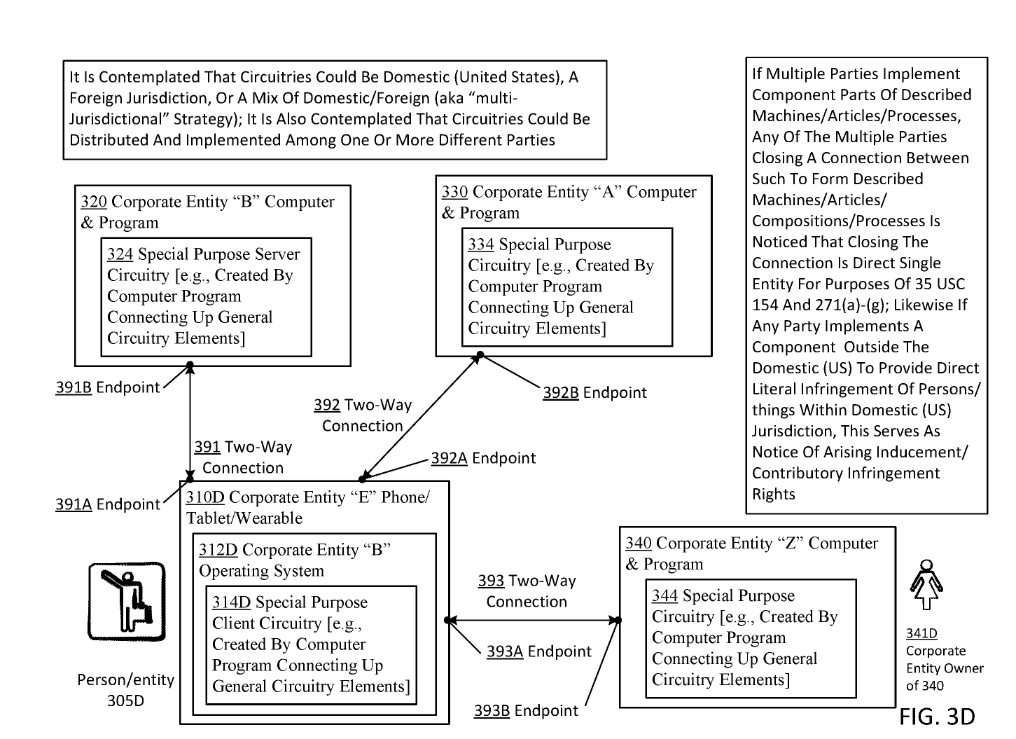

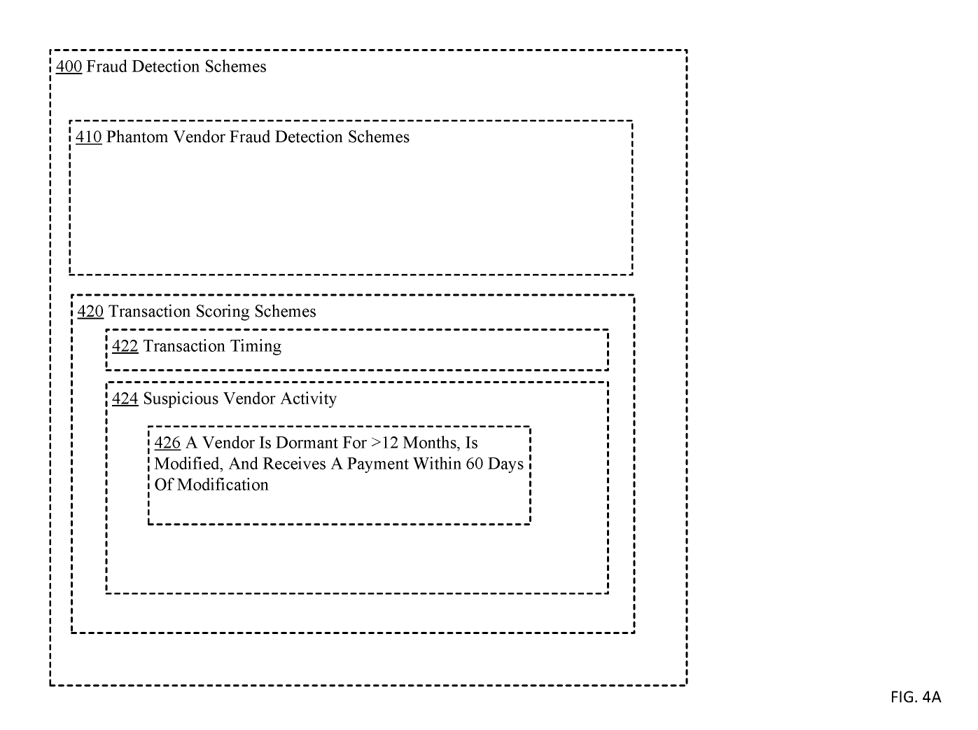

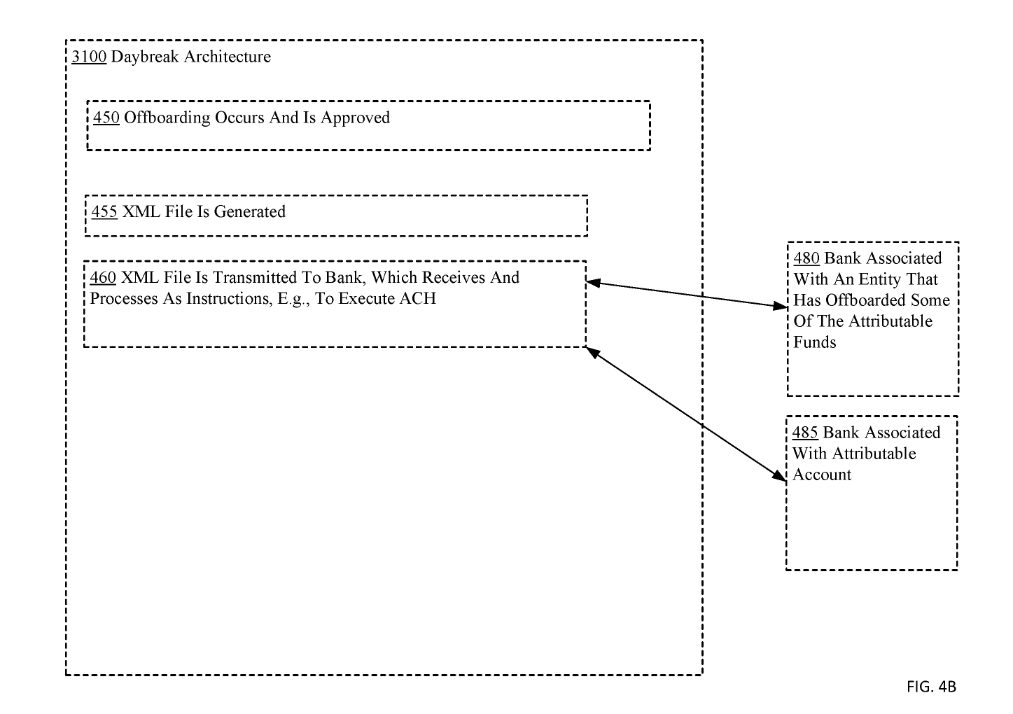

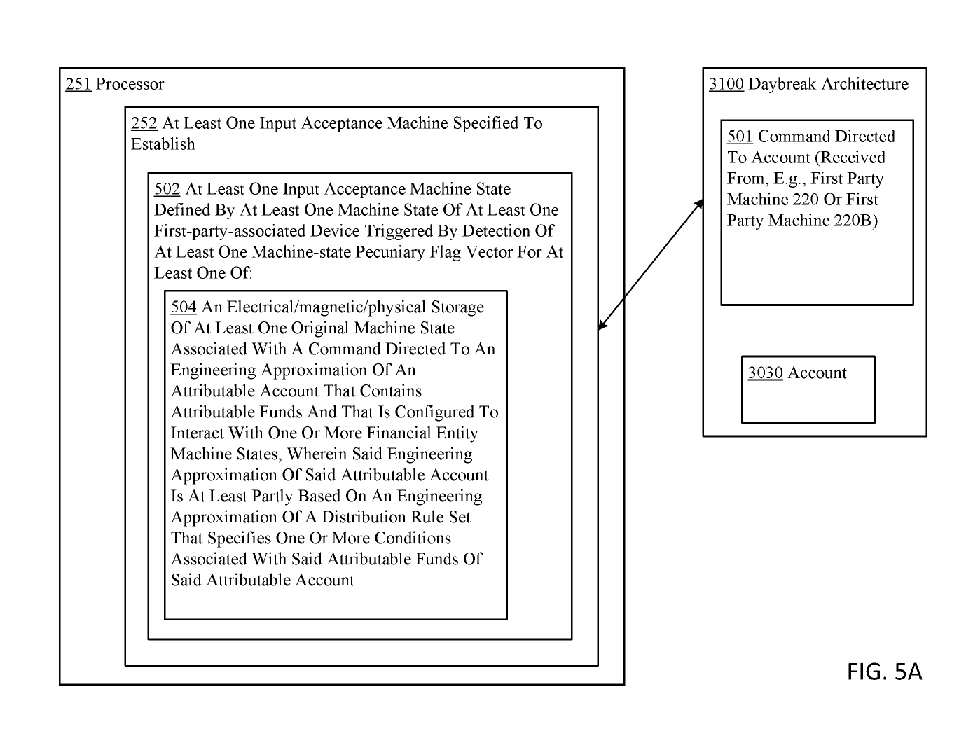

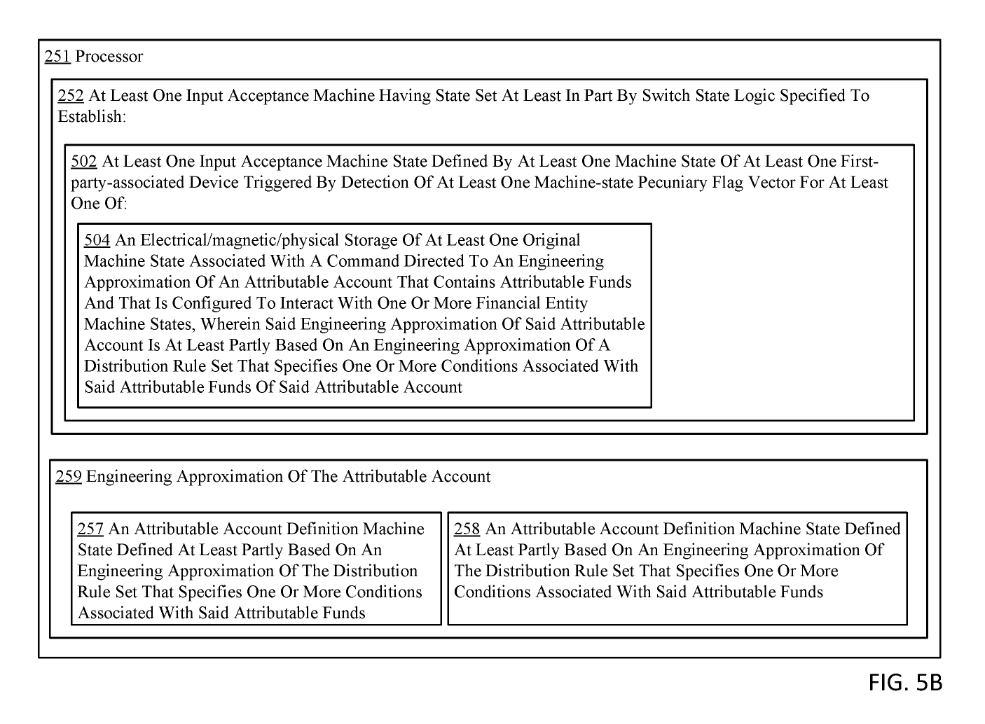

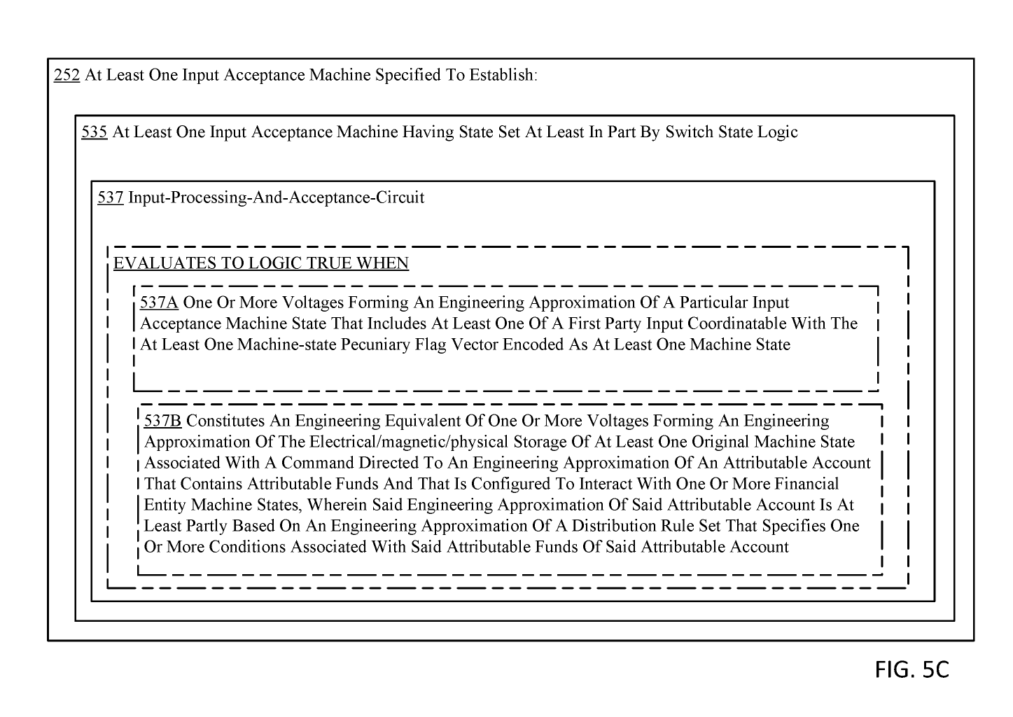

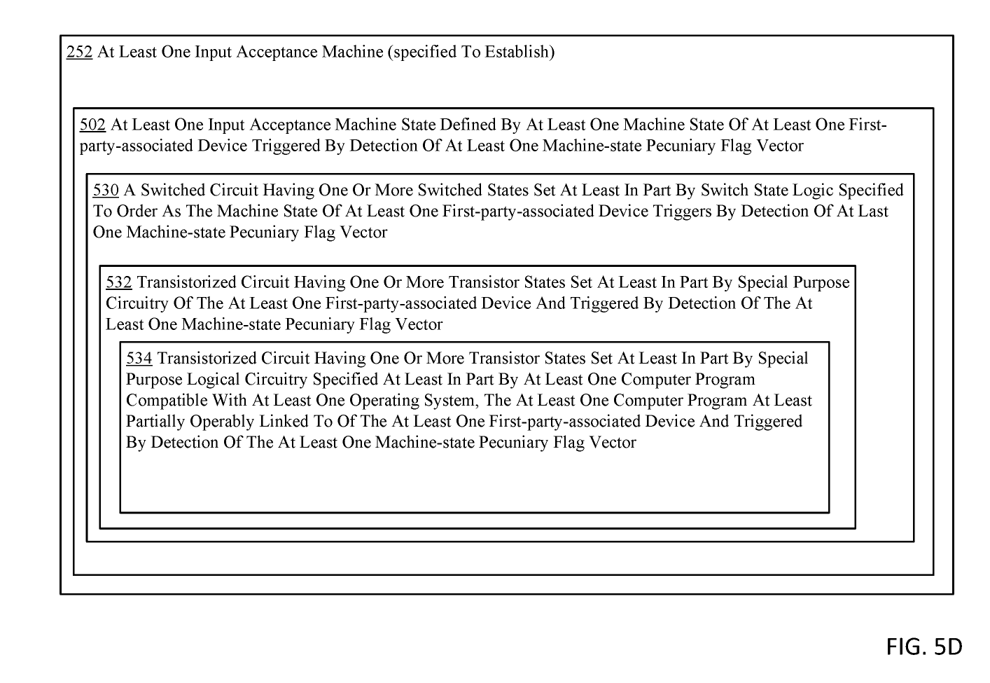

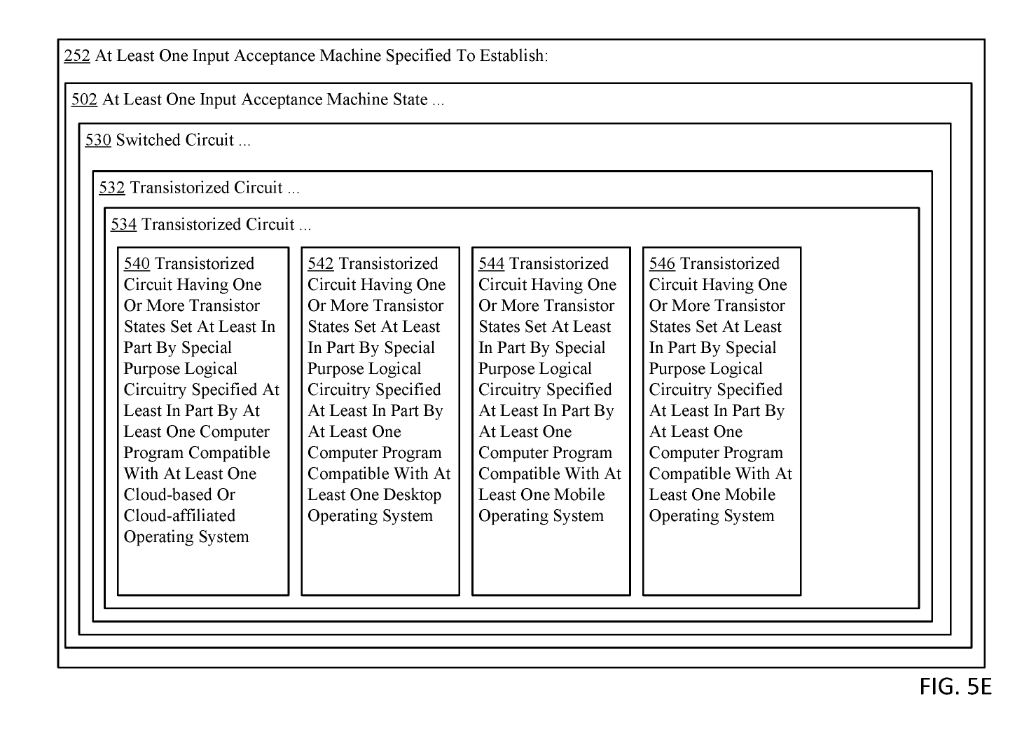

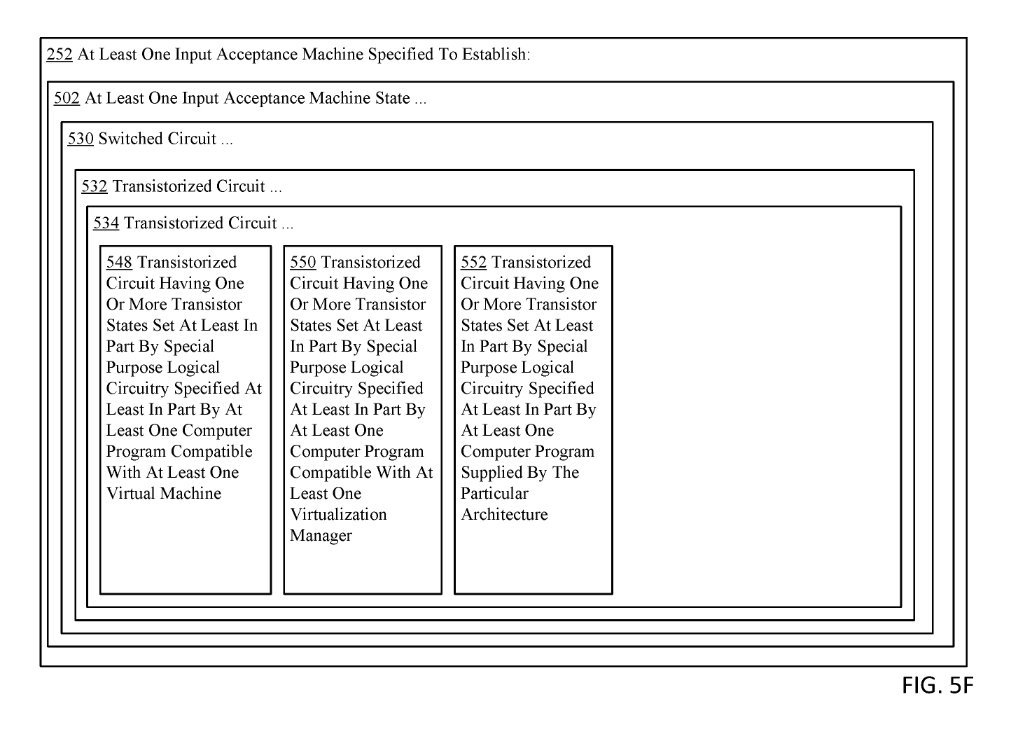

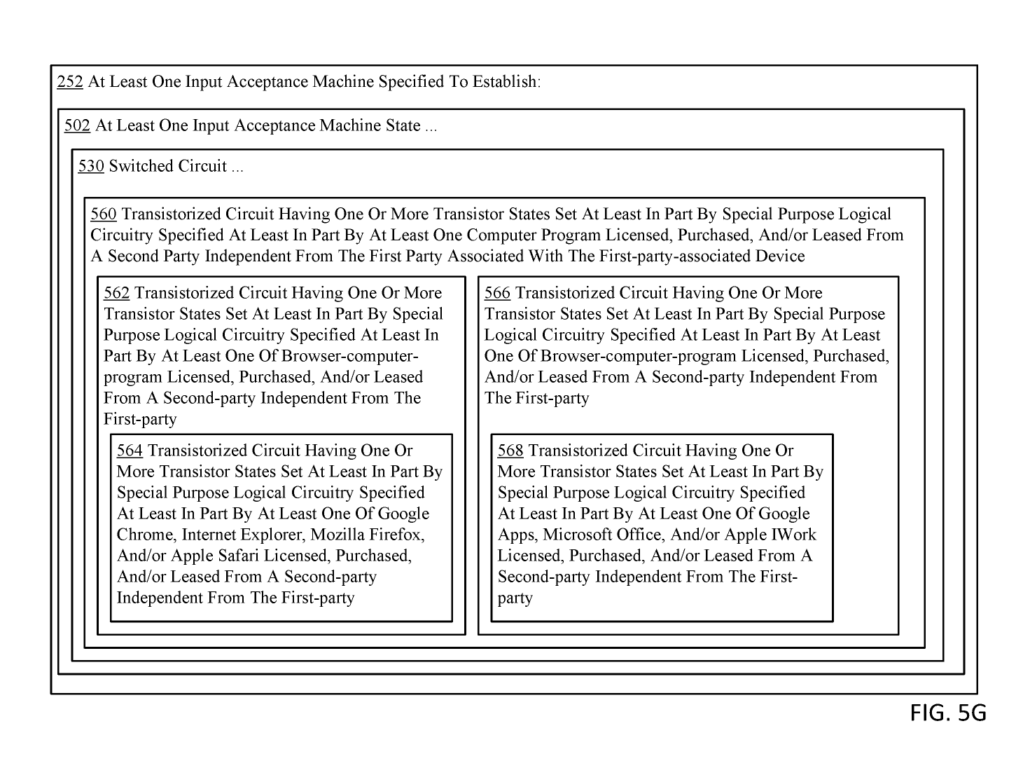

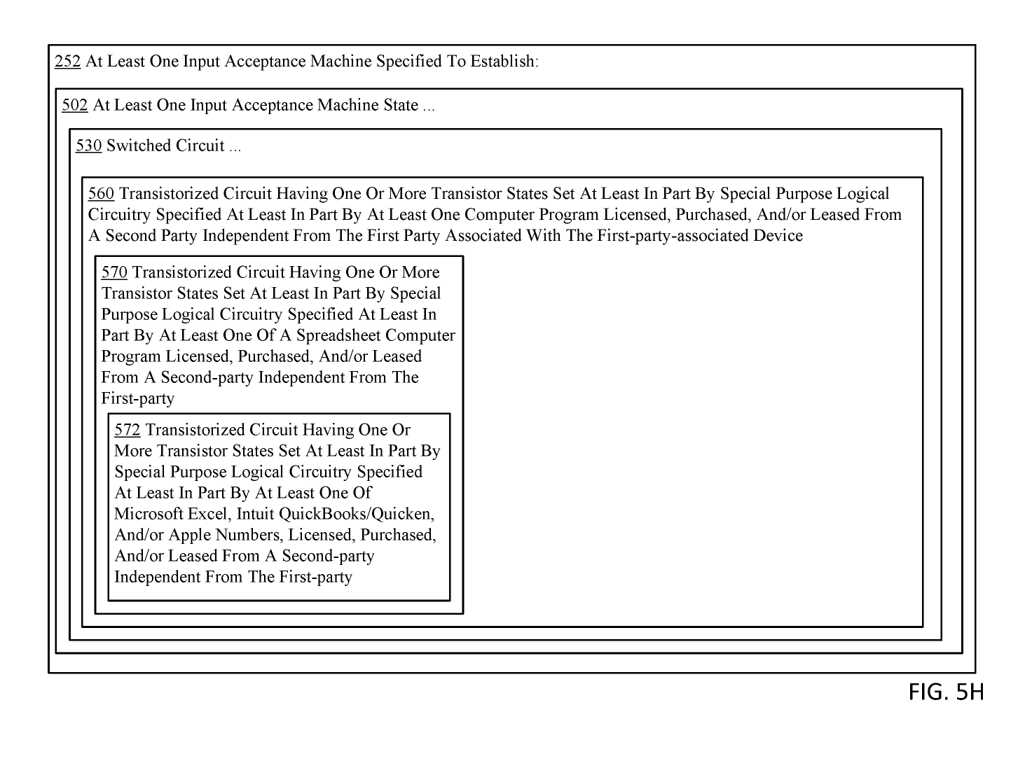

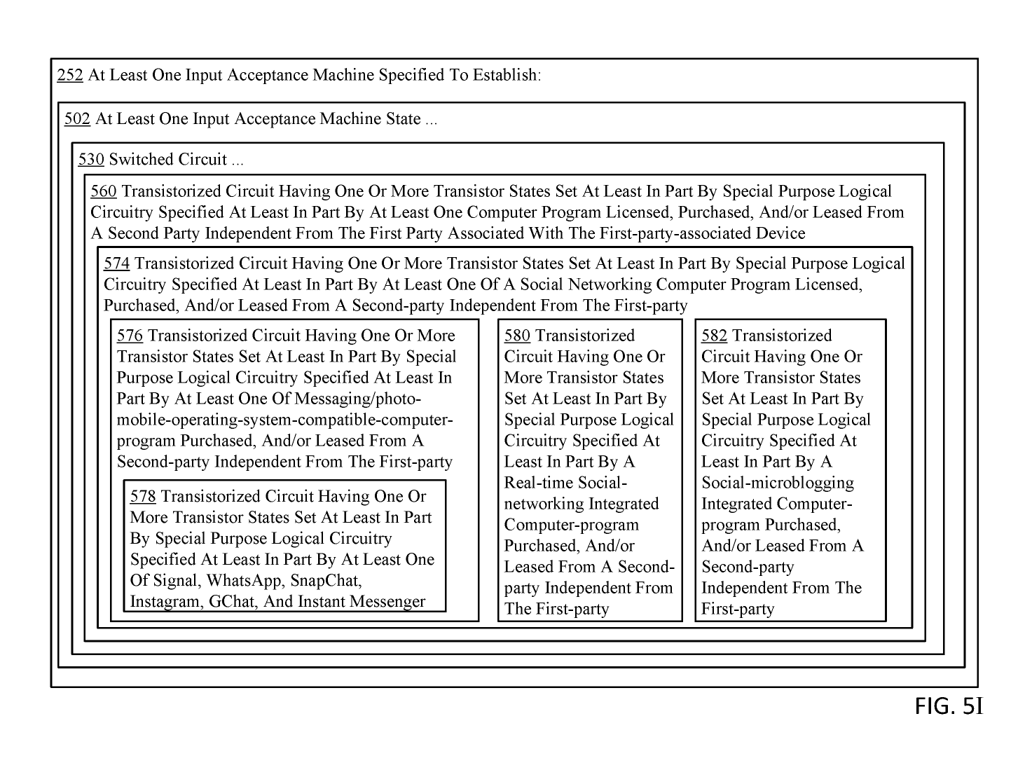

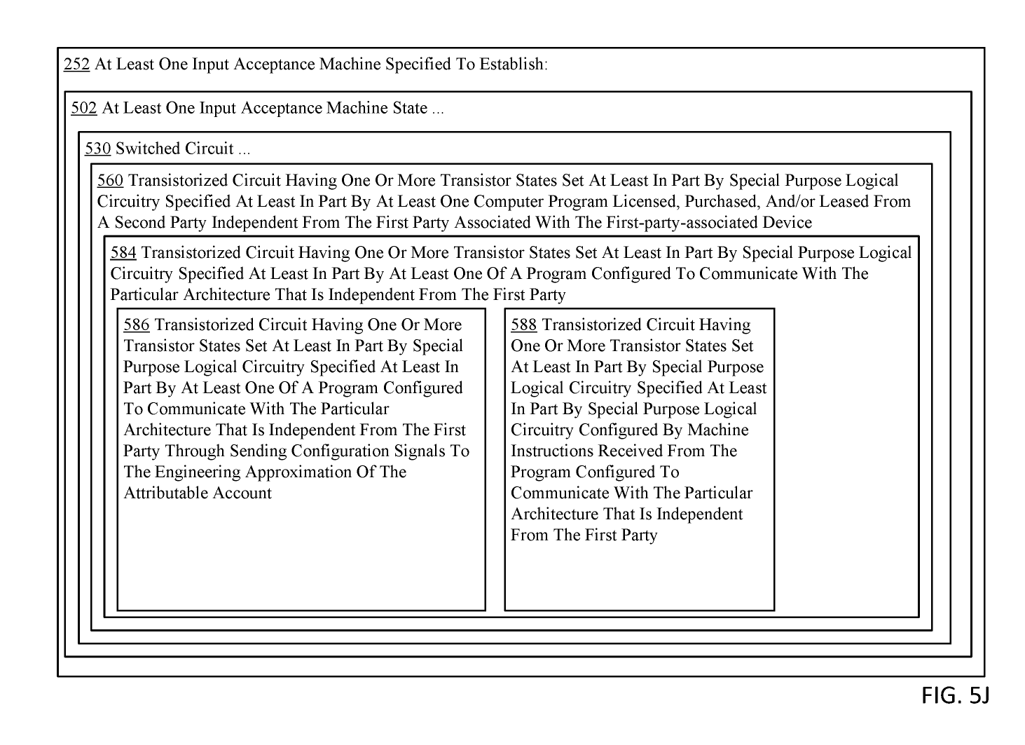

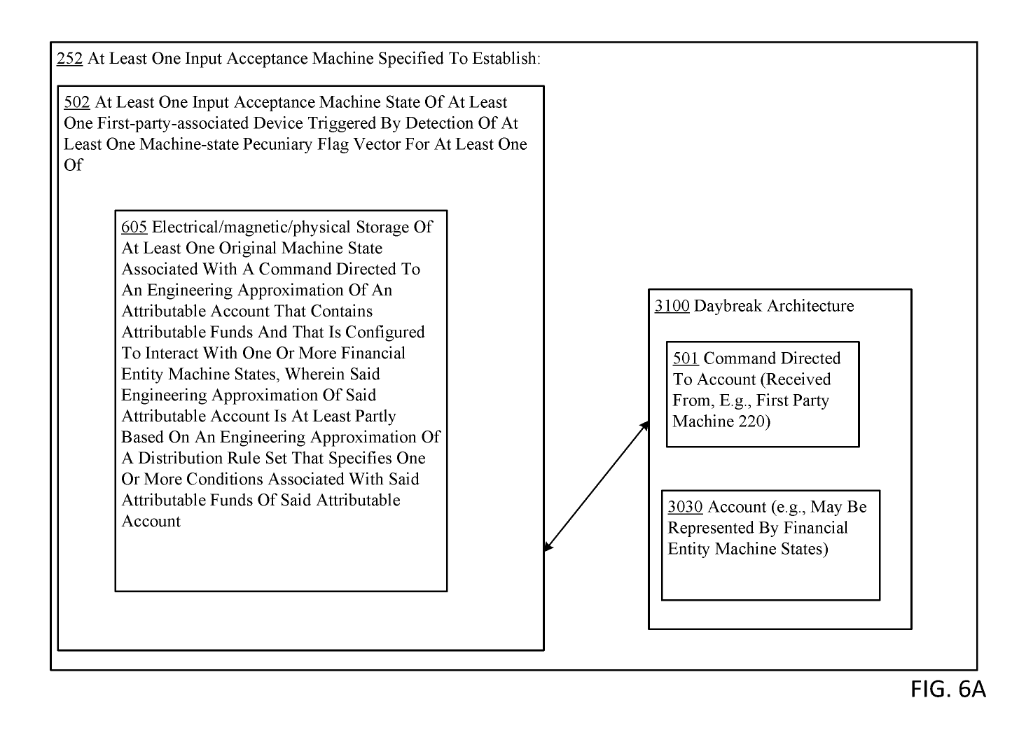

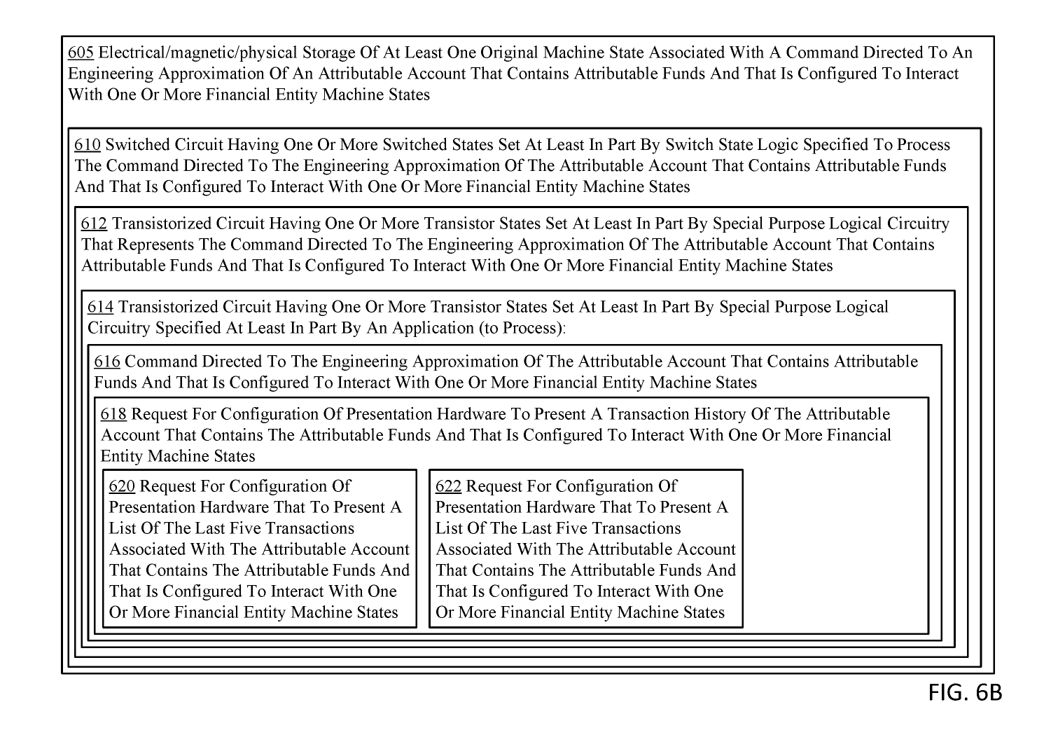

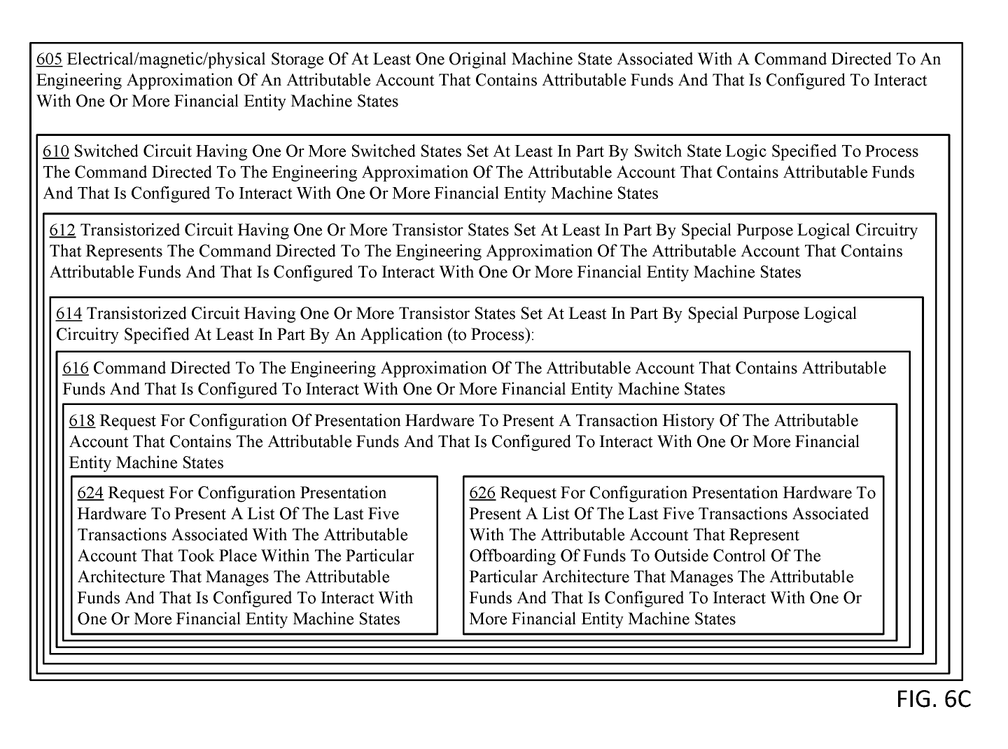

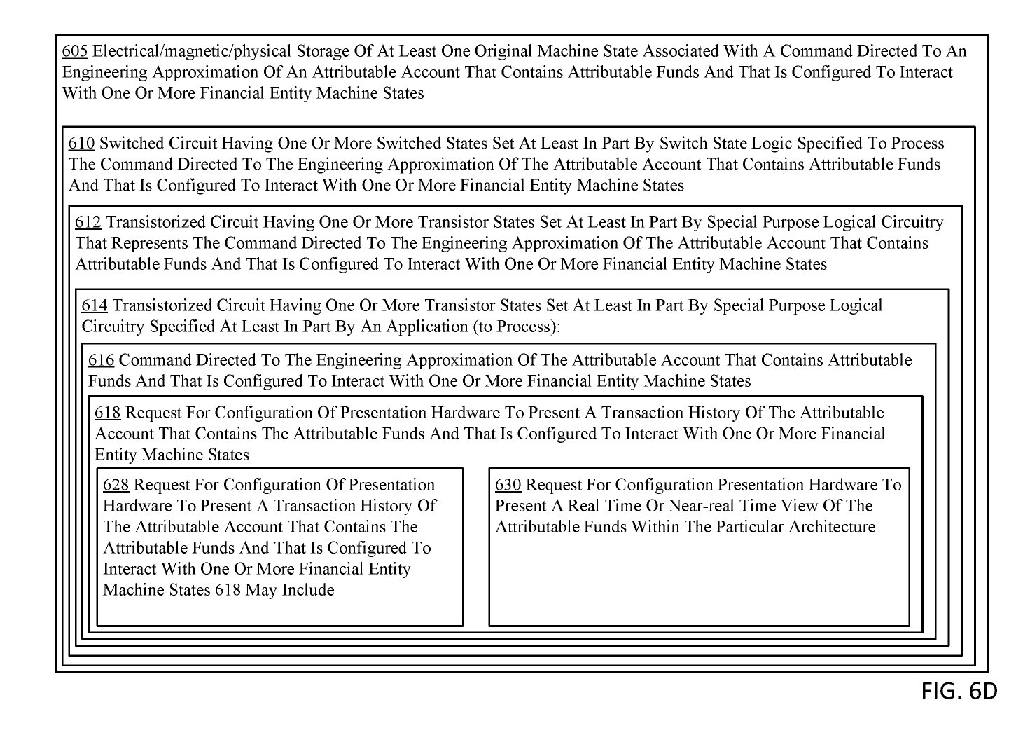

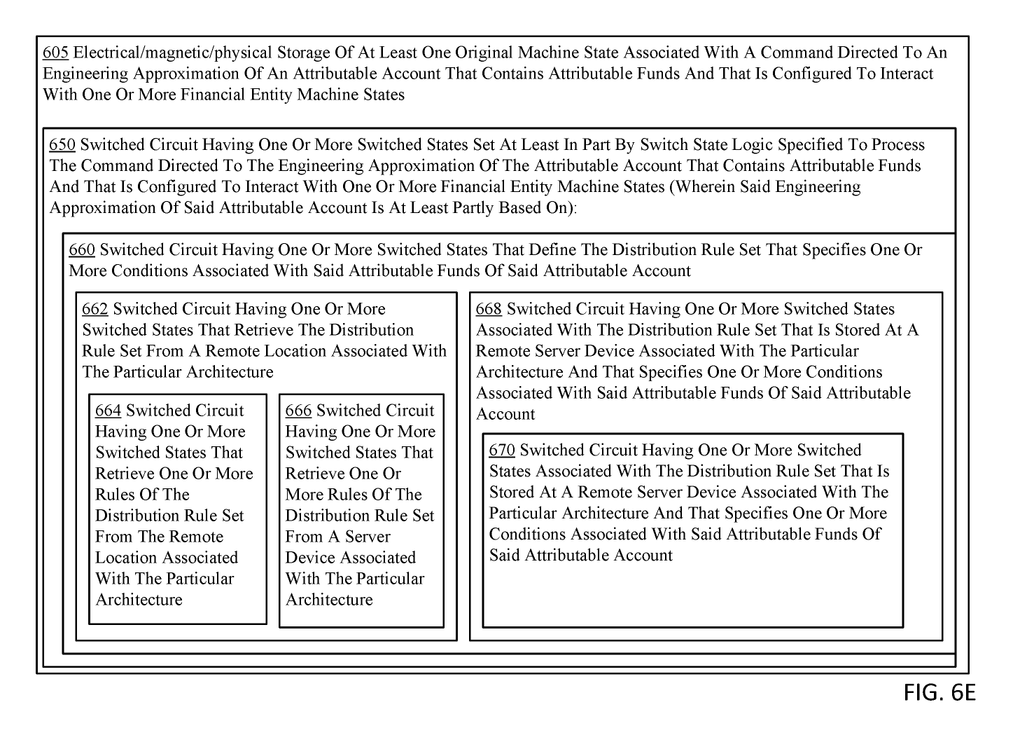

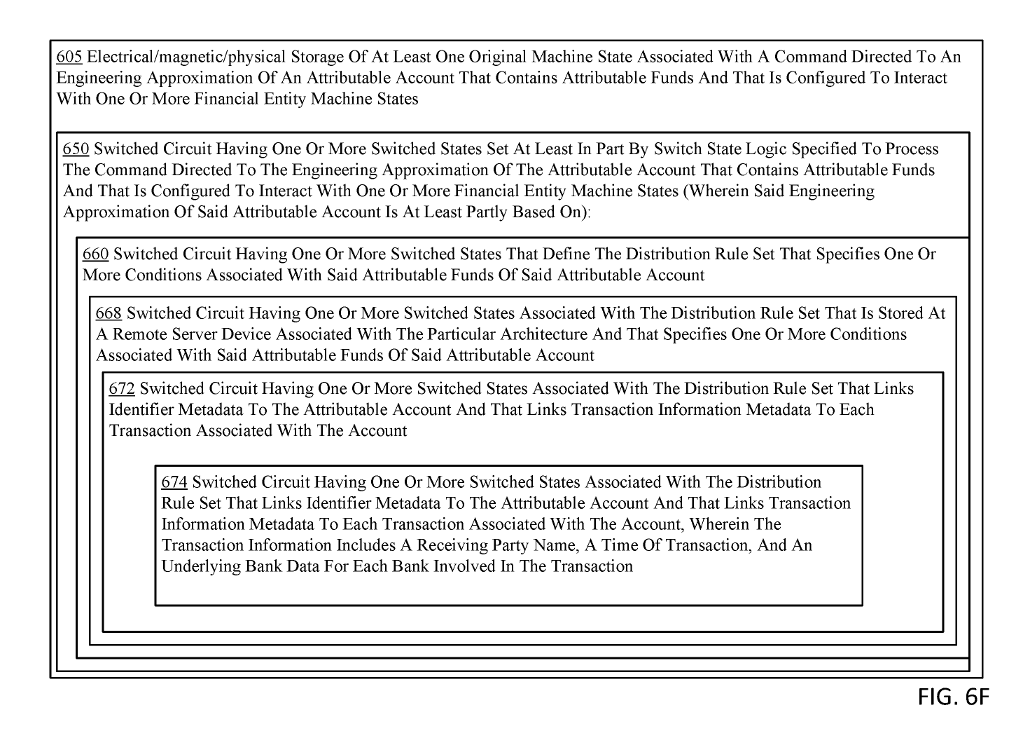

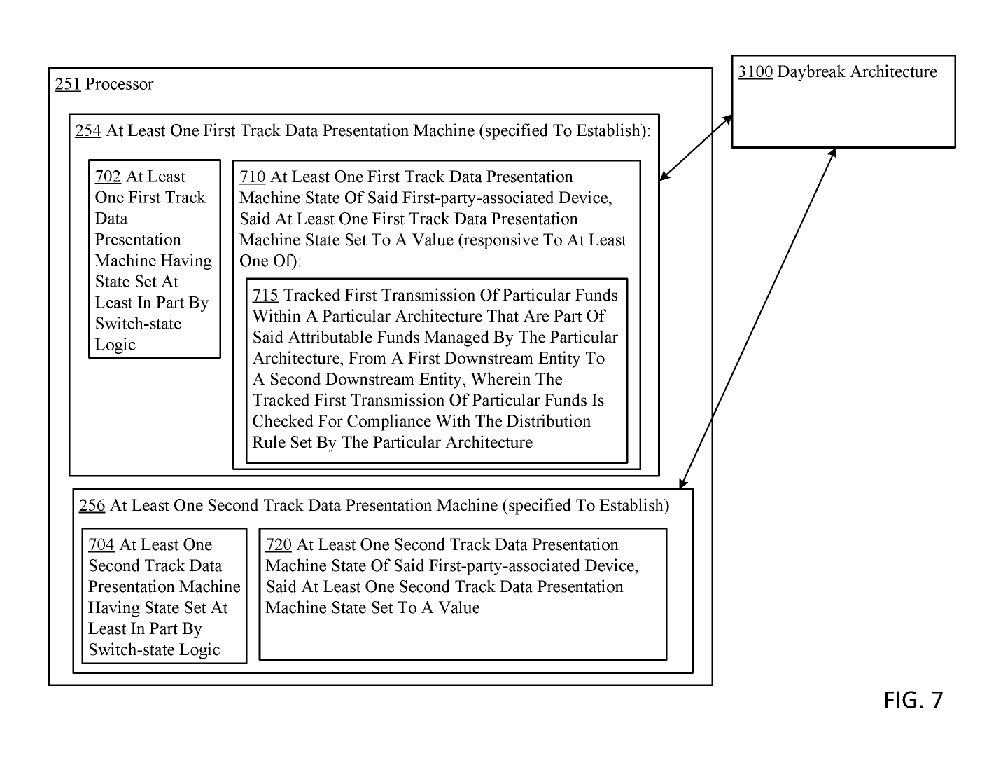

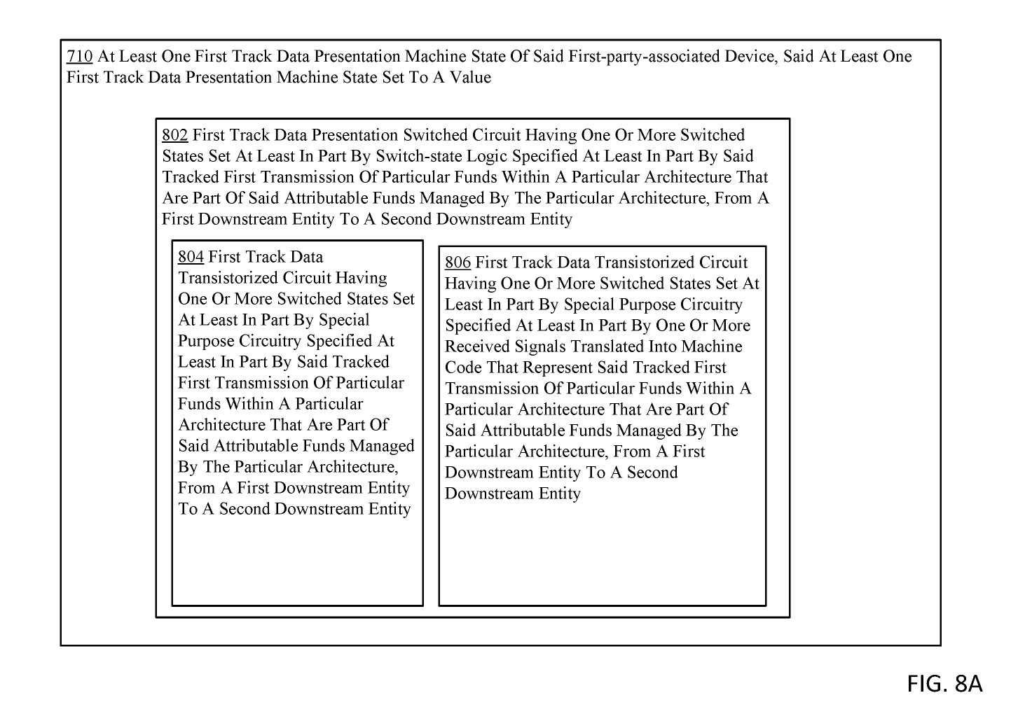

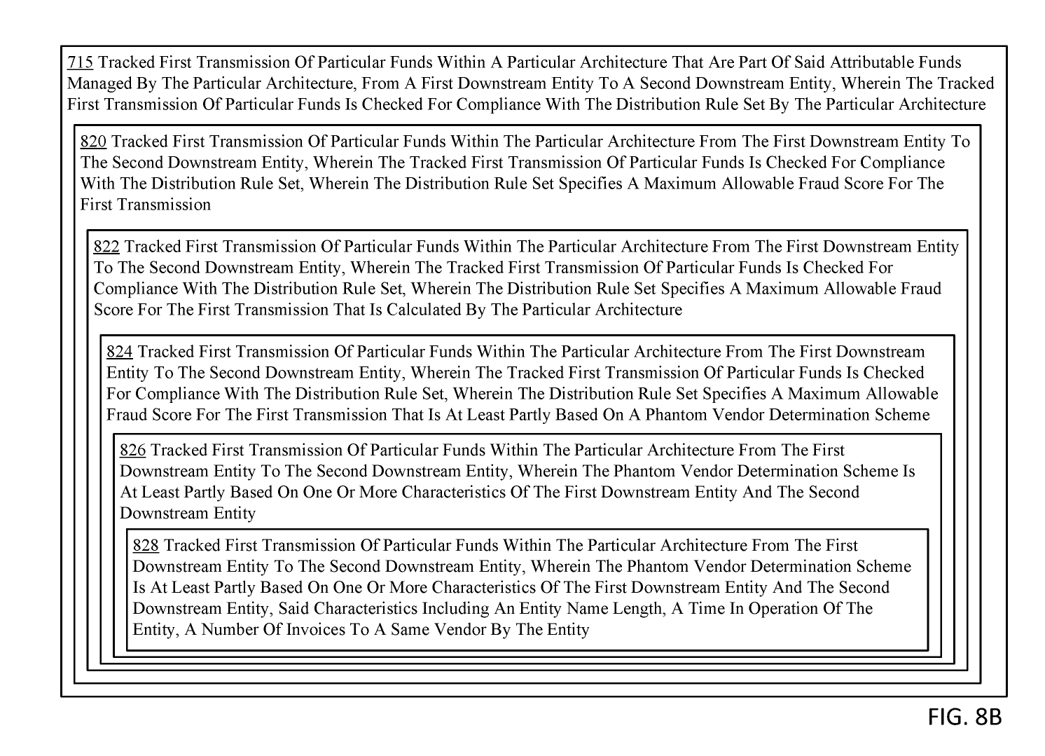

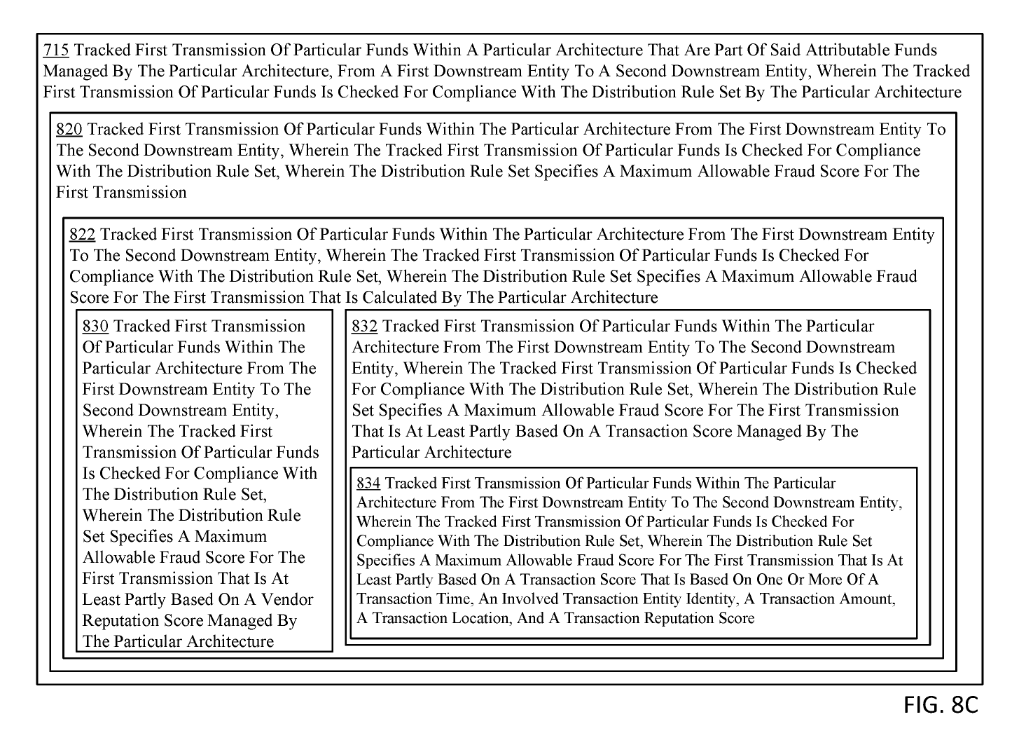

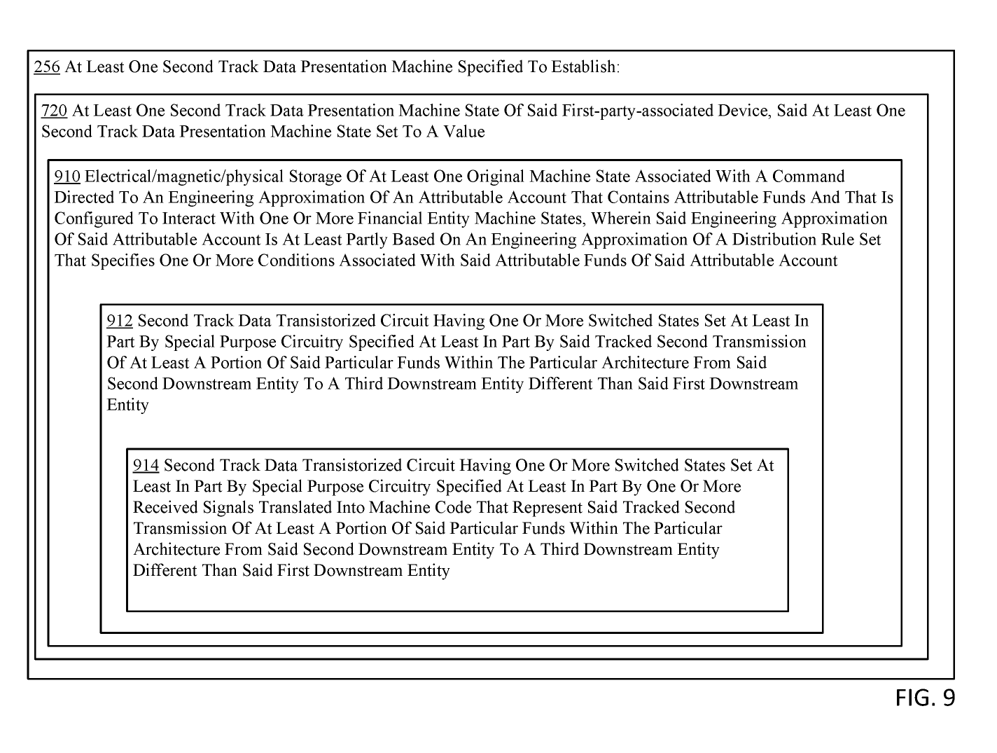

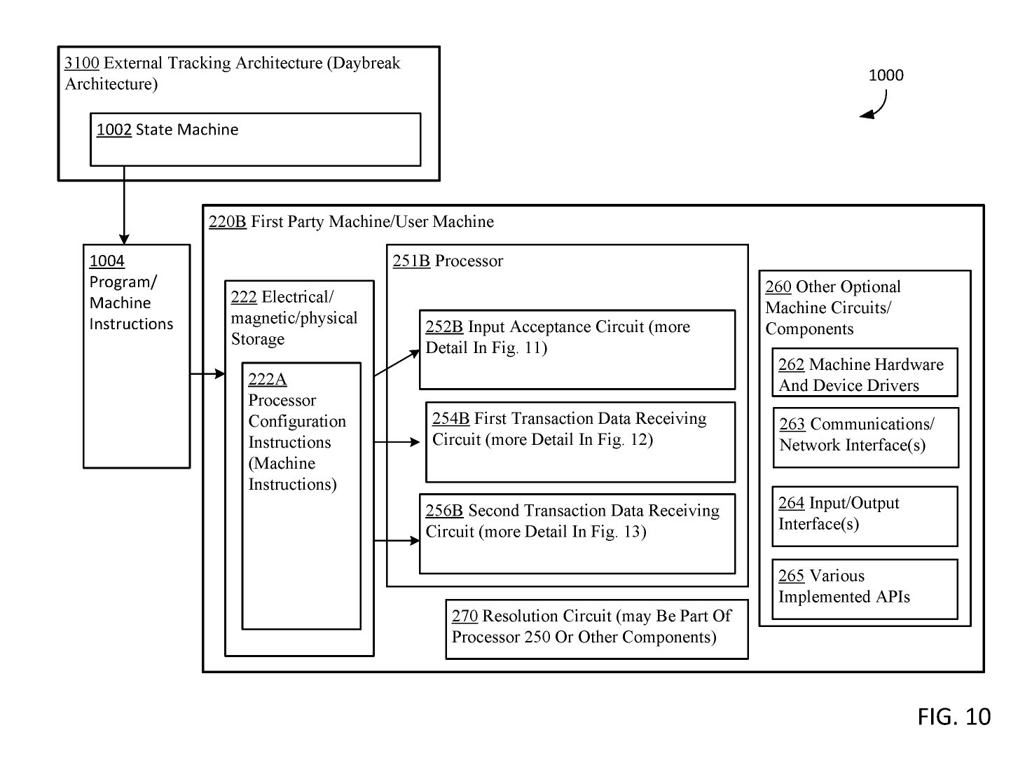

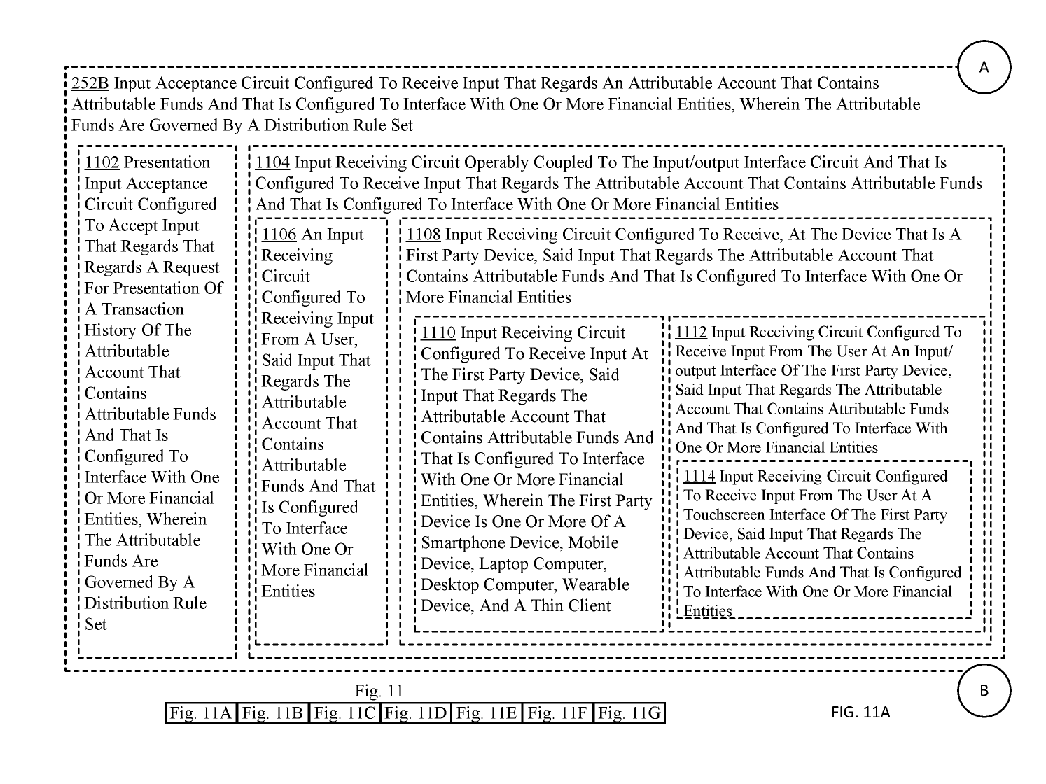

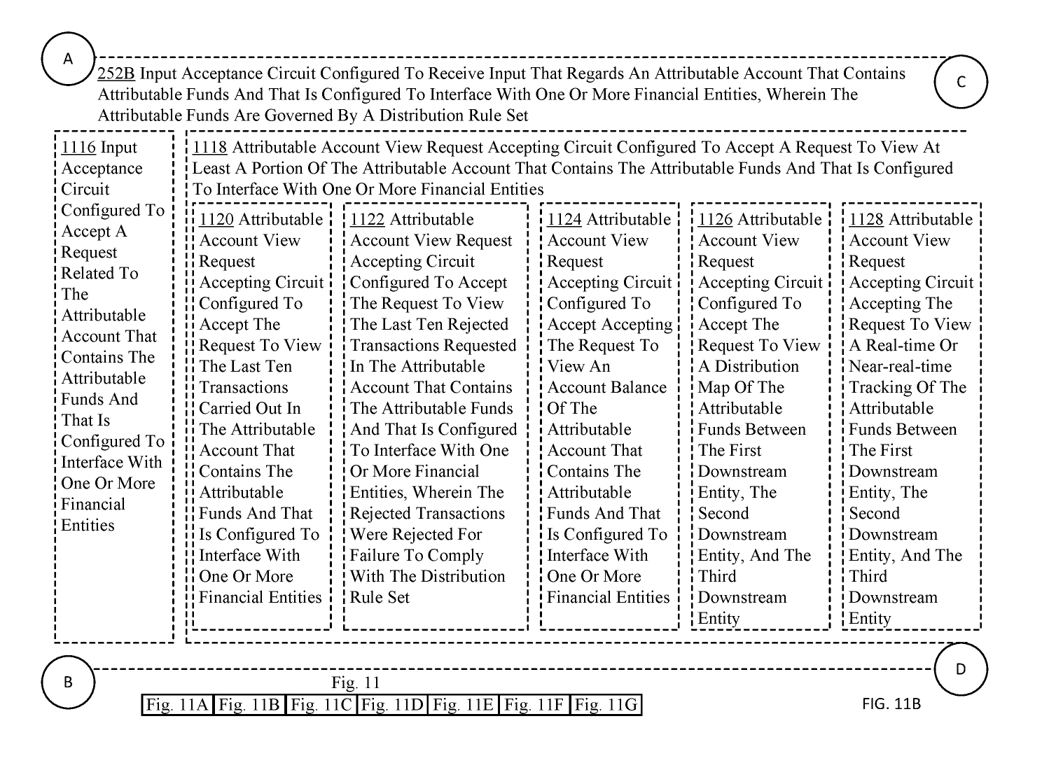

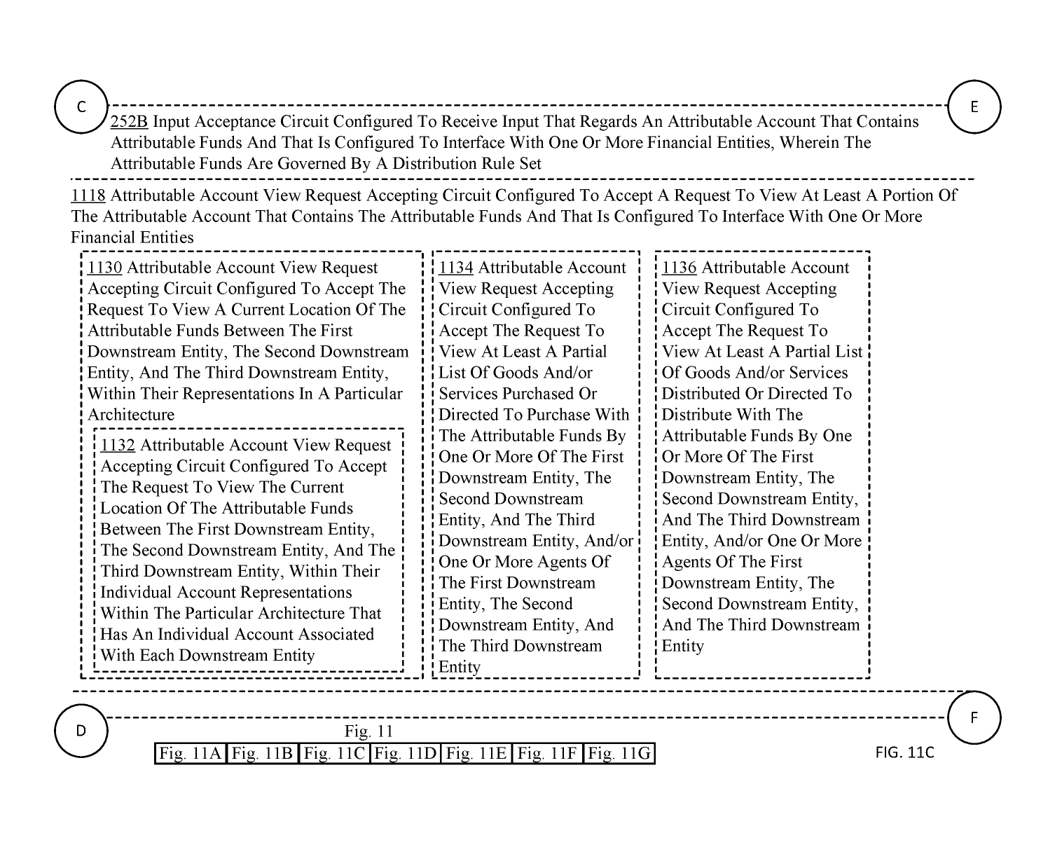

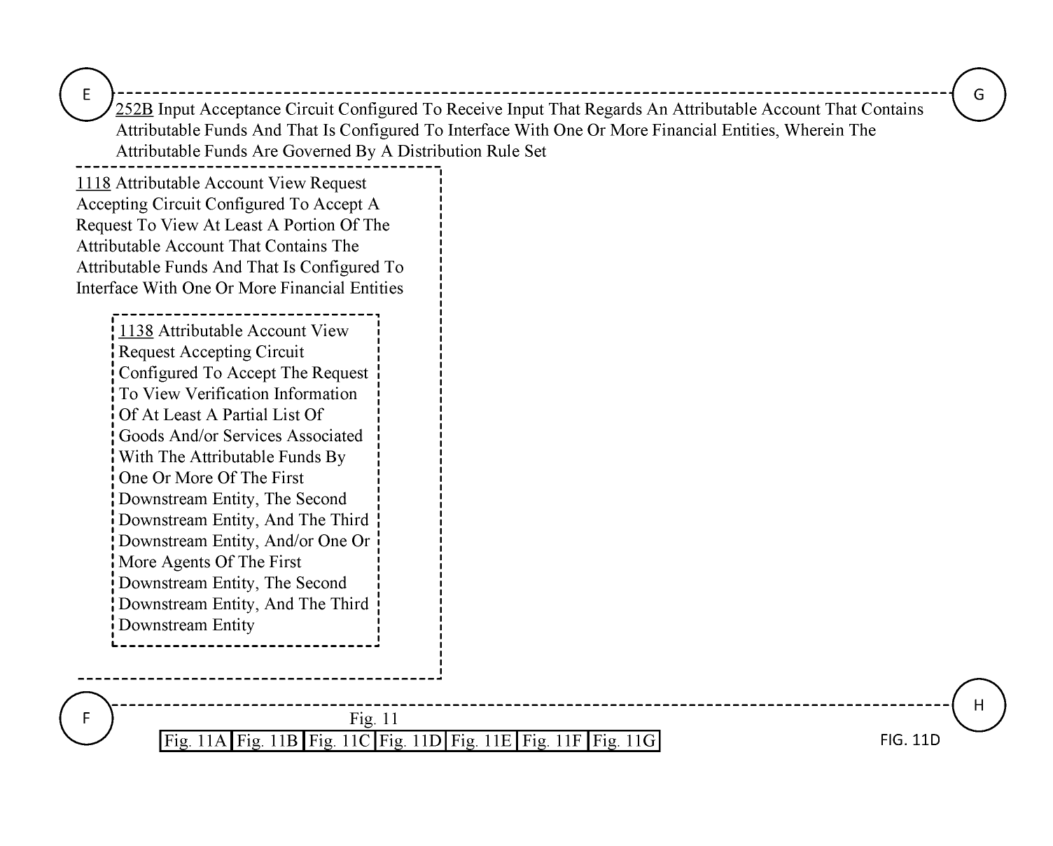

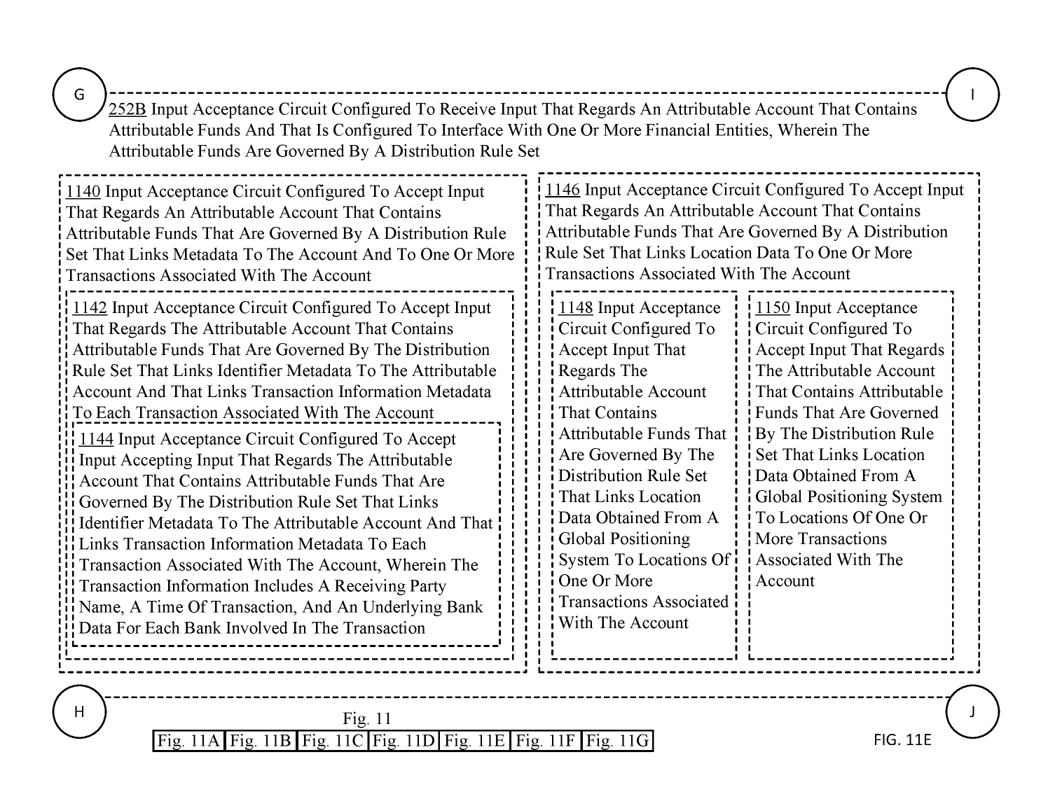

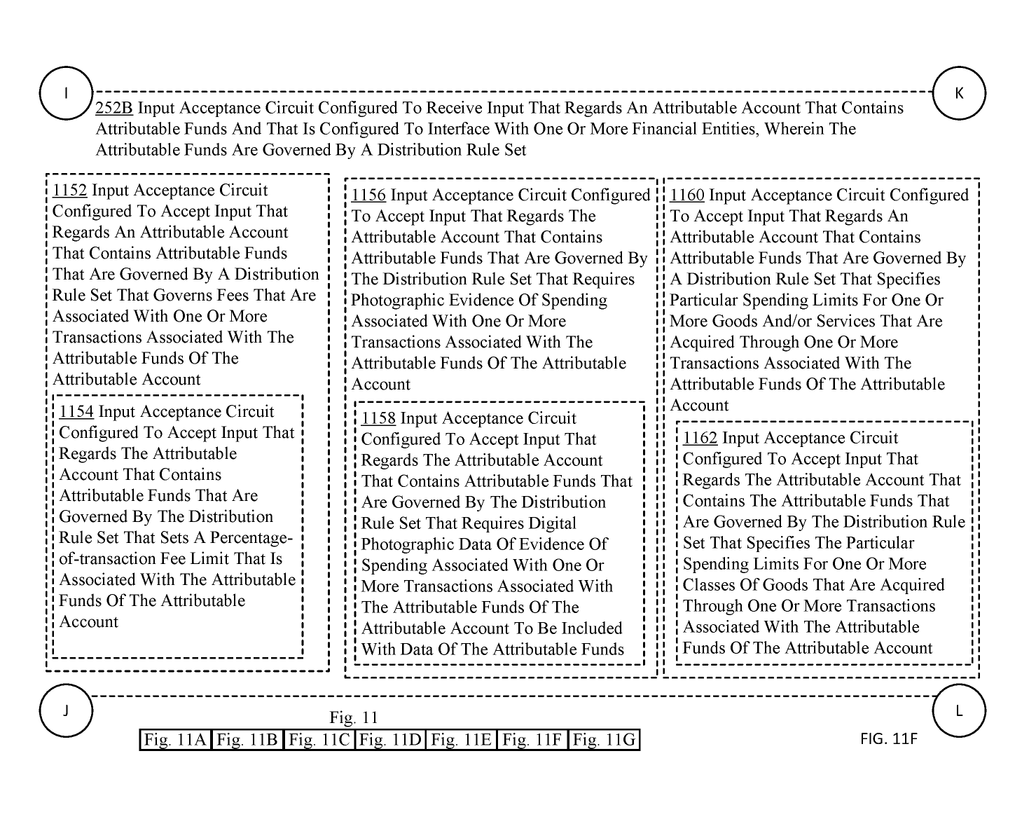

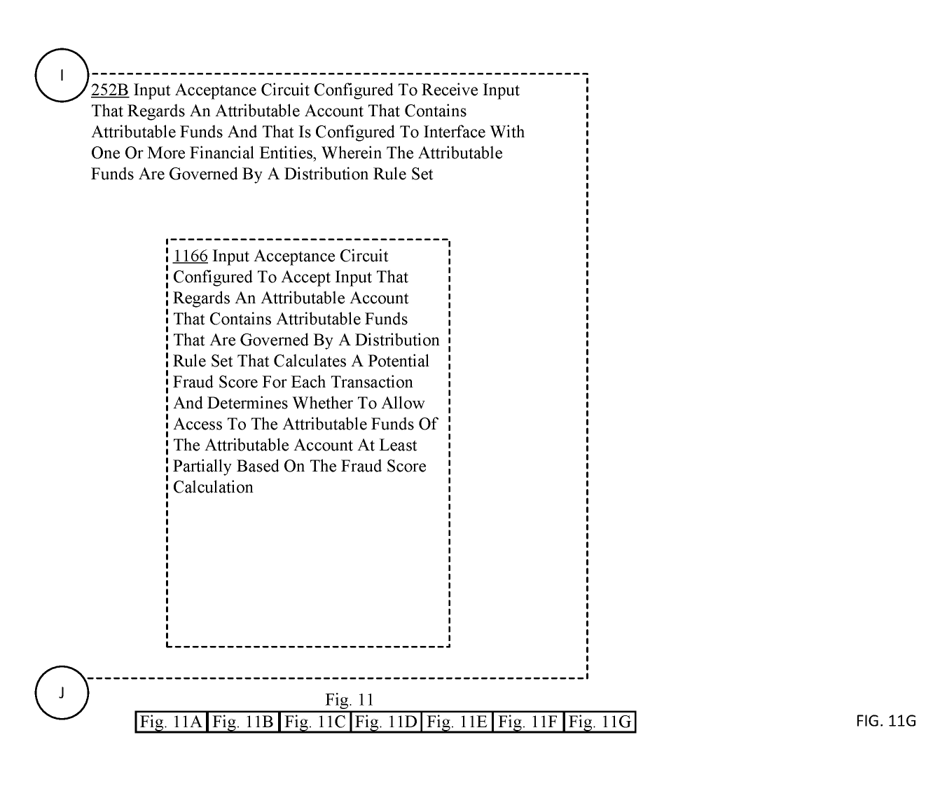

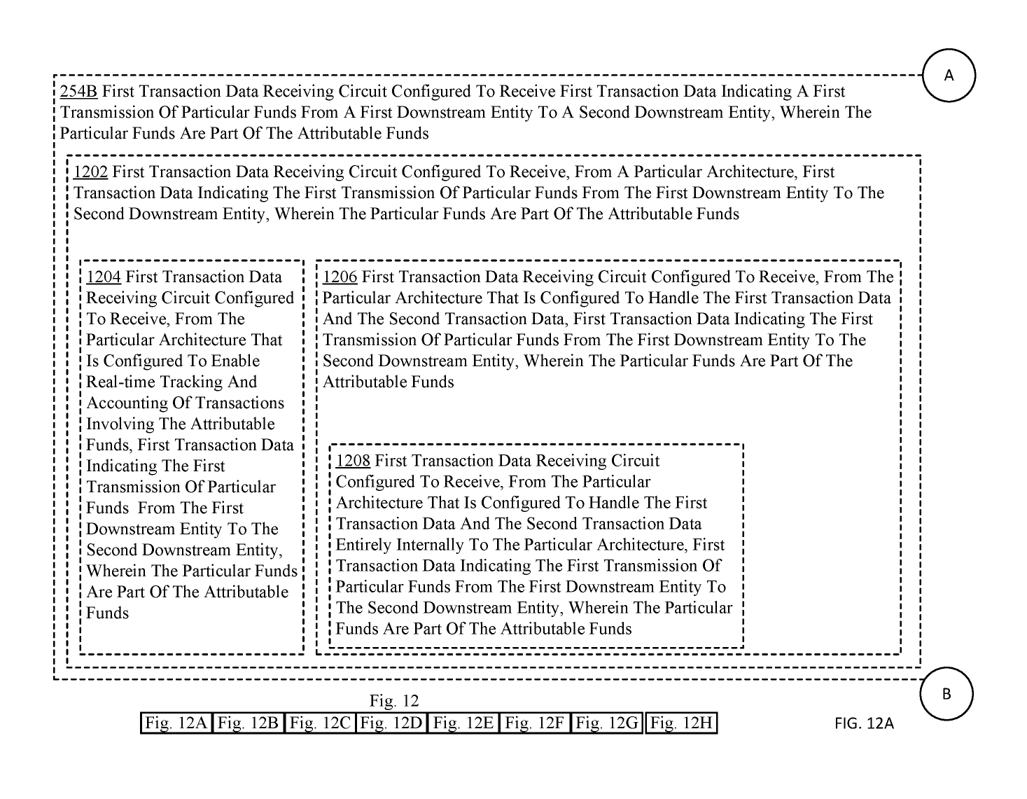

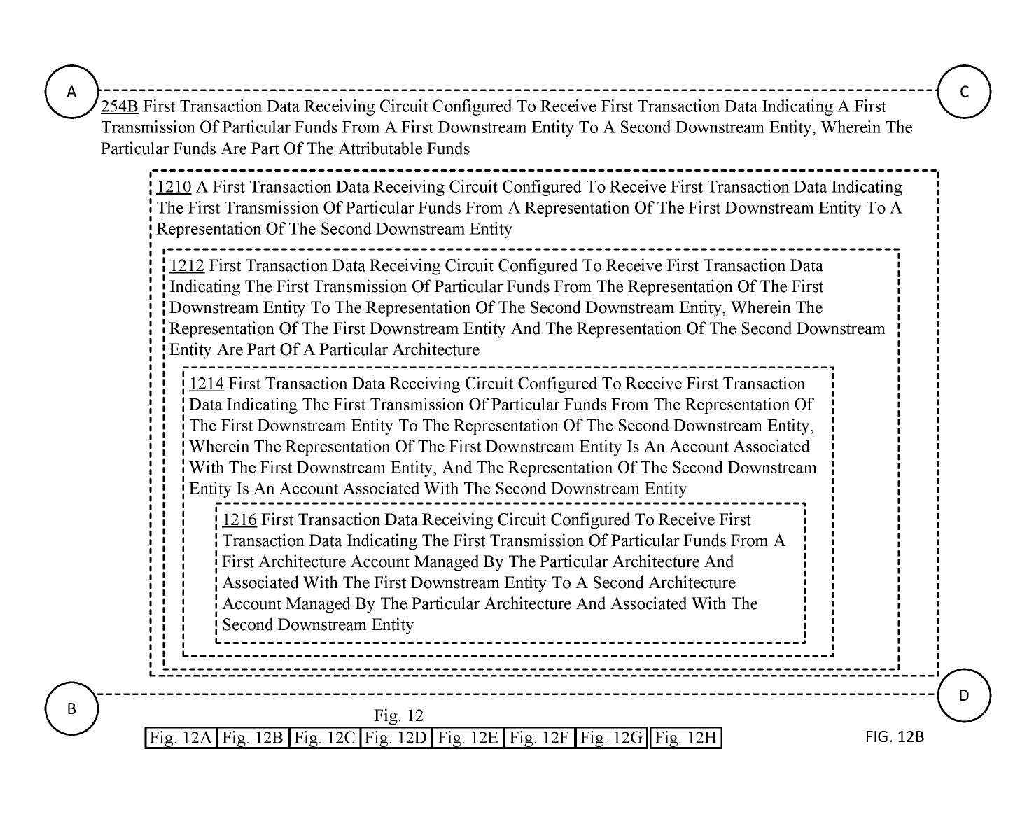

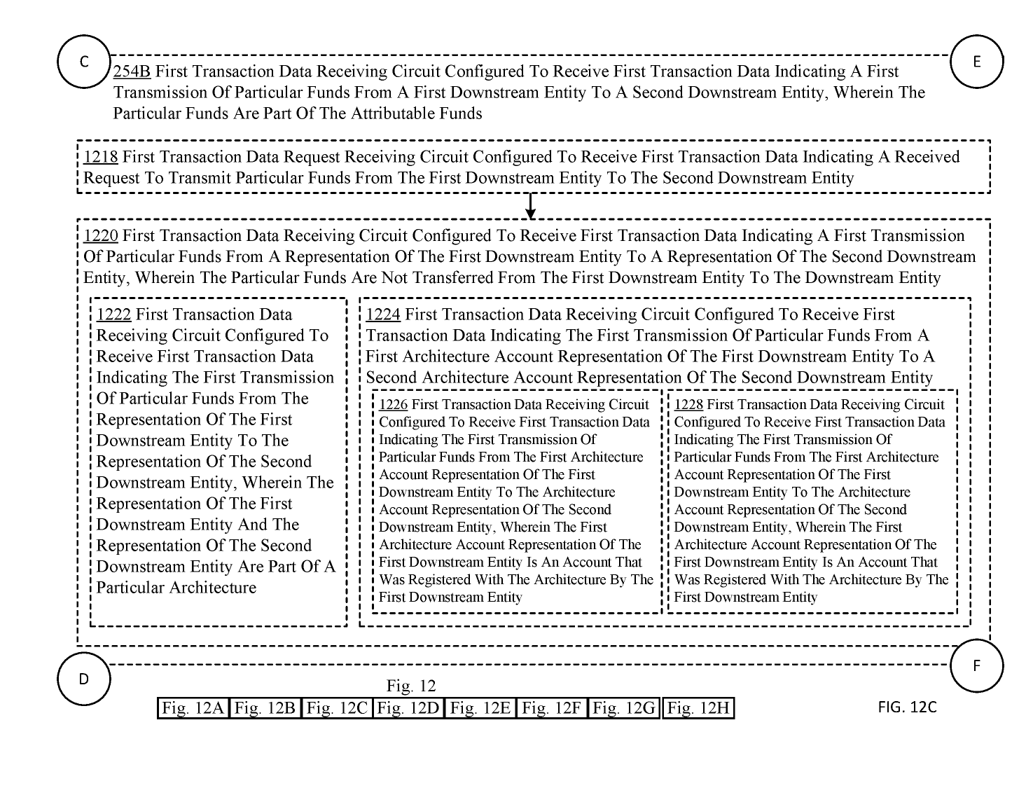

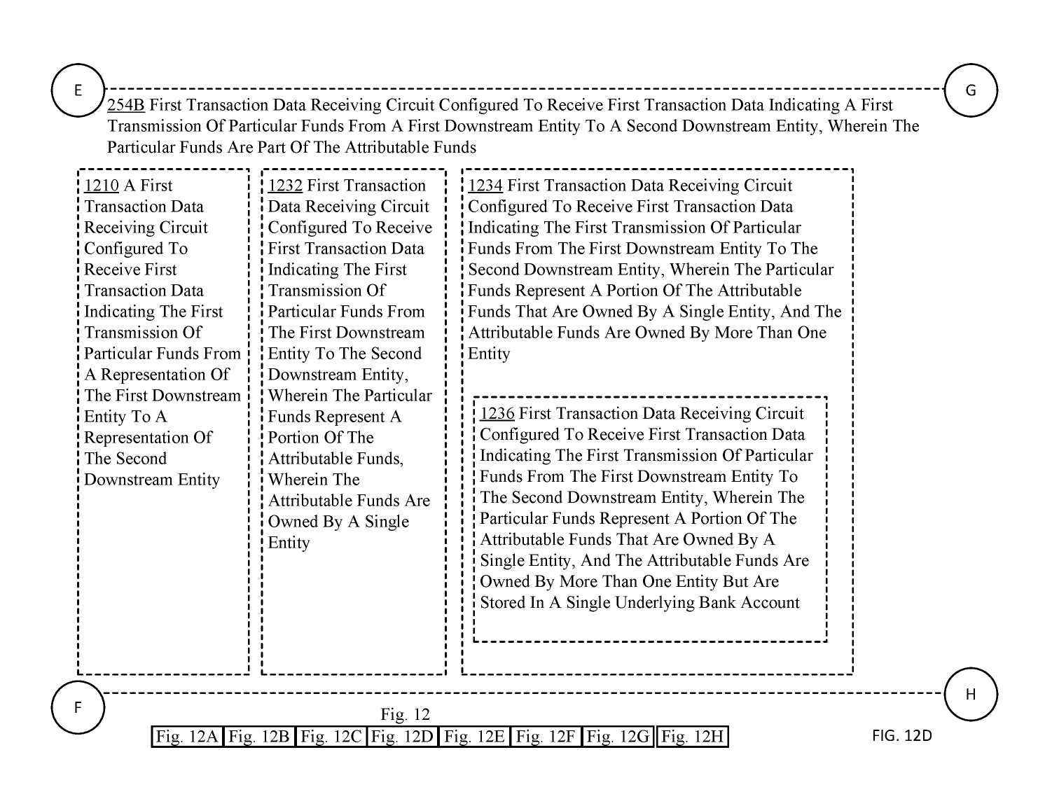

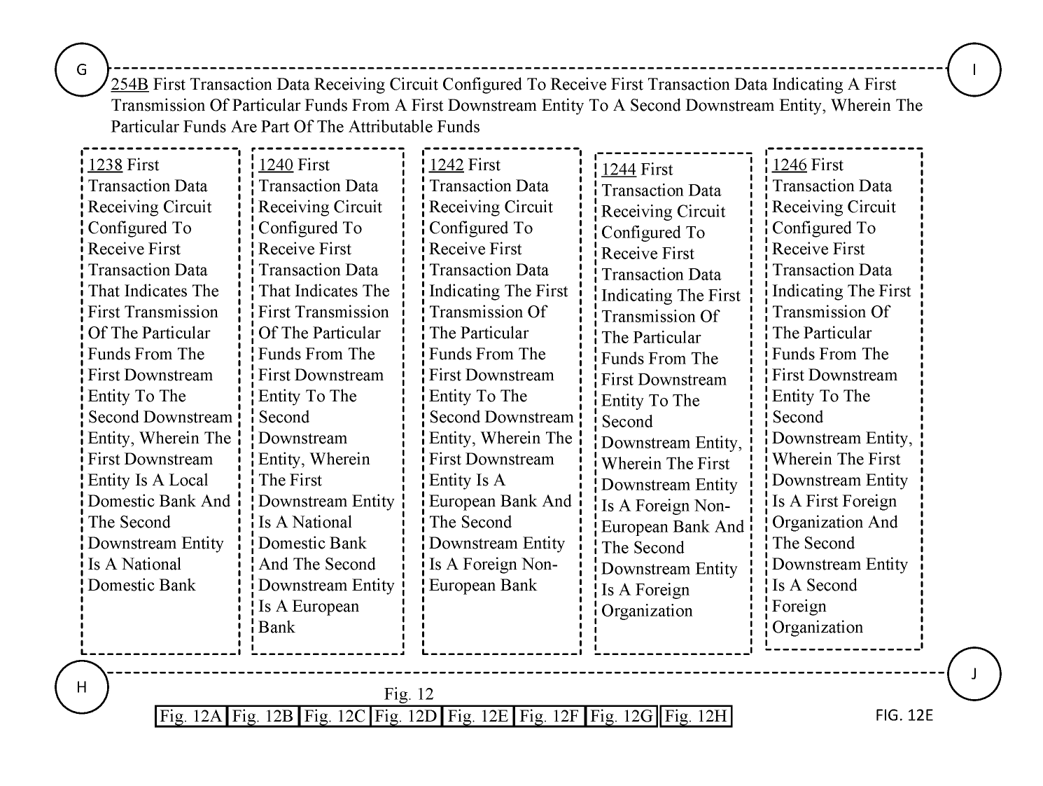

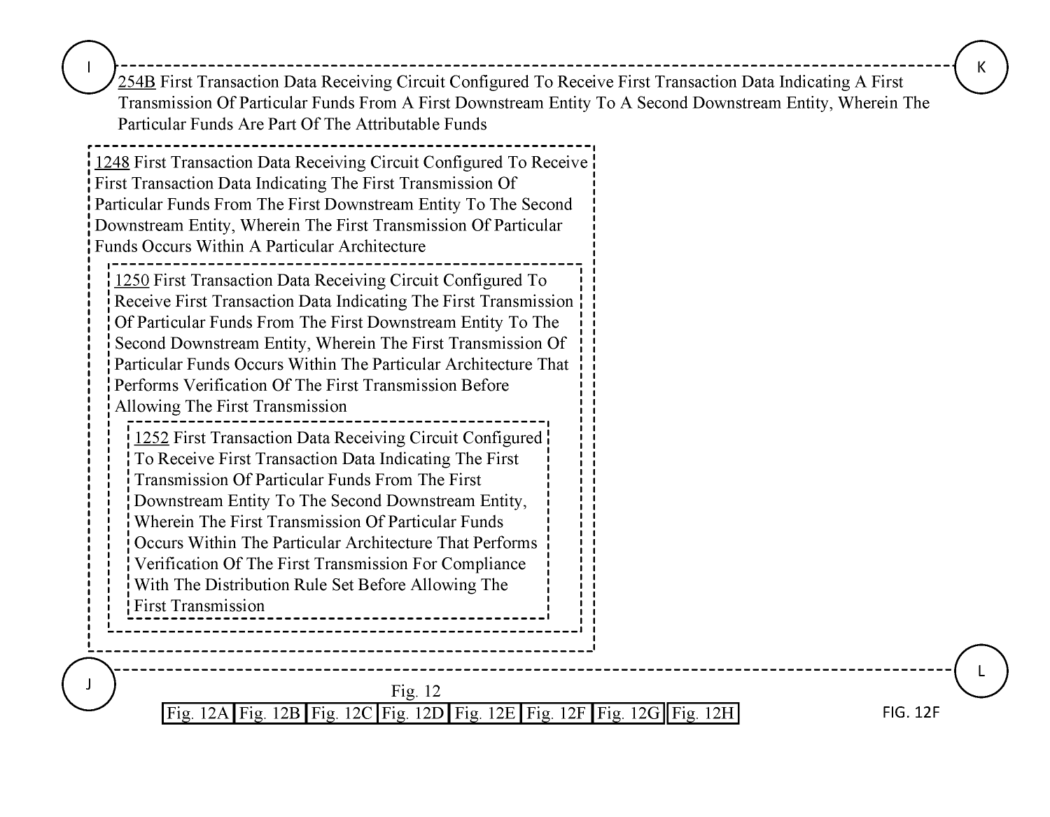

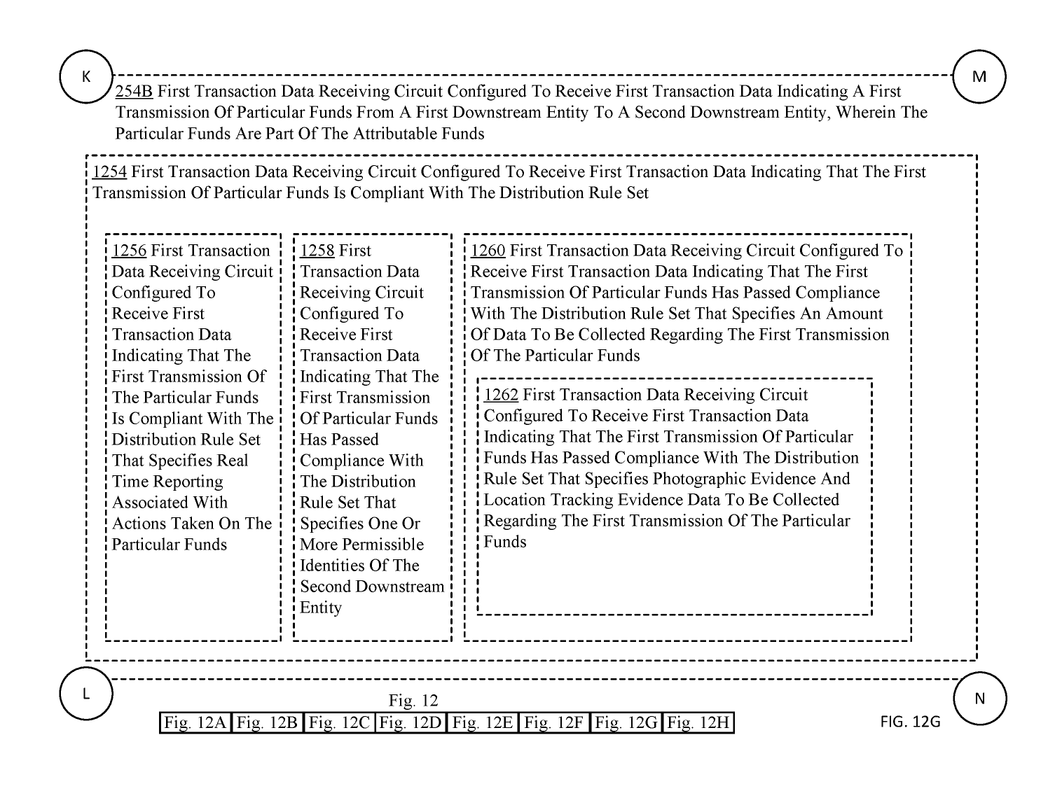

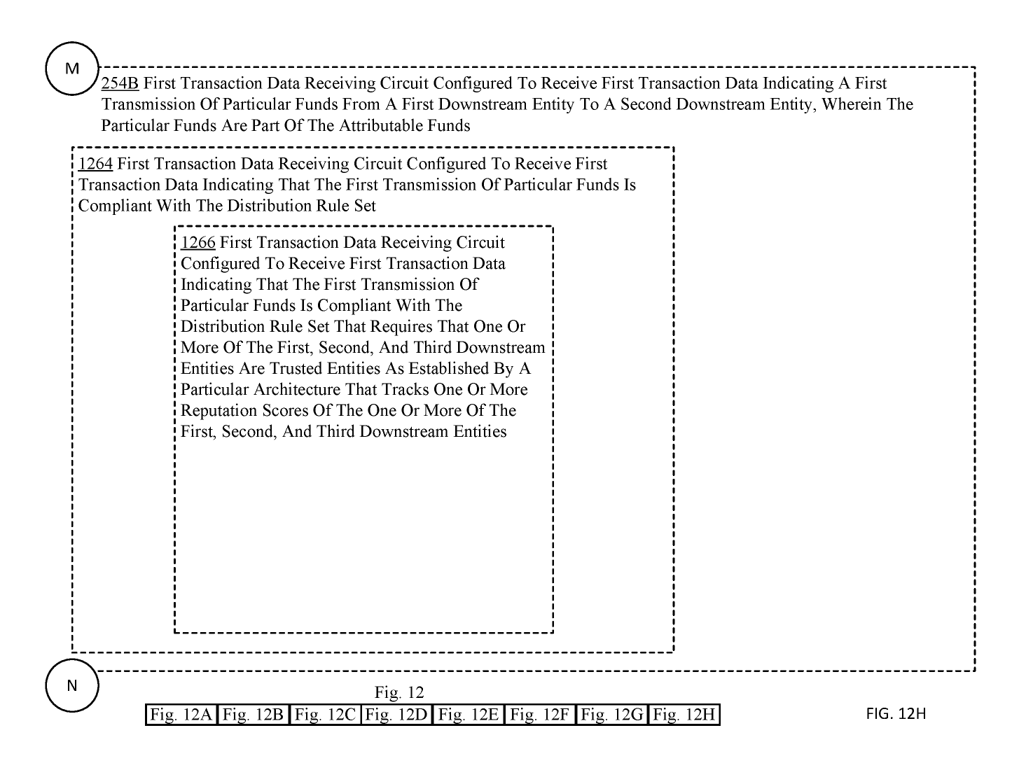

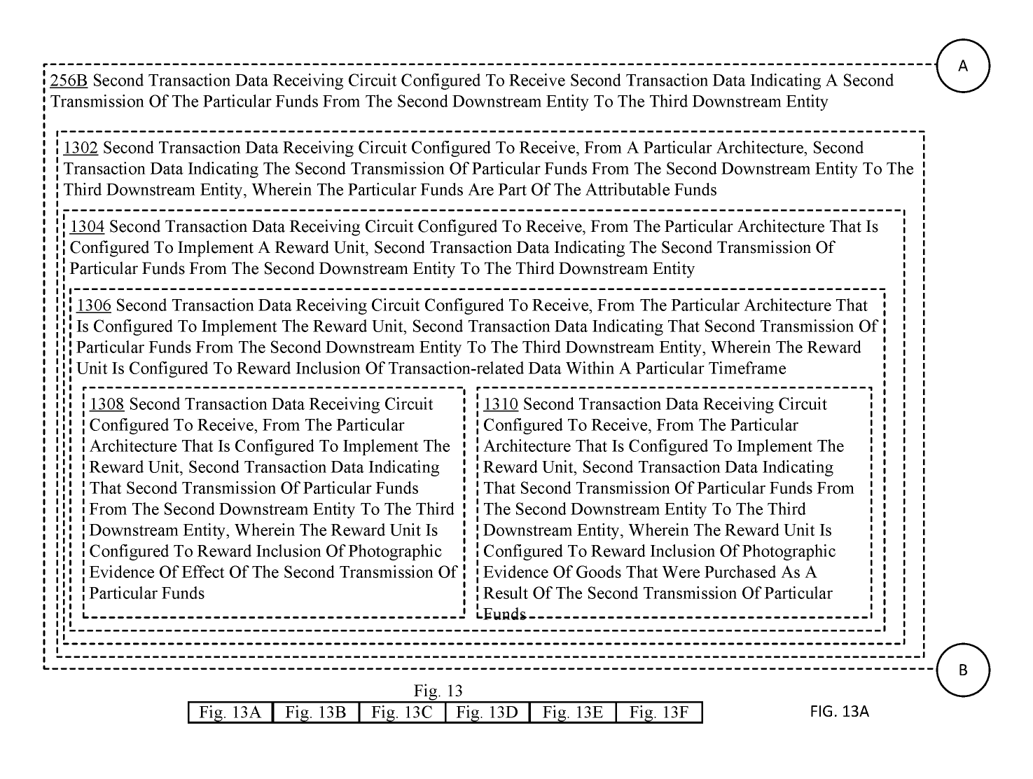

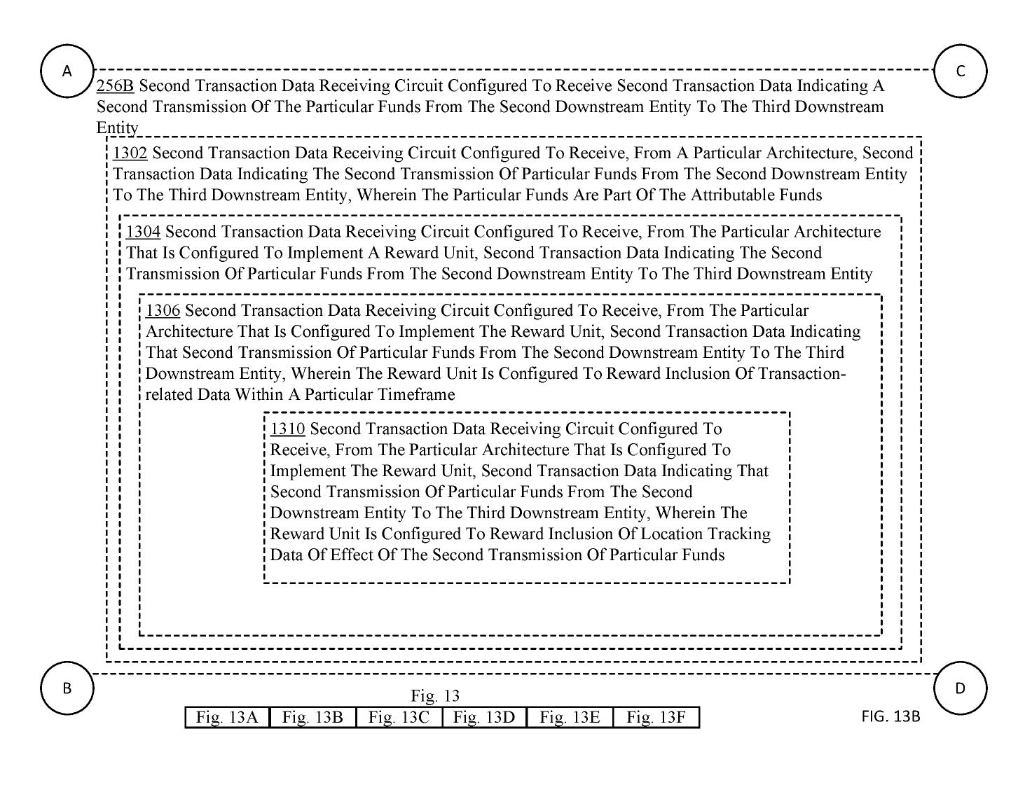

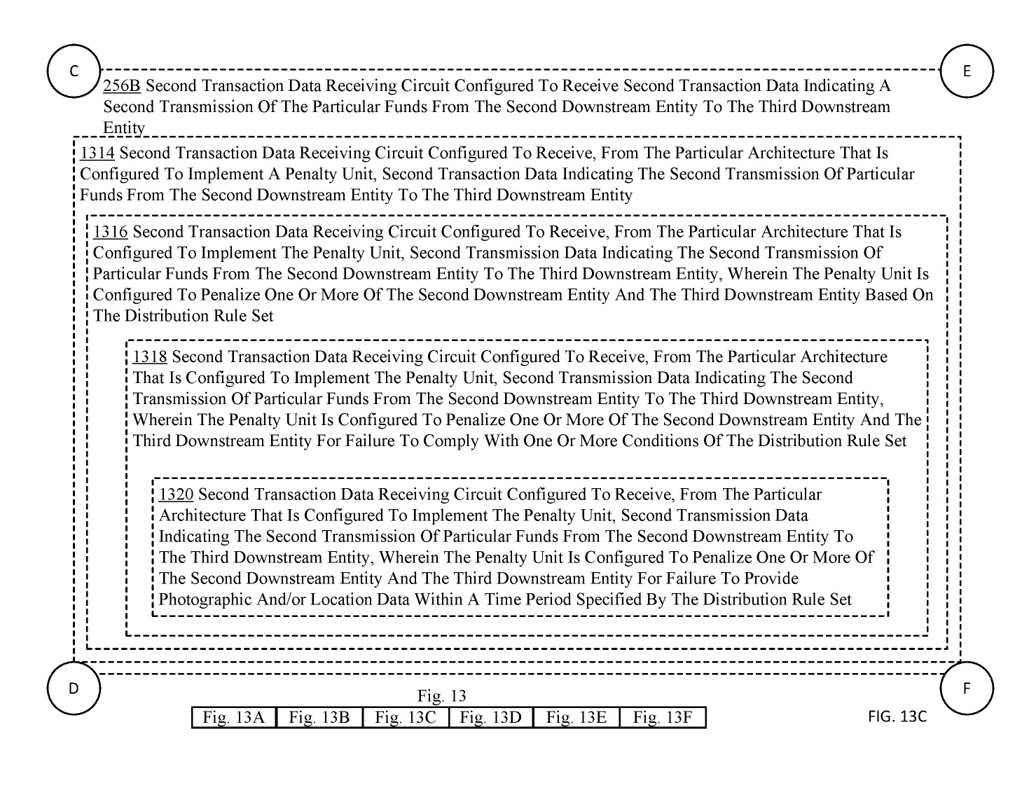

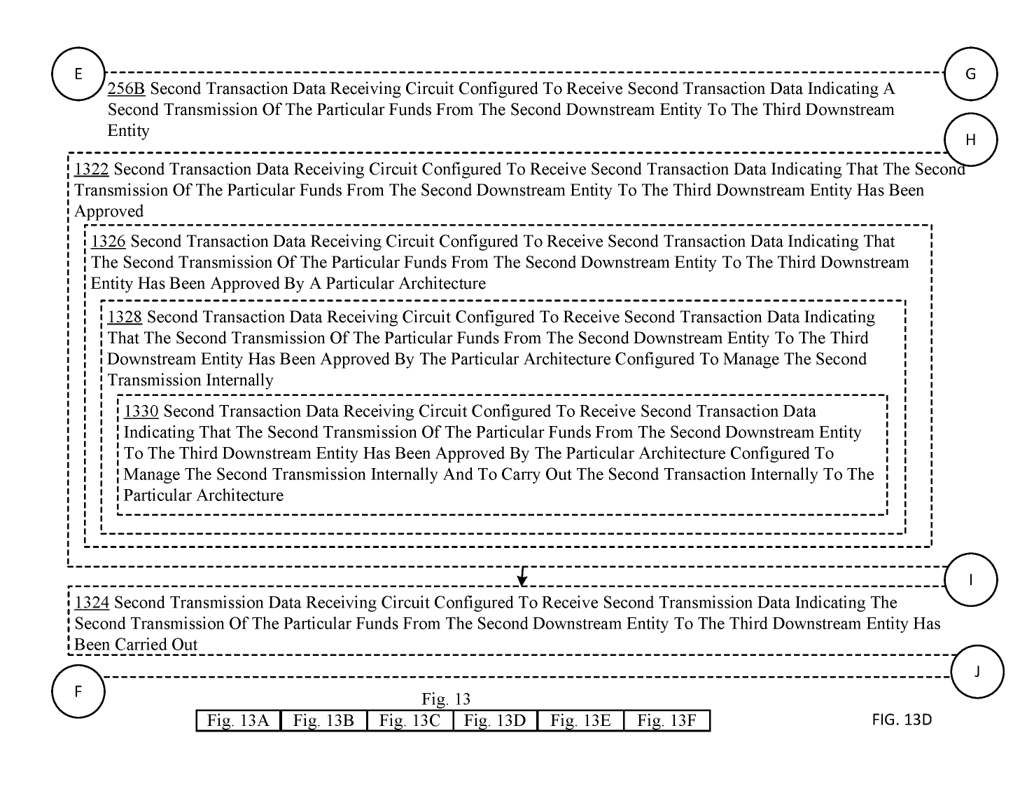

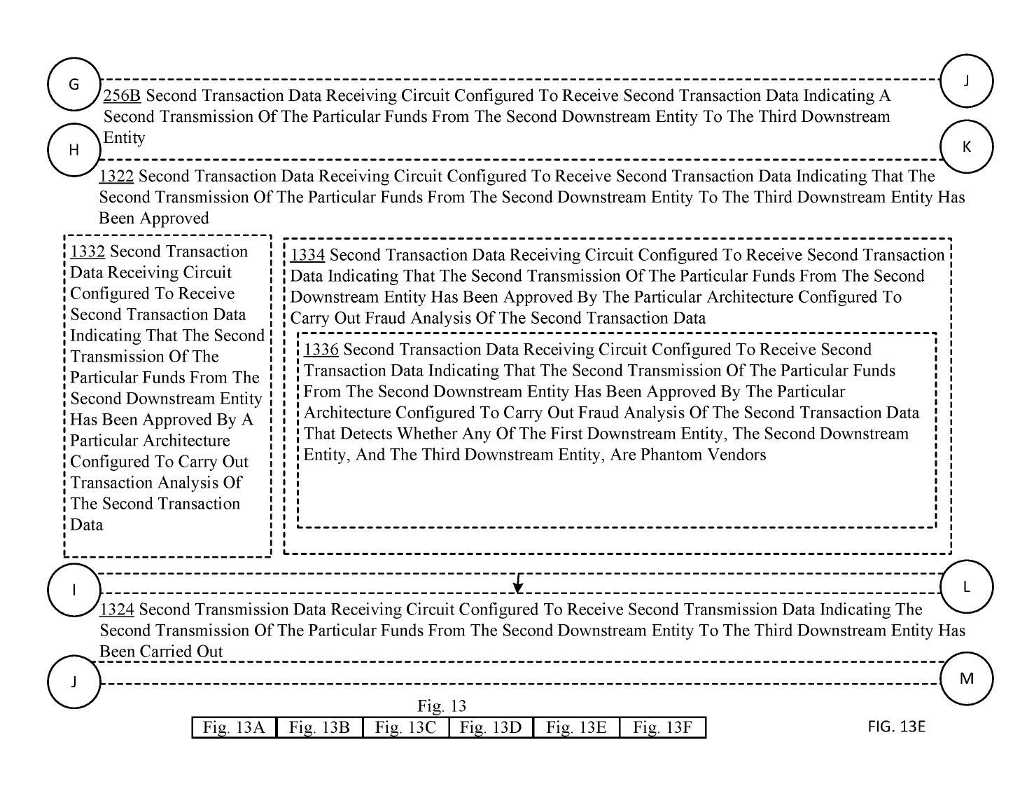

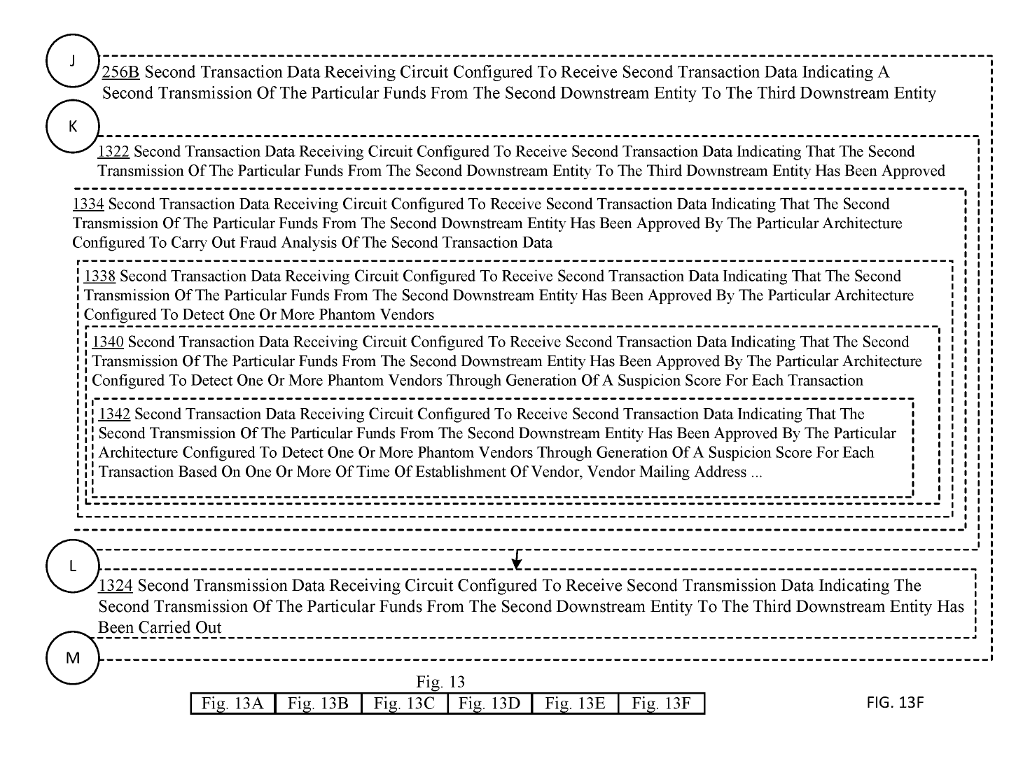

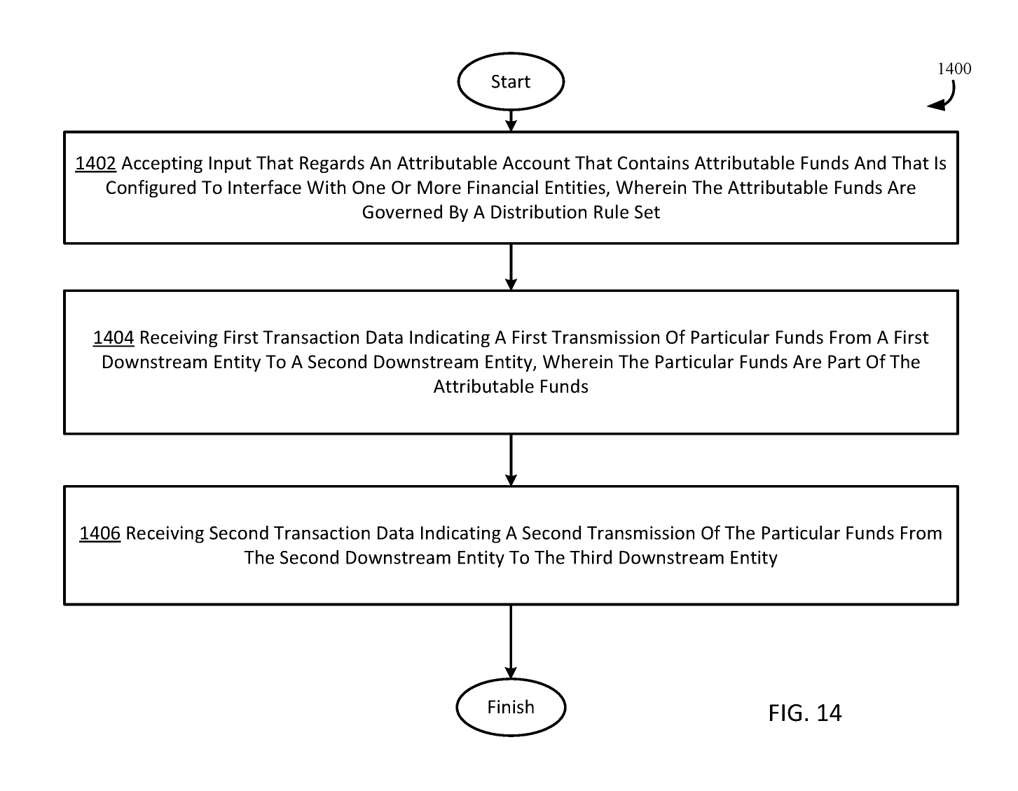

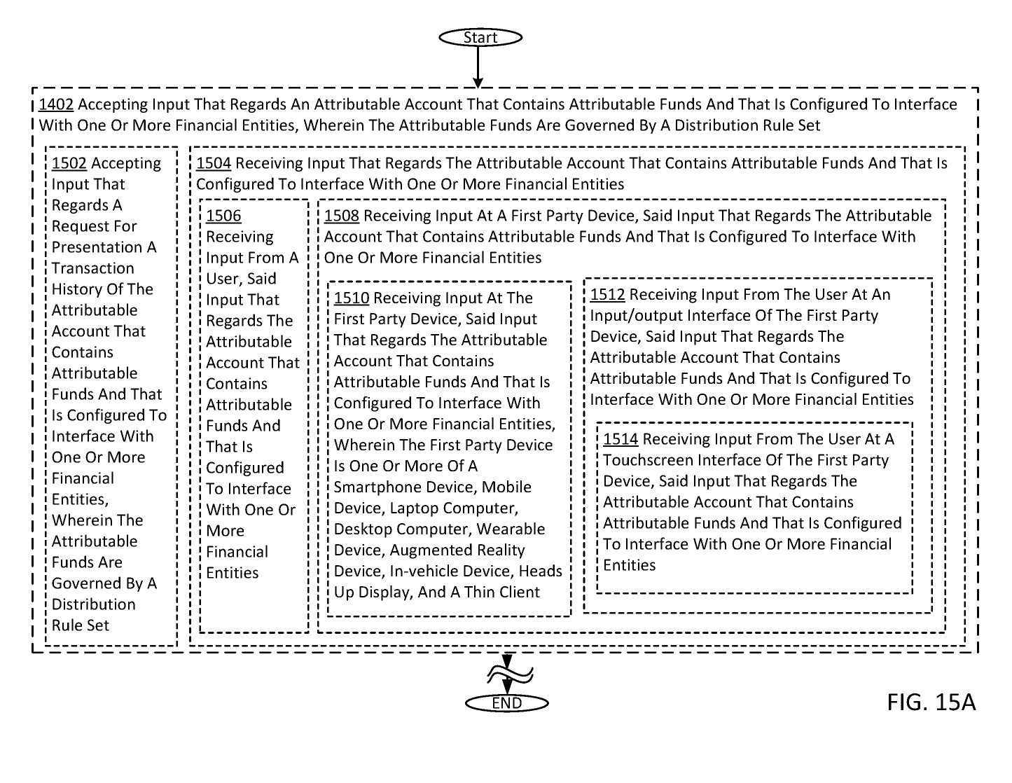

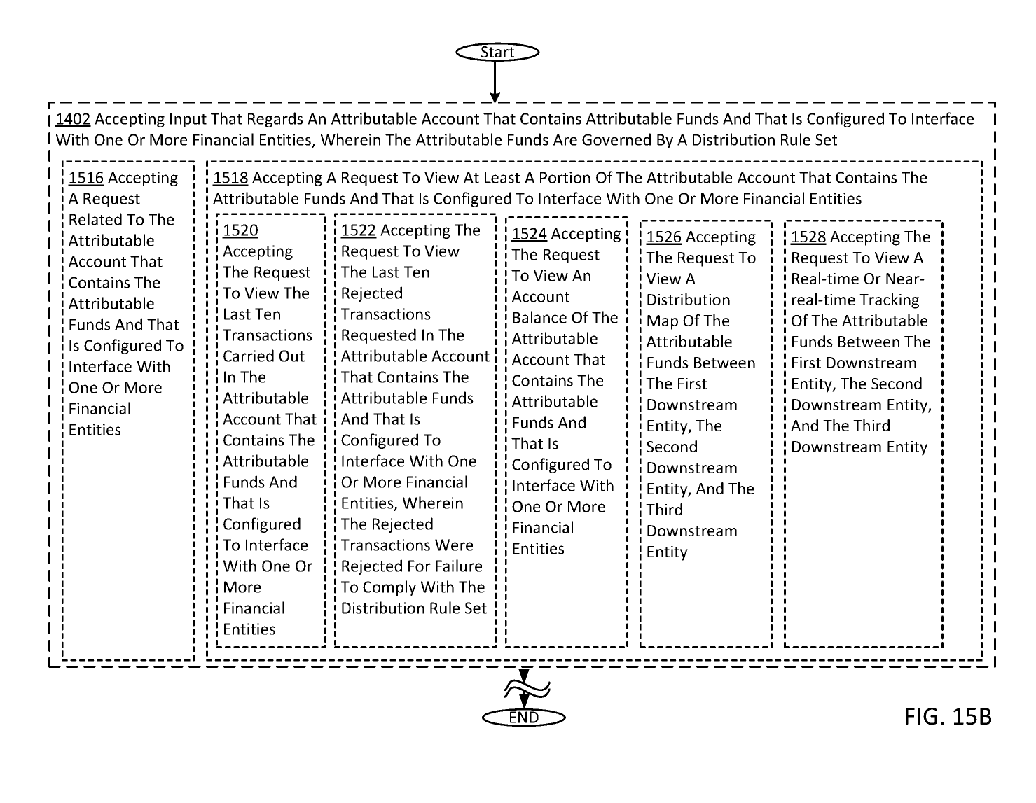

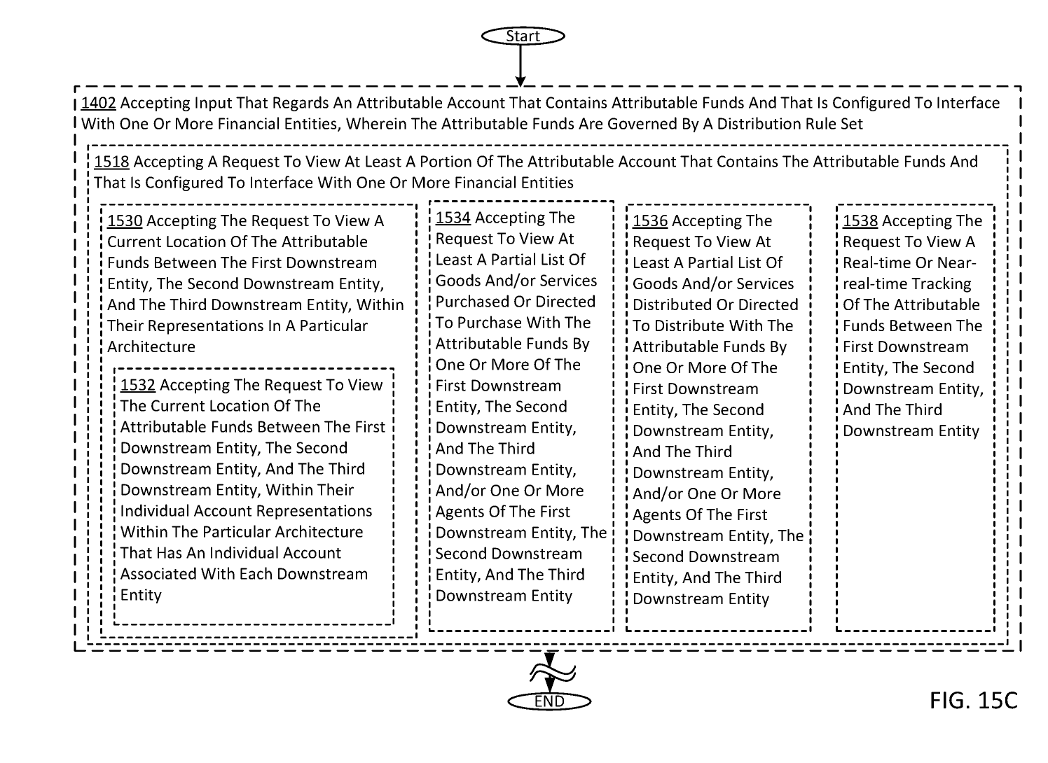

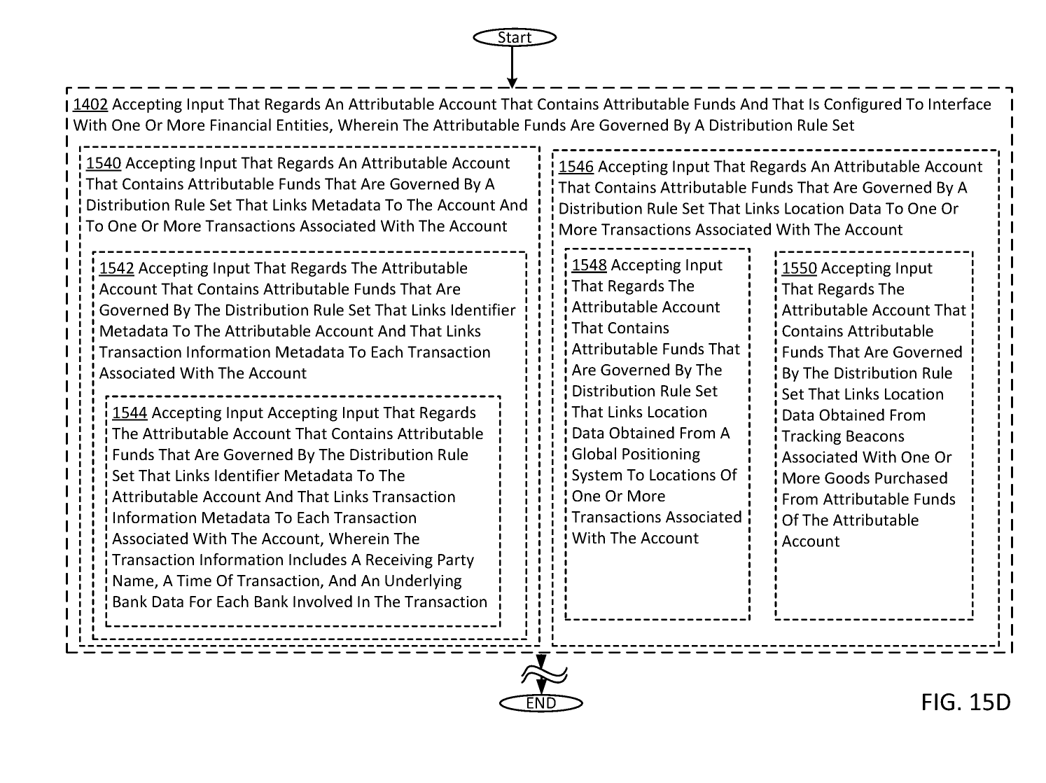

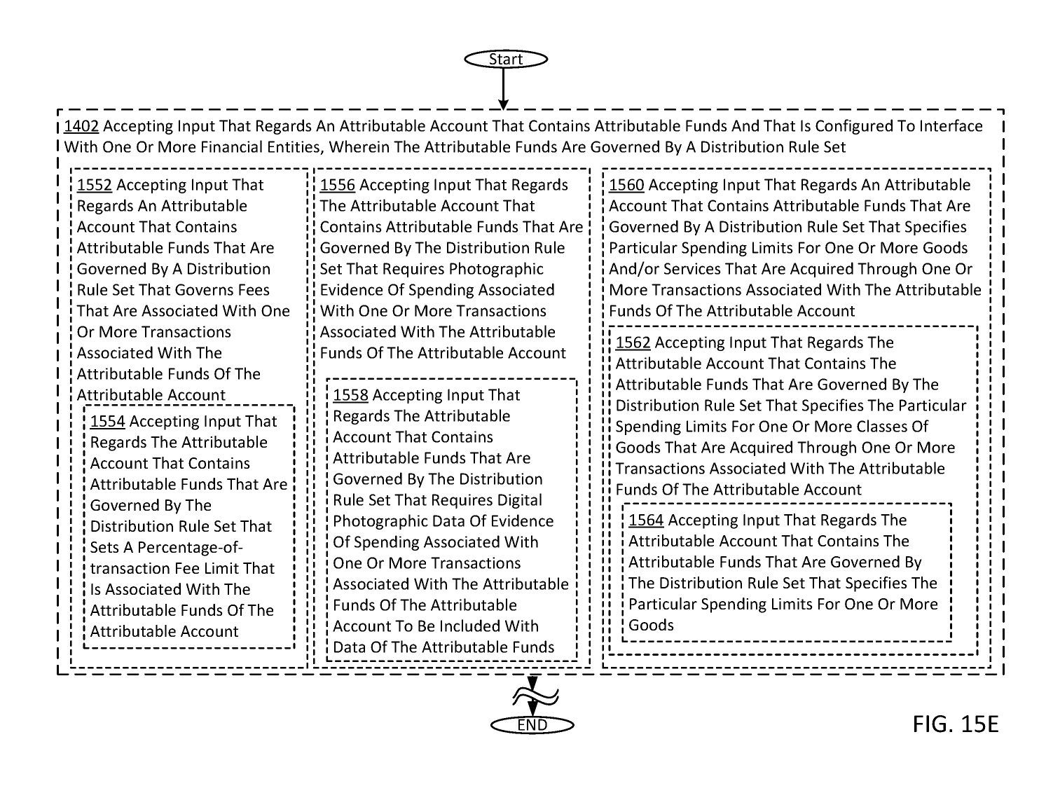

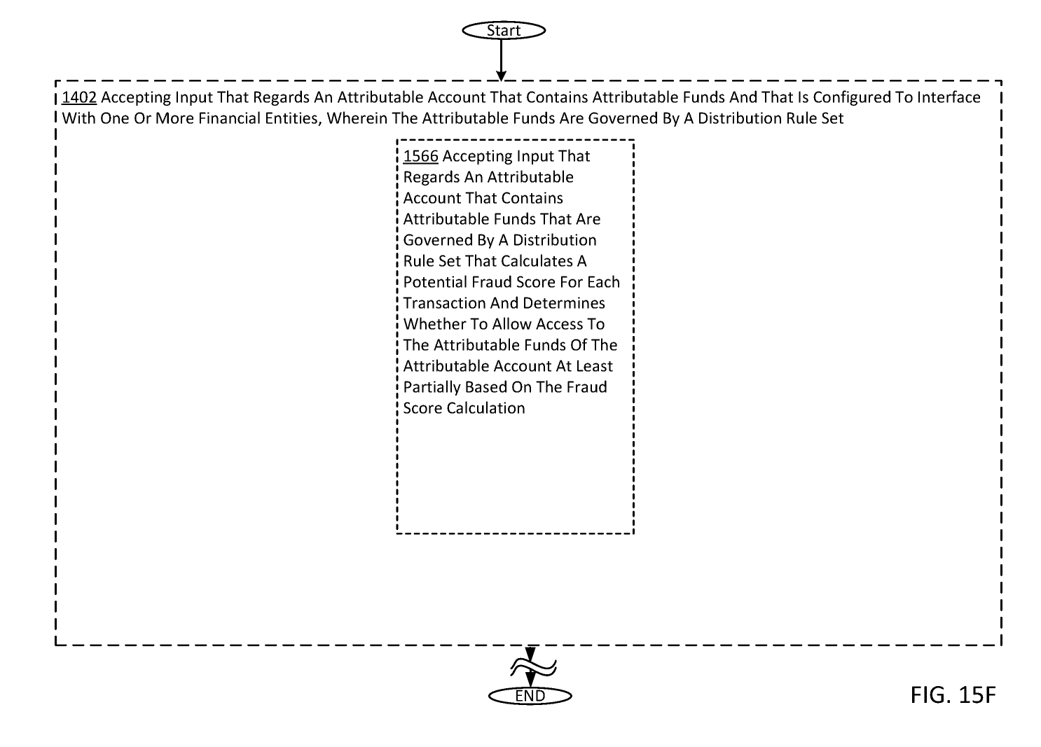

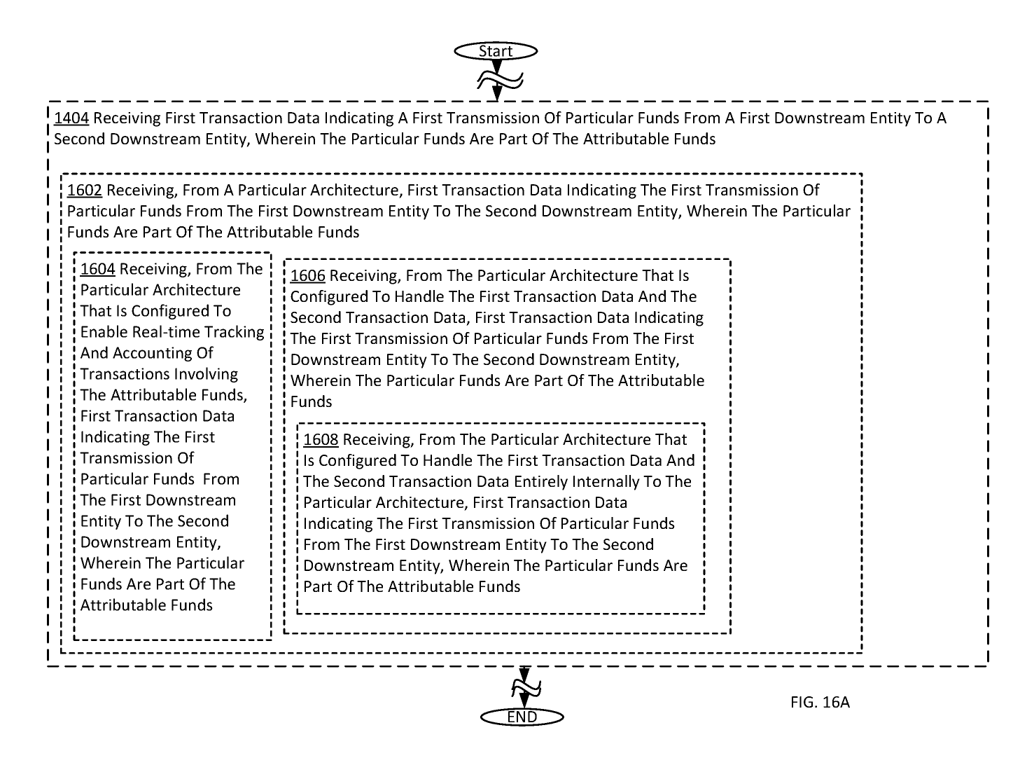

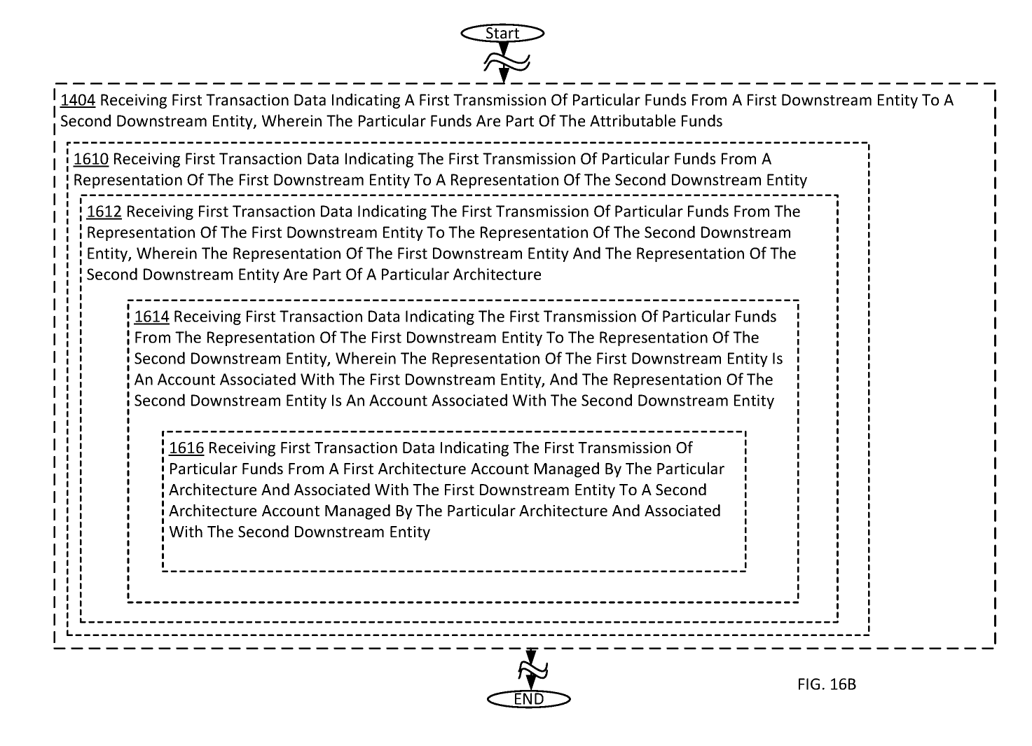

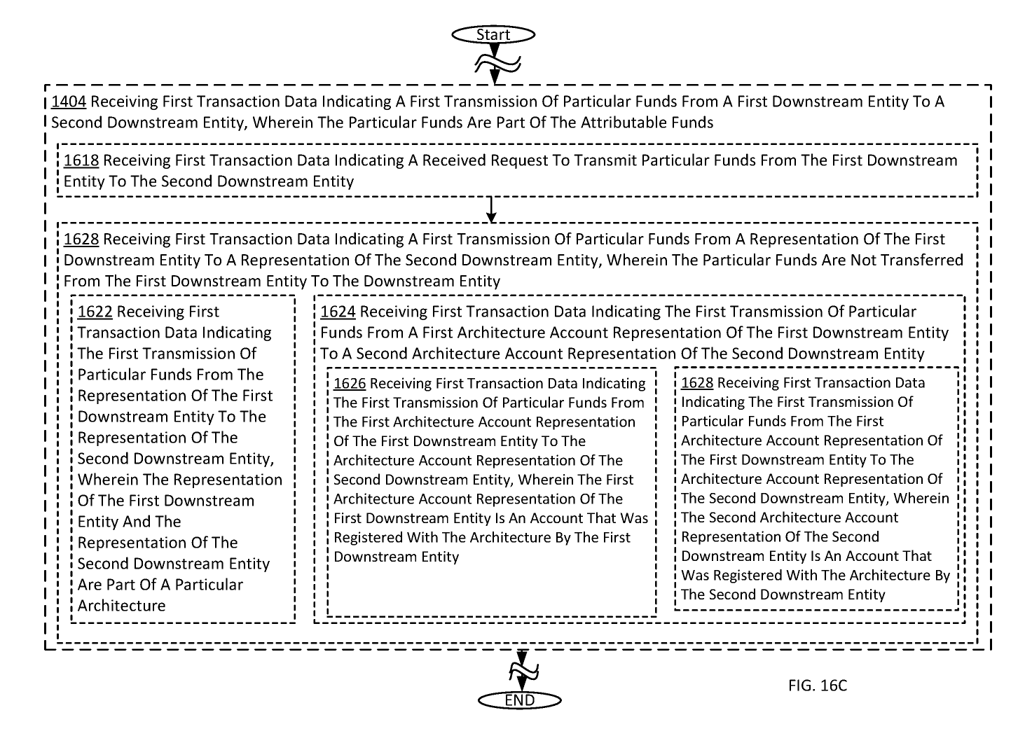

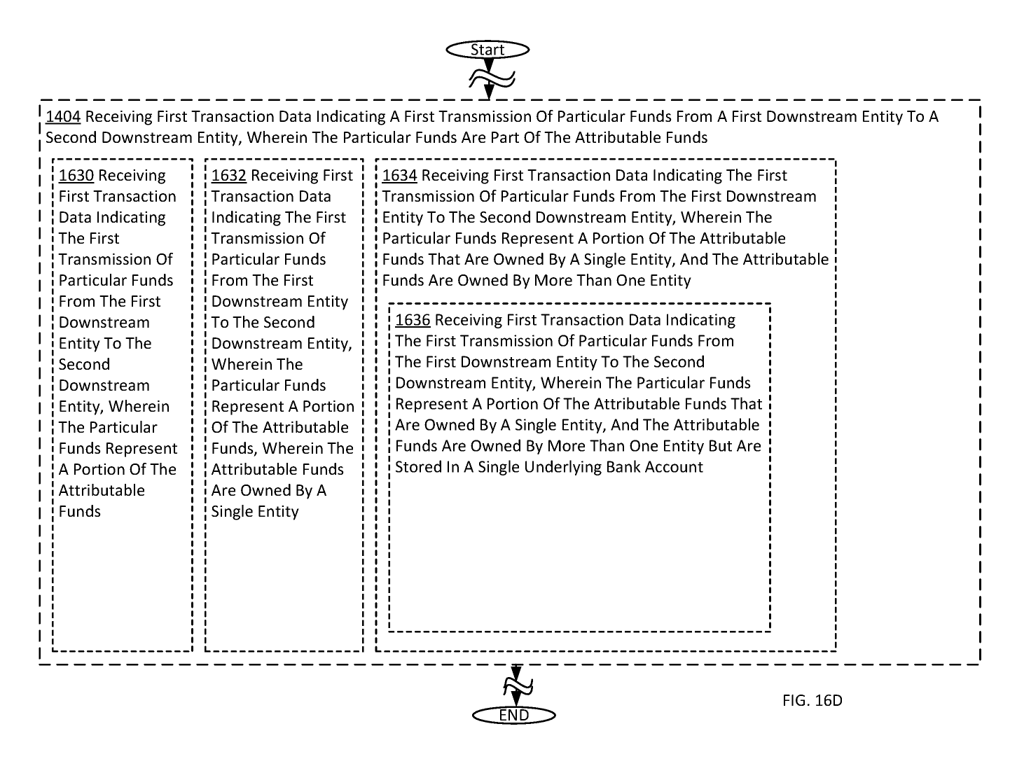

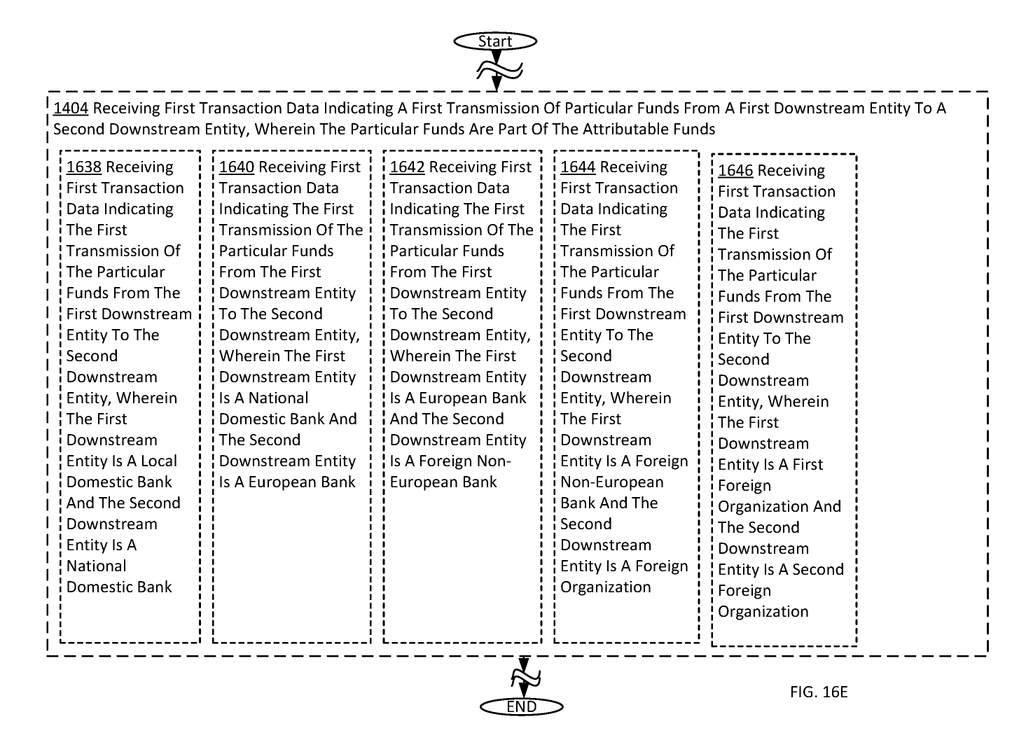

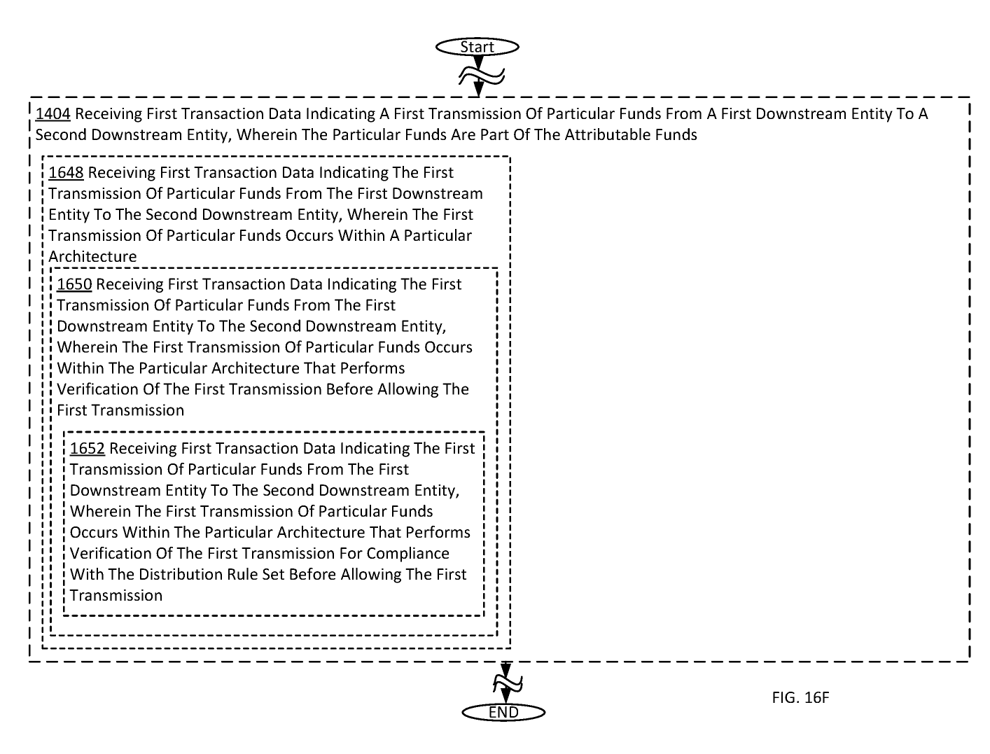

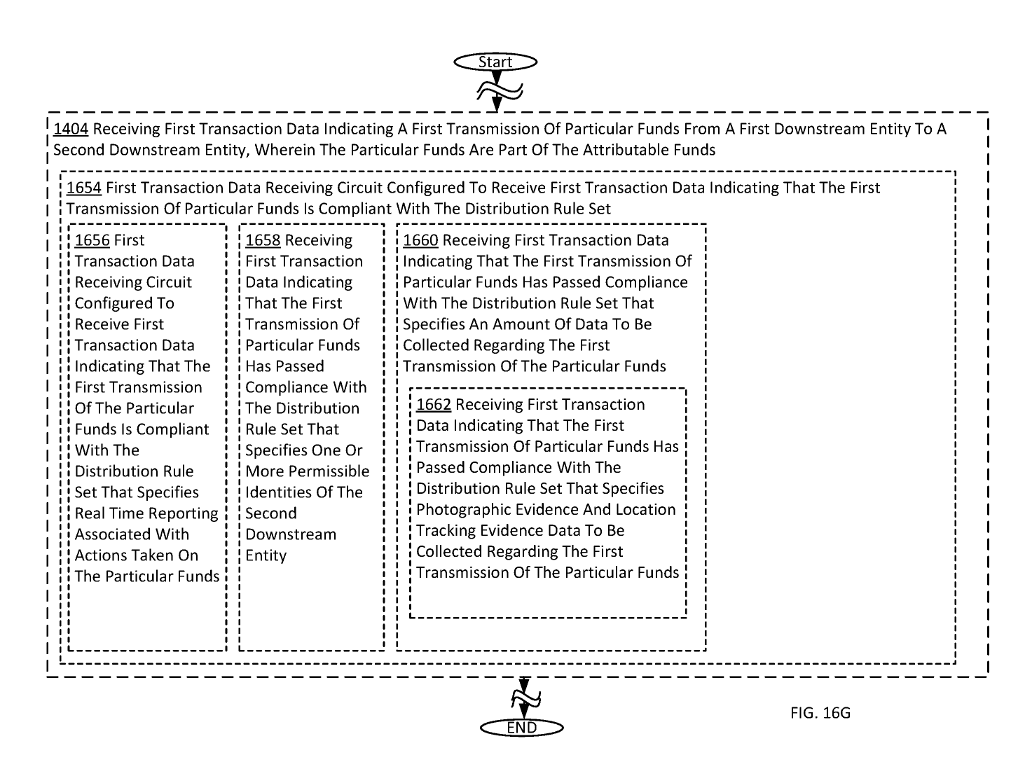

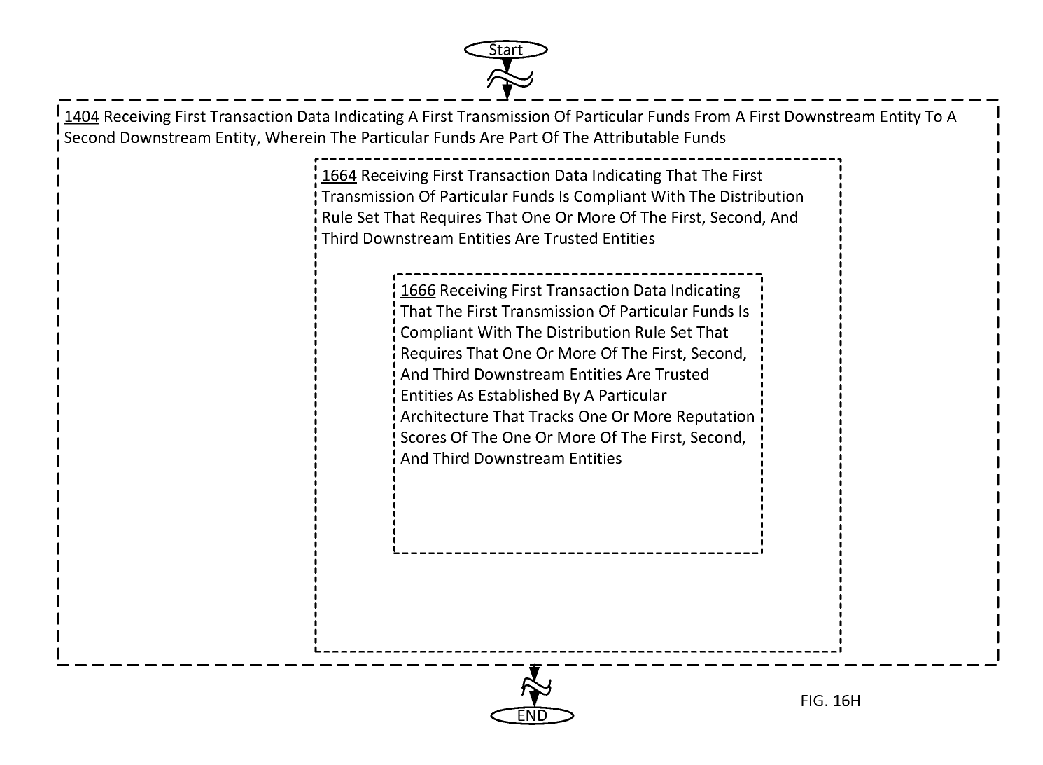

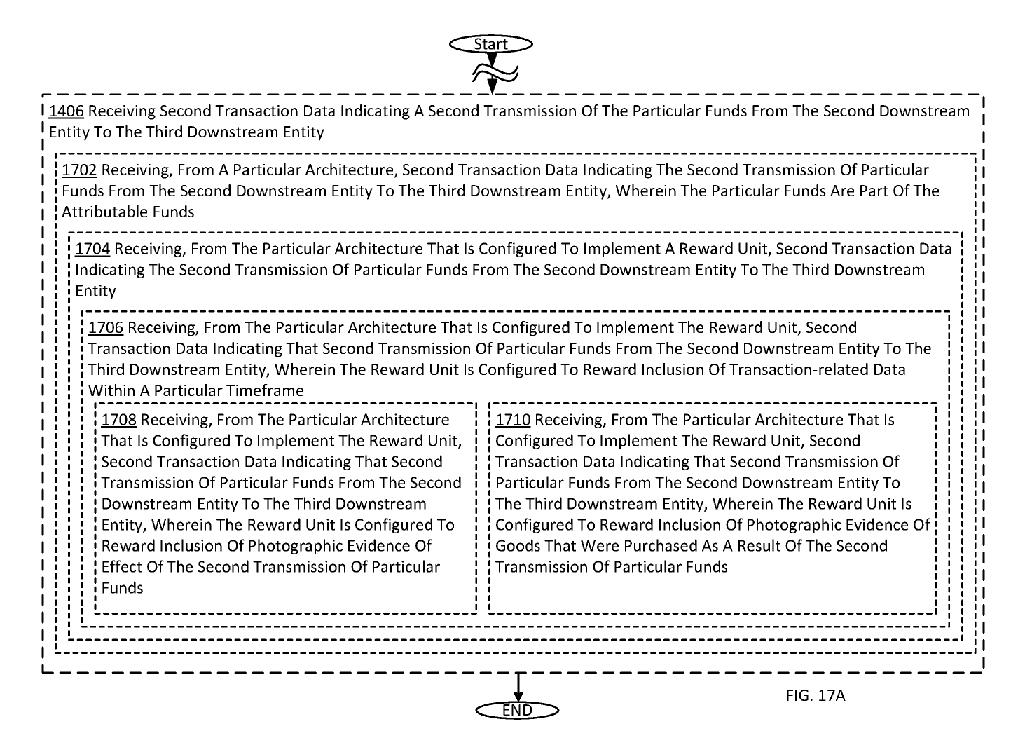

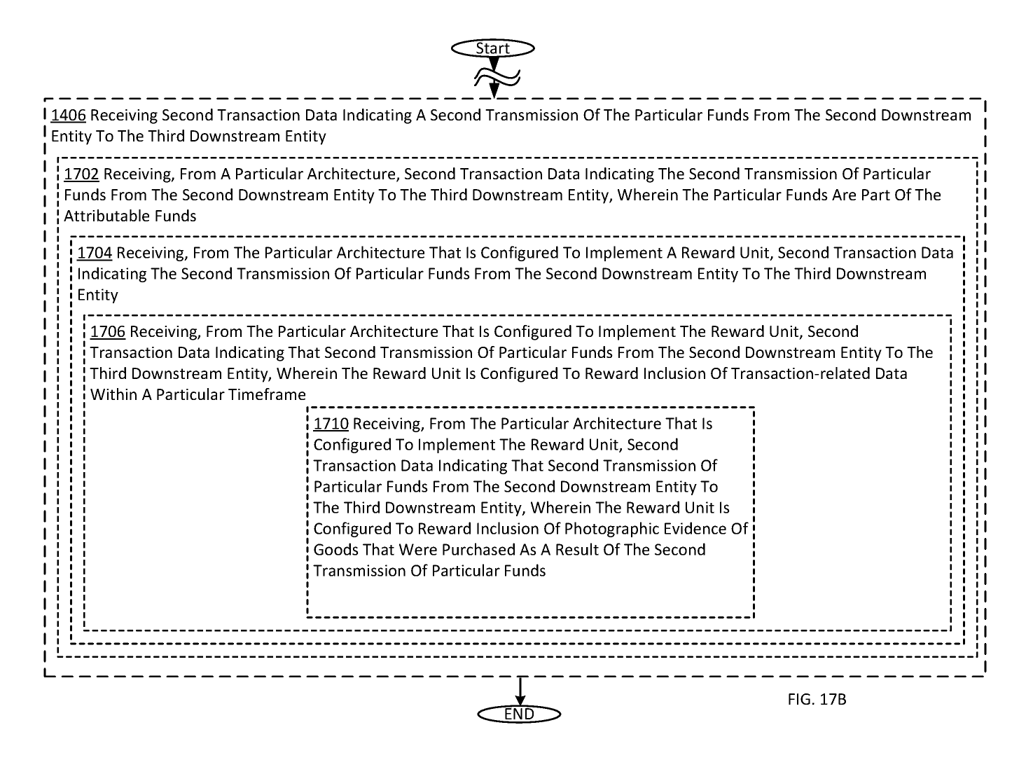

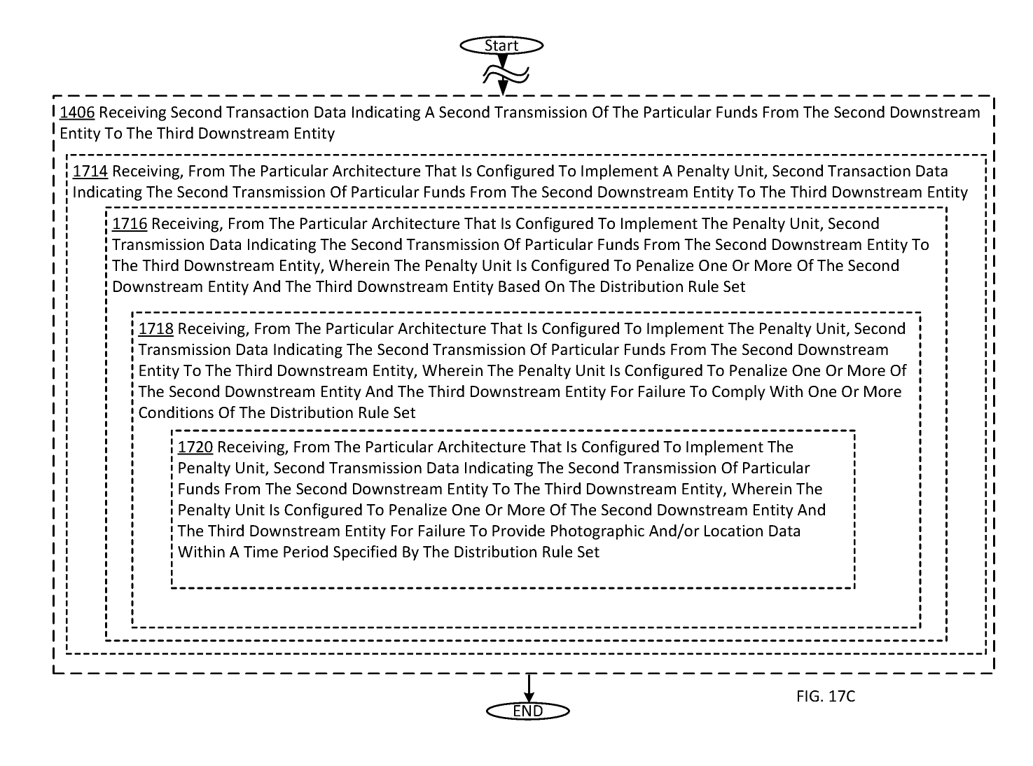

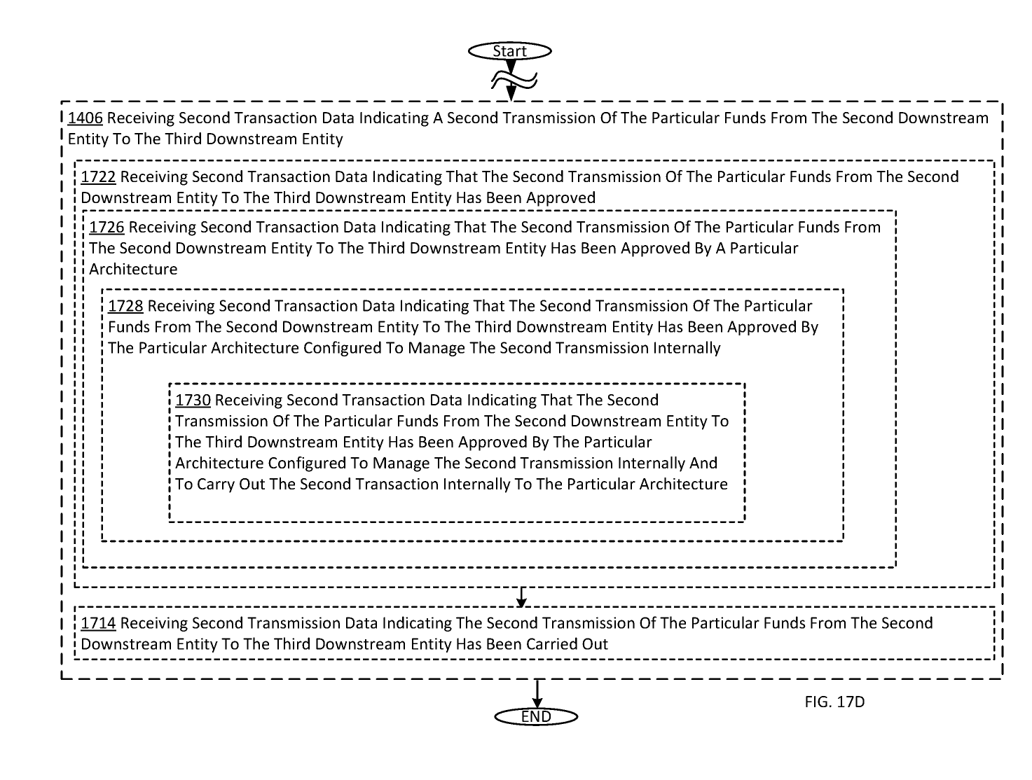

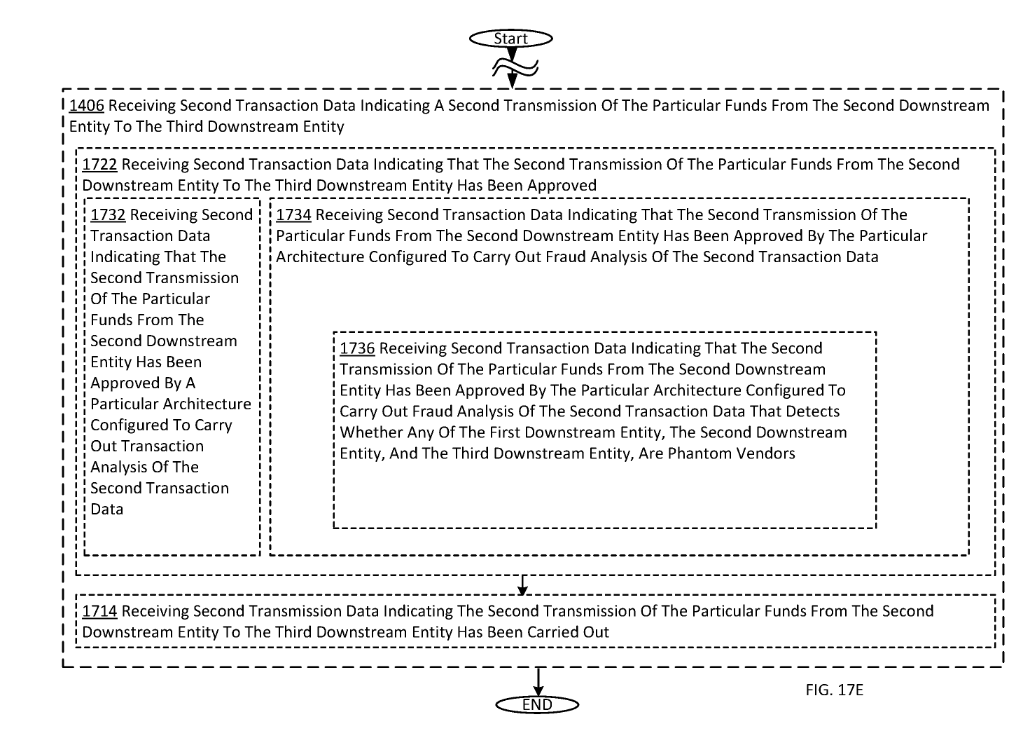

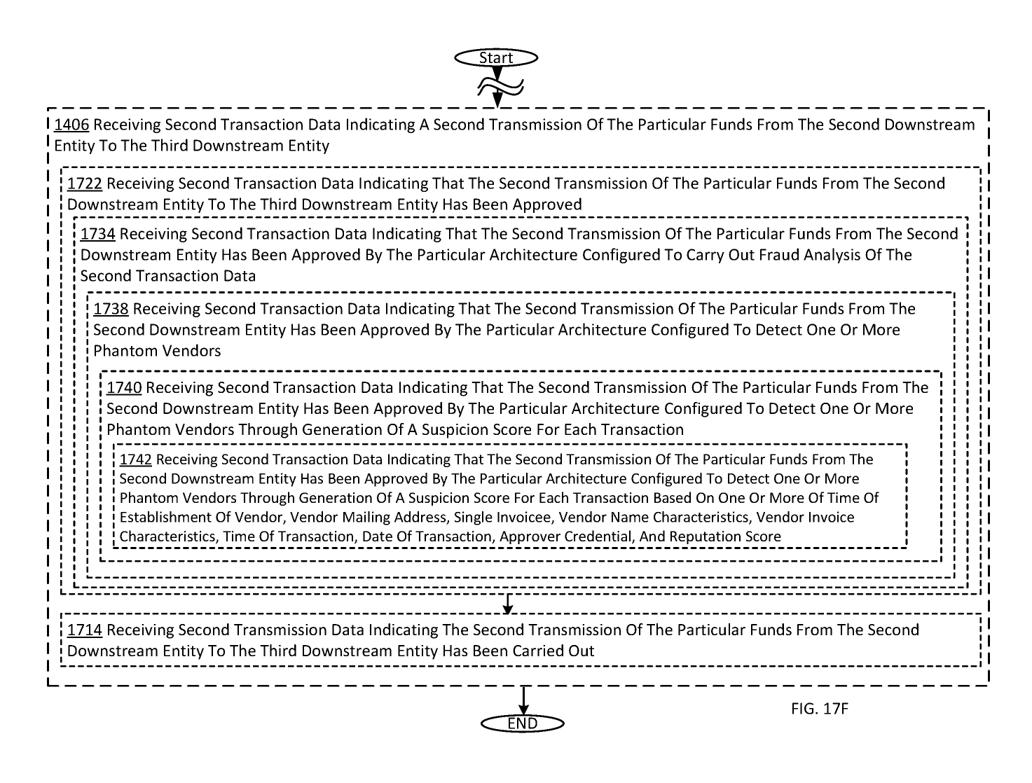

In accordance with 37 C.F.R. §1.84(h)(2), FIG. 1 shows “a view of a large machine or device in its entirety . . . broken into partial views . . . extended over several sheets” labeled FIG. 1-A through FIG. 1-L (Sheets 1-12). The “views on two or more sheets form, in effect, a single complete view, [and] the views on the several sheets . . . [are] so arranged that the complete figure can be assembled” from “partial views drawn on separate sheets . . . linked edge to edge. Thus, in FIG. 1, the partial view FIGS. 1-A through 1-L are ordered alphabetically, by increasing in columns from left to right, and increasing in rows top to bottom, as shown in the following table:

TABLE 1
Table showing alignment of enclosed drawings to form
partial schematic of one or more environments.

| Pos. (0, 0) | X-Pos 1 | X-Pos 2 | X-Pos 3 | X-Pos 4 |
|---|---|---|---|---|
| Y-Pos. 1 | (1, 1): FIG. | (1, 2): FIG. | (1, 3): FIG. | (1, 4): FIG. |
| | 1-A | 1-B | 1-C | 1-D |
| Y-Pos. 2 | (2, 1): FIG. | (2, 2): FIG. | (2, 3): FIG. | (2, 4): FIG. |
| | 1-E | 1-F | 1-G | 1-H |
| Y-Pos. 3 | (3, 1): FIG. | (3, 2): FIG. | (3, 3): FIG. | (3, 4): FIG. |
| | 1-I | 1-J | 1-K | 1-L |

FIG. 1-A, when placed at position (1,1), forms at least a portion of a partially schematic diagram of an environment(s) and/or an implementation(s) of technologies described herein.

FIG. 1-B, when placed at position (1,2), forms at least a portion of a partially schematic diagram of an environment(s) and/or an implementation(s) of technologies described herein.

FIG. 1-C, when placed at position (1,3), forms at least a portion of a partially schematic diagram of an environment(s) and/or an implementation(s) of technologies described herein.

FIG. 1-D, when placed at position (1,4), forms at least a portion of a partially schematic diagram of an environment(s) and/or an implementation(s) of technologies described herein.

FIG. 1-E, when placed at position (2,1), forms at least a portion of a partially schematic diagram of an environment(s) and/or an implementation(s) of technologies described herein.

FIG. 1-F, when placed at position (2,2), forms at least a portion of a partially schematic diagram of an environment(s) and/or an implementation(s) of technologies described herein.

FIG. 1-G, when placed at position (2,3), forms at least a portion of a partially schematic diagram of an environment(s) and/or an implementation(s) of technologies described herein.

FIG. 1-H, when placed at position (2,4), forms at least a portion of a partially schematic diagram of an environment(s) and/or an implementation(s) of technologies described herein.

FIG. 1-I, when placed at position (3,1), forms at least a portion of a partially schematic diagram of an environment(s) and/or an implementation(s) of technologies described herein.

FIG. 1-J, when placed at position (3,2), forms at least a portion of a partially schematic diagram of an environment(s) and/or an implementation(s) of technologies described herein.

FIG. 1-K, when placed at position (3,3), forms at least a portion of a partially schematic diagram of an environment(s) and/or an implementation(s) of technologies described herein.

FIG. 1-L, when placed at position (3,4), forms at least a portion of a partially schematic diagram of an environment(s) and/or an implementation(s) of technologies described herein.

FIG. 2A is a depiction of a table showing the difference between data level vs. information level, according to embodiments.

FIG. 2B is a depiction of a table showing electronic circuit machine state approximation of human-semantic information.

FIG. 2C-1 is a high-level block diagram of an exemplary environment 200C, including a first party machine 220, according to one or more embodiments.

FIG. 2C-2 is a high-level block diagram of an exemplary environment 200C-2, including a first party machine 220B, according to one or more embodiments.

FIG. 2D is a high-level block diagram of daybreak architecture 250D, according to one or more embodiments.

FIG. 2E is a high-level block diagram of daybreak architecture 250E, according to one or more embodiments.

FIG. 2F is a diagram of operation of the daybreak architecture 250F according to one or more embodiments.

FIG. 2G is a diagram of operation of the daybreak architecture 250F according to one or more embodiments.

FIG. 2H is a diagram of operation of the daybreak architecture 250F according to one or more embodiments.

FIG. 2I is a diagram of operation of the daybreak architecture 250F according to one or more embodiments.

FIG. 2J is a diagram of operation of the daybreak architecture 250F according to one or more embodiments.

FIG. 2K is a diagram of operation of the daybreak architecture 250F according to one or more embodiments.

FIG. 2L is a diagram of operation of the daybreak architecture 250F according to one or more embodiments.

FIG. 2M is a diagram of operation of the daybreak architecture 250F according to one or more embodiments.

FIG. 2N is a diagram of operation of the daybreak architecture 250F according to one or more embodiments.

FIG. 3A is a high-level block diagram of operation of corporate entity “C” computer 310, according to one or more embodiments.

FIG. 3B is a high-level block diagram of operation of corporate entity “C” computer 310, according to one or more embodiments.

FIG. 3C is a high-level block diagram of operation of corporate entity “C” computer 310, according to one or more embodiments.

FIG. 3D is a high-level block diagram of operation of corporate entity “E” phone 310D, according to one or more embodiments.

FIG. 4A is a high-level block diagram of fraud detection schemes 400, according to one or more embodiments.

FIG. 4B is a high-level block diagram of daybreak architecture 3100, according to one or more embodiments.

FIGS. 5A-5J show a high-level block diagram of a processor 251 and/or an at least one input acceptance machine 252, according to one or more embodiments.

FIGS. 6A-6F shows a high-level block diagram of at least one input acceptance machine 252 and/or an electrical/magnetic/physical storage of at least one original machine state 605, according to one or more embodiments.

FIG. 7 shows a high-level block diagram of a processor 251 and/or at least one first track data presentation machine 254 and/or at least one second track data presentation machine 256, according to one or more embodiments.

FIG. 8A shows a high-level block diagram of one or more of at least one first track data presentation machine states 710, according to one or more embodiments.

FIGS. 8B-8C show a high-level block diagram of one or more of at least one tracked first transmission of particular funds within a particular architecture 715, according to one or more embodiments.

FIG. 9 shows a high-level block diagram of a processor 251 and/or at least one second track data presentation machine 256, according to one or more embodiments.

FIG. 10 is a high-level block diagram of at least one first party machine 220B operating in environment 1000, according to one or more embodiments.

FIG. 11, including FIGS. 11A-11G, shows a particular perspective of an input acceptance circuit 252B of a first party machine 220B of FIG. 2C-2, according to one or more embodiments.

FIG. 12, including FIGS. 12A-12H, shows a particular perspective of an first transaction data receiving circuit 254B of a first party machine 220B of FIG. 2C-2, according to one or more embodiments.

FIG. 13, including FIGS. 13A-13F, shows a particular perspective of an second transaction data receiving circuit 256B of a first party machine 220B of FIG. 2C-2, according to one or more embodiments.

FIG. 14 is a high-level logic flowchart of a process, e g., operational flow 1400, including one or more operations of accepting input that regards an attributable account that contains attributable funds operation, a receiving first transaction data operation, and a receiving second transaction data operation, according to an embodiment.

FIG. 15A is a high-level logic flow chart of a process depicting alternate implementations of accepting input that regards an attributable account that contains attributable funds operation 1402, according to one or more embodiments.

FIG. 15B is a high-level logic flow chart of a process depicting alternate implementations of accepting input that regards an attributable account that contains attributable funds operation 1402, according to one or more embodiments.

FIG. 15C is a high-level logic flow chart of a process depicting alternate implementations of accepting input that regards an attributable account that contains attributable funds operation 1402, according to one or more embodiments.

FIG. 15D is a high-level logic flow chart of a process depicting alternate implementations of accepting input that regards an attributable account that contains attributable funds operation 1402, according to one or more embodiments.

FIG. 15E is a high-level logic flow chart of a process depicting alternate implementations of accepting input that regards an attributable account that contains attributable funds operation 1402, according to one or more embodiments.

FIG. 15F is a high-level logic flow chart of a process depicting alternate implementations of accepting input that regards an attributable account that contains attributable funds operation 1402, according to one or more embodiments.

FIG. 16A is a high-level logic flow chart of a process depicting alternate implementations of receiving first transaction data operation 1404, according to one or more embodiments.

FIG. 16B is a high-level logic flow chart of a process depicting alternate implementations of receiving first transaction data operation 1404, according to one or more embodiments.

FIG. 16C is a high-level logic flow chart of a process depicting alternate implementations of receiving first transaction data operation 1404, according to one or more embodiments.

FIG. 16D is a high-level logic flow chart of a process depicting alternate implementations of receiving first transaction data operation 1404, according to one or more embodiments.

FIG. 16E is a high-level logic flow chart of a process depicting alternate implementations of receiving first transaction data operation 1404, according to one or more embodiments.

FIG. 16F is a high-level logic flow chart of a process depicting alternate implementations of receiving first transaction data operation 1404, according to one or more embodiments.

FIG. 16G is a high-level logic flow chart of a process depicting alternate implementations of receiving first transaction data operation 1404, according to one or more embodiments.

FIG. 16H is a high-level logic flow chart of a process depicting alternate implementations of receiving first transaction data operation 1404, according to one or more embodiments.

FIG. 17A is a high-level logic flow chart of a process depicting alternate implementations of receiving second transaction data operation 1406, according to one or more embodiments.

FIG. 17B is a high-level logic flow chart of a process depicting alternate implementations of receiving second transaction data operation 1406, according to one or more embodiments.

FIG. 17C is a high-level logic flow chart of a process depicting alternate implementations of receiving second transaction data operation 1406, according to one or more embodiments.

FIG. 17D is a high-level logic flow chart of a process depicting alternate implementations of receiving second transaction data operation 1406, according to one or more embodiments.

FIG. 17E is a high-level logic flow chart of a process depicting alternate implementations of receiving second transaction data operation 1406, according to one or more embodiments.

FIG. 17F is a high-level logic flow chart of a process depicting alternate implementations of receiving second transaction data operation 1406, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for the environment illustrated in FIG. 1.

### Operational Descriptions are Not Abstract Ideas but are A Specification for Massively Complex Computational Machines

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although one or more users maybe shown and/or described herein, e.g., in FIG. 1, and other places, as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

The Document Herein is A Legal Instrument that Recites Claims to Patentable Subject Matter Under the Patent Laws Set Forth By Congress and Authorized in the U.S. Constitution.

1. The Natural English Disclosures/Claims Herein are to be Construed in View of the Technology Knowledge and Expertise of One of Skill in the Art, at Least a Part of which is Set forth Herein so that any Reviewing Authority will Understand the almost Incomprehensible Complexities of the Electrical/Electronic/Computer Engineering Technologies as Would be Understood by One of Skill in the Art

A “patent is a legal instrument, to be construed, like other legal instruments . . . by the standard construction rule that a term can be defined only in a way that comports with the instrument as a whole . . . the decision maker vested with the task of construing the patent . . . to ascertain whether an expert's proposed definition fully comports with the specification and claims and so will preserve the patent's internal coherence.” Markman v. Westview Instruments, 517 U.S. 370 (1996). That said, “one must bear in mind, moreover, that patents are ‘not addressed to lawyers, or even to the public generally,’ but rather to those skilled in the relevant art. Carnegie Steel Co. v. Cambria Iron Co., 185 U. S. 403, 437 (1902) (also stating that “any description which is sufficient to apprise [steel manufacturers] in the language of the art of the definite feature of the invention, and to serve as a warning to others of what the patent claims as a monopoly, is sufficiently definite to sustain the patent”).“Nautilus, Inc. v. Biosig Instruments, Inc., 134 S. Ct. 2120 (U.S. 2014). Thus, a duly-licensed attorney—further registered to practice before the United States Patent and Trademark Office (USPTO)—drafting a complex legal instrument known as a “patent” faces a difficult balancing act. On the one hand, the drafting attorney must keep in mind that the ultimate authority construing her claim to legal monopolistic rights in which her client is most interested will be a member of the Federal Judiciary (e.g., a typically a licensed attorney). On the other hand, the drafting attorney must keep in mind that the technological disclosures/distinctions which the law requires are addressed to “those of skill in the relevant art” (e.g., persons of technology).
To some, such a balancing act would seem impossible, especially in Information Age/Intelligence Amplification technologies, such as described herein, where the way in which those skilled in the art disclose, and the legal requirements around disclosure in such arts, open patent owners to linguistic arguments that disclosures/claims are made to “abstract ideas”. Fortunately, in CLS Bank v. Alice the Court has explained how to disclose in an effort to minimize the chance that patent owners will be subjected to “abstract ideas” arguments:
Section 101 of the Patent Act defines the subject matter eligible for patent protection. It provides: “Whoever invents or discovers any new and useful process, machine, manufacture, or composition of matter, or any new and useful improvement thereof, may obtain a patent therefor, subject to the conditions and requirements of this title.” 35 U.S.C. §101.
“We have long held that this provision contains an important implicit exception: Laws of nature, natural phenomena, and abstract ideas are not patentable.” . . . We have interpreted §101 and its predecessors in light of this exception for more than 150 years . . . .
We have described the concern that drives this exclusionary principle as one of pre-emption. . . . (upholding the patent “would pre-empt use of this approach in all fields, and would effectively grant a monopoly over an abstract idea”). Laws of nature, natural phenomena, and abstract ideas are “‘“ the basic tools of scientific and technological work.”’” . . . “[Monopolization of those tools through the grant of a patent might tend to impede innovation more than it would tend to promote it,” thereby thwarting the primary object of the patent laws . . . ; see U.S. Const., Art. I, §8, cl. 8 (Congress “shall have Power . . . To promote the Progress of Science and useful Arts”). We have “repeatedly emphasized this . . . concern that patent law not inhibit further discovery by improperly tying up the future use of these building blocks of human ingenuity.
At the same time, we tread carefully in construing this exclusionary principle lest it swallow all of patent law. . . . At some level, “all inventions . . . embody, use, reflect, rest upon, or apply laws of nature, natural phenomena, or abstract ideas.”
Thus, an invention is not rendered ineligible for patent simply because it involves an abstract concept. . . . “[A]pplication[s]” of such concepts “‘to a new and useful end,’” we have said, remain eligible for patent protection. . . . Accordingly, in applying the §101 exception, we must distinguish between patents that claim the “‘buildin[g] block[s]’” of human ingenuity and those that integrate the building blocks into something more, . . . , thereby “transform[ing]” them into a patent-eligible invention, . . . . The former “would risk disproportionately tying up the use of the underlying” ideas, . . . , and are therefore ineligible for patent protection. The latter pose no comparable risk of pre-emption, and therefore remain eligible for the monopoly granted under our patent laws.

In Mayo Collaborative Services v. Prometheus Laboratories, Inc., . . . , we set forth a framework for distinguishing patents that claim laws of nature, natural phenomena, and abstract ideas from those that claim patent-eligible applications of those concepts. First, we determine whether the claims at issue are directed to one of those patent-ineligible concepts. . . . If so, we then ask, “[w]hat else is there in the claims before us?” . . . . To answer that question, we consider the elements of each claim both individually and “as an ordered combination” to determine whether the additional elements “transform the nature of the claim” into a patent-eligible application. . . . We have described step two of this analysis as a search for an “‘inventive concept’”—i.e., an element or combination of elements that is “sufficient to ensure that the patent in practice amounts to significantly more than a patent upon the [ineligible concept] itself.”

Alice Corp. Pty. LTD v. CLS Bank Int′l, 134 S.Ct. 2347, 2360-62 (Jun. 19, 2014).) (internal citations omitted).

So, to be clear, and as expressly set forth herein no claims are made to “laws of nature, natural phenomena, or abstract ideas” and insofar as that any argument is made that any claim/disclosure herein is to such, this document hereby provides public notice that any claims herein are to be construed as only laying claim to patentable subject matter as defined by the patent statutes and as further modified by judge made exceptions to same. Also, as explained herein, it is in no way conceded that any machine, process, composition, or article claims are “same in substance” in that one of skill in the art—if consulted, and especially in view of the deep technological disclosures herein—would understand such claims to different things and associated legal rights. The inventor(s) have gone to great lengths in this document to explain that the present disclosures are addressed to one(s) of skill in the art (e.g., electrical/electronic/computer/etc. engineers) who will understand such to teach machines/articles/compositions/processes not to “a method of organizing human activity” nor human “mental constructs” especially in light of the overt technological teachings of the present disclosures (and especially, any machine/process/composition/articles state(s) in support of the legal definiteness, written description, and enablement requirements to claims made are in no way generic, but are instead are to very tightly claimed/engineered special purpose and unique machine/process/composition/article state(s). One reason why is that an engineer typically can't get paid by his employer for philosophizing, and thus it is highly likely that he would not see “methods of organizing human behavior” or “mental steps” in the present disclosure and claims, and the inventor(s) have gone to great length to explain at least a part of the massive technological complexities which would by “understood” by an engineer viewing the text/drawings of the present disclosure so that any ultimately reviewing authority—even before/without consulting one of skill in the art—will understand that the present disclosures are deeply and fundamentally complex and technical. Thus, any such argument as to “abstract ideas” should be seen through and dismissed in light of the extensive technical disclosures and explanations herein.

However, insofar as that CLS Bank clarified, that the Court will not require that the trial judge consult one skilled in the art before it rules on whether the claims are drawn to patentable subject matter, out of an abundance of caution the inventors explain herein deep technologies as would be understood by one of skill in the art. Some might say that a redacted version of the present disclosure/claims would be understood by one of skill in the art of electrical/electronic/computer engineering to be drafted to describe, e.g., machines (e.g., massive configurations of special purpose electrical circuits) and transformations (e.g., processes describing the humanly-perceivable transformations of voltage level inputs to voltage level outputs). But in light of the subtleties of the technologies the disclosing inventors have elected to overtly explain some of the technologies that one skilled in the art(s) will understand from this disclosure.

This is especially true as regard the term “information.” Insofar as that the natural English language of the present disclosures/claims is directed to ones of skill in the appropriate art(s) (e.g., information age/intelligence amplification technologies), such disclosures are subject to (i) arguments intentionally confusing/conflating “engineering-information” with “‘ordinary information’” (e.g., “abstract ideas”) and/or (ii) arguments that any implications/explications of “software” in such disclosures/claims are drawn to “software per se” aka “abstract ideas” (human thinking). As briefly shown following, all of these arguments can be seen to be false and when the disclosures are viewed through the lens of one of skill in the art or who approximates one of skill in the art (e.g., a Registered Patent Attorney, a Patent Examiner of the USPTO, etc.) who will understand that the disclosures herein are directed at least in part to Information Age/Intelligence Amplification machine/article/composition/process state(s).

2. Descriptions Herein are Drawn to Machines/Processes/Articles/Compositions such as Might be Configured and/or Operated to Produce “Engineering-Information” and NOT the Human Meaning/Thinking (“Ordinary-Information”) such One or More Machine/Process/Article/Composition States are Expected/Hoped to Trigger

As explained herein, the term “engineering-information” may be employed as a mnemonic device to help keep straight that, unless context dictates otherwise, the present disclosures/claims are drawn to machines/processes/articles/compositions configured and/or operated to produce one or more states, such one or more states forming known symbols of a human language (e.g., English language alphabet and numerals—first-order-human-thought-symbol-information) and such one or more states expected/hoped to trigger second-order-human-thought-concept-information (e.g., desired result of understood and humanly-useful currency trading concepts or other humanly-useful human-semantic logics (e.g., Boolean logic) which the English reader who understood currency trading/other might glean from the electrified pixels of an LCD). That is, in general the present disclosures/claims are of machine/process/article/composition configured/operated one or more states that constitute “engineering-information”—e.g., human-perceivable-machine-state-differences—And NOT the human meaning/thinking (“ordinary-information”) such one or more states are expected/hoped to trigger. (Human-perceivable generally includes all phenomena humanly perceivable by some technological means such as voltmeters, current meters, electron microscopes, spectroscopy, etc.—such as machine-generated differences that humans can perceive by some technological means.)

The present disclosures/claims, when understood in an engineering context such as employed by the USPTO and hoped to be employed by any construing/reviewing authority, are descriptive of machines/machine-states/machine-state transformations carefully engineered to create structured DATA (machine-generated-tangible-differences),¹ said DATA structured in view of first-order-human-thought-symbol-information (e.g., English language words which have concrete meaning to English-readers), and said DATA further structured in view of second-order-human-thought-concept-information (e.g., desired result of understood and humanly-useful currency trading concepts which the English reader gleans from the English words of Information Age/Intelligence Amplification disclosures). In Information Age/Intelligence Amplification technologies DATA (machine-generated-tangible-differences) are not thinking; rather, DATA (machine-generated-tangible-differences) are structured to trigger, or cause, human thinking. Information Age/Intelligence Amplification patent disclosures/claims are to statutory subject matters that produce DATA, not to the thinking/meaning—INFORMATION—such DATA are structured to trigger in humans. ¹ ″Tangible” meaning perceivable by humans via some technology such as voltmeter measurements, pixel brightness differences (LCD monitor), haptic differences (cell phone on vibrate), audio differences (cell phone with audible ringtone), etc.

It is easy to confuse/conflate “‘engineering’ information” with “‘ordinary information,’” even if understanding is the goal. However, it is important to understand that they are radically different.

This difference may be highlighted by reference to the field of Semiotics, which relates to the study of signs as opposed to that which they signify and which draws a further distinction that arises in very precise semiotics as well as Information Age/Intelligence Amplification technologies: the distinction between the sign vehicle (one or more humanly-perceivable machine-generated differences—DATA), the sign (first-order human thought, e.g., DATA interpreted as English language words by humans who understand English—first-order-human-thought-symbol-information), and the signified (second-order human thought, e.g., such as would be understood from the English words of business machine claims by English-readers who further work in the highly complex world of international currency trading—second-order-human-thought-concept-information). Noth, Handbook of Semiotics 79-80 (1995).

Engineers usually work with “information” as that term is used in Shannon and Weaver's Mathematical Theory of Communication, traditionally referred to in data communications engineering as “information theory,” but better described as “data theory” outside of engineering as explained herein. As used by engineers, “information” is neither signifier (first-order-human-thought-symbol-information) nor signified (second-order-human-thought-concept-information). Rather, it is “something else”—what precise semiotics calls the “sign vehicle”: “In information theory, the term signal corresponds to the sign vehicle of semiotics. This signal . . . is opposed to the sign since it is only its physical embodiment.” Noth, Handbook of Semiotics 79-80 (1995).

“From a semiotic point of view, Shannon & Weaver's . . . communications models do not represent signs as one of their elements. Not signs but signals are transmitted in the process of communication. Signals are only the energetic or material vehicles of signs, and their physical form. In this sense, a signal is a physical event, while a sign is a mental process.” Id at 174.

As explained in herein, the signals (“information”) of “information theory”—machine-generated differences that humans can perceive by some technological means—may be better understood if the term DATA is used to refer to “engineering-information.”

Information Age/Intelligence Amplification technologies are difficult to understand even when the goal is understanding. This confusion can be remedied by use of this chain: engineer-designed machines create structured DATA,² where said DATA are structured to generate first-order-human-thought-symbol-information (e.g., English language words which have concrete meaning to English readers), and said DATA are further structured to generate second-order-human-thought-concept-information (e.g., result of understood and humanly-useful currency trading concepts gleaned from the English words).³ So, engineers CREATE MACHINES to generate DATA structured to function as first-order English symbols AND generate second-order logical concepts at the same time—Information Age/Intelligence Amplification technology such as described herein really is that complicated. ² Data are machine-generated-tangible-differences, where “tangible” means perceivable by humans via some technology such as voltmeter measurements, pixel brightness differences (LCD monitor), haptic differences (cell phone on vibrate), audio difference (cell phone with audible ringtone), etc.

As described, this complexity allows for the very real danger of confuting/conflating “engineering” information (as in the present disclosure, and such as data communications/computer/electrical engineers sometimes use the term) with “ordinary” everyday information (the way normal people use the term), and vice-versa. Yet this dichotomy is real, and can be very important in Information Age/Intelligence Amplification technologies. However, confusion/conflation can be avoided due largely in part to the newer vocabulary cataloged by Professor Luciano Floridi in his article, “Semantic Conceptions of Information”, The Stanford Encyclopedia of Philosophy (Spring 2013 Edition), Edward N. Zalta (ed.).

3. Professor Luciano Floridi's Newer Formal Convention that Utilizes the Term DATA tn Lieu of “Engineering-Information” (E.G., Machine-Generated-Differences-Human-Perceivable-By-Some-Means) to Clarify that in in Information Age/Intelligence Amplification Technologies such DATA “Cause” INFORMATION (Concrete Meanings or Thoughts in the Mind of the Human Perceiving the DATA) Helps Engineers, Patent Examiners, and Construing/Reviewing Authorities to Remember that the Present Disclosures/Claims are Drawn to Machines/Processes/Articles/Compositions and NOT the Human Mind Thinking

Engineers' (e.g., computer/electronic/electrical) use of the term “information” (“engineering-information”)—e.g., consistent with Shannon's Mathematical Theory of Communication (MTC)—can be very confusing because it is so different from the way normal people use the term. In engineering-information, psychological/mental states are irrelevant. Engineering-information is not information in the ordinary sense of the word. “Engineering-information” has an entirely technical meaning: information without human meaning, such as would be transmitted over a fiber optic cable or telegraph wire. Floridi, Semantic, §2.2. “The ‘goal [of engineering information] is to . . . eliminate the psychological factors involved’ . . . subtract human knowledge from the equation” J. Gleick, Information: A History, A Theory, A Flood 200-201 (2011). “Shannon . . . declared meaning to be ‘irrelevant to the engineering problem.’” Id at 416.

But, in engineering references, the term used is typically just “information”—even though what is meant is “engineering-information”; information devoid of all human-semantic meaning such as might be transmitted over a telegraph wire. This unfortunate identity of terms for radically different things (engineering-information versus “ordinary” information), can cause some to conclude that Information Age/Intelligence Amplification disclosures/claims are drawn to “ordinary” information: human-semantic meaning, or human thought.

Why does this matter? Because in this way it can be argued that Information Age/Intelligence Amplification disclose/claim ordinary “information” or “human-semantic meaning” which matches up with “mental steps” which are “ . . . abstract ideas” and hence are drawn to unpatentable subject matter. (“abstract ideas—”mental steps”).

This is false. One way to see that it is false is to take note of Professor Floridi's convention of using the term “DATA” instead of “engineering-information” and using the term “INFORMATION” as “ordinary” information and as such term is commonly used both inside and outside of engineering.

Floridi has created a map showing the concept of semantic information as “meaningful data.” This table/map is shown in FIG. 2-A.

Both inside and outside of engineering, it helps to keep Floridi's vocabulary and distinctions in mind so that the reader does not confuse the DATA and INFORMATION levels and thus reach the conclusion that the disclosures/claims are drawn to INFORMATION (abstract ideas), when in fact the disclosures/claims herein are drawn to machines (electronic circuits)/machines-states (e.g., voltages of electronic circuits)/transitions of machine-states (e.g., transformation of voltage state levels from 0.0-0.8 to 2.0-5.0 measured volts) that create DATA (MACHINE-GENERATED-TANGIBLE-DIFFERENCES), structured to cause INFORMATION in some pre-defined group of humans (e.g., humans who understand English-language symbols and who further understand currency trading concepts).

4. Exemplary Machine/Process/Article/Composition State(s) Showing how Information Age/Intelligence Amplification Technologies Rely on Engineering Techniques to Activate Human Subjectivity (“‘Ordinary’ Information”) through Carefully Controlled and Engineered Machine Objectivity (“Engineering-Information”)

Information Age/Intelligence Amplification technologies augment/improve the intelligence of humans (such as a human currency trader) via engineering of electronic circuits (machines) to create DATA (plural of DATUM). A datum is a difference that can be perceived by a human via one of the 5 human senses (e.g., sight, hearing, touch, taste, smell). Floridi, Semantic, S 1.3; Gleick, Information p. 161.

Information Age/Intelligence Amplification technologies use conventions such that the DATA can “stand for” some defined human-semantic meaning (INFORMATION). For example, the following table shows how ANALOG electronic circuit voltages and an accompanying set of conventions allow the ANALOG electronic circuit voltages—DATA—to “stand in for,” or mimic, two-valued (e.g., DIGITAL) human-symbolic logics (e.g., Boolean logics or equivalently natural-language-like “if then” conditional logic statements). These techniques are fundamental, and still form the basis of Information Age/Intelligence Amplification technologies, albeit via increased design complexities by factors that likely number in the trillions.

This table/map is shown in FIG. 2-B.

Referring to FIG. 2B, the table illustrated in FIG. 2-B shows that the analog electronic circuit—paired with the convention of assigning 0.0-0.8 volts to human-semantic “false” and 2.0-5.0 volts to human-semantic “true”—allow the voltages arising from circuit operation to “stand for” or “mimic” the human-symbolic “digital” “If-Then” conditional logic of computer programming or Boolean Truth Tables. Today's hyper-complex microprocessors/VLSICs are built using this and similar circuits over and over. Information Age/Intelligence Amplification typically uses higher-level programs that assemble combinations of the microprocessors/VLSIC instructions to mimic yet-higher-level human semantic logic (e.g., currency trading). Thus, from this single example engineers, patent examiners, and any ultimately construing reviewing authorities should understand that the present disclosure/claims are drawn to massively complicated circuits such as VLSIC/microprocessor and related Information Age/Intelligence Amplification technologies.

Information Age/Intelligence Amplification patent disclosures/claims are not of human thinking, but instead of, e.g., the machines (electrical circuits)/machine-states (electrical circuit voltages)/machine state transformations (transitions of voltage levels) perceivable by a human (DATA), said DATA structured to create a concrete meaning in the mind of a human observer (INFORMATION).

Thus, one skilled in the art of electrical/electronic/computer/other engineering will understand the present disclosures/claims words/concepts are drawn to machines/articles/processes/compositions that “stand for” such words/concepts via engineering techniques analogous to those just described, unless context dictates otherwise.

5. Any Implications/Explications of “Software” in the Present Disclosures/Claims—such as Might be Reached through Use of Seemingly Human-Semantic Words, Concepts, or Logics as Set Forth Herein—are Drawn to “Software” as such would be Understood by a Patent Examiner Drawing on Her Electronic/Electrical/Computer Engineering Knowledge or a Reviewing Authority Assisted by Electronic/Electrical/Computer Engineering Experts as Opposed to “Software Per Se aka “Abstract Ideas” (Human Thinking) Sometimes/Often Referenced by Non-Engineers

For many, many years, computer science was not an approved degree allowing registration to practice before the USPTO due to a mistaken consensus opinion that computer science was not _really_ technical/technology in the way that, say, electrical or mechanical engineering is, due at least in part that higher-order computer languages resemble natural language (a misunderstanding that is addressed and laid to rest elsewhere herein). Ultimately, though, the USPTO did extend recognition to computer science as “technical enough” to sit for the exam to be registered with the USPTO, because in a very real sense “computer languages” constitute rewritings and renaming of the machines/processes created by electrical/electronic/computer engineers, such as processors and their associated Instruction Set Architectures-microarchitectures which computer programs utilize to create special purpose circuitries. In fact and over time in modern technology software engineering might be described as just as much an engineering discipline as, say, mechanical engineering. See, e.g., Brief of Amicus Curiae Margo Livesay, PH, D. In Support of Neither Party, l ALICE v CLS Bank No. 13-298 (U.S. Jan. 28, 2014)

As the USPTO did eventually recognize—e.g., through an extended chain of reasoning/technology, e.g., via recognition that compiler/linker programs/circuits through direct substitution translate the “source code” of programmers to processor memory reservations and associated machine instructions (which are themselves ultimately specifications of, in most technologies, resistors, transistors, capacitors, inductors etc.)—some outputs of some computer scientists could be viewed as technological/technical in that via such translations it can be seen that the programs actually constitute specifications of machines, machine operations, and/or machine interoperations at the rate of millions per second (e.g., Millions of Instructions Per Second)). Thus, computer science did ultimately become a USPTO approved degree.

Thus, the work products of some computer scientists, properly understood with the assistance of electrical/computer/electronic engineers who actually understand the deeper level machines/processes that the computer scientists typically employ in their designs, can be viewed as immensely complicated specifications of hardware and methods of operation of same. However, even though higher order computer languages resemble human natural language and thus the work products of some computer scientists require translation/explication by computer/electronic/electrical engineers to be understood as indeed technical/technology, on the flip side computer programs are written for machines, not humans. Consequently, while in the early days, computer programs were submitted in patent applications as a description of the technologies, it quickly became apparent that neither the highly skilled technologists of the USPTO, nor the engineering community itself, nor the construing reviewing authorities could glean much from submission of computer source code. The reason such is not very helpful to humans is that computer source code itself is not in any sense natural human language, but is instead a code written for an intermediate level of machines/processes, e.g., an extremely powerful/complicated set of machines/processes known as compilers/linkers, which typically substitute several tens of binary (e.g., composed of two symbols, such as “1” and “0”) processor instructions for each “higher order” computer program instruction, and where each bit of each of the substituted binary instruction is translated into a voltage/current level of a vendor-specific VLSIC/microprocessor to create special purpose circuits. Thus, computer program source codes, which ultimately specifies voltage and current levels which quickly number into the billions, are generally incomprehensible to most humans, and especially busy, important, and powerful ones like patent examiners and reviewing authorities. So, in light of this reality and over time, the USPTO and the courts started asking that patent attorneys disclose by describing _functions_ to be performed by data communications/computation machinery, but in natural English language, which those skilled in the art and PTO examiners and reviewing authorities—preferably with the assistance of one skilled in the art—are to understand as disclosing technical (i.e., patentable) subject matter such as by the logic of the following _highly-simplified_ logic chain demonstrating how a technical person (e.g., computer engineer) understands a patent disclosure implicating/explicating “software”:

(a): natural English language functional descriptions in patent applications should be understood by one of skill in the art of computer programming to imply an implementation via a higher-order computer language such as the C programming language;

(b) implementation of a higher-order computer language such as C should be understood by one of skill in the art of engineering (e.g., electrical/computer/electronic) as representative of reservation of memories (e.g., Random Access Memories, or RAMs) and associated VLSIC/microprocessor instructions such as an engineer understands will be produced by compiler/linker electronic logic circuits;

(c) memory reservations and machine instructions such as would be produced by the compiler/linker electronic logic circuits should be understood by engineers (e.g., computer/electronic/electrical) as specifying voltages/currents dictated by the circuits used to “stand in or” or “mimic” the human-semantic instructions of the Instruction Set Architecture of the particular vendor-specific microprocessor in use;

(d) the “instructions” of the Instruction Set Architecture should be understood by engineers (e.g., electrical/electronic/computer) as turning off and on electronic circuits provided by the micro-architecture of the particular vendor-specific microprocessor/VLSIC in use; and

(e) thus, natural English descriptions in the present disclosure, that might include partially functional/operational language which might implicate/explicate computer programs can be understood, such as through this _very simplified_ explanation—as technical/technology disclosures or machine/article/composition/process state(s) such as might “stand in for” or “mimic” human-semantic words, logic, concepts, etc. via, for example, Information Age/Intelligence Amplification engineering techniques.

Consequently, descriptions in the present disclosure/claims in human-semantic meaning or human-semantic logic form are to be understood as disclosing hardcore electrical/electronic/computer engineering technology via an application of the foregoing logic chain by one skilled in the art(s) unless context dictates otherwise.

In particular, it should be understood that the fact that the complexity of the technologies virtually mandates such type of disclosure should not in any sense be understood as giving rise to “functional claiming.” Both the USPTO and courts have long-ago found that other types of disclosures—such as describing computer programs in source code, or binary code and memory reservations, or as electrical voltages/currents/timing signals, or as electronic circuits that “stand in for” or “mimic” human-semantic logic (the briefly described circuit that approximates the human-semantic Boolean logic function described herein)—quickly become incomprehensible by reviewing authorities, working engineers, and especially patent examiners at the USPTO. Thus, the law has developed that patent attorneys are strongly encouraged to disclose the as-described electronic circuits, voltages, currents, timings, etc. at least partially _functionally_ so that such disclosures are within the realm of human comprehension with the expectation that the patent examiner will use her deep technical knowledge to engage in a logic chain such as briefly described above to discern the electronic/electrical/computer engineering technologies disclosed thereby and with the further expectation that any reviewing authority will consult with electrical/electronic/computer engineers to likewise reach engineering technologies which one skilled in the art would “see” in functional disclosures.

Notwithstanding the foregoing, superficial similarities between the antonyms “soft” and “hard” can be used to create a Sophistic false dilemma (either-or choice between software (“not hardware”) and hardware)—used to construct an argument that “software” matches the dictionary definition of “abstract” and is thus indicative of “mental steps”—unpatentable subject matter.

As should be apparent by now, this type of sophistry is demonstrably false: any implications/explications of “software” in the present disclosure/claims are actually indicative of engineering terms used to distinguish the design choice of using computer programs to create special purpose circuits from reconfigurable but slower hardware versus the design choice of using circuit manufacturing techniques to create non-reconfigurable (but much faster) hardware.

Non-technologists (e.g., trial attorneys) have been able to generate confusion by the exploitation of a false choice between “hardware” and “software” (“not hardware”) which has been deftly inserted into the phrases “computer-implemented invention, “software patents,” “patents on software,” etc. See Brief of Amicus Curiae IEEE USA in Support of Neither Party, ALICE v CLS Bank No. 13-298 (US. Jan. 28, 2014). This dilemma is false, and the disclosures/claims should be understood consistent with technology.

For example, the phrase “claims to computer-implemented inventions,” “software patents,” “patents on software,” etc., see, e.g., Brief of Amicus Curiae IEEE USA in Support of Neither Party, ALICE v CLS Bank No. 13-298 (US. Jan. 28, 2014), improperly give the appearance of a “split nature” of such claims. For example, by using “computer-implemented” as an adjective that is appended to “invention,” a “computer” (e.g., a hardware microprocessor) is made to seem like a generic or neutral component of “something else” (e.g., “not hardware” (“software”)) that “is” the “invention.”

Why does this matter? Because when mischaracterized via clever use of the antonyms “hard” and “soft”—“software” as “not hardware”—but otherwise ill-defined, “not hardware “matches up” with a non-technology general usage dictionary definition of “abstract idea”: “disassociated from any specific instance . . . expressing a quality apart from an object <the word poem is concrete, poetry is [abstract]>”). An abstract idea is one that has no reference to material objects or specific examples—i.e., it is not concrete.”—This general usage dictionary “similarity” can be used to support Sophistic/specious arguments that lead one to the conclusion that, as an abstract idea, “software” is unpatentable. But the hardware-software (“not hardware”) dichotomy used to generate this “similarity” is false because it is a linguistic, and not engineering-based, argument.

As shown herein, one skilled in the art will understand that what is called “software” is actually use of computer programs to create special purpose (unique, and not generic) circuits from reconfigurable but slower hardware, and what is called “hardware” is actually use of circuit manufacturing techniques to create unique and not generic non-reconfigurable but much faster hardware.

In the absence of the false dichotomy construing/reviewing authorities should understand—as electronic and computer engineers understand—that any “software” of the present disclosure/claims is a specification of special purpose—not generic—electronic circuits which are assembled/operated/logged/torn down/subsequently interconnected (e.g., via saved fed-back states) at the rate of millions of circuits per second (e.g., “millions of instructions per second”). That this is true can be briefly illustrated as follows.

In operation, a higher level computer language program implementation of the present disclosure/claims, such as one written in the C programming language, is translated (compiled) into the binary instructions appropriate to the Instruction Set Architecture-microarchitecture of the vendor specific (e.g., Intel, NEC, AMD, etc.) microprocessor in use.

These binary instructions actually represent voltages that are applied in parallel to the microprocessor. To understand that the “hardware”-“software” dichotomy is false, it helps to keep in mind that a microprocessor is a Very Large Scale Integrated Circuit (VLSIC) having a collection of reconfigurable (slower) circuit components that are able to be activated by applied voltages; in the absence of a program the VLSIC/microprocessor is inert. It also helps to keep in mind that a “computer program” consists of encoded voltage levels that turn transistors on and off in a VLSIC/microprocessor; in the absence of the appropriate type of microprocessor/VLSIC a computer program is inert.

Any digital logic design of a computer program, in order to work in the real world, must be such that it can compile to voltages that will work with the circuitries of a vendor-specific microprocessor that is ultimately “married up” with the program. (This is even and especially true when a “virtual processor” such as is used in Sun's/Oracle's JAVA technologies, is employed, because at some point the “'virtual machine instructions” (e.g., JAVA bytecodes) of the “virtual machine” must be put into the form dictated by the vendor-specific VLSIC/microprocessor that underlies the “virtual machine.” Oracle's JAVA system is an abstraction layer whereby Oracle supplies the “heavy lifting” regarding the true underlying hardware, thereby leaving JAVA “programmers” or “compiler writers” to write code without regard for capabilities of the underlying vendor specific VLSIC/microprocessor actually in use (except, of course, when a programmer asks the virtual machine to do something that the underlying real hardware just cannot do, in which case a catastrophic “JAVA spill” occurs). In some sense, this heavy lifting of Oracle/Sun is occult to rank and file computer programmers, which may be giving rise to the unjustifiable confusion about the patentable nature of data communications and computing technologies. Rest assured, if something is experienced via a machine, some real hardware and/or electricity must be doing work to manifest that experience, and this reality needs to be kept firmly in mind).

A microprocessor/VLSIC contains millions of electronic transistors and resistors. The VLSIC/microprocessor is engineered such that its electronic transistors can be selectively activated—just like flipping an on-off light switch in a room—to create special purpose analog electronic circuits which can accept electrical inputs and produce electrical output in ways that “mimic” or “stand in” for certain defined human-semantic logical operations. The defined human-semantic logical operations which a microprocessor's/VLSIC's special circuits can mimic are called “instructions.” Taken together, the defined human-semantic logical operations and the hardware engineering of the VLSIC/microprocessor that is necessary to produce the special circuits that when operated within engineering parameters can mimic the defined human-semantic logical operations are called the Instruction Set Architecture-microarchitecture (“ISA-microarchitecture”) of the microprocessor/VLSIC. The ISA-microarchitecture is vendor specific, so an Atmel microcontroller's ISA-microarchitecture is different than an Intel microprocessor's ISA-microarchitecture, etc.

Activating and/or setting the inputs of the special purpose circuits which mimic the defined human semantic logical operations (”instructions“) of the VLSIC/microprocessor is typically done via voltages applied in parallel to metallic traces (”bit lines“) which connect with metallic pins, each of which electrically connect with the VLSIC which make up the microprocessor. For example, with respect to one Atmel microcontroller, 8 voltages are applied in parallel to activate specific instructions of the Atmel microcontroller.

The circuits of the microprocessor/VLSIC are analog—as are all circuits—but are engineered in view of a special convention which allows the analog circuits to mimic human semantic digital logic. For example, in one type of circuit implementation (“Resistor-Transistor Logic”), 0.0 to +0.8 measured volts, by convention, is treated as “standing for” human-semantic logical zero, and measured +2.0 to +5.0 volts, by convention, is treated as “standing for” human-semantic logical one. The voltages can thus be “treated as” (encoded as) “strings” of “binary “symbols, but electrical and computer engineers understand that such strings specify voltage levels that open and close transistors of the VLSIC/microprocessor to create or set the inputs of the special purpose circuits which mimic the human-semantic logic of the Instruction Set Architecture of the microcontroller/VLSIC.

Control of the circuitry of the VLSIC/microprocessor consists of a sequence of a number of encoded voltage levels—e.g., a sequence of eight parallel voltage levels for the Atmel processor. When such a sequence is constructed to achieve a humanly useful and meaningful (concrete meaning to a human) output of circuits (tangible machines) and associated voltage transitions (transformations) via clever use of the special purpose electrical circuits-associated human semantic instructions that make up the Instruction Set Architecture, such an encoded sequence of voltage levels is denoted as a “computer program.” There is nothing abstract about a sequence of 8 voltages to be applied in parallel to metallic traces known as bit lines such as for the Atmel 8-bit processor. Modern microprocessors/VLSICs can execute their instructions at the rate of millions per second. Since each instruction has an accompanying electronic circuit that “stands for” the human-semantic logic instruction, it follows that the computer programs are creating, using, and tearing down hardware designs (electronic circuits) from the electronic circuit components of vendor specific microprocessors/VLSICs at the rate of millions per second.

The either-or “hardware”-“software” Sophistic dilemma is thus again seen to be false.

6. As Explained Herein, Engineers, Patent Examiners, and Construing/Reviewing Authorities should Understand that any Human-Semantic Words, Concepts, and/or Logics Herein—when Understood in Technical Context—Disclose/Support Claiming at all Points Up and Down the Abstraction Levels Known to those of Skill in the Art; such Technical Context includes at least Electrical/Electronic/Data Communications/Computer Engineering Anywhere Up and Down the Abstraction Levels Herein Described

In the descriptions herein (e.g., which include but are not limited to those incorporated by reference), reference is made to the text referred to as “claims” (e.g., any text entitled “Claims” as such might appear at the end of this document which texts are incorporated by reference herein at this position in the detailed description in their entireties and which those skilled in the art will thus recognize serve at least the purpose of at least one example of how to make and use the machine/article/process/composition described without undue experimentation, but especially when read in context of other text herein (e.g., technical “specification includes the claims” for what they disclose when read for technical content as opposed to the legal rights activated the text of the claims are read/construed in light of the law of post-issuance claim interpretation). The illustrative embodiments herein are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for at least part of the technologies shown/illustrated as such would be understood by one skilled in the art.

The text (e.g., claims/detailed description/etc.) and/or drawings herein may describe one or more of the instant technologies in partially operational/functional language, for example as a set of operations. Such partially operational/functional description in some instances could be understood by one skilled the art as the mapped states of specifically-configured “hardware” (e.g., programming creates a new machine, because a general purpose computer in effect becomes a special purpose computer once it is programmed to perform particular functions pursuant to instructions of a computer program).

Importantly, although the partially operational/functional descriptions described herein are understandable by the human mind, they are not abstract ideas of the operations/functions divorced from machine/process/article/composition state(s) used to provide computational implementation of those operations/functions. Rather, the operations/functions represent a specification for massively complex computational machines or other means. As discussed in detail below, the partially operational/functional language should be read in its proper technological context, i.e., as concrete specifications for physical implementations.

Some logical operations/functions described herein are a distillation of machine specifications or other physical mechanisms specified by the operations/functions such that the otherwise inscrutable machine specifications may be comprehensible to the human mind. The distillation also allows one of skill in the art to adapt the partially operational/functional description of the technology across many different specific vendors' hardware configurations or platforms, without being limited to specific vendors' hardware configurations or platforms.

Some of the present technical description (e.g., detailed description/drawings/claims, etc.) may be set forth in terms of logical operations/functions. As described in more detail in the following paragraphs, these logical operations/functions are not representations of abstract ideas, but rather representative of static or sequenced specifications of various hardware (e.g., electronic circuit) elements. Differently stated, unless context dictates otherwise, the logical operations/functions should be understood by those of skill in the art to be representative of static or sequenced specifications of various hardware (e.g., electrical circuit) elements. This is true because tools available to one of skill in the art to implement technical disclosures set forth in partially operational/functional formats—tools in the form of a high-level programming language (e.g., C, Java, Visual Basic), etc.), or tools in the form of Very high speed Hardware Description Language (“VHDL,” which is a language that uses text to describe logic circuits)—are generators of static or sequenced specifications of various hardware configurations. This fact is sometimes obscured by the engineering term “software,” but, as shown by the following explanation, those skilled in the art understand that what is termed “software” may be a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language. In order to facilitate human comprehension, in many instances, high-level programming languages resemble or even share symbols with natural languages. See, e.g., Wikipedia, Natural language, http://en.wikipedia.org/wiki/Natural_language.

It has been Sophistically argued by non-engineers that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding of very complex and technical electronic/computer/electronic engineering subject matter as a technology for shortening the design cycle of such complex and technical electronic/computer/electrical subject matters should not be taken as an indication that what is expressed is an abstract idea. In fact, those skilled in the art understand that just the opposite is true. If a high-level programming language is a tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines/articles/compositions/processes to desired effect.

The many different computational machines/articles/compositions/processes that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality approximation of Boolean logic (e.g., the herein-described RTL electronic circuits and associated conventions which electrical engineers use to approximate the human-semantic Boolean AND function).

Logic gates may be arranged to form logic circuits, which are typically physical devices that may be electrically, mechanically, chemically, or otherwise driven to create a physical reality approximation of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor may often contain more than one hundred million logic gates in its many logic circuits (and often more than a billion transistors).

The logic circuits forming the microprocessor are arranged to provide a microarchitecture that will carry out the instructions defined by that microprocessor's defined Instruction Set Architecture. The Instruction Set Architecture is the part of the microprocessor architecture which as described herein engineers use to “stand in for” or “mimics,” human-semantic meanings/logic including native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific circuits which approximate groupings of logic gates from the millions of logic gate circuits of the more general machine. Thus, far from abstract mathematical expressions, machine language instruction programs, even though “coded” as a string of zeroes and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second. Thus, programs written in machine language—which may be tens of millions of machine language instructions long—are incomprehensible to some humans. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus, among other things, translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a partially functional/operational technical description, when viewed by one of skill in the art, is far from an abstract idea. Rather, such a partially functional/operational technical description, when understood through the tools available in the art such as described herein and elsewhere, is instead understood to be a humanly understandable representation of a hardware specification, the complexity and specificity of which far exceeds the comprehension of most any one human. With this in mind, those skilled in the art will understand that any such partially operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, almost any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a partially functional/operational technical description as a humanly-understandable representation of one or more almost unimaginably complex and time sequenced hardware instantiations. The fact that partially functional/operational technical descriptions might lend themselves readily to high-level computing languages (or high-level block diagrams for that matter) that share some words, structures, phrases, etc. with natural language simply cannot be taken as an indication that such partially functional/operational technical descriptions are abstract ideas, or mere expressions of abstract ideas. In fact, as outlined herein, in the technological arts this is simply not true. When viewed through the tools available to those of skill in the art, such partially functional/operational technical descriptions are seen as specifying hardware configurations/operations of almost unimaginable complexity.

As outlined above, the reason for the use of partially functional/operational technical descriptions is at least twofold. First, the use of partially functional/operational technical descriptions allows near-infinitely complex machines and machine operations arising from interchained hardware elements to be described in a manner that the human mind can process (e.g., by mimicking natural language and logical narrative flow). Second, the use of partially functional/operational technical descriptions assists the person of skill in the art in understanding the described subject matter by providing a description that is more or less independent of any specific vendor's piece(s) of hardware.

The use of partially functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description could likely add complexity without a corresponding benefit (e.g., by describing the subject matter utilizing the conventions of one or more vendor-specific pieces of hardware). Thus, the use of partially functional/operational technical descriptions may assist those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner relatively independent of a specific vendor's hardware implementation.

The words and illustrations in this patent disclosure, in the main, are not primarily words and illustrations to be read and understood only by humans, but rather and more importantly are set forth primarily as models, forms, and/or functions teaching engineers to emulate/manifest such models and forms via automata such as electronic/photonic/magnetic etc. circuitries, processes, other related automata, etc. That is, such words and illustrations are generally not primarily set forth to be read or understood, but as exemplars for one skilled in the arts to manifest through properly configured machine/process/article/composition state or states.

Specifically, in some instances in this disclosure human-semantic logics are set forth as forms or templates to guide those skilled in the arts in constructing machine/process/article/composition state or states to approximate such logics (e.g. such as via electronic engineering techniques briefly described in relation to approximating the Boolean ‘AND’ function as illustrated and described herein). In other instances in this disclosure human-semantic words or illustrations are set forth as forms or templates to guide those skilled in the arts in constructing machine/process/article/compositions state or states to present such forms or templates via machines/articles/compositions/processes arranged such that a human would perceive some analog of such human-semantic words or illustrations.

7. As Explained herein, Engineers, Patent Examiners, and Construing/Reviewing Authorities should Understand that any Human-Semantic Words, Concepts, and/or Logics Herein—when Understood in Technical Context—Disclose/Support Claiming at all Points Up and Down the Abstraction Levels known to those of Skill in the Art; such Technical Context includes at Least Electrical/Electronic/Data Communications/Computer Engineering Anywhere Up and Down the Abstraction Levels Herein Described

The words and illustrations in this patent disclosure, in the main, are not primarily words and illustrations to be read and understood only by humans, but rather and more importantly are set forth primarily as models, forms, and/or functions teaching engineers to emulate/manifest such models and forms via automata such as electronic/photonic/magnetic etc. circuitries, processes, other related automata, etc. That is, such words and illustrations are generally not primarily set forth to be read or understood by the general reader, but as exemplars for one skilled in the arts to manifest through properly configured machine/process/article/composition state or states.

Specifically, in some instances in this disclosure human-semantic logics are set forth as forms or templates to guide those skilled in the arts in constructing machine/process/article/composition state or states to approximate such logics (e.g. such as via electronic engineering techniques briefly described in relation to approximating the Boolean ‘AND’ function as illustrated and described herein). In other instances in this disclosure human-semantic words or illustrations are set forth as forms or templates to guide those skilled in the arts in constructing machine/process/article/compositions state or states to present such forms or templates via machines/articles/compositions/processes arranged such that a human would perceive some analog of such human-semantic words or illustrations.

For sake of brevity, the disclosure herein may be in the form of nouns/verbs/adjectives/adverbs/other parts of speech/etc. that discuss one or more humanly useful (e.g., economic, informative, assistive, etc.) concepts, but it is to be understood that the present disclosure is directed to one of skill in the art of at least electrical/electronic/data communications/computer engineering, as well as other technical disciplines appropriate to context. Accordingly, such nouns/verbs/adjectives/adverbs/other parts of speech/etc. will generally be understood to disclose automata composed in whole or in part of one or more machines/processes/articles/compositions engineered to generate one or more human-perceivable state (e.g., machine-state) differences in view of at least a language (e.g., Spanish, Chinese, Japanese, English, etc.) and at least one higher order concept (e.g., a computer application concept/a search concept/a social networking concept/etc. as such might be understood by Spanish readers, Chinese readers, Japanese readers, English readers, etc.). Thus, the present disclosure, irrespective of shorthand, is to be read as disclosing states/state differences/state transitions of one or more machines/processes/articles/compositions which can generally be perceived at least in part by humans via some means (e.g., via voltmeters, reflectometers, current meters, imaging, pixel brightnesses, sound variations, haptic variations, etc.).

Those having skill in the art will recognize that the state of the art has progressed to the point where there is little distinction left between hardware, software (e.g., a high-level computer program serving as a hardware specification), and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software (e.g., a high-level computer program serving as a hardware specification), and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software (e.g., a high-level computer program serving as a hardware specification) implementation; or, yet again alternatively, the implementer may opt for some combination of hardware, software (e.g., a high-level computer program serving as a hardware specification), and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software (e.g., a high-level computer program serving as a hardware specification), and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although one or more users maybe shown and/or described herein, e.g., in FIG. 1, and other places, as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

### FIG. 1—System Overview

Referring now to FIG. 1, FIG. 1 shows various implementations of the overall system. At a high level, FIG. 1 shows various implementations of an attributed digital currency system, in all of its parts. The boxes of FIG. 1 are not labeled as “modules” or “circuits” or “steps” because one of skill in the art would understand that the differences are matters of conventional implementation. There exist automated tools, for example, VHDL interpreters, for example, Xilinx Vivado (described simply at http [colon-slash-slash] www.xilinx.com/products/design-tools/vivado.html). Accordingly, the blocks of FIG. 1 will be herein interchangeably referred to as “panticles,” or “all [pan] articles,” and it will be understood to one of skill in the art that these panticles could be implemented as method steps (e.g., and then converted to FPGAs or ASICs as described above) or as circuit/modules of one or more processors. Nothing in this paragraph should be interpreted as limiting an implementation of various embodiments.

In an embodiment, a philanthropist/user, e.g., user 3005, may be referred to herein for illustrative purposes, interchangeably, as “Charity User.” User 3005 may be connected with an individual charitable organization 3015. It is noted here that, although the words “charitable organization” may appear throughout the specification and disclosure, it is not necessary for the organization in question to be a charitable organization. Although charitable organizations may benefit substantially by the arrangement here, there is no technological limitation for non-charitable organizations that wish to keep their funds in an attributable manner. The “charitable organization” here is used as an exemplary implementation and should not be construed as placing any limitations on the entity using or benefitting from the system. There exist embodiments in which the Daybreak architecture 3100 and the other entities shown in FIG. 1 are used for commercial purposes, or a mix of charitable and/or commercial purposes.

In various embodiments, the individual charitable organization 3015 may be omitted completely. For example, the user/philanthropist may wish to use personal funds that are not tied to an organization. In such an implementation, the user 3005 may communicate directly with their local bank (described in more detail herein) and create the computationally-attributable account on their own.

Referring now to FIG. 1-A, in an embodiment, a charity organization 3015 may request an account, which is account 3030, which, in an embodiment, may be a computationally-attributable account that tracks and/or verifies funds that are contributed to the account 3050. More details about various embodiments of account 3030, which, in an embodiment, may be a computationally-attributable account, will be discussed herein. The request may be sent to the bank, as shown in FIG. 1-A, e.g., local bank 3100 or national domestic bank 3200. In an embodiment, the request for the account 3002 by the philanthropist 3005 may occur in panticle 3050, which may be originated by the philanthropist 3005, the charity organization 3015, or one of the banks 3100 and 3200.

In an embodiment, the bank at which the account 3030 was requested may send an agreement that the computationally-attributable account has been created 3052. This agreement may specify the terms of the account 3030. In an embodiment, the account 3030 may be created at local bank 3200, national domestic bank 3300, or at external tracking architecture 3100 running on external architecture application 3105 (e.g., as shown in FIG. 1-B), which may interface with one or more of the entities in FIG. 1.

In an embodiment, the account 3030 may be associated with a network account and/or a mobile application 3054. The mobile application 3054 may include a unique identifier and/or password input. In an embodiment, the unique identifier may be an anonymous identifier. In another embodiment, the mobile application 3054 may utilize two-factor authentication.

Mobile application 3054 will be discussed in more detail herein, but in an embodiment, mobile application 3054 may include a display panticle 3056. The display panticle 3056 may include various components that allow interaction with a display, e.g., an application back end, a device graphics unit, a screen or other input or output device, and the like. Display panticle 3056 may be configured to show various implementations of the computationally-attributable account, for example all of the horizontal and vertical spending details. In an embodiment, as shown in FIG. 1A, display panticle 3056 may include facilitating the display of one or more of the account information, spending verification information, account balance, location of funds, goods purchased, allocation of funds, and fees associated with the account.

Referring now to FIG. 1-B, in an embodiment, there may be an external tracking application and or/server 3100 (hereinafter interchangeably referred to as the “Daybreak App,” with or without the designation 3100). Daybreak app 3100 is listed in this application as an application and/or server to indicate that in various embodiments, the daybreak app 3100 could be one or more applications, servers, local devices, or a combination thereof. In an embodiment, the daybreak app 3100 is a web extension or a web page. In an embodiment, daybreak app 3100 includes a server portion 3110 and an application portion 3105. In an embodiment, application portion 3105 may be distributed to various devices and/or servers under the control of one or more of philanthropist/user 3005, charity organization 3015, local bank 3200, and national domestic bank 3300.

Referring again to FIG. 1-B, in an embodiment, panticle 3120 represents a creation of an internal account for the computationally-attributable account. The internal account may track payments of money to various entities throughout the life cycle. In an embodiment, the internal account tracks money that is transferred between midpoint entities (e.g., not the direct providers of services, but subcontractors, middle men, governments, etc., as will be described in more detail herein), but does not actually take steps to move the money until it reaches its ultimate destination.

In an embodiment, the internal account may follow an account rule set, shown in more detail in FIG. 1-C. FIG. 1-C shows some of the rule set circuitry for implementing various rules and conditions, which will be discussed in more detail herein.

Referring back to FIG. 1-B, in an embodiment, in accordance with the creation of the internal account, with an initial balance of, for example, one million (1,000,000) dollars (the actual number is exemplary only and does not matter), the money will be transferred from the charitable organization 3015 and/or the philanthropist/user 3005 to a banking entity. In an embodiment, this transfer may be accomplished by an ACH transfer from an account under the control of one or more of the charitable organization 3015 and/or the philanthropist/user 3005 to a bank which has a relationship with the external tracking app. Panticle 3130 represents the facilitation of a transfer of funds to a local bank 3200 or a national bank 3300, although other banks represented throughout FIG. 1, and other financial institutions generally, may be represented.

Referring now to FIG. 1-C, FIG. 1-C shows external tracking architecture 3100 (which will hereinafter be interchangeably referred to as “Daybreak architecture 3100”). The term “Daybreak” here is merely an identifier and does not have any specific functional meaning. In an embodiment, the Daybreak architecture 3100 may be separate from the other entities in FIG. 1, e.g., the banks, the users, the organizations, and the endpoint goods and/or services providers. For example, in an embodiment, Daybreak architecture may run on a separate server, and may interface with various banking and other entities through various interfaces, e.g., an XML template interface (e.g., as will be described in more detail with respect to panticle 3160). In an embodiment, Daybreak architecture 3100 may run on a server 3110, as shown in FIG. 1-B, and may be associated with one or more banking entities, e.g., national domestic bank 3300. In an embodiment, Daybreak architecture 3100 may have a single account with a banking entity, e.g., national domestic bank 3300, in which all of the various funds contributed from various users 3005 are deposited. The funds in these accounts may be managed by the Daybreak architecture through use of various ledger transactions, e.g., paper transactions that represent tracking money as it moves through various entities, but in which the money itself is not transferred. For example, in an embodiment, Daybreak architecture 3100 may effect actual transfers only when money is deposited from an outside source, and when money is “offboarded,” that is transferred to an entity such that it has complied with the distribution rule sets, and is no longer under the control and/or supervision of the Daybreak architecture 3100.

In another embodiment, Daybreak architecture may be separate from the other entities shown in FIG. 1, but may use a multitude of accounts, which may be across various banks, and which may, or in other embodiments, may not, have a correlation to the accounts 3030 that are created by the users 3005 and/or the organizations 3015 that have deposited the funds. In an embodiment, for example, Daybreak architecture 3100 may create a separate account each time money is transferred from one or more users 3005 and/or organizations 3015. In another embodiment, for example, money transferred under the control of Daybreak architecture 3100 may be grouped by how it is to be spent (e.g., different accounts for various services) or where it is to be spent (e.g., different accounts for different known endpoints).

In another embodiment, Daybreak architecture 3100 may be integrated into any one or more of the entities shown in FIG. 1, and which will be discussed in more detail herein. For example, in an embodiment, although not pictured for ease in understanding, Daybreak architecture 3100 may be implemented by national domestic bank 3300, and in an embodiment, other entities that wish to access the Daybreak architecture 3100 may work with national domestic bank 3300. The same applies to any other of the entities shown in FIG. 1, including the user 3005 and the organization 3015. For example, in an embodiment, Daybreak architecture 3100 may be implemented by the organization 3015 as a way to track and/or manage its funds and their allocation.

In an embodiment, the Daybreak architecture 3100 may include an interface that is accessible to any of the entities shown in FIG. 1, including user 3005 and/or organization 3015. In an embodiment, e.g., as shown in FIG. 1-B, this interface may be app 3015, which may run on the Internet, on other devices, on mobile phones, tablets, “smart” devices, and other similar electronics. In an embodiment, various entities in FIG. 1 may have access to various levels of data regarding the flow of funds from account 3030. For example, in an embodiment, the user 3005/organization 3015 may have complete access to all entities that are participating in their particular account set up by Daybreak architecture 3100. In another embodiment, each entity may have access only to its own portion of the funds. In another embodiment, each entity may have downstream visibility for its funds (e.g., each entity can see the ledger transactions that occur after it receives funds from a ledger transaction, but not what happens before). In an embodiment, the distribution rule set may specify the level of access for each of the entities that have access to the Daybreak architecture 3100.

Referring again to FIG. 1-B, in an embodiment, Daybreak architecture 3100 may include panticle 3120, which may implement the creation of an internal account. For example, in an embodiment, the donation 3020 (shown in FIG. 1-A) to the local bank 3200 (shown in FIG. 1-E) may trigger the creation of an internal account in the daybreak architecture 3100 at panticle 3120 (referring back to FIG. 1-B). In an embodiment, there may be a rule set associated with that account (or portions of that account), which will be discussed in more detail herein with respect to FIG. 1-C. In an embodiment, the account rule set may be specified by user 3005, organization 3015, Daybreak architecture 3100 (e.g., which may have a default rule set, or a rule set based on previous rule sets used by user 3005/organization 3015), some other entity shown in FIG. 1, or some other combination thereof. In an embodiment, the internal account created at panticle 3120 may be accessed by any or all of the entities shown in FIG. 1.

Referring again to FIG. 1-B, in an embodiment, the creation of (or addition to) internal account by the Daybreak architecture 3100 may trigger a facilitation of the transfer of funds from the user 3005/organization 3015 to a bank, e.g., local bank 3200 or national bank 3300, e.g., as shown in panticle 3130. As will be discussed in more detail herein, in an embodiment, funds may be transferred from user 3005/organization 3015 to a bank account under the at least partial control of the Daybreak architecture 3100. This transfer may be accomplished through traditional means, e.g., ACH transfer, wire transfer, etc. In an embodiment, further moves of the funds may be handled internally, e.g., through what will be referred to throughout this application as “ledger transactions,” that is, the money does not move from the account in which it was initially deposited, but transfers of the money are displayed and treated as if the money had actually been moved through the Daybreak architecture. For example, in an embodiment, user 3005 may contribute three thousand (3,000) dollars to be used in the system of FIG. 1. In an embodiment, the Daybreak architecture 3100 creates an account with three thousand (3,000) dollars in it. In an embodiment, that three thousand dollars is deposited in the existing bank account under the control of the Daybreak architecture 3100. In an embodiment, further transactions that are not to the endpoint service providers (e.g., transfers to subcontractors, to middle men, to other banks, etc.), are recorded as ledger transactions, e.g., as shown in panticle 3140, but may not include actual transfers of the money.

For example, in an embodiment, the Daybreak architecture may store, as an example from the previous paragraph, the three thousand (3,000) dollars in an account with local bank 3200, and the money is transferred from a bank account of organization 3015 to the Daybreak architecture 3100 account. From there, the money is transferred to national bank 3200. In an embodiment, as implemented by panticle 3140, this may be a “ledger transaction” in which the money is recorded as transferred to national bank 3300, and national bank 3300 has control of the money (within the Daybreak architecture 3100), but the money is not actually transferred from local bank 3200 to national bank 3300. Rather, each of the intermediary transactions between the final payee and the account under the control of the Daybreak architecture are executed as ledger transactions.

In an embodiment, when the funds reach an endpoint services provider, e.g., FO/NGO/FI 3800 (which will be discussed in more detail herein), this payee may receive the funds directly. At this point, another ledger transaction may be executed from wherever the funds are at the time (e.g., at NU/NE bank 3500) according to the ledger transactions, to the FO/NGO/FI 3800, who is the receiver of the funds. At this point, the ledger transaction may also be implemented, e.g., at panticle 3150, as an offboarding of the money, e.g., the actual funds are transmitted from the account with local bank 3200 to the FO/NGO/FI 3800, in addition to the ledger transaction. This may be accomplished, for example, in a specific implementation, by panticle 3160, which is the implementation of an XML interface that is sent to local bank 3200.

In an embodiment, the controllers of external tracking architecture 3100 may have a relationship with one or more specific banks at the local or national level. In an embodiment, external tracking architecture 3100 may be embedded into local domestic bank 3200 or national domestic bank 3300, and may have one or more components interacting with the various components.

Referring now to FIG. 1-C, in an embodiment, the Daybreak architecture 3100 may implement a rule set related to the account and the funds therein. Panticle 4900 shows a variety of exemplary rules that may be applied to the funds, some of which will be additionally listed and/or elaborated upon here. This list of rules that could be part of the rule set is not intended to be exhaustive or limiting, but rather exemplary.

For example, in an embodiment, rule set 4900 may include metadata that is linked to the account. For example, as the funds are transferred through the ledger transactions, metadata that identifies one or more properties of user 3005 (e.g., who may be a philanthropist, as a specific example). The metadata may identify to whom the money belongs, for example, or any other data that may “travel” with the money. In an embodiment, this may include some form of modified digital currency, e.g., a Bitcoin-like setup, which may be localized or specified for specific accounts.

Referring again to FIG. 1-C, in an embodiment, rule set circuitry panticle 4900 may include geographic location tracking of goods and/or services that are associated with the account or distributed with the account. For example, in an embodiment, a rule set may specify that certain funds may only be spent at particular geographic locations. For example, the rule set may specify that the money must be spent in specific locations in Sub-Saharan Africa. In another embodiment, the rule set may specify that the money must be spent in locations associated with hospitals, or schools. The rule set may depend on conditions, as well. For example, in an embodiment, the rule set may specify that the money may only be spent in locations that have an average GDP per capita below a certain amount. In an embodiment, the location tracking may include GPS verification (e.g., when the money is transferred to an entity, that entity's location is recorded), or verification of location through monitoring of satellite pictures, pictures taken onsite, geotagged images, or trusted person/device verification.

Referring again to FIG. 1-C, in an embodiment, rule set circuitry panticle 4900 may include an account fee tracking function, e.g., which, in an embodiment, may set limits and/or conditions on how much account fees can be charged by the various banking entities. In an embodiment, the amounts and conditions may be changed if the Daybreak architecture 3100 is used versus the money being transferred between one or more of the various midpoints. Moreover, in an embodiment, each amount and/or condition may be different depending on the conditions at the midpoint entity. In an embodiment, the amount limits and/or conditions may be dependent upon conditions themselves, e.g., “if X happens, then an escalating limit may be established.” In an embodiment, the amount of funds stored/controlled/ledger transferred to the various banks and/or entities may control the limits and/or conditions on the account fees. In another embodiment, the rule set may specify changes to the limits and/or conditions when a number of transactions (e.g., true transactions or ledger transactions) are carried out.

Referring again to FIG. 1-C, in an embodiment, rule set circuitry panticle 4900 may include a rule set that specifies a requirement for photographic evidence associated with the acquisition/distribution of goods/services. For example, in an embodiment, the rule set may specify that, at the point of delivery of goods and/or services, photo documentation must be captured at the time of the transaction for the money to be released (e.g., it may be ledger transacted in the Daybreak architecture 3100, but with separate requirements for an actual transfer of the funds). Referring again to FIG. 1-C, in an embodiment, rule set circuitry panticle 4900 may include implementation of a spending limit associated with the goods and/or services, e.g., as will be discussed in more detail herein. In an embodiment, rule set circuitry panticle 4900 may include implementation of a spending linked to the nature of the goods/and or services (e.g., funds are restricted to particular classes of goods, e.g., vaccines, food, clothing, etc.).

Referring again to FIG. 1-C, in an embodiment, rule set circuitry panticle 4900 may include implementation of a time stamp for receipt of distribution of funds associated with the delivery of goods and/or services. For example, this time stamp may take the form of a time-tagged photo, a time-tagged post to the internet (e.g., through any medium, via twitter, e-mail, etc.), location (e.g., GPS) confirmation of the location and/or meeting of the parties. In an embodiment, rule set circuitry panticle 4900 may include implementation of a system in which payment is given (e.g., which may be the “ledger transaction” payment or the “actual transfer of funds” payment, depending on embodiments). In an embodiment, rule set circuitry panticle 4900 may include implementation of a trusted sources system, in which the payment for goods and/or services must be verified by a trusted source, either by previous dealings, outside reputation score, or some other trust-verification system. In an embodiment, Daybreak architecture 3100 may implement a trust level system for individuals and/or organizations. In another embodiment, Daybreak architecture may tap into one or more existing systems.

Referring again to FIG. 1-C, in an embodiment, rule set circuitry panticle 4900 may include implementation of a limit of funding available to sources based on past history, and a term sheet for specific endpoint entities. In an embodiment, rule set circuitry panticle 4900 may include implementation of a system for recouping funds (e.g., forcing return of funds if the agreement for the acquisition and/or the distribution is not met). For example, in an embodiment, the ledger transaction that transfers the money may be allowed to go through prior to the actual transfer of funds, and if the conditions specified in the rule set are not met, the actual transfer of funds may be stopped and/or delayed (e.g., in an embodiment, this may use delays in timing of banking processes in order to implement).

Referring again to FIG. 1C, in an embodiment, rule set circuitry panticle 4900 may include implementation of a reputation system for actors, either through Daybreak architecture 3100, through tapping an existing system, and/or through analysis of social media, an encryption function, e.g., through a multi-part encryption key to be sent through at least two different transmission routes, a currency conversion function (e.g., exchange rate determinations, a currency transfer unit, digital currency protections, and language conversion function.

Referring again to FIG. 1-C, in an embodiment, rule set circuitry panticle 4900 may include implementation of scoring engine that analyzes vendors, transactions, etc., and compares to programmed patterns. For example, in an embodiment, a scoring engine may analyze a transaction and drop it into one of three buckets. Bucket 1 is “definitely bad,” bucket 2 is “definitely good,” and bucket 3 is “needs human evaluation for final decision” so the scoring engine will drop it into one of those three buckets.

Referring now to FIG. 1-E, FIG. 1-E shows Box 12, which starts at FIG. 1-E, and extends through FIGS. 1-F and 1-G, describes that, in an embodiment, actual monetary transfers (e.g., ACH transfers, wire transfers, and the like) may be used at endpoints of various transactions between the philanthropist/user's 3005 bank account, e.g., at local bank 3200, and the foreign organization/NGO/foreign individual 3800 (e.g., as shorthand, “foreign organization/NGO/Foreign Individual 3800” will hereafter be interchangeably referred to as “foreign entity 3800”). That is, in an embodiment, endpoint money transfers may be made at local bank 3200 (or one of the other entity banks), and may be made at the foreign entity 3800, with other transactions occurring as “ledger transactions.” In an embodiment, this may except offboarding of funds designated for a specific entity.

For example, in an embodiment, donation 3020 may be given by the philanthropist/user 3005 (e.g., through the charity organization 3015). Donation 3020 may be received by local bank 3200. In an embodiment, local bank 3200 may create an account for the charity funds 3220, e.g., “Fund X” (hereinafter will be interchangeably referred to as “account 3220”). In an embodiment, Fund X may be the repository for the funds until they are paid out to a specific person, e.g., foreign entity 3800, or appropriated as part of a fee by an intervening entity, e.g., offboarded, e.g., as shown in panticles 3350, 3450, and 3550, which will be discussed in more detail herein. In an embodiment, any movement of funds between other entities, e.g., entities inside the box 12, may occur as ledger transactions. In another embodiment, funds may be moved from the local bank 3200 (e.g., Omaha bank) to other banking/management entities as will be described herein.

Referring again to FIG. 1-E, in an embodiment, local bank 3200 may use an existing account 3230, and earmark the charity funds for specific distributions according to their rule set. For example, in an embodiment, local bank 3200 may have a single account that uses the daybreak architecture, which may be implemented as external tracking architecture 3100 (e.g., see FIG. 1-B, which will be discussed in more detail herein), or by a system similar to external tracking architecture 3100 but implemented partially or wholly internal to local bank 3200. In an embodiment, any funds that will be managed by the daybreak architecture 3100 will be placed in the existing account 3230, and can be tracked through ledger transactions and payouts to end recipients of funds, as will be discussed in more detail herein.

Referring again to FIG. 1-E, in some embodiments, whether account 3220 or 3230 is used, panticle 3210 includes panticle 3212 of creation of a unique and/or anonymous identifier and password. In an embodiment, this identifier/password 3212 may be login information that will be given to user 3005 in order to access the account, change the rule set, and receive reports and/or auditing regarding the account 3220 or 3230. In an embodiment, at panticle 3214, data may be sent to the user 3005. This data may include one or more tools used to access the information, e.g., login credentials for a network application, in an embodiment, or a mobile application for interfacing with bank 3200 and/or daybreak architecture 3100.

Referring again to FIG. 1-E, FIG. 1-E shows a national domestic bank 3300 (e.g., hereinafter interchangeably referred to as “national bank 3300”). In an embodiment, national domestic bank 3300 may be a nationally-established bank, e.g., Bank of New York. In an embodiment, national bank 3300 may receive a request at panticle 3302, e.g., a request from the local bank 3200 (e.g., Omaha bank), which is a request for the bank to accept the tracking and/or verifying account. In an embodiment, panticle 3302 may include the request from local bank 3200 for national bank 3300 to register an account with the Daybreak architecture 3100 (e.g., which, as previously described, may be separate from one or more of the figures in this entity, or may be partially or wholly integrated with one or more of the entities in this figure).

Referring again to FIG. 1-E, in an embodiment, national bank 3300 may, at panticle 3304, send a confirmation that the national bank 3300 will accept the tracking and verification account. In an embodiment, panticle 3304 may include the notification of acceptance and/or completion of registration with the Daybreak architecture 3100. In an embodiment, registration may mean that the national bank 3300 is newly registered with the Daybreak architecture 3100, or that the national bank 3300 is adding data to the registration indicating its acceptance of the account created in panticle 3210. In an embodiment, at panticle 3304, national bank 3300 may communicate with Daybreak architecture 3100 (not shown in panticle 3304).

Referring again to FIG. 1-E, in an embodiment, national bank 3300 may, at panticle 3306, receive a donation sent from the local bank 3200. In an embodiment, panticle 3306 may represent national bank 3300 receiving an actual transfer of funds into its accounts, e.g., via an ACH or a wire transfer. In another embodiment, panticle 3306 may represent a ledger transfer of the funds, as represented in Daybreak architecture 3100, but the location of the funds stays in an account with local bank 3200, e.g., in the Daybreak architecture.

In an embodiment, as described above, a ledger transaction may show a funds transfer to national bank 3300 as performed by the Daybreak architecture 3100, but the actual funds may stay in the account designated by the daybreak architecture 3100 at local bank 3200. Nevertheless, national bank 3300 may be authorized to draw funds from the account for services rendered, e.g., national bank 3300 may be awarded a flat fee of five thousand (5,000) dollars or a percentage of the contents of the account created/used by local bank 3200. In such an embodiment, the national bank's 3300 funds to which they are entitled are “offboarded” at panticle 3350 of FIG. 1-A. In this context, offboarded means that the funds to which national bank 3300 is entitled, which are part of the overall funds which have been ledger-transferred to national bank 3300 but are still in possession of an account at local bank 3200, said funds are actually transferred to the national bank 3300 through conventional means, e.g., an ACH transfer or a wire transfer. Thus, if the account contains one million (1,000,000) dollars that have been ledger transferred from local bank 3200 to national bank 3300, and the national bank 3300 is collecting a five thousand (5,000) dollar payment for services rendered, then in addition to the ledger transaction that transfers the one million (1,000,000) dollars from local bank 3200 to national bank 3300, another ledger transaction is made from the ledger account at national bank 3300 that contains the one million (1,000,000) dollars, into a personal account under the control of national bank 3300. This ledger transaction is for the five thousand (5,000) dollars and is accompanied by an actual transfer (e.g., wire transfer or ACH transfer) of five thousand (5,000) dollars. Once the money has been subject to an actual transfer, tracking and/or verification may be stopped, as the money is now in the possession/control of national bank 3300. It is noted that the Daybreak architecture 3100 makes sure that any actual transfer out of the account under control of local bank 3200 must meet the rule set conditions specified, which will be discussed in more detail herein.

Referring now to FIG. 1-F, FIG. 1-F shows a European bank 3400, e.g., the Bank of England, according to various embodiments. Although bank 3400 is labeled “European bank,” bank 3400 is not limited to being located in Europe. Bank 3400 may be any bank external to the United States, regardless of location, that participates in the management and/or distribution of funds from the account 3030 (and/or other accounts that may be established throughout FIG. 1). In an embodiment, at panticle 3402, the national bank 3300 may send the request to European bank 3400 to accept and implement the tracking and/or verifying account. In an embodiment, panticle 3402 may include the request (e.g., from local bank 3200, although the request could come from any entity shown in FIG. 1) for national bank 3400 to register an account with the Daybreak architecture 3100 (e.g., which, as previously described, may be separate from one or more of the figures in this entity, or may be partially or wholly integrated with one or more of the entities in this figure).

Referring again to FIG. 1-F, FIG. 1-F shows European bank with panticle 3404. Panticle 3404 describes European bank 3400 sending a confirmation that European bank 3400 will accept and implement the tracking and/or verification account. In an embodiment, this acceptance may include opening a new account and accepting a monetary transfer (e.g., through wire transfer, ACH, or other means) of the account funds, and managing an account similar to account 3030. In an embodiment, panticle 3404 may include the notification of acceptance and/or completion of registration with the Daybreak architecture 3100. In an embodiment, registration may mean that the European bank 3400 is newly registered with the Daybreak architecture 3100, or that the European bank 3400 is adding data to the registration indicating its acceptance of the account created in panticle 3210. In an embodiment, at panticle 3304, European bank 3400 may communicate with Daybreak architecture 3100 (not shown in panticle 3404).

Referring again to FIG. 1-F, in an embodiment, European bank 3400 may operate with panticle 3406. In an embodiment, panticle 3406 may represent a receiving of a donation sent from the national bank 3300, or, in another embodiment from one or more of the other entities shown in FIG. 1. In an embodiment, panticle 3406 may represent European bank 3400 receiving an actual transfer of funds into its accounts, e.g., via an ACH or a wire transfer. In another embodiment, panticle 3406 may represent a ledger transfer of the funds, as represented in Daybreak architecture 3100, but the location of the funds stays in an account with local bank 3200, e.g., in the Daybreak architecture.

Referring again to FIG. 1-F, in an embodiment, at panticle 3408, the European bank 3400 may conduct an audit of the funds that have been spent and/or distributed for a given time. The audit may include all of the downstream and/or upstream activity from the European bank 3400. In an embodiment, the audit may be conducted through analysis of the ledger transactions executed by the Daybreak architecture 3100. Audit details will be described in more detail further herein.

In an embodiment, as described above, a ledger transaction may show a funds transfer to European bank 3400 as performed by the Daybreak architecture 3100, but the actual funds may stay in the account designated by the daybreak architecture 3100 at local bank 3200. Nevertheless, European bank 3400 may be authorized to draw funds from the account for services rendered, e.g., European bank 3400 may be awarded a flat fee of five thousand (5,000) dollars or a percentage of the contents of the account created/used by local bank 3200. In such an embodiment, the funds to which European bank 3400 is entitled are “offboarded” at panticle 3350 of FIG. 1-A. In this context, offboarded means that the funds to which European bank 3400 is entitled, which are part of the overall funds which have been ledger-transferred to European bank 3400 but are still in possession of an account at local bank 3200, said funds are actually transferred to the European bank 3400 through conventional means, e.g., an ACH transfer or a wire transfer. Thus, if the account contains one million (1,000,000) dollars that have been ledger transferred from local bank 3200 to European bank 3400, and the European bank 3400 is collecting a five thousand (5,000) dollar payment for services rendered, then in addition to the ledger transaction that transfers the one million (1,000,000) dollars from local bank 3200 to European bank 3400, another ledger transaction is made from the ledger account at European bank 3400 that contains the one million (1,000,000) dollars, into a personal account under the control of European bank 3400. This ledger transaction is for the five thousand (5,000) dollars and is accompanied by an actual transfer (e.g., wire transfer or ACH transfer) of five thousand (5,000) dollars. Once the money has been subject to an actual transfer, tracking and/or verification may be stopped, as the money is now in the possession/control of European bank 3400. It is noted that the Daybreak architecture 3100 makes sure that any actual transfer out of the account under control of local bank 3200 must meet the rule set conditions specified, which will be discussed in more detail herein.

Referring now to FIG. 1-J (to the south of FIG. 1-F), in an embodiment, European bank 3400 may implement a panticle 4200, which may facilitate the reputation/trustworthiness verification as part of the chain. It is noted that, although these panticles are associated with European bank 3400, this is merely for ease of display, and any of the entities shown in FIG. 1 may implement similar methods and/or systems. For example, in an embodiment, panticle 4200 may include panticle 4210, in which the European bank 3400 verifies the reputation and/or trustworthiness of one or more of the other entities shown in FIG. 1. In an embodiment, this is because European bank 3400 has a higher trust score, e.g., has a trust score that makes it a verified source according to the rule set architecture put in place for a specific account by the Daybreak architecture 3100. In an embodiment, panticle 4210 may implement verification using one or more of reputation score 4212 and/or past accounting and/or reporting history.

Referring again to FIG. 1-J, in an embodiment, at panticle 4220, the verification of the reputation and/or trustworthiness of other entities may include acquisition, analysis, implementation, or other actions taken toward the rule set, if such are not implemented by Daybreak architecture 3100. For example, in an embodiment, European bank 3400 may include panticle 4230 in which European bank 3400, alone or in conjunction with Daybreak architecture 3100, may facilitate one or more actions that go with implementing a rule set for the acquisition and/or distribution of funds, to one or more of subcontracting foreign organizations (e.g., subcontracting foreign organization 3700) and Foreign Organization/Non-Governmental Organization/Foreign Individual (FO/NGO/FI), e.g., FO/NGO/FI 3800. The rule set architecture will be described in more detail with respect to panticle 4900 of FIG. 1-C. In an embodiment, European bank panticle 4230 may receive the rule set from Daybreak architecture 3100. In an embodiment, the funds from the account 3030 may not be actually transmitted to European bank panticle 4230, but may be transmitted through ledger transactions. In another embodiment, European bank panticle 4230 may implement the rule set from Daybreak architecture 3100 for the funds from the account 3030 that are actually received by European bank 3400.

In an embodiment, referring again to European bank panticle 4230 of FIG. 1-J, European bank panticle 4230 may include panticle 4232, in which panticle 4232 effects an implementation of an acquisition or a distribution of funds rule set based on a type of goods and/or services (e.g., food, water, potable water, medicine, vaccines, health care services, shelters, clothing, tools, transport services, vehicles, firearms, etc.). For example, a part of the distribution rule set may specify that the funds must be spent on vaccinations or organizations that provide vaccinations. In another example, a part of the distribution rule set may specify that certain types of drugs cannot be purchased with funds from the account 3030, e.g., prohibition on Schedule 2 narcotics, for example.

In an embodiment, referring again to European bank panticle 4230 of FIG. 1-J, European bank panticle 4230 may include panticle 4234, in which panticle 4234 effects an implementation of an acquisition or a distribution of funds rule set based on a distribution area of goods and/or services (e.g., food, water, potable water, medicine, vaccines, health care services, shelters, clothing, tools, transport services, vehicles, firearms, etc.). In an embodiment, the distribution area may be purely geographical (e.g., “between the two rivers,” or “within a box defined by specific latitudes and longitudes), political (e.g., within the boundaries of a specific foreign country), or data-based (e.g., “only to areas in which the poverty rate is above 85%,” or “only to areas in which HIV infection is above 22%”). For example, a part of the distribution rule set may specify that the funds can only be spent in targeted areas of sub-Saharan Africa.

In an embodiment, referring again to European bank panticle 4230 of FIG. 1-J, European bank panticle 4230 may include panticle 4236, in which panticle 4236 effects an implementation of an acquisition or a distribution of funds rule set based on a quantity of goods and/or services (e.g., food, water, potable water, medicine, vaccines, health care services, shelters, clothing, tools, transport services, vehicles, firearms, etc.) to be provided. The numbers may be absolute, e.g., “this money must be used to purchase three thousand (3,000) vaccines,”) or relative (e.g., “30% of this money must be used to purchase vaccines).

Referring again to FIG. 1-J, in an embodiment, European bank 3400 may, in a process of implementing reputation and/or trustworthiness verification, e.g., at panticle 4200, implement a reporting rule set for various downstream entities to report distribution of funds. For example, panticle 4250 may include facilitating implementation of the reporting rule set (which may be similar to the acquisition/distribution rule set, and which may be developed/implemented in conjunction with Daybreak architecture 3100). In an embodiment, implementation of the reporting rule set for one or more entities may include requiring an audit of the various entities upon request, e.g., as described in panticle 4255.

Referring again to FIG. 1-J, in an embodiment, European bank 3400 may, in a process of implementing the reporting rule set, at panticle 4260, reporting evidence of the transaction may be required. The reporting evidence may be required as a condition of releasing the funds, which, in an embodiment, may be preventing the ledger transaction of the funds, or preventing an actual underlying transaction of the funds to the endpoint entity. For example, in an embodiment, the panticle 4260 that requires reporting evidence may require, e.g., photographic evidence, as part of panticle 4262. Photographic evidence here may include audio, video, still shot, any capture of light and/or motion in any portion of the electromagnetic spectrum, and also may include metadata, e.g., timestamp of photo and/or geolocation tagging of photo (e.g., from a camera device with geolocation/timestamp tagging enabled).

Referring again to FIG. 1-J, in an embodiment, European bank 3400 may implement reporting rule set at panticle 4250, which may include panticle 4260 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 4260 may include panticle 4264, which may implement a reporting rule set through use of various monitoring devices, which may be attached to various goods, e.g., food goods, shipping containers, vaccines, clothing, etc.) The monitoring devices may use near-field communication, or may be RFID tags. In an embodiment, the monitoring may be accomplished through surveillance, e.g., visual, infrared, or some other form, from localized cameras or satellite cameras, for example.

Referring again to FIG. 1-J, in an embodiment, European bank 3400 may implement reporting rule set at panticle 4250, which may include panticle 4260 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 4260 may include panticle 4266, which includes verification from a trusted source as a requirement for reporting. For example, in an embodiment, if an unknown/untrusted FO/NGO/FI 3800, which may be an endpoint entity, performs a service, and wants to receive compensation, they may seek verification from a trusted source, e.g., which may be a different FO/NGO/FI 3800, or some other entity, which may or may not be associated with the Daybreak architecture 3100. In an embodiment, Daybreak architecture 3100 may keep the list of trusted sources and require verification from those sources, however, in another embodiment, the trusted sources may become trusted sources through a relationship with European bank 3400 or one of the other banking entities.

Referring again to FIG. 1-J, in an embodiment, European bank 3400 may implement reporting rule set at panticle 4250, which may include panticle 4260 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 4260 may include panticle 4268 and/or panticle 4269, which may require real time reporting associated with implementation of the goods and/or services, or real time reporting associated with payment for the implementation of the goods and/or services.

In an embodiment, Daybreak architecture 3100, and in conjunction with one or more of the other entities shown in FIG. 1, or independently, may build out at least two different types of rule sets. The first will be to prevent known fraud schemes, e.g., such as use of a phantom vendor, no-bid arrangements, bad acting vendors, imaginary vendors, and the like. A second type of rule set, in an embodiment, may be a set of attributes, e.g., characteristics that alone do not mean anything, but may in certain circumstances or in combination with other attributes, may raise flags that require further analysis or may require delaying the transaction until clearance. For example, in an embodiment of the attribute set, odd time of day, transactions on holidays, transactions late at night, or structured transactions, transactions that are right at the approval limit, may, in some various combinations, require additional approval or other steps to be taken to release the funds from the Daybreak architecture 3100 or the other entities shown in FIG. 1.

Referring again to FIG. 1-F, FIG. 1-F shows non-USA/non-European bank (e.g., shown in FIG. 1 as “Central Bank of Kenya,” but this is just an example) 3500 (hereinafter interchangeably referred to as NU/NE “bank 3500”). NU/NE bank 3500 may communicate with one or more of the entities shown in FIG. 1. In FIG. 1, NU/NE bank 3500 is shown in communication with European bank 3400, but in other embodiments, NU/NE bank 3500 may communicate with other entities depicted in FIG. 1, regardless of whether lines are directly drawn that connect NU/NE bank 3500 to those entities (the same is also true for the other banks discussed previously and discussed herein).

Referring again to FIG. 1-F, in an embodiment, the European bank 3400 may send the request for NU/NE bank 3500 to accept and/or implement the tracking and/or verifying account at panticle 3502. In an embodiment, e.g., as shown in FIG. 1-F, this request comes from European bank 3400, but, in other embodiments, the request may come from any other entity depicted in FIG. 1. In an embodiment, at panticle 3502, the European bank 3400 may send the request to NU/NE bank 3500 to accept and implement the tracking and/or verifying account. In an embodiment, panticle 3502 may include the request (e.g., from local bank 3200, although the request could come from any entity shown in FIG. 1) for NU/NE bank 3500 to register an account with the Daybreak architecture 3100 (e.g., which, as previously described, may be separate from one or more of the figures in this entity, or may be partially or wholly integrated with one or more of the entities in this figure).

Referring again to FIG. 1-F, in an embodiment, NU/NE bank 3500 may include panticle 3504. Panticle 3504 describes NU/NE bank 3500 sending a confirmation that indicates acceptance and/or implementation of a tracking and or verification account. This confirmation may be sent electronically or may be part of a general agreement that governs particular types of accounts or transactions, or may be implemented in a different way. In an embodiment, this acceptance may include opening a new account and accepting a monetary transfer (e.g., through wire transfer, ACH, or other means) of the account funds, and managing an account similar to account 3030. In an embodiment, panticle 3504 may include the notification of acceptance and/or completion of registration with the Daybreak architecture 3100. In an embodiment, registration may mean that the NU/NE bank 3500 is newly registered with the Daybreak architecture 3100, or that the NU/NE bank 3500 is adding data to the registration indicating its acceptance of the account created in panticle 3210. In an embodiment, at panticle 3504, NU/NE bank 3500 may communicate with Daybreak architecture 3100 (not shown in panticle 3404).

Referring again to FIG. 1-F, in an embodiment, NU/NE bank 3500 may implement panticle 3506. In an embodiment, panticle 3506 may represent reception of account funds (e.g., the donation) from European bank 3400, or, in another embodiment from one or more of the other entities shown in FIG. 1. In an embodiment, panticle 3506 may represent a ledger transfer of the funds, as represented in Daybreak architecture 3100, but the location of the funds stays in an account with local bank 3200, e.g., in the Daybreak architecture.

Referring again to FIG. 1-F, in an embodiment, at panticle 3508, NU/NE bank 3500 may conduct an audit of the funds that have been spent and/or distributed for a given time. The audit may include all of the downstream and/or upstream activity from NU/NE bank 3500. In an embodiment, the audit may be conducted through analysis of the ledger transactions executed by the Daybreak architecture 3100. Audit details will be described in more detail further herein.

Referring now to FIG. 1-K, in an embodiment, the reporting rule set may be implemented by NU/NE bank 3500, although, in other embodiments, any of the entities in FIG. 1 may implement the reporting rule set, alone or in conjunction with the Daybreak architecture 3100, or singly by the Daybreak architecture 3100. In an embodiment, NU/NE bank 3500 may include panticle 4300, which may include implementation of the reporting rule set.

In an embodiment, panticle 4300 may include panticle 4310, in which a request for an audit of the account, e.g., whether the account has followed the rule set implemented by the various entities of FIG. 1, either as a whole-picture audit, a single-entity audit, or a downstream-entity audit, or some combination thereof, is made. The audit may take any form as requested by the entity requesting the audit, and may include any data to which the requesting entity has access. In an embodiment, the audit may be performed by Daybreak architecture 3100, and facilitated or passed along by NU/NE bank 3500. In another embodiment, Daybreak architecture 3100 may assist NU/NE bank 3500 in performing the audit, and, in another embodiment, NU/NE bank 3500 may perform the audit without the assistance of Daybreak architecture 3100.

Referring again to FIG. 1-K, in an embodiment, implementation of reporting rule set panticle 4300 may include a reporting evidence requirement panticle 4350. Panticle 4350 may implement architecture in which reporting evidence of the transaction may be required. The reporting evidence may be required as a condition of releasing the funds, which, in an embodiment, may be preventing the ledger transaction of the funds, or preventing an actual underlying transaction of the funds to the endpoint entity. For example, in an embodiment, the panticle 4350 that requires reporting evidence may require, e.g., photographic evidence, as part of panticle 4352. Photographic evidence here may include audio, video, still shot, any capture of light and/or motion in any portion of the electromagnetic spectrum, and also may include metadata, e.g., timestamp of photo and/or geolocation tagging of photo (e.g., from a camera device with geolocation/timestamp tagging enabled).

Referring again to FIG. 1-K, in an embodiment, NU/NE bank 3500 may implement reporting rule set at panticle 4300, which may include panticle 4350 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 4350 may include panticle 4354, which may implement a reporting rule set through use of various monitoring devices, which may be attached to various goods, e.g., food goods, shipping containers, vaccines, clothing, etc.) The monitoring devices may use near-field communication, or may be RFID tags. In an embodiment, the monitoring may be accomplished through surveillance, e.g., visual, infrared, or some other form, from localized cameras or satellite cameras, for example.

Referring again to FIG. 1-K, in an embodiment, NU/NE bank 3500 may implement reporting rule set at panticle 4300, which may include panticle 4350 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 4350 may include panticle 4356, which includes verification from a trusted source as a requirement for reporting. For example, in an embodiment, if an unknown/untrusted FO/NGO/FI 3800, which may be an endpoint entity, performs a service, and wants to receive compensation, they may seek verification from a trusted source, e.g., which may be a different FO/NGO/FI 3800, or some other entity, which may or may not be associated with the Daybreak architecture 3100. In an embodiment, Daybreak architecture 3100 may keep the list of trusted sources and require verification from those sources, however, in another embodiment, the trusted sources may become trusted sources through a relationship with NU/NE bank 3500 or one of the other banking entities or other entities shown in FIG. 1.

Referring again to FIG. 1-K, in an embodiment, NU/NE bank 3500 may implement reporting rule set at panticle 4300, which may include panticle 4350 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 4350 may include panticle 4358 and/or panticle 4359, which may require real time reporting associated with implementation of the goods and/or services, or real time reporting associated with payment for the implementation of the goods and/or services.

Referring again to FIG. 1-K, in an embodiment, FO/NGO/FI 3800 may implement a reporting rule set to report back to one or more entities shown in FIG. 1, e.g., in various embodiments, in conjunction with the Daybreak architecture 3100. For example, in an embodiment, FO/NGO/FI 3800 may implement reporting rule set panticle 4400, which includes audit provision panticle 4410 to provide an audit of the account and/or the funds that were spent by FO/NGO/FI 3800 to one or more of the entities shown in FIG. 1. Additionally, in an embodiment, panticle 4400, as implemented by FO/NGO/FI 3800, ay include panticle 4450 for providing the reporting evidence to one or more entities, which has been previously described with respect to receiving that data. For example, in an embodiment, panticle 4450 may include one or more of panticle 4452 for providing photographic evidence of the goods and/or services being delivered and/or provided. For example, photographic evidence here may include audio, video, still shot, any capture of light and/or motion in any portion of the electromagnetic spectrum, and also may include metadata, e.g., timestamp of photo and/or geolocation tagging of photo (e.g., from a camera device with geolocation/timestamp tagging enabled).

For example, in an embodiment, panticle 4450 may include one or more of panticle 4454 for providing the monitoring information related to the goods and/or services (e.g., food goods, shipping containers, vaccines, clothing, etc.). The monitoring devices may use near-field communication, or may be RFID tags. In an embodiment, the monitoring may be accomplished through surveillance, e.g., visual, infrared, or some other form, from localized cameras or satellite cameras, for example, and panticle 4456 for providing verification from a trusted source, e.g., in an embodiment, if an unknown/untrusted FO/NGO/FI 3800, which may be an endpoint entity, performs a service, and wants to receive compensation, they may seek verification from a trusted source, e.g., which may be a different FO/NGO/FI 3800, or some other entity, which may or may not be associated with the Daybreak architecture 3100. In an embodiment, Daybreak architecture 3100 may keep the list of trusted sources and require verification from those sources, however, in another embodiment, the trusted sources may become trusted sources through a relationship with NU/NE bank 3500 or one of the other banking entities or other entities shown in FIG. 1.

Referring again to FIG. 1-K, in an embodiment, panticle 4450 may include one or more of panticle 4458 and/or panticle 4459, which may require real time reporting associated with implementation of the goods and/or services, or real time reporting associated with payment for the implementation of the goods and/or services.

Referring now to FIG. 1-G, FIG. 1-G shows some examples of services performed by one or more of the entities shown in FIG. 1. This list is not meant to be exhaustive or exclusionary, but merely exemplary. For example, in an embodiment, one or more of the entities in FIG. 1 may include a reputation and/or trustworthiness module. This module, described in panticle 3600, may include a panticle 3610 in which the NU/NE bank 3500 (or another entity from FIG. 1; NU/NE bank 3500 is used throughout FIG. 1-G as an example, but any entity from FIG. 1 or other entity may be substituted in various embodiments without changing the overall operation of the system). At panticle 3610, NU/NE bank 3500 may verify the reputation and/or the trustworthiness of the FO/NGO/FI 3800, through one or more methods, including but not limited to, verification data (e.g., pictures, video, documents, trusted account numbers), pre-existing relationship, identity confirmation, or one or more other techniques which will be discussed in more detail herein. For example, panticle 3610 may facilitate verification of reputation through panticle 3612, which tracks a “reputation score” for various FO/NGO/FI entities (e.g., FO/NGO/FI 3800). In another example, panticle 3610 may facilitate verification of various FO/NGO/FI entities through panticle 3614 which tracks or receives from a tracking entity a past accounting and/or a reporting history regarding the various FO/NGO/FI entities (e.g., FO/NGO/FI 3800).

Referring again to FIG. 1-G, FIG. 1-G shows some examples of services performed by one or more of the entities shown in FIG. 1. This list is not meant to be exhaustive or exclusionary, but merely exemplary. For example, in an embodiment, one or more of the entities in FIG. 1 may include an NU/NE rule set panticle 3650. NU/NE rule set panticle 3650 may, alone or in conjunction with Daybreak architecture 3100, facilitate one or more actions that go with implementing a rule set for the acquisition and/or distribution of funds, to one or more of subcontracting foreign organizations (e.g., subcontracting foreign organization 3700) and Foreign Organization/Non-Governmental Organization/Foreign Individual (FO/NGO/FI), e.g., FO/NGO/FI 3800. The rule set architecture will be described in more detail with respect to panticle 4900 of FIG. 1-C. In an embodiment, NU/NE rule set panticle 3650 may receive the rule set from Daybreak architecture 3100. In an embodiment, the funds from the account 3030 may not be actually transmitted to NU/NE rule set panticle 3650, but may be transmitted through ledger transactions. In another embodiment, NU/NE rule set panticle 3650 may implement the rule set from Daybreak architecture 3100 for the funds from the account 3030 that are actually received by NU/NE bank 3500.

In an embodiment, referring again to panticle 3650 of FIG. 1-G, panticle 3650 may include panticle 3652, in which panticle 3652 effects an implementation of an acquisition or a distribution of funds rule set based on a type of goods and/or services (e.g., food, water, potable water, medicine, vaccines, health care services, shelters, clothing, tools, transport services, vehicles, firearms, etc.). For example, a part of the distribution rule set may specify that the funds must be spent on vaccinations or organizations that provide vaccinations. In another example, a part of the distribution rule set may specify that certain types of drugs cannot be purchased with funds from the account 3030, e.g., prohibition on Schedule 2 narcotics, for example.

In an embodiment, referring again to panticle 3650 of FIG. 1-G, panticle 3650 may include panticle 3654, in which panticle 3654 effects an implementation of an acquisition or a distribution of funds rule set based on a distribution area of goods and/or services (e.g., food, water, potable water, medicine, vaccines, health care services, shelters, clothing, tools, transport services, vehicles, firearms, etc.). In an embodiment, the distribution area may be purely geographical (e.g., “between the two rivers,” or “within a box defined by specific latitudes and longitudes), political (e.g., within the boundaries of a specific foreign country), or data-based (e.g., “only to areas in which the poverty rate is above 85%,” or “only to areas in which HIV infection is above 22%”). For example, a part of the distribution rule set may specify that the funds can only be spent in targeted areas of sub-Saharan Africa.

In an embodiment, referring again to panticle 3650 of FIG. 1-G, panticle 3650 may include panticle 3656, in which panticle 3656 effects an implementation of an acquisition or a distribution of funds rule set based on a quantity of goods and/or services (e.g., food, water, potable water, medicine, vaccines, health care services, shelters, clothing, tools, transport services, vehicles, firearms, etc.) to be provided. The numbers may be absolute, e.g., “this money must be used to purchase three thousand (3,000) vaccines,”) or relative (e.g., “30% of this money must be used to purchase vaccines).

Referring again to FIG. 1-G, FIG. 1-G describes a subcontracting foreign organization (SFO) 3700. SFO 3700 may communicate with one or more of the entities shown in FIG. 1. In FIG. 1, SFO 3700 is shown in communication with NU/NE bank 3500, but SFO 3700 may communicate with other entities depicted in FIG. 1, regardless of whether lines are directly drawn that connect SFO 3700 to those entities (the same is also true for the other banks discussed previously and discussed herein). In an embodiment, SFO 3700 may receive funds from the account 3030 to manage and distribute, for example, among other Foreign Organizations, Non-Governmental Organizations, and Foreign Individuals, e.g., FO/NGO/FI 3800. In an embodiment, SFO 3700 may be enrolled in the Daybreak architecture 3100 and may manage ledger transactions to and/or from the various entities shown in FIG. 1.

In an embodiment, SFO 3700 may include implementations of panticle 3710, in which panticle 3710 may implement verification of the reputation and/or the trustworthiness of the FO/NGO/FI 3800, through one or more methods, including but not limited to, verification data (e.g., pictures, video, documents, trusted account numbers), pre-existing relationship, identity confirmation, or one or more other techniques which will be discussed in more detail herein.

Referring again to FIG. 1-G, in an embodiment, SFO 3700 may include implementations of panticle 3720, in which rule set panticle 3720 may, alone or in conjunction with Daybreak architecture 3100, facilitate one or more actions that go with implementing a rule set for the acquisition and/or distribution of funds, to one or more of subcontracting foreign organizations and/or Foreign Organization/Non-Governmental Organization/Foreign Individuals (FO/NGO/FI), e.g., FO/NGO/FI 3800. The rule set architecture will be described in more detail with respect to panticle 4900 of FIG. 1-C. In an embodiment, SFO rule set panticle 3720 may receive the rule set from Daybreak architecture 3100. In an embodiment, the funds from the account 3030 may not be actually transmitted to SFO rule set panticle 3720, but may be transmitted through ledger transactions. In another embodiment, NU/NE rule set panticle 3650 may implement the rule set from Daybreak architecture 3100 for the funds from the account 3030 that are actually received by SFO rule set panticle 3720.

Referring now to FIG. 1-H, FIG. 1-H shows Foreign Organization/Non-Governmental Organization/Foreign Individual (FO/NGO/FI) entity 3800. FO/NGO/FI 3800 may be one or more of an end point services delivery entity, e.g., a truck driver, a doctor, a supplier, or a (or another) subcontracting entity, or a management entity, e.g., for a set of workers, or any other entity that is to receive payment of funds. In an embodiment, FO/NGO/FI entity 3800 includes panticle 3810. Panticle 3810 is configured to facilitate execution of verification of the reputation and/or the trustworthiness of the FO/NGO/FI 3800, through one or more methods, including but not limited to, verification data (e.g., pictures, video, documents, trusted account numbers), pre-existing relationship, identity confirmation, or one or more other techniques which will be discussed in more detail herein. The verification may continue down the chain to other FO/NGO/FIs that are receiving funds, or, in an embodiment in which FO/NGO/FI 3800 is the endpoint, then panticle 3810 may include taking the action that generates the verification data, or messaging a different entity with instructions to capture the verification data. In an embodiment in which computationally-attributable currency is used to verify transactions, FO/NGO/FI 3800 may close the ledger for that particular unit of currency.

Referring again to FIG. 1-H, FO/NGO/FI 3800 may implement panticle 3810, as previously discussed. Panticle 3810 may include panticle 3812, which, in an embodiment, may provide a reputation score of FO/NGO/FI 3800, or provide a reputation score of a further subcontracted entity, to one or more of the entities shown in FIG. 1 (it is noted that the reputation score is illustrated as provided to SFO 3700, but SFO 3700 may not be present in various embodiments, or FO/NGO/FI 3800 may provide the reputation score to a different entity, or to the Daybreak architecture 3100, regardless of the presence of SFO 3700). The reputation score may be numeric or scaled, or may be review-oriented, objective or subjective, or any combination thereof. In an embodiment, FO/NGO/FI 3800 may have a reputation score that it provides to various entities, but has no control over (e.g., other entities may change the reputation score, e.g., other entities shown in FIG. 1, other FO/NGO/FIs, or some combination thereof). In an embodiment, panticle 3812 may perform management of the reputation score, may verify the reputation score, and may deliver the reputation score.

Referring again to FIG. 1-H, FO/NGO/FI 3800 may implement panticle 3810, as previously discussed. Panticle 3810 may include panticle 3814. Panticle 3814 may, alone or in conjunction with Daybreak architecture 3100, provide past accounting and/or reporting history of FO/NGO/FI 3800, or another entity that reports to and/or has a relationship with FO/NGO/FI 3800. Panticle 3814 may, alone or in conjunction with Daybreak architecture 3100, record, collect, receive, track, or perform other operations related to the accounting and/or reporting history of FO/NGO/FI 3800, for example, previous times that FO/NGO/FI 3800 received a good score for reporting promptly, or a bad score for failing to report promptly, or reporting in a format that was not accepted, or, for example, providing photographic evidence that did not show what was claimed to be shown.

Referring again to FIG. 1-H, FO/NGO/FI 3800 may implement panticle 3820, which may facilitate implementation of acceptance of the acquisition and/or the distribution rule set needed to receive funds. For example, in an embodiment, panticle 3820 may include panticle 3822, which may implement verification of the type of goods and services that are to be provided (e.g., provides the data that will be sent to panticle 3650, which may be implemented by, for example, NU/NE bank 3500). Verification of the goods and/or services (e.g., food, water, potable water, medicine, vaccines, health care services, shelters, clothing, tools, transport services, vehicles, firearms, etc.) may include providing verification that the types of goods and services were the types for which the distribution rule set specifies payment. For example, a part of the distribution rule set may specify that the funds must be spent on vaccinations or organizations that provide vaccinations. In another example, a part of the distribution rule set may specify that certain types of drugs cannot be purchased with funds from the account 3030, e.g., prohibition on Schedule 2 narcotics, for example. The verification may take various forms, e.g., as described in panticle 4600 with respect to FIG. 1-L. In an embodiment, verification may include one or more of photographic evidence, video camera evidence, surveillance camera evidence, satellite camera evidence, GPS verification evidence, RFID/serial number tracking evidence, verification from a trusted and/or known source evidence, or other implementations.

Referring again to FIG. 1-H, in an embodiment, panticle 3820 may include panticle 3824, which may implement verification of where (e.g., at what location) the distribution of goods and/or services will occur. For example, in an embodiment, panticle 3824 may implement that the distribution area may be purely geographical (e.g., “between the two rivers,” or “within a box defined by specific latitudes and longitudes), political (e.g., within the boundaries of a specific foreign country), or data-based (e.g., “only to areas in which the poverty rate is above 85%,” or “only to areas in which HIV infection is above 22%”). For example, a part of the distribution rule set may specify that the funds can only be spent in targeted areas of sub-Saharan Africa.

Referring again to FIG. 1-H, in an embodiment, panticle 3820 may include panticle 3826, which may implement verification of a quantity of goods and/or services that will be distributed. For example, in an embodiment, panticle 3826 may implement an absolute, e.g., “this money must be used to purchase three thousand (3,000) vaccines,”) or relative (e.g., “30% of this money must be used to purchase vaccines) quantity of goods, and provide verification to one or more other entities, e.g., entities depicted in FIG. 1.

Referring again to FIG. 1-H, in an embodiment, panticle 3820 may include panticle 3828, which may implement verification of a source of the goods and/or services that are to be distributed. In an embodiment, the “source” may be an unverified location/supplier, and thus the verification implementation may be to verify that the goods and/or services that are received/performed by the FO/NGO/FI are authentic. In another embodiment, the source may be a verified shipper (e.g., shipping vaccine components from the United States), and panticle 3828 may implement verification that the goods that were alleged to be shipped for distribution have arrived and been verified.

Referring again to FIG. 1-H, in an embodiment, panticle 3820 may include panticle 3829, which may implement the sending of a verification report that details verification that was performed by panticle 3820, e.g., one or more of verifications performed in panticles 3822, 3824, 3826, and 3828. In an embodiment, the verification report may detail the work performed by FO/NGO/FI 3800 if FO/NGO/FI 3800 is the endpoint for service performance/goods delivery. In an embodiment, the verification report may be kept as part of the Daybreak architecture 3100. In another embodiment, Daybreak architecture 3100 may supplement, verify, confirm, or create (and/or prepare for verification) the report, alone or in conjunction with panticle 3820 of FO/NGO/FI 3800.

Referring now to FIG. 1-L, in an embodiment, FIG. 1-L shows implementation of the distribution chain panticle 4600, e.g., by FO/NGO/FI 3800, although in other embodiments, the distribution chain 4600 could be implemented by any of the entities shown in FIG. 1. In an embodiment, panticle 4600 includes panticle 4605, which implements an architecture in which the distributor provides evidence with regard to goods and/or services to FO/NGO/FI 3800. For example, in an embodiment, panticle 4605 may include panticle 4610 for providing photographic evidence of goods and/or services being distributed. As specific examples, although not limiting, panticle 4610 may include one or more of panticle 4612 for implementing a photograph of the delivery vehicle delivering the goods and/or services, photographs of the license plates of the delivery vehicles or the receiving vehicles, photographs of the delivery persons (e.g., with optionally facial recognition algorithms to confirm identity, e.g., as with trusted sources) and panticle 4614 for implementing a photograph of location-identifying markers, e.g., street signs, mountains, and the like.

Referring again to FIG. 1-L, in an embodiment, panticle 4605 may implement an architecture that includes panticle 4620, for location information of goods and services being distributed, e.g., GPS positioning or other location-based services, of, for example, delivery vehicles, goods, medical personnel, delivery personnel, and the like. In an embodiment, panticle 4605 may implement an architecture that includes panticle 4630 for monitoring data associated with distribution of goods and/or services, e.g., various monitoring devices, which may be attached to various goods, e.g., food goods, shipping containers, vaccines, clothing, etc.) The monitoring devices may use near-field communication, or may be RFID tags. In an embodiment, the monitoring may be accomplished through surveillance, e.g., visual, infrared, or some other form, from localized cameras or satellite cameras, for example.

Referring again to FIG. 1-L, in an embodiment, panticle 4605 may implement an architecture that includes panticle 4640, that is, a confirmation form a trusted source, e.g., trusted individual information, e.g., at panticle 4642, such as RFID information, serial number information, and the like, a trusted organization/individual at panticle 4644, or an external audit of trustworthiness at panticle 4646.

Referring now again to FIG. 1-H, in an embodiment, FO/NGO/FI 3800 may provide mechanisms for implementation of payment of the funds from the account 3030 (or other accounts with the funds originally donated, in various embodiments), to the FO/NGO/FI 3800 (and/or its specific representatives). For example, in an embodiment, FO/NGO/FI 3800 may include a panticle 3830 that implements architecture for registering/creating an account with external payment architecture (e.g., Daybreak architecture) 3100. In an embodiment, FO/NGO/FI 3800 may create an account that allows FO/NGO/FI 3800 to receive funds, prepare reports, and ultimately “offboard” the funds from account 3030 (or other accounts) to the persons/entities.

It is noted that, although not explicitly shown (because not required for functionality), in an embodiment, some or all of the entities depicted in FIG. 1, and other entities that may participate in transactions related to the funds from user 3005/organization 3015, may register with the Daybreak architecture 3100. In an embodiment, user 3005, organization 3015, Daybreak architecture 3100, or another entity may impose registration with the Daybreak architecture 3100 as a prerequisite for participating in activities involving the funds contributed by user 3005/organization 3015. In another embodiment, user 3005, organization 3015, Daybreak architecture 3100, or another entity may impose registration with the Daybreak architecture 3100 as a prerequisite for endpoint entities to receive funds, that is, it may be a prerequisite for those persons/entities performing the actual services in the locations for which the funds are specified. In yet another embodiment, registration with Daybreak architecture 3100 may be optional for one or more entities shown in FIG. 1. In still another embodiment, registration with some sort of payment architecture, but not necessarily the Daybreak architecture 3100 (e.g., a competing payment architecture system), may be required.

In an embodiment, referring again to FIG. 1-G, FO/NGO/FI 3800 may include panticle 3832, which may, alone or in conjunction with the Daybreak architecture 3100, verify that any distribution of funds to an endpoint entity (e.g., anyone receiving payment for goods and/or services rendered from the funds) comply with the acquisition and/or distribution rules specified previously by one or more of the entities in FIG. 1. In addition, FO/NGO/FI 3800 may specify further conditions on the distribution rule set, in various embodiments. In an embodiment, FO/NGO/FI 3800 may include panticle 3834, which may request payment from the entity in possession of the funds, e.g., which may be different from the entity indicated by Daybreak architecture 3100 in the ledger transactions. For example, the ledger transactions may show that NU/NE bank 3500 is in possession of 6500 dollars of 10,000 original dollars (the rest being allocated for other entities in the chain), but in actuality the entirety of the 10,000 original dollars may still be with original account 3030. Thus, when the payment is received from the bank account (shown in panticle 3836), only one transfer is needed (from the original bank to the destination), although the ledger transactions show the funds passing between multiple, possibly numerous entities.

Referring now to FIG. 1-D, in an embodiment, FO/NGO/FI 3800 may not have access to a concrete bank. For example, many individual parties outside the United States, particularly in poverty-stricken countries, do not have regular bank accounts or access to bank accounts. Thus, in an embodiment, Daybreak architecture 3100 may interface with a local endpoint payment delivery system, as shown in panticle 4500. For example, local endpoint payment delivery system 4500 may be a money transfer, financing, or microfinancing service, e.g., M-Pesa, or any other service, e.g., a Know Your Customer (KYC) service. In an embodiment, a payment delivery system may receive payment instructions, e.g., from Daybreak architecture 3100, or from one of the other entities in FIG. 1, or a combination thereof, at panticle 4150. In an embodiment, the individual without a bank account may be identified and/or located using the endpoint payment delivery system at panticle 4520 (this panticle includes the process of communicating via the endpoint payment delivery system, e.g., the M-Pesa system). In an embodiment, payment is then effected by an external transfer from one of the entities in FIG. 1 to the endpoint payment delivery system, at panticle 4530, and the payment is delivered to the person through the endpoint payment delivery system at panticle 4540.

Referring now to FIG. 1-I, FIG. 1-I shows some details of the tracking/verification account, which may, in various embodiments, be controlled by Daybreak architecture 3100, or may be implemented at one or more of the entities described throughout FIG. 1, or may be implemented as some combination thereof.

Referring again to FIG. 1-I, in an embodiment, panticle 4100 groups some of the details of the tracking and verification account located inside or outside the United States. In an embodiment, tracking/verification panticle 4100 includes a user query unit 4110. User query unit 4110 may be configured to respond to one or more queries from the user, e.g., user 3005, or another member of the charity organization 3015, or any other representative of an entity depicted in FIG. 1 that has been given access to view the system information.

In an embodiment, user query unit 4110 may respond to example queries from an authorized user. A non-exhaustive list of queries is shown inside panticle 4110. For example, some of the queries handled by user query unit 4110 include a current location of funds query (e.g., a query requesting location data of some or all of the funds, whether via the ledger transactions or the actual accounts where the funds reside), a current account balance query (e.g., a query that requests the current account balance, from one or more of the entities described in FIG. 1), a goods and/or services purchased query (e.g., a query that requests a detailed report of the goods and/or services that have been purchased from the account to date), a goods and/or services distributed query (e.g., a query that requests detail regarding to whom the goods and or services purchased by the account have been distributed), and a verification of goods and/or services distributed query (e.g., a query that shows, for example, if any of the goods and/or services were distributed in a manner that does not follow the specified rule sets).

Referring again to FIG. 1-I, in an embodiment, panticle 4100 may group some of the details of the tracking and/or verification account, which may be located inside or outside the United States. In an embodiment, tracking/verification panticle 4100 may include a recording unit 4120. Recording unit 4120 may record transactions involving the funds in the account 3030, or may record transactions between the various entities shown in FIG. 1, or some combination thereof. In an embodiment, recording unit 4120 may record ledger transactions, actual transactions (e.g., ACH transactions or wire transfers), both, or some combination based on characteristics. In an embodiment, recording unit panticle 4120 may facilitate one or more actions, such as record a location of funds, e.g., at various intervals, for example, a daily recordation, a monthly recordation, a check every hour, a check every second, or any interval whether repeating or nonrepeating. In an embodiment, recording unit panticle 4120 may facilitate one or more actions record a transfer of funds, e.g., each time funds are transferred, e.g., whether an actual funds transfer or a ledger transaction, from any of the entities shown in FIG. 1, to any other entity, or any other transaction that involves account 3030 or the funds contributed by user 3005. The recordation may occur on an ad-hoc basis, or may occur at specific intervals (e.g., every hour, or every day, for example). There may be multiple recordations and/or multiple reports generated in various embodiments.

Continuing to refer to tracking/verification panticle 4100 in FIG. 1-I, in an embodiment, recording unit panticle 4120 may facilitate one or more actions, such as record goods and/or services that are acquired based on funds in the account 3030 or other funds associated with user 3005. For example, when funds are provided for the acquisition of services, whether to the endpoint user (e.g., through a payment system, e.g., M-PESA), or to a middle entity (e.g., a sub-contractor), the goods and/or services that are acquired, or that are alleged to have been acquired, may be recorded. This may include various verification techniques which will be discussed in more detail further herein. In an embodiment, recording unit panticle 4120 may facilitate one or more actions, such as recording fees associated with various accounts, e.g., account 3030 as it passes through one more entities in ledger transactions, or actual account fees, e.g., maintenance fees and/or convenience fees for one or more actual accounts held by one or more entities shown in FIG. 1.

Referring again to FIG. 1-I, in an embodiment, panticle 4100 may provide some measure of digital security to one or more transactions, whether actual transactions or ledger transactions, shown in FIG. 1. For example, in an embodiment, digital security unit panticle 4130 may be implemented as a digital security unit that facilitates provision of digital security to the account 3030, to another account, to one or more of the entities shown in FIG. 1-I, to one or more specific transactions, or to some combination thereof. In an embodiment, digital security unit 4130 may operate inside or outside the United States, or a combination thereof. In an embodiment, digital security unit 4130 may include one or more of identity verification, transaction verification, transaction security, and the like. In an embodiment, digital security unit panticle 4130 may use digital currency, e.g., Bitcoin, for one or more transactions. The use of digital currency may be transparent or may be hidden from the participants in the transaction (e.g., the Bitcoin transaction is an underlying layer.

In an embodiment, one or more digital currencies may be used, including, for example, a sub-category of digital currencies commonly referred to as cryptocurrencies. Among the best known cryptocurrencies include, for example, Bitcoin, Ripple, Primecoin, and so forth. Some common features among all of these digital currencies include maintaining a global electronic ledger (e.g., in Bitcoin, this is referred to as a “block chain”) that includes records of all global transactions and a requirement that a relatively complex problem (typically a complex mathematical problem), which in Bitcoin is called “proof of work” be solved whenever a bundle of transactions is to be recorded to the global electronic ledger in order to ensure trustworthiness of the recorded transactions.

In the case of Bitcoins, each transaction requires a new address to be used for each recipient receiving the spent currency. Each transaction is recorded in a transaction block (e.g., a page in global electronic ledger), and a transaction block will at least identify the account/address that the “spent” digital currency originated from. As a result, each unit of currency in the bitcoin eco-system can be traced back to its origin even though Bitcoin is often lauded/despised because of its ability to maintain the anonymity of its participates. This anonymity feature exists partially because the users whose addresses where currencies are being deposited/assigned to remain publically anonymous (e.g., only a participant knows the addresses that belong to the participant). Other types of cryptocurrencies function in similar fashion with some relatively subtle differences.

Although current digital currency systems (e.g., Bitcoin) allows for tracing of individual units of currency (e.g., in Bitcoin, the smallest unit of currency is called a “Satoshi”) back to their origins through their global ledgers (e.g., in Bitcoin, the global ledger is called a “blockchain”), such systems only provide certain basic transactional information (e.g., for a specific transaction, which address was the unit or units of digital currency being reassigned from and which address is the unit or units of digital currency being assigned to, which previous transaction did the unit or units of currency did the currency originate from, and a time stamp). Accordingly, systems and methods are provided herein that employs digital currency that has memory and that is able to “remember,” among other things, information regarding past transactions.

Referring again to FIG. 1-I, in an embodiment, digital security unit panticle 4130 may include one or more implementations of a secure pipeline 4134 that ensures security of a transaction between one or more parties. For example, secure pipeline 4134 may include, as a non-limiting example, a Secure Electronic Transaction (SET) system, or a 3-D secure WL-based protocol. Secure pipeline 4134 may include one or more of such implementations as an electronic wallet, a verified digital certificate, a combination of digital certificates and/or digital signatures. Secure pipeline 4134 may implement or ensure the use of such technologies as Secure Sockets Layer (SSL), Secure Transaction Technology (STT), Secure Hypertext Transfer Protocol (S-HTTP).

Referring again to FIG. 1-I, in an embodiment, tracking/verification panticle 4100 may include a real time tracking/accounting panticle 4140. Real time tracking/accounting panticle 4140 may provide one or more real time functions for, for example, user 3005, although any of the entities shown in FIG. 1 may, in various embodiments, have access to real time tracking and/or real time accounting. As mentioned previously with respect to the panticles as part of the tracking/verification account 4100, real time tracking/accounting panticle 4140 may, in various embodiments, be controlled by Daybreak architecture 3100, or may be implemented at one or more of the entities described throughout FIG. 1, or may be implemented as some combination thereof. It is noted that, here and throughout the specification, the term “real time” also may mean “near real time,” that is, not delivered in what is colloquially considered to be “real time,” but near enough to provide a simulation of real time, due to delays in transmission, processing, or displaying the information, for example.

Referring again to FIG. 1-I, in an embodiment, tracking/verification panticle 4100 may include implementation details for a reward/penalty unit 4150. Reward/penalty unit 4150 may, in various embodiments, be controlled by Daybreak architecture 3100, or may be implemented at one or more of the entities described throughout FIG. 1, or may be implemented as some combination thereof. Reward/penalty unit 4150 may be implemented by a rule set specified by one or more of the entities shown in FIG. 1, including user 3005 and organization 3015. In an embodiment, reward/penalty unit 4150 may use all or a portion of a default rule set specified by Daybreak architecture 3100 or one or more of the other entities. In an embodiment, more than one entity may provide a rule set, and, in an embodiment, multiple rule sets may be honored or attempted to honor. In another embodiment, a first rule set may supersede a second rule set. In an embodiment, reward/penalty unit panticle 4150 may perform one or more of rewarding prompt reporting, penalizing late reporting, returning funds if graft and/or failure to report and/or misuse of funds is detected, and return of funds if goods and/or services are not provided within a particular time frame. Verification of what is happening at endpoints (e.g., through GPS/photographic evidence/etc.) will be discussed in more detail elsewhere in this application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

### Configuration of the First Party Device, e.g., a User Device, as Shown in FIG. 2C-1

Referring now to FIG. 2C-1, in an embodiment, FIG. 2C-1 shows an implementation of a user machine/first party machine 220, according to various embodiments, operating in environment 200. In an embodiment, user device 220 may be a device associated with a user 100. In an embodiment, user 100 may be an account holder of the attributable account. In an embodiment, user 100 may be a philanthropist/philanthropic organization/philanthropic entity who intends to give away portions of his funds to various charitable interests. In another embodiment, user 100 may be a for-profit person, business, organization, or other entity. In an embodiment, user 100 may be the “first party” referenced herein, although in other embodiments, the “first party” may be any person, entity, being, computer, terminal, or other discrete object/person/machine.

Referring again to FIG. 2C-1, in an embodiment, user 100 may be associated with a first party machine 220. First party machine 220 may be a whole or portion of a device, any electronic device, or combination of devices, which may be located together or spread across multiple devices and/or locations. First party machine 220 may be a server device, or may be a user-level device, e.g., including, but not limited to, a laptop computer, a personal computer, cellular phone, a network phone, a smartphone, a tablet, a music player, a walkie-talkie, a radio, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

Referring again to FIG. 2C-1, in an embodiment, first party machine 220 may include electrical/magnetic/physical storage 222. In an embodiment, electrical/magnetic/physical storage may include any form of storing data, whether temporary or permanent, for example, in the electrical and/or magnetic field, any sort of memory or data storage, including, but not limited to, random access memory (“RAM”), read only memory (“ROM”), flash memory, hard drives, disk-based media, magnetic storage, optical storage, volatile memory, nonvolatile memory, mass storage devices, programmable read-only memory (“PROM”), erasable programmable read-only memory (“EPROM”), electronically-erasable programmable memory (“EEPROM”), cache memory such as random access memory (RAM), flash memory, synchronous random access memory (SRAM), dynamic random access memory (DRAM), and/or other types of memory. In an embodiment, some such memory may be integrated with processor 251 or other components 260. For example, first party machine 220 may include a graphics card with a Graphics Processing Unit (GPU) that may be part of processor 251, and a dedicated memory that may be part of electrical/magnetic/physical storage 222.

In another embodiment, physical storage may refer to physical media on which magnetic data are stored, or it may refer to the storage of data coded into physical objects, e.g., biological constructs, quantum constructs, and, in a basic sense, physical machines, e.g., a simple example of which would be gears and levers that can maintain data storage, e.g., as in a Difference Engine.

In another embodiment, the electrical/magnetic/physical storage may be remote or partially remote from first party machine 220, such as stored in a cloud storage device, or in situations in which first party machine 220 acts as a “thin client” or terminal. As shown in FIGS. 3A-3C, for example, such implementations are contemplated by FIG. 2C-1, and such implementations of remote memory should be considered as part of first party machine 220.

Referring again to FIG. 2C-1, in an embodiment, first party machine 220 may include a processor 251. Processor 251 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single device 220, processor 222 may be multiple processors distributed over one or many devices 220, which may or may not be configured to operate together. In an embodiment, all or a portion of processor 251 may be performed remotely, e.g., at a remote site, with first party machine 220 acting as a thin client. Such implementations should be considered as the processor 251 as part of first party machine 220. See, e.g., FIGS. 3A-3C.

Referring again to FIG. 2C-1, in an embodiment, processor 251 may include at least one input acceptance machine 252, which will be discussed in more detail with respect to FIG. 5A herein, at least one first track data presentation machine 254, which will be discussed in more detail with respect to FIG. 7A herein, and/or at least one second track data presentation machine 256 which will be discussed in more detail with respect to FIG. 5C herein. What is depicted in FIG. 2C-1 at processor 251 is that one or more machines/processes/articles/compositions may include creation of three or more machines, e.g., within a processor or partially within a processor, that correspond to at least one input acceptance machine 252, which will be discussed in more detail with respect to FIG. 5A herein, at least one first track data presentation machine 254, which will be discussed in more detail with respect to FIG. 5B herein, and or at least one second track data presentation machine 256 which will be discussed in more detail with respect to FIG. 9A herein.

Referring again to FIG. 2C-1, in an embodiment, first party machine 220 may include a resolution circuit 270. A resolution circuit 270 may, as a simplification, connect one or more parts of the first party machine 220 that are not specific to the workings described in this specification/invention, to the specific machines specified, that is at least one input acceptance machine 252, and at least one first track data presentation machine 254. Resolution circuit 270 will be described in more detail further herein.

Referring again to FIG. 2C-1, in an embodiment, first party machine 220 may include other machine components 260. It is noted that other machine components 260 may be optional components, that is, not every first party machine 220 will have all or necessarily any of the components listed as other machine components 260. For example, in an embodiment, first party machine 220 may include one or more machine hardware and device drivers 262, which may be specific hardware components of first party machine 220, and drivers for the specific hardware components, e.g., video drivers, audio drivers, input device drivers, network communications drivers, mass storage drivers, and their concordant hardware components. In an embodiment, first party machine 220 may include a communications network interface 263, in which first party machine 220 may communicate with other devices. In an embodiment, communications/network interface 263 may be one or more of an Ethernet card, a LAN card, an antenna (e.g., a 4G LTE antenna), a cable port, a network interface card, or similar. Communications/network interface 263 may be adapted to communicate with a communication network 240. In various embodiments, the communication network 240 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 240 may be wired, wireless, or a combination of wired and wireless networks. It is noted that “communication network” as it is used in this application refers to one or more communication networks, which may or may not interact with each other. It is further noted that, throughout this specification, reference may be made to the “two way communication” or “two way connection,” which may utilize communication network 240 regardless of whether communication network 240 is specifically illustrated.

Referring again to FIG. 2C-1, in an embodiment, first party machine 220 may include one or more input/output interfaces 264. Input/output interface 264 may include one or more of a speaker, microphone, screen, touchscreen, mouse, keyboard, pen, haptic sensor, environment sensor (e.g., that measures temperature, humidity, motion, speed, etc.), and the like. In an embodiment, first party machine 220 may include various implemented APIs 265 which may be implemented to allow first party machine 220 to perform various tasks.

It is noted that, although FIG. 2C-1 shows components separately in first party machine 220, this is merely for convenience. Those skilled in the art will understand that there may be substantial overlap between components of first party machine 220, particularly in processor 251, which may in fact be many processors/subprocessors used throughout first party machine 220, and which may shift through various configurations as specific machine states faster than human comprehension, e.g., two billion times per second (e.g., for a device operating at 2 GHz, for example).

### Configuration of the First Party Device, e.g., a User Device, as Shown in FIG. 2C-2

Referring now to FIG. 2C-2, FIG. 2C-2 shows a more detailed version of a first party machine 220B including a processor 251B, which is a different implementation of processor 251, according to another embodiment. Many of the features of first party machine 220B are similar to first party machine 220, and those portions which are similar to the embodiments shown in FIG. 2C-1 are not be repeated.

In an embodiment, first party machine 220B may include a processor 251B. Processor 251B may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 251B may be a server. In an embodiment, processor 251B may be a distributed-core processor. Although processor 251B is illustrated in FIG. 2C-2 as a single processor that is part of a single first party machine 220B, processor 251B may be multiple processors distributed over one or many first party machine 220B, which may or may not be configured to operate together.

Processor 251B is illustrated as being configured to execute computer readable instructions in order to execute one or more operations described above, and as illustrated in FIG. 14, FIGS. 15A-15F, FIGS. 16A-16H, and FIGS. 17A-17C. In an embodiment, processor 222 is designed to be configured to operate as processing module 251, which may include one or more of an input acceptance circuit 252B, which may be configured to receive input that regards an attributable account that contains attributable funds and that is configured to interface with one or more financial entities, wherein the attributable funds are governed by a distribution rule set, a first transaction data receiving circuit 254B that may be configured to receive first transaction data indicating a first transmission of particular funds from a first downstream entity to a second downstream entity, wherein the particular funds are part of the attributable funds, and a second transaction data receiving circuit 256B configured to receive second transaction data indicating a second transmission of the particular funds from the second downstream entity to the third downstream entity.

In an embodiment, first party machine 220B may include electrical/magnetic/physical storage 222. In an embodiment, electrical/magnetic/physical storage 222 may include processor configuration instructions 222A which cause the processor 251B to form various circuits, e.g., input acceptance circuit 252B, first transaction data receiving circuit 254B, and second transaction data receiving circuit 256B. Processor configuration instructions 222A may allow processor 251B to use advanced techniques to form the various circuits, including pipelining, instruction-level parallelism, branch prediction, branch delays, instruction scheduling, out-of-order execution, and instruction cache. Although these implementations may exist (and may be implemented with a modern processor), the circuits shown in processor 251B may be formed at some point in the cycle, even if different parts of the circuit are broken down and re-purposed according to the instruction unit of processor 251B. Such implementations, usually done for processor optimization (although not always) should not be considered as preventing or not implementing the formation of the various circuits of processor 251B, e.g., input acceptance circuit 252B, first transaction data receiving circuit 254B, and second transaction data receiving circuit 256B. The same is true for the implementations discussed throughout this application, including with respect to FIG. 2C-1 and elsewhere.

### Exemplary Environment 200D of Daybreak Architecture (FIG. 2D)

Referring now to FIG. 2D, FIG. 2D shows an implementation of the daybreak architecture, e.g., daybreak architecture 250D, according to various embodiments. It is noted that, throughout this disclosure, with regards to the daybreak architecture and/or other elements described herein, different numbers may be used to describe similar/the same elements. In such an instance, it is to be understood that such numbering is merely to distinguish embodiments, which may be interchangeable unless logically inconsistent.

Referring again to FIG. 2D, in an embodiment, daybreak architecture 250D has a single attributable account 252D. Attributable account 252D may reside at a bank, either foreign or domestically. Any time funds, e.g., new attributable funds, e.g., attributable funds 253D, are put into the daybreak architecture, the funds are transferred to the attributable account. In an embodiment, in the actual underlying bank account 248D of bank 247D that is associated with daybreak architecture 250D, the funds may (but are not required to) be commingled. In an embodiment, for example, attributable funds 249D, other unrelated attributable funds 243D and 242D are deposited into the same bank account 248D. The daybreak architecture 250D manages the attributable funds 253D and the other attributable funds 254D and 255D and prevents the funds from becoming entangled.

### Exemplary Environment 200E of Daybreak Architecture (FIG. 2D)

Referring now to FIG. 2E, in an embodiment, daybreak architecture 250D has multiple attributable accounts, e.g., 252E, 254E, and 255E, which contain attributable funds 253E, 256E, and 257E, respectively. In an embodiment, each attributable account represents a separate bank account in an underlying bank, e.g., attributable account 252E may be associated with underlying bank account 248E, other attributable account 254E may be associated with bank account 244E, and other attributable account 255E may be associated with bank account 245E. It is noted that bank accounts 248E, 244E, and 245E need not be lodged with the same bank. Moreover, in various embodiments, the accounts kept at various banks may not match exactly with the accounts managed by the daybreak architecture 250E. For example, if the bank associated with bank account 244E offers better terms of service for the account if there is more than ten million dollars in the account, then multiple accounts may be combined or split so that the money “actually” resides in bank account 244E. In such embodiments, the location of the funds is managed by daybreak architecture 250E, such that, if movement of funds to/from the underlying accounts is required, the architecture determines which banks from which to withdraw the funds.

### Exemplary Embodiment of Daybreak Architecture 3100 (FIGS. 2F-2N)

FIGS. 2F to 2N describe a transfer of funds through the daybreak architecture 3100, according to one embodiment. It is noted that this is merely an example embodiment and is not intended to be limiting, but rather to be illustrative of one example of a process executed by the daybreak architecture 3100 and first party machine 220.

For example, referring now to FIG. 2F, FIG. 2F shows a first step in the use of the daybreak architecture 250F. In an embodiment, a user or organization, e.g., user 251F, wants to deposit ten million dollars of their money to be managed by the daybreak architecture. This is accomplished by first registering with the daybreak architecture 250F, providing, for example, a username and password, e.g., as described in FIGS. 1-E and 1-B, for example. Upon registering for the daybreak architecture 250F, the deposit is made internally to the daybreak architecture for 10 million dollars to user 251F's attributable account 252F (1) in FIG. 2F). In an embodiment, after/before/concurrently with the allocation within the daybreak architecture 250F, the ten million dollars is transferred from original bank account 205F to the account associated with the daybreak architecture, e.g., through an ACH or other similar type of transfer (e.g., wire transfer) (e.g., (2) in FIG. 2F).

Referring now to FIG. 2G, in an embodiment, the user 251F wants to “transfer six million dollars to a large foreign entity (LFE 280G) for charitable purposes.” In the daybreak architecture, an internal transaction is made from the attributable account 252F to the daybreak architecture account associated with LFE 280G, that is, account 252G. This transaction is checked for compliance with the distribution rule set, and may be approved, denied, or held pending further review.

In an embodiment, Daybreak Architecture transfers 6 million dollars from the attributable account 252F to an account within daybreak architecture associated with LFE 280G. Regardless of the outcome of the check for compliance with the distribution rule set, no actual funds transfer takes place—e.g., the six million dollars stays with the daybreak architecture account 262F where it was transferred in FIG. 2F.

Referring now to FIG. 2H, in an embodiment, after receiving the six million dollars, LFE 280G wants to transfer two million dollars to a subcontractor 280H, e.g., to build a hospital. In an embodiment, two million dollars will be transferred from the daybreak architecture account associated with LFE 280G, that is, daybreak architecture account 252G, to the daybreak architecture account associated with sub 280H, that is daybreak architecture account 252H. As before, Daybreak Architecture transfers 2 million dollars from the Account 252G of LFE 280G to Subcontractor SUB280H who complies with the Distribution Rule Set (1) in FIG. 2H, but (2) no actual funds transfer happens between the various banks. The ten million dollars is still in account 262F.

Referring now to FIG. 2I, FIG. 2I shows what happens if a proposed transfer does not comply with the distribution rule set. As shown in FIG. 2I, in an embodiment, LFE 280G attempts to transfer one million dollars to subcontractor 280I, e.g., who is not on an approved list, or who fails the fraud prevention analysis (e.g., as discussed in more detail in FIG. 5). In an embodiment, the transaction is denied for noncompliance with the distribution rule set, and no money is transferred, either within the daybreak architecture or in the actual underlying banks.

In an embodiment, the daybreak architecture 250F may be set to initially allow the transaction to go through, but then “claw back” the funds, whether by human intervention or failure of one of the automated fraud protection analyses. Due to the daybreak architecture not actually moving the money between bank accounts, this claw back becomes simpler to perform.

Referring now to FIG. 2J, in an embodiment, Sub 280H (who received two million dollars in FIG. 2H), wants to transfer one million dollars to trucking company 280J for purchasing cement mixer trucks. In an embodiment, this transaction is again checked for compliance with the distribution rule set. In an embodiment, the transaction clears the distribution rule set, and one million dollars is transferred from daybreak architecture account 252H to daybreak architecture account 252K, as shown in (1) of FIG. 2J. It is noted, however, that no actual funds transfer takes place (2).

Referring now to FIG. 2K, in an embodiment, Trucking Company (TrCo) 280J needs the million dollars to gas up the trucks (for example). In an embodiment, Trucking Company is going to use the one million dollars to pay for gas. So, TrCo 280J makes a request to “offboard” the funds, that is, to remove them from the daybreak architecture 250F. The transaction again may be checked for compliance with the distribution rule set—e.g., the trucking company may be allowed only to spend 100,000 dollars at a time. But, in an embodiment, if the transaction is approved in view of the distribution rule set, the transaction is approved, and recorded within the daybreak architecture (1). In an embodiment, funds are then transferred directly from the bank associated with the daybreak architecture 260F to the bank associated with the TrCo 280J. Thus, all middle entities are avoided, and fees can be reduced, which may be small if all ACHs are used, but other forms of transfer may be more, to say nothing of fees associated with establishing many accounts at many banks along the way.

Referring now to FIG. 2L, in an embodiment, the Sub 280H may want to spend the funds directly, e.g., to buy large quantities of concrete directly to save money. In an embodiment, Sub 280H requests to offboard 500,000 dollars, and the transaction is checked with the distribution rule set. If the transaction clears, then (1) the transfer is recorded within the daybreak architecture and (2) the funds are transferred directly from the attributable account either 1) to the concrete supplier or 2) to the sub 280H account, depending on various embodiments.

Referring now to FIG. 2M, in an embodiment, the Sub 280H may be owed 100,000 dollars in management fees for overseeing the project. In an embodiment, assuming this withdrawal complies with the distribution rule set (e.g., management fees are capped at 10% of total imbursement), then the withdrawal is recorded within the daybreak architecture (1), and the funds are transferred directly to the Sub 280H bank account, where the funds are no longer tracked by the daybreak architecture because they have been “paid” to the Sub 280H.

Referring now to FIG. 2N, in an embodiment, LFE 260G may be owed 1,000,000 dollars in management fees for overseeing the project. In an embodiment, assuming this withdrawal complies with the distribution rule set, then the withdrawal is recorded within the daybreak architecture (1), and the funds are transferred directly to the LFE 280G's bank account 262G, where the funds are no longer tracked by the daybreak architecture.

### FIG. 3

Referring now to FIG. 3A, FIG. 3A shows a high level view of various systems that interact in order to facilitate first party machine 220 to operate. For example, in an embodiment, as shown in FIG. 3A, a first party device, e.g., a computer 310, that is created by a corporate entity “C” is shown.

Referring again to FIG. 3A, FIG. 3A shows parts or wholes of at least one of (a) driving a state change of a data presentation device within a domestic (United States) jurisdiction; (b) driving a state change of a data communication device within a domestic (United States) jurisdiction; and (c) driving a state change of a data computation device within a domestic (United States) jurisdiction may include receiving a signal of at least one state change outside United States jurisdiction, and in response to the signal of at least one state change outside United States jurisdiction driving a state change of a data presentation device within United States jurisdiction, (b) driving a state change of a data communication device within United States jurisdiction, or (c) driving a state change of a data computation device within United States jurisdiction. For example, in an embodiment, receiving a signal of at least one state change outside United States jurisdiction (e.g., receiving a signal over two-way connection 392 from corporate entity “A” Computer and program 330 (e.g., “Google Cloud Services Server Farm”), which, in an embodiment, may be placed slightly beyond United States jurisdiction in an effort to avoid some United States patents as drafted (e.g., server farm on a barge in extraterritorial waters or in Canada/Mexico/Trinidad-Tobago, etc.); and in response to the signal of at least one state change outside United States jurisdiction (e.g., the signal received from and transmitted into the Unites States via corporate entity “A” Computer and program 330 (e.g., “Google Cloud Services Server Farm”) outside the United States connection with the United States in the form of two-way connection 392), for example, at least one of (a) driving a state change of a data presentation device within United States jurisdiction (e.g., changing a voltage driving a pixel of a display of desktop computer 310 owned by person/entity 305 within United States Jurisdiction in response to the Google signal, which may be evidenced by noting a change in display (e.g., “now connecting to Google Cloud Services . . . ”), (b) driving a state change of a data communication device within United States jurisdiction (e.g., changing a current within a modem of desktop computer corporate entity “C” computer 310) owned by person 305 within United States Jurisdiction, in response to a signal received from/transmitted by a processor in corporate entity “A” Computer and program 330 (e.g., “Google Cloud Services Server Farm”), or (c) driving a state change of a data computation device within United States jurisdiction in response to an electronic current/voltage/photonic pulse/electromagnetic wave transmitted over two-way communication 392 by corporate entity “A” Computer and program 330 (e.g., “Google Cloud Services Server Farm”).

In addition, in an embodiment, it will be understood that receiving a signal of at least one state change outside United States jurisdiction, and in response to the signal of at least one state change outside United States jurisdiction driving a state change of a data presentation device within United States jurisdiction, (b) driving a state change of a data communication device within United States jurisdiction, or (c) driving a state change of a data computation device within United States jurisdiction also constitutes action/presence within United States jurisdiction in that when another endpoint 393B of two-way connection 393, in the ownership or control of another legal entity, e.g., that may be different from person 305, and in which said another legal entity, who in some instances might be outside of United States jurisdiction (e.g., Corporate User/Legal Owner 341 of Corporate Entity “Z” computer & program (e.g., “Amazon Cloud Services Server Farm”) placed slightly outside of U.S. Jurisdiction as an attempted legal strategy to avoid some patent claims as drafted) also drives a state change in the United States since the communications channel 393 extends all the way into the United States and causes a state change in single end 393A (e.g., computer 310 owned by person/entity 305) in much the same way that poking someone in the eye with a stick while standing in Canada will expose the person (in Canada) wielding the stick to U.S. jurisdiction.

Referring now to FIG. 3B, FIG. 3B shows a high level view of various systems that interact in order to facilitate first party machine 220 to operate. For example, in an embodiment, as shown in FIG. 3B, a first party device, e.g., a computer 310, which is created by a corporate entity “C” is shown. Referring again to FIG. 3B, FIG. 3B shows that parts and/or wholes of driving a change of matter or energy within the ownership or control of a single legal entity may include at least one of (a) driving a state change of a data presentation device within a domestic (United States) jurisdiction; (b) driving a state change of a data communication device within a domestic (United States) jurisdiction; and (c) driving a state change of a data computation device within a domestic (United States) jurisdiction. For example, in an embodiment, at least one of (a) driving a state change of a data presentation device within domestic (e.g., United States) jurisdiction, which may be evidenced by noting a change in display (e.g., “now connecting to Microsoft's Cloud Services . . . ”); (b) driving a state change of a data communication device within a domestic (e.g., United States) jurisdiction (e.g., changing a current within a component, e.g., a network communications interface, e.g., a modem), of corporate entity “C” computer 310 owned by person/entity 305 within domestic (e.g., United States) jurisdiction, in response to a signal received from a processor in corporate entity “A” Computer and program 330 (e.g., “Google Cloud Services Server Farm”) will also constitute action by legal owner/user of corporate entity “A” Computer and program 330 (e.g., “Google Cloud Services Server Farm”), e.g., “Google” in this example, in the domestic territory (e.g., the United States) (e.g., analogous to the stick example, corporate entity “A” Computer and program 330 (e.g., “Google Cloud Services Server Farm”), which as illustrated will often, as an attempted legal strategy, likely be placed slightly beyond United States jurisdiction in an effort to avoid some United States patents as drafted (e.g., server farm on a barge in extraterritorial water, but two-way communication extends into and causes state change within the United States)—which may be evidenced by a change in display (e.g., “now connecting to Google Cloud Services . . . ”) and when it is known that corporate entity “A” Computer and program 330 (e.g., “Google Cloud Services Server Farm” is providing a back end, or (c) driving a state change of a data computation device within domestic, e.g., United States jurisdiction (e.g., a processor in corporate entity “A” computer and program 330, e.g., “Apple Cloud Services Server Farm” located in, for example, Eden Prairie, Minn., USA).

Referring now to FIG. 3C, FIG. 3C shows a high level view of various systems that interact in order to facilitate first party machine 220 to operate. For example, in an embodiment, as shown in FIG. 3C, a first party device, e.g., a computer 310, which is created by a corporate entity “C” is shown. Referring again to FIG. 3C, FIG. 3C shows that parts and/or wholes of “creating one or more machine states that link at least two parts of . . . ” (e.g., as described in operations notice clause 1) may include driving a change of matter or energy within a domestic (United States) jurisdiction. For example, driving a change of matter or energy within the ownership or control of a single legal entity within domestic (e.g., United States) jurisdiction (e.g., desktop computer 310 owned by person/entity 305 (e.g., which may be a Legal Corporation/Partnership) to form a single endpoint 393A of a two-way communication channel 393 where another end 393B may be in the ownership or control of another legal entity, different from person/entity 305, who in some instances might be inside United States jurisdiction but who in other instances might be outside of United States jurisdiction (e.g., Corporate Entity “Z” Computer & Program 340, e.g., (“Apple Cloud Services Server Farm”), which as illustrated, may in some instances be within United States jurisdiction but which will often, in view of legal strategies to avoid infringement, more likely be placed slightly beyond United States jurisdiction in an effort to avoid some United States patents as drafted (e.g., server farm in Canada/Mexico/Trinidad-Tobago, etc.). In addition, it will be understood that driving a change of matter or energy within a domestic (United States) jurisdiction is also achieved when another end 392B in the ownership or control of yet another legal entity—also different from person/entity 305 and possibly different from corporate entity 341B,—who in some instances might be outside of United States jurisdiction (e.g., Corporate Entity “Z” Computer & Program 340, e.g., (“Apple Cloud Services Server Farm”), placed slightly outside of U.S. Jurisdiction as an attempted legal strategy to avoid some patent claims as drafted) also drives a state change in the United States since the communications channel 393 extends all the way into the United States and causes a state change in single end 393A (e.g., computer 310 owned by person/entity 305) in much the same way that poking someone in the eye with a stick while standing in Canada will expose the person (in Canada) wielding the stick to U.S. jurisdiction).

Referring now to FIG. 3D, FIG. 3D shows a high level view of various systems that interact in order to facilitate first party machine 220 to operate. For example, in an embodiment, as shown in FIG. 3D, a first party device, e.g., a computer 310, that is created by a corporate entity “C” is shown. Referring again to FIG. 3D, FIG. 3D shows that parts and/or wholes of “creating one or more machine states that link at least two parts of . . . ” (e.g., as described in operations notice clause 1) may include driving a change of matter or energy within the ownership or control of a single legal entity, for example, driving a change of matter or energy within the ownership or control of a single legal entity (e.g., person within United States jurisdiction 305D, who may be tablet/smartphone computer user) to form a single end 393A of a two-way communication channel 393 (e.g., fiber optic cable) where the other end 393B might be in the ownership or control of another legal entity different from person/entity 305D (e.g., Corporate User/Legal Owner 341D of Corporate Entity “Z” Computer & Program 340, e.g., “Amazon Cloud Services Server Farm,” which as illustrated, may in some instances be within United States jurisdiction but which will often more likely be placed slightly beyond United States jurisdiction in an effort to avoid some United States patents as drafted (e.g., server farm in Canada/Mexico/Trinidad-Tobago, etc.) but it will be understood that either party individually closing a connection from either end constitutes a joint and several making or using of the illustrated/described machines/articles/compositions/processes (i.e., single entities, as shown in the figures, are noticed up that closing a connection to form subject matter herein is claimed to be direct literal infringement by a single entity irrespective of whether two (or more) legal entities have “parted up” the subject matter disclosed herein. In addition, it will be understood that driving a change of matter or energy within the ownership or control of a single legal entity also constitutes making/using subject matters disclosed herein in that when another end 393B, of communications channel 393, in the ownership or control of another legal entity—different from person 305D—who in some instances might be inside of United States jurisdiction (e.g., e.g., Corporate User/Legal Owner 341D of Corporate Entity “Z” Computer & Program 340, e.g., “Amazon Cloud Services Server Farm,”) as an attempted legal strategy to avoid some patent claims as drafted) also drives a state change constituting making/using subject matters herein since the communications channel 393 is within the control of e.g., Corporate User/Legal Owner 341D of Corporate Entity “Z” Computer & Program 340, e.g., “Amazon Cloud Services Server Farm,” and thus such state change/closing a connection constitutes making/using the system in its entirety by any such legal entity so closing/connecting irrespective of legal ownership of the individual component parts. Thus any party so closing/connecting (e.g., via closing of an electronic switch or relay such as might be used in fiber optic or wireless communication) makes/uses the claimed subject matter and is noticed up that joint/several liability for infringement via such closing/connection is taught and contemplated.

### FIG. 4

Referring now to FIG. 4A, FIG. 4A shows some various fraud detection schemes that may be implemented by daybreak architecture 3100. For example, in an embodiment, there are some “phantom vendor” scheme specific patterns that may be recognized, which will be discussed in more detail herein.

Referring now to FIG. 4A, in an embodiment, the daybreak architecture may, optionally through use of the distribution rule set, perform one or more fraud detection schemes 400. For example, in an embodiment, one fraud detection scheme 400 covered by the daybreak architecture is a phantom vendor fraud detection scheme 410. In this fraud scheme, a dirty contractor or entity makes a payment to a vendor that either doesn't exist (and then steals the money), or a “shadow” vendor that will kick back all or a portion of the money to the dirty entity in exchange for releasing the funds to them.

In an embodiment, referring again to FIG. 4A, each transaction may receive a “score,” based on one or more factors regarding how suspicious the activity is. For example, there may be many factors that, by themselves would not be suspicious, but added up, make the overall transaction suspicious enough to either halt the transaction or call for further review of the transaction prior to allowing the transaction through the daybreak architecture or through offboarding the funds. In an embodiment, for example, if a transaction is done late at night, on a weekend, with a newly-established vendor, with a vendor that only has a post office box, with a vendor with a middling trust factor, with a vendor with no prior history of authentication, e.g., through RFID tagging, pictures, etc., alone these factors may be insufficient to trigger a refusal, but together they may provide a “score” that indicates to hold or deny the transaction.

For example, in an embodiment, transaction timing may matter (e.g., transaction timing 422). In another embodiment, suspicious vendor activity 424 may matter. An example of this would be at 426, where, upon payment creation, identify payments made to a vendor that had been dormant for 12 months, had vendor details changed, and then received a payment. A dormant vendor (one that hasn't had any transactions related to it in, for example, over a year) could potentially be hijacked by a perpetrator in order to avoid the scrutiny that is associated with “new” vendors. Once the vendor has been modified to reflect the phantom vendor details, it is ready to receive fraudulent payments. If a vendor hasn't been used for more than twelve months, e.g., has its details changed, and receives a payment within sixty days, e.g., of that change, flag the transaction for this analytic. In various embodiments, the daybreak architecture would make this a difficult fraud scheme to execute.

Upon vendor modification, identify vendors that have had information details changed, received a payment, and then had the information changed back to the initial value. A previously approved vendor can be “borrowed” by a fraud perpetrator and temporarily used as a phantom vendor. In various embodiments, the daybreak architecture would make this a difficult fraud scheme to execute.

Upon vendor creation or modification, identify vendors that only have a PO Box or an address that houses boxes, such as Mailboxes, Etc., listed as an address, may contribute to a lower score, because many vendors have a brick and mortar address they use for their business dealings and related correspondence. While there are legitimate reasons for a vendor to only have a PO Box as an address, it may flag various analytics.

Upon invoice creation, identify invoices for a vendor where that vendor has one user for all of the invoices it submitted, because, in an embodiment, if multiple people deal with a vendor, it may be more difficult to cover up fraudulent activity. If a vendor's invoices are only created or approved by one person, it is riskier than if a vendor has exposure to various users. If an invoice for a vendor that only has one user for all of its invoices is detected, flag the transaction for this analytic.

Upon invoice creation, identify invoices for a single vendor that are sequentially numbered, or payments to a vendor that have no other customers, or vendors that have a name that consists only of initials, or that is very short, e.g., four or fewer characters). A more generic sounding vendor could provide almost any type of product or service and may be harder to track. If a vendor name is particularly short or contains just initials, flag the transaction for this analytic.

Referring now to FIG. 4B, in an embodiment, daybreak architecture 3100 may receive a signal that offboarding has been requested and approved 450. In an embodiment, daybreak architecture now may communicate with the underlying bank 480 of the offboarding entity and/or the bank associated with the attributable account. In an embodiment, an XML file is generated 455, and transmitted to the bank 460. The XML file may include instructions for the bank to take certain actions, e.g., execute an ACH. In an embodiment, the XML file may be made according to the bank's standard or specification, or a national/group/consortium specification, e.g., Open Financial Exchange (OFX) XML Schema, Interactive Financial Exchange (IFX), and the like.

### Electronic Systems and Methods for Employing Digital Currency

In an embodiment, one hurdle faced by charitable organizations and for-profit organizations (e.g., private business), when such organizations distribute funds is the diversion of monetary funds and resources from reaching their intended targets/recipients. The diversion of funds and/or resources may be as a result of many factors including, for example, corruption, incompetence, and so forth. Of course, such problems are not limited to charitable and commercial interests but may also be faced by private individuals. For example, parents often give their children money for specific purposes (e.g., education, athletic gear, food, etc.). However, it is not uncommon for children, upon receiving funds from their parents, use the money for other purposes (e.g., drugs, movies, clothes, etc.). This type of problem can also arise in trust/beneficiary situations where a beneficiary spends money intended for use in education for drugs.

Accordingly, in an embodiment, systems and methods are included that allow for tracking and/or tracing of funds, e.g., attributable funds, e.g., digital currency, to and from various entities, e.g., so that one may determine how, what, who, and/or when one or more units of attributable funds (e.g., digital currency) are spent and or used. For example, in an embodiment, a source entity (e.g., a charity, a business organization, a parent, a citizen investor, etc.) to determine whether the funds (e.g., attributable funds, e.g., digital currency) provided by them are actually being spent for their intended purposes and/or whether the funds are actually reaching the intended recipients (e.g., a villager or a farmer in a third world country). In some embodiments, this may be accomplished by employing a digital currency that has memory, either through storage of the digital currency itself or through transmissions of the digital currency within a framework, e.g., the Daybreak architecture. In an embodiment, the digital currency, either separately or within the architecture, may record, among other things, who, when, how, and/or upon what the digital currency was used, e.g., for the exchange of goods and/or services.

In various embodiments, the systems and methods may be implemented using one or more network devices (e.g., one or more servers, workstations, mass storage, etc.). In one or more embodiment, the systems and methods may be implemented as one or more electronic payment systems, e.g., which may be linked, e.g., through the Daybreak architecture. The Daybreak architecture, in one or more embodiments, may be implemented using dedicated circuitry such as an ASIC, or in programmable circuitry (e.g., one or more processors, FPGAs, etc.) executing machine readable instructions (e.g., software).

In an implementation, a computationally-implemented method implemented by a network computer system may include receiving a request, e.g., at a device, e.g., accepting input, that regards an attributable account, e.g., to reassign one or more units of a digital currency, e.g., attributable funds, from a first pseudo-identity (e.g., a representation and/or an account or other structure associated with an entity within the Daybreak architecture). The request may be a request for transaction data indicating a first transmission of particular funds (e.g., units of digital currency) from a first downstream entity to a second downstream entity (e.g., a first entity, or a first pseudo-identity of a first entity). The request may include a further request for second transaction data indicating a second transmission of particular funds (e.g., units of digital currency) from the second downstream entity (e.g., a first entity, or a first pseudo-identity of a first entity), to the third downstream entity (e.g., the second entity or the second pseudo-identity of the second entity.

### FIG. 5 Implementation

Referring now to FIG. 5A, FIG. 5A shows processor 251, according to various embodiments. Specifically, FIG. 5A shows that, in an embodiment, an at least one input acceptance machine having state set at least in part by switch-state logic, may be specified to establish at least one input acceptance machine state 502, which may be implemented as at least one input acceptance machine state defined by at least one machine state of at least one first-party-associated device triggered by detection of at least one machine-state pecuniary flag vector 502. In an embodiment, an at least one input acceptance machine 252 may be specified to establish at least one input acceptance machine state defined by at least one machine state of at least one first-party-associated device triggered by detection of at least one machine-state pecuniary flag vector 502 for at least one of an electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account 504. For example, at least one input acceptance machine state (e.g., a machine state of a cell phone device that is multiple transistors ordered on a Snapdragon mobile chip) defined by at least one machine state of at least one first-party-associated device (e.g., a cellular telephone in the hands of a philanthropist/user) triggered by detection of at least one machine-state pecuniary flag vector (e.g., an engineering approximation/electronic representation of the human experience that the user has inputted a command to the device to perform some action related to the attributable account, e.g., display some detail, view the status, update the distribution rule set, etc.). It is noted that the distribution rule set may be changed by the user, alone or in concert with other entities, depending on the needs of the user, and on other factors (e.g., the use of the funds in the attributable account, the conditions in the area to which the attributable funds are to be applied).

In an embodiment, at least one input acceptance machine state defined by at least one machine state of at least one first-party-associated device triggered by detection of at least one machine-state pecuniary flag vector 502 for at least one of electrical/magnetic/physical storage (e.g., nonvolatile memory) of at least one original machine state associated with a command (e.g., “display the account balance in the attributable account”) directed to an engineering approximation of an attributable account (e.g., the engineering approximation on the device 220 that corresponds to the attributable account details associated with the daybreak architecture 3100, e.g., which in an embodiment may be received at least in part from the daybreak architecture, e.g., in preparation for responding to the user's inputted command) contains attributable funds (e.g., funds in an account that are subject to a distribution rule set) and that is configured to interface with one or more financial entities (e.g., the attributable funds may be distributed to one or more entities, e.g., financial entities, e.g., banks, governmental organizations, contractors, laborers, service providers, goods providers, and the like).

Referring again to FIG. 5A, processor 251 may include at least one input acceptance machine state defined by at least one machine state of at least one first-party-associated device triggered by detection of at least one machine-state pecuniary flag vector 502. Specifically, FIG. 5A shows that, in an embodiment, an at least one input acceptance machine having state set at least in part by switch-state logic, may be specified to establish at least one input acceptance machine state 502, which may be at least one input acceptance machine state defined by at least one machine state of at least one first-party-associated device triggered by detection of at least one machine-state pecuniary flag vector. In an embodiment, at least one input acceptance machine state defined by at least one machine state of at least one first-party-associated device triggered by detection of at least one machine-state pecuniary flag vector 502 may include at least one of at least one first-party-associated device machine state (e.g., a state indicating that data has been stored at a particular location) that includes at least one accepted command (e.g., “show me how many transactions have been denied because they violated a specific portion of the distribution rule set”) directed to the engineering approximation of the attributable account (e.g., the engineering approximation on the device 220 that corresponds to the attributable account details associated with the daybreak architecture 3100, e.g., which in an embodiment may be received at least in part from the daybreak architecture).

Referring again to FIG. 5A, in an embodiment, there may be two-way communication between first party machine 220 (not pictured) and daybreak architecture 3100, which may receive a command directed to the account that is received from the first party machine, and then applied to the attributable account 3030, for example. In an embodiment, daybreak architecture 3100 may supply information about the account that allows formation of, e.g., the engineering approximation of an attributable account.

Referring now to FIG. 5B, FIG. 5B shows one or more implementations of processor 251. As previously described, processor 251 may include at least one input acceptance machine 252. In an embodiment, at least one input acceptance machine 252 may be specified to establish at least one input acceptance machine state defined by at least one machine state of at least one first-party-associated device triggered by detection of at least one machine-state pecuniary flag vector 502 for at least one of an electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account 504. In an embodiment, processor 251 may include an engineering approximation of an attributable account 259.

Referring again to FIG. 5B, in an embodiment, an engineering approximation of the attributable account 259 may include 257. For example, the engineering approximation of an attributable account 259 may include an attributable account definition machine state defined at least partly based on an engineering approximation of the distribution rule set that specifies one or more conditions (e.g., one or a set of machine states that specifies the distribution rule set, e.g., “transactions must be under 100,000 dollars,” or “transactions may only be conducted with trusted parties,” or “transactions may not be carried out on holiday weekends,” or “the specific known bad actors may not be included as a recipient of funds in any transactions” associated with said attributable funds (e.g., the funds for which the distribution rule set is implemented).

Referring again to FIG. 5B, in an embodiment, the engineering approximation of an attributable account 259 may include. For example, in an embodiment, engineering approximation of an attributable account 259 may include an attributable account adjustment machine state defined at least partly based on an engineering approximation of an adjustment (e.g., a withdrawal or a deposit) to be applied to the attributable funds (e.g., the funds that are tracked in the project daybreak architecture 3100) of the attributable account (e.g., account 3030).

Referring now to FIG. 5C, in an embodiment, FIG. 5C shows one or more implementations of the at least one input acceptance machine 252. In an embodiment, at least one input acceptance machine 252 may include at least one input acceptance machine having state set at least in part by switch-state logic 535. The at least one input acceptance machine having state set at least in part by switch-state logic 535 may include an input-processing-and-acceptance-circuit 537. The input-processing-and-acceptance-circuit 537, as shown in FIG. 5C, may be configured to transition to at last one voltage which an integrated circuit data sheet equates to LOGIC TRUE when the conditions shown with dotted lines in FIG. 5C are met, that is the condition of one or more voltages forming an engineering approximation of a particular input acceptance machine state that includes at least one of a first party input coordinatable with the at least one machine-state pecuniary flag vector encoded as at least one machine state 537A constitutes an engineering equivalent of one or more voltages forming an engineering approximation of the electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account 537B. It is noted that although FIG. 5C shows implementations of circuits that are part of machines that are part of the processor 251, FIG. 5C also shows the conditions that allow a particular circuit to evaluate to logic-true, which allows processing, e.g., the creation of other circuits within processor 251, to continue.

Referring now to FIG. 5D, in an embodiment, FIG. 5D shows one or more implementations of the at least one input acceptance machine state 502 according to various embodiments. For example, as shown in FIG. 5D, the at least one input acceptance machine state defined by at least one machine state of at least one first-party-associated device triggered by detection of at least one machine-state pecuniary flag vector 502 may be implemented at least in part as a switched circuit having one or more switched states set at least in part by switch-state logic of the at least one first-party-associated device and triggered by detection of the at least one machine-state pecuniary flag vector 530. For example, the at least one input acceptance machine state defined by at least one machine state of at least one first-party-associated device triggered by detection of at least one machine-state pecuniary flag vector 502 may be implemented at least in part as a switched circuit (e.g., a circuit that uses one or more hardware elements, e.g., transistors, to implement so-called “switches,” which in an embodiment, are binary representations that can be chained together to represent complex expressions) having one or more switched states (e.g., a state of one or more hardware elements based on the binary states of many switches, e.g., which may be implemented as transistors on a computer chip) set at last in part by switch state logic (e.g., logic that specifies how the transistors are to act, with simple logic building blocks to form complex logical chains, e.g., which may be so vast as to be beyond simple human comprehension) specified to order as the machine state of at least one first-party-associated device (e.g., a wearable computer, e.g., an Apple watch that is configured to display push-notifications regarding the attributable account and particular status changes, e.g., in an embodiment, a push-notification is sent each time an amount over a certain threshold value is transferred and/or offboarded) triggers by detection of at least one machine-state pecuniary flag vector (e.g., a machine representation that indicates something about the attributable account, e.g., that a user has requested data about the attributable account or is issuing a command or function to the attributable account).

Referring again to FIG. 5C, in an embodiment, the switched circuit having one or more switched states set at least in part by switch-state logic of the at least one first-party-associated device and triggered by detection of the at least one machine-state pecuniary flag vector 530 may be implemented as a transistorized circuit having one or more transistor states set at least in part by special purpose circuitry of the at least one first-party-associated device and triggered by detection of the at least one machine-state pecuniary flag vector 532. For example, in an embodiment, the switched circuit having one or more switched states set at least in part by switch-state logic of the at least one first-party-associated device and triggered by detection of the at least one machine-state pecuniary flag vector 530 may be implemented as the transistorized circuit having one or more transistor states set at least in part by special purpose circuitry of the at least one first-party-associated device and triggered by detection of the at least one machine-state pecuniary flag vector that is a machine representation of a change in a real-world state (e.g., money has been withdrawn, offboarded, or moved around within the daybreak architecture 3100, or a status of one of the rules of the distribution rule set has changed) of the attributable account (e.g., an account established by a non-philanthropist that is a construction contractor) 532.

Referring again to FIG. 5C, in an embodiment, the transistorized circuit having one or more transistor states set at least in part by special purpose circuitry of the at least one first-party-associated device and triggered by detection of the at least one machine-state pecuniary flag vector 532 may be implemented as a transistorized circuit having one or more transistor states set at least in part by special purpose logical circuitry specified at least in part by at least one computer program compatible with at least one operating system, the at least one computer program at least partially operably linked to the at least one first-party-associated device and triggered by detection of the at least one machine-state pecuniary flag vector 534. For example, in an embodiment, the transistorized circuit having one or more transistor states set at least in part by special purpose circuitry of the at least one first-party-associated device and triggered by detection of the at least one machine-state pecuniary flag vector 532 may be implemented as a transistorized circuit having one or more transistor states set at least in part by special purpose logical circuitry logic specified at least in part by at least one computer program (e.g., an account management computer program, e.g., a standalone application, or an add-in to an existing management program, e.g., QuickBooks) compatible with at least one operating system (e.g., Windows, Apple iOS, Google Android, Linux, etc.), the at least one computer program at least partially operably linked (e.g., the computer program receives data and/or commands and/or configuration and/or user data and/or user profiles and/or instructions) to the at least one first-party-associated device and triggered by detection of the at least one machine-state pecuniary flag vector (e.g., a machine representation of a change in a real-world state of the attributable account (e.g., the funds in the account have dropped below a certain value), wherein the attributable account is a managed account including more than one representation of attributable funds (e.g., the attributable account includes attributable funds from multiple discrete account holders, e.g., user 100).

Referring now to FIG. 5E, in an embodiment, FIG. 5E shows one or more implementations of the at least one input acceptance machine 252 and the at least one input acceptance machine state defined by at least one machine state of at least one first-party-associated device triggered by detection of at least one machine-state pecuniary flag vector 502 according to various embodiments. For example, in an embodiment, transistorized circuit 534 may be implemented as a transistorized circuit having one or more transistor states set at least in part by special purpose logical circuitry specified at least in part by at least one computer program compatible with at least one cloud-based or cloud-affiliated operating system 540. As an exemplary implementation, transistorized circuit 540 may be implemented as a transistorized circuit having one or more transistor states set at least in part by special purpose logical circuitry specified at least in part by at least one computer program compatible with at least one cloud-based or cloud-affiliated operating system (e.g., (e.g., Microsoft Azure, VMware vCloud, Amazon Cloud EC2, Google App Engine, etc.).

Referring again to FIG. 5E, in an embodiment, FIG. 5E shows one or more implementations of the at least one input acceptance machine 252 and the at least one input acceptance machine state defined by at least one machine state of at least one first-party-associated device triggered by detection of at least one machine-state pecuniary flag vector 502 according to various embodiments. For example, in an embodiment, transistorized circuit 534 may be implemented as a transistorized circuit having one or more transistor states set at least in part by special purpose logical circuitry specified at least in part by at least one computer program compatible with at least one desktop operating system 542. As an exemplary implementation, transistorized circuit having one or more transistor states set at least in part by special purpose logical circuitry specified at least in part by at least one computer program compatible with at least one desktop operating system 542 may be implemented as transistorized circuit having one or more transistor states set at least in part by special purpose logical circuitry specified at least in part by at least one computer program compatible with at least one desktop operating system (e.g., Microsoft Windows, Linux, Apple OSX, Google ChromeOS, etc.).

Referring again to FIG. 5E, in an embodiment, transistorized circuit 534 may be implemented as transistorized circuit having one or more transistor states set at least in part by special purpose logical circuitry specified at least in part by at least one computer program compatible with at least one mobile operating system 544. For example, as an exemplary implementation, transistorized circuit having one or more transistor states set at least in part by special purpose logical circuitry specified at least in part by at least one computer program compatible with at least one mobile operating system 544 may be implemented as transistorized circuit having one or more transistor states set at least in part by special purpose logical circuitry specified at least in part by at least one computer program compatible with at least one mobile operating system (e.g., Apple iOS, Google Android, Windows Phone 10, Palm OS).

Referring again to FIG. 5E, in an embodiment, transistorized circuit 534 may be implemented as transistorized circuit having one or more transistor states set at least in part by special purpose logical circuitry specified at least in part by at least one computer program compatible with at least one mainframe and/or server operating system 546. For example, as an exemplary implementation, transistorized circuit having one or more transistor states set at least in part by special purpose logical circuitry specified at least in part by at least one computer program compatible with at least one mainframe and/or server operating system 546 may be implemented as a transistorized circuit having one or more transistor states set at least in part by special purpose logical circuitry specified at least in part by at least one computer program compatible with at least one mainframe and/or server operating system (e.g., operating systems used by mainframes of IBM, Hitachi, Hewlett-Packard, Fujitsu, Siemens, Group Boulle, NEC, IBM's z/OS and Parallel Sysplex, or Unisys' XPCL.).

Referring now to FIG. 5F, FIG. 5F shows various embodiments of at least one input acceptance machine state 502 including transistorized circuit 534, according to embodiments. For example, in an embodiment, transistorized circuit 534 may be implemented as transistorized circuit having one or more transistor states set at least in part by special purpose logical circuitry specified at least in part by at least one computer program compatible with at least one virtual machine 548. For example, as an exemplary implementation, transistorized circuit having one or more transistor states set at least in part by special purpose logical circuitry specified at least in part by at least one computer program compatible with at least one virtual machine 548 may be implemented as transistorized circuit having one or more transistor states set at least in part by special purpose logical circuitry specified at least in part by at least one computer program compatible with at least one virtual machine (e.g., Java Virtual Machine, VMware, Google Dalvik Machine, Windows Hyper-V).

Referring again to FIG. 5F, in an embodiment, transistorized circuit 534 may be implemented as transistorized circuit having one or more transistor states set at least in part by special purpose logical circuitry specified at least in part by at least one computer program compatible with at least one virtualization manager 550. For example, as an exemplary implementation, transistorized circuit having one or more transistor states set at least in part by special purpose logical circuitry specified at least in part by at least one computer program compatible with at least one virtualization manager 550 may be implemented as transistorized circuit having one or more transistor states set at least in part by special purpose logical circuitry specified at least in part by at least one computer program compatible with at least one virtualization manager (e.g., Microsoft Hyper-V, Citrix Xen, etc.).

Referring again to FIG. 5F, in an embodiment, transistorized circuit 534 may be implemented as transistorized circuit having one or more transistor states set at least in part by special purpose logical circuitry specified at least in part by at least one computer program supplied by the particular architecture 552. For example, in an exemplary implementation, transistorized circuit having one or more transistor states set at least in part by special purpose logical circuitry specified at least in part by at least one computer program supplied by the particular architecture 552 may be implemented as transistorized circuit having one or more transistor states set at least in part by special purpose logical circuitry specified at least in part by at least one computer program supplied by the particular architecture (e.g., the Daybreak architecture may have an application associated with accessing the Daybreak architecture that may be loaded on various devices, e.g., phones, tablets, computers).

Referring now to FIG. 5G, FIG. 5G shows various implementations of switched circuit having one or more switched states set at least in part by switch-state logic of the at least one first-party-associated device and triggered by detection of the at least one machine-state pecuniary flag vector 530. For example, in an embodiment, switched circuit having one or more switched states set at least in part by switch-state logic of the at least one first-party-associated device and triggered by detection of the at least one machine-state pecuniary flag vector 530 may include transistorized circuit having one or more transistor states set at least in part by special purpose logical circuitry specified at least in part by at least one computer program licensed, purchased, and/or leased from a second party independent from the first party associated with the first-party-associated device 560. For example, in an exemplary implementation, transistorized circuit 560 may include a transistorized circuit having one or more transistor states set at least in part by special purpose logical circuitry specified at least in part by at least one computer program licensed, purchased, and/or leased from a second party (e.g., an operating system manufacturer, an application manufacturer, etc.) independent from the first party associated with the first-party-associated device (e.g., an Apple iPhone).

Referring again to FIG. 5G, in an embodiment, transistorized circuit 560 may include transistorized circuit having one or more transistor states set at least in part by special purpose logical circuitry specified at least in part by at least one of browser-computer-program licensed, purchased, and/or leased from a second-party independent from the first-party 562. For example, in an exemplary implementation, transistorized circuit 562 may be implemented as a transistorized circuit having one or more transistor states set at least in part by special purpose logical circuitry specified at least in part by at least one of browser-computer-program (e.g., Mozilla Firefox, Windows Internet Explorer, Apple Safari, Google Chrome, Opera) licensed, purchased, and/or leased from a second-party independent from the first-party.

Referring again to FIG. 5G, in an embodiment, transistorized circuit 562 may include transistorized circuit having one or more transistor states set at least in part by special purpose logical circuitry specified at least in part by at least one of Google Chrome, Internet Explorer, Mozilla Firefox, and/or Apple Safari licensed, purchased, and/or leased from a second-party independent from the first-party 564. For example, in an exemplary implementation, transistorized circuit 564 may be implemented as a transistorized circuit having one or more transistor states set at least in part by special purpose logical circuitry specified at least in part by at least one of Google Chrome, Internet Explorer, Mozilla Firefox, and/or Apple Safari licensed, purchased, and/or leased from a second-party independent from the first-party.

Referring again to FIG. 5G, in an embodiment, transistorized circuit 560 may be include transistorized circuit having one or more transistor states set at least in part by special purpose logical circuitry specified at least in part by at least one of work-productivity-suite-program licensed, purchased, and/or leased from a second-party independent from the first-party 566. For example, in an exemplary implementation, transistorized circuit 566 may be implemented as transistorized circuit having one or more transistor states set at least in part by special purpose logical circuitry specified at least in part by at least one of a work-productivity-suite-program (e.g., OpenOffice, Apple iWork, Corel WordPerfect, Adobe Photoshop) licensed, purchased, and/or leased from a second-party independent from the first-party (e.g., the party associated with the device).

Referring again to FIG. 5G, in an embodiment, transistorized circuit 566 may include transistorized circuit having one or more transistor states set at least in part by special purpose logical circuitry specified at least in part by at least one of Google Apps, Microsoft Office, and/or Apple iWork licensed, purchased, and/or leased from a second-party independent from the first-party 568. For example, in an exemplary implementation, transistorized circuit 568 may be implemented as transistorized circuit having one or more transistor states set at least in part by special purpose logical circuitry specified at least in part by at least one of Google Apps, Microsoft Office, and/or Apple iWork licensed, purchased, and/or leased from a second-party independent from the first-party.

Referring now to FIG. 5H, in an embodiment, transistorized circuit 560 may be include transistorized circuit having one or more transistor states set at least in part by special purpose logical circuitry specified at least in part by at least one of a spreadsheet computer program licensed, purchased, and/or leased from a second-party independent from the first-party 570. For example, in an exemplary implementation, transistorized circuit 570 may be implemented as transistorized circuit having one or more transistor states set at least in part by special purpose logical circuitry specified at least in part by at least one of a spreadsheet (e.g., Lotus 1-2-3, OpenOffice, Google Docs, Gnumeric, KSpread, LibreOffice Calc) computer program licensed, purchased, and/or leased from a second-party independent from the first-party.

Referring again to FIG. 5H, in an embodiment, transistorized circuit 570 may include transistorized circuit having one or more transistor states set at least in part by special purpose logical circuitry specified at least in part by at least one of Microsoft Excel, Intuit QuickBooks/Quicken, and/or Apple Numbers, licensed, purchased, and/or leased from a second-party independent from the first-party 572. For example, in an exemplary implementation, transistorized circuit 572 may be implemented as a ransistorized circuit having one or more transistor states set at least in part by special purpose logical circuitry specified at least in part by at least one of Microsoft Excel, Intuit QuickBooks/Quicken, and/or Apple Numbers, licensed, purchased, and/or leased from a second-party independent from the first-party

Referring again to FIG. 5H, in an embodiment, transistorized circuit 560 may include transistorized circuit having one or more transistor states set at least in part by special purpose logical circuitry specified at least in part by at least one of a social networking computer program licensed, purchased, and/or leased from a second-party independent from the first-party 574. For example, transistorized circuit 574 may, in an exemplary embodiment, be implemented as transistorized circuit having one or more transistor states set at least in part by special purpose logical circuitry specified at least in part by at least one of a social networking computer program (e.g., Facebook, MySpace, Instagram, Twitter, FourSquare, Bumble, Tinder, SnapChat) licensed, purchased, and/or leased from a second-party independent from the first-party

Referring now to FIG. 5I, FIG. 5I shows, in an embodiment, transistorized circuit 574 may include transistorized circuit having one or more transistor states set at least in part by special purpose logical circuitry specified at least in part by at least one of messaging/photo-mobile-operating-system-compatible-computer-program purchased, and/or leased from a second-party independent from the first-party 576. For example, in an embodiment, transistorized circuit 576 may be implemented as transistorized circuit having one or more transistor states set at least in part by special purpose logical circuitry specified at least in part by at least one of messaging/photo-mobile-operating-system-compatible-computer-program (e.g., WhatsApp, SnapChat, Instagram, Twitter) purchased, and/or leased from a second-party independent from the first-party.

Referring again to FIG. 5I, in an embodiment, transistorized circuit 576 may include transistorized circuit having one or more transistor states set at least in part by special purpose logical circuitry specified at least in part by at least one of Signal, WhatsApp, SnapChat, Instagram, gChat, and Instant Messenger 578. For example, in an implementation, transistorized circuit 576 may be implemented as transistorized circuit having one or more transistor states set at least in part by special purpose logical circuitry specified at least in part by at least one of Signal, WhatsApp, SnapChat, Instagram, gChat, and Instant Messenger.

Referring again to FIG. 5I, in an embodiment, transistorized circuit 574 may include transistorized circuit having one or more transistor states set at least in part by special purpose logical circuitry specified at least in part by a real-time social-networking integrated computer-program purchased, and/or leased from a second-party independent from the first-party 580. For example, in an exemplary implementation, transistorized circuit 580 may be implemented as a transistorized circuit having one or more transistor states set at least in part by special purpose logical circuitry specified at least in part by a real-time social-networking (e.g., YikYak, SnapChat, Kik, Burn Note) integrated computer-program purchased, and/or leased from a second-party independent from the first-party.

Referring again to FIG. 5I, in an embodiment, transistorized circuit 574 may include transistorized circuit having one or more transistor states set at least in part by special purpose logical circuitry specified at least in part by a social-microblogging integrated computer-program purchased, and/or leased from a second-party independent from the first-party 582. For example, in an embodiment, transistorized circuit 582 may be implemented as transistorized circuit having one or more transistor states set at least in part by special purpose logical circuitry specified at least in part by a social-microblogging (e.g., Twitter, Instagram) integrated computer-program purchased, and/or leased from a second-party independent from the first-party.

Referring now to FIG. 5J, in an embodiment, transistorized circuit 560 may include transistorized circuit having one or more transistor states set at least in part by special purpose logical circuitry specified at least in part by at least one of a program configured to communicate with the particular architecture that is independent from the first party 584. For example, in an embodiment, transistorized circuit 560 may be implemented as a transistorized circuit having one or more transistor states set at least in part by special purpose logical circuitry specified at least in part by at least one of a program configured to communicate with the particular architecture (e.g., the daybreak architecture, e.g., as shown in FIGS. 2E-2I) that is independent from the first party (e.g., the user associated with the device).

Referring again to FIG. 5J, in an embodiment, transistorized circuit 584 may include transistorized circuit having one or more transistor states set at least in part by special purpose logical circuitry specified at least in part by at least one of a program configured to communicate with the particular architecture that is independent from the first party through sending configuration signals to the engineering approximation of the attributable account 586. For example, in an embodiment, transistorized circuit 586 may be implemented as a transistorized circuit having one or more transistor states set at least in part by special purpose logical circuitry specified at least in part by at least one of a program configured to communicate with the particular architecture (e.g., the Daybreak architecture) that is independent from the first party through sending configuration signals (e.g., signals that change a state of the various accounts associated with the Daybreak architecture, e.g., signals to move funds from one account to another, to audit compliance with the rule set architecture, to provide a transaction history, etc.) to the engineering approximation of the attributable account (e.g., the account associated with the user that is operating the first party device).

Referring again to FIG. 5J, in an embodiment, transistorized circuit 584 may include transistorized circuit having one or more transistor states set at least in part by special purpose logical circuitry specified at least in part by special purpose logical circuitry configured by machine instructions received from the machine configured to communicate with the particular architecture that is independent from the first party 588. For example, in an embodiment, transistorized circuit 588 may be implemented as a transistorized circuit having one or more transistor states set at least in part by special purpose logical circuitry specified at least in part by at least one of a program configured to communicate with the particular architecture (e.g., the Daybreak architecture) that is independent from the first party through sending machine instructions (e.g., signals that change a state of the various accounts associated with the Daybreak architecture, e.g., signals to move funds from one account to another, to audit compliance with the rule set architecture, to provide a transaction history, etc.) received from the machine (e.g., the circuitry inside the processor that is specified by the program running on the first party device) that is configured to communicate with the particular architecture (e.g., the Daybreak architecture), to the engineering approximation of the attributable account (e.g., the account associated with the user that is operating the first party device).

Referring now to FIG. 6, e.g., FIG. 6A, FIG. 6A shows processor 251, and at least one input acceptance machine 252, according to various embodiments. Specifically, FIG. 6 shows that, in an embodiment, at least one input acceptance machine 252 may be specified to establish at least one input acceptance machine state defined by at least one machine state of at least one first-party-associated device triggered by detection of at least one machine-state pecuniary flag vector 502. The input acceptance machine state 502 may be triggered by detection of at least one machine-state pecuniary flag vector for at least one of a an electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account 605, as shown in FIG. 6A.

Referring again to FIG. 6A, in an embodiment, electrical/magnetic/physical storage of at least one original machine state 605 may be associated with a command 501 that is directed to an account 3030 within the particular architecture, e.g., the Daybreak Architecture, e.g., as shown in FIG. 6A. Specific examples of commands will be discussed in more detail herein with reference to FIGS. 6B-6F.

Referring now to FIG. 6B, in an embodiment, electrical/magnetic/physical storage of at least one original machine state 605 may, in various embodiments, include a switched circuit having one or more switched states set at least in part by switch state logic specified to process the command directed to the engineering approximation of the attributable account that contains attributable funds and that is configured to interact with one or more financial entity machine states 610. For example, in an embodiment, switched circuit 610 may be implemented as a switched circuit having one or more switched states set at least in part by switch state logic specified to process the command directed to the engineering approximation of the attributable account that contains attributable funds and that is configured to interact with one or more financial entity machine states (e.g., machine states that represent accounts of entities, e.g., financial entities, e.g., which may have a value, e.g., the value specified by a property of the daybreak architecture account).

Referring again to FIG. 6B, in an embodiment, switched circuit 610 may be implemented as transistorized circuit having one or more transistor states set at least in part by special purpose logical circuitry that represents the command directed to the engineering approximation of the attributable account that contains attributable funds and that is configured to interact with one or more financial entity machine states 612. For example, as shown in FIG. 6B, transistorized circuit 612 may be implemented as transistorized circuit having one or more transistor states set at least in part by special purpose logical circuitry that represents the command directed to the engineering approximation of the attributable account that contains attributable funds and that is configured to interact with one or more financial entity machine states (e.g., account representations within the Daybreak architecture).

Referring again to FIG. 6B, in an embodiment, transistorized circuit 612 may be implemented as transistorized circuit having one or more transistor states set at least in part by special purpose logical circuitry specified at least in part by an application 614. In an embodiment, transistorized circuit having one or more transistor states set at least in part by special purpose logical circuitry specified at least in part by an application 614 may be configured to process at least one command directed to the engineering approximation of the attributable account that contains attributable funds and that is configured to interact with one or more financial entity machine states 616.

Referring again to FIG. 6B, in an embodiment, a command directed to the engineering approximation of the attributable account that contains attributable funds and that is configured to interact with one or more financial entity machine states 616 may be implemented in various formats. For example, as shown in FIG. 6B, command directed to the engineering approximation of the attributable account that contains attributable funds and that is configured to interact with one or more financial entity machine states 616 may include a request for configuration of presentation hardware to present a transaction history of the attributable account that contains the attributable funds and that is configured to interact with one or more financial entity machine states 618.

Referring again to FIG. 6B, in an embodiment, the request for configuration of presentation hardware to present a transaction history of the attributable account that contains the attributable funds and that is configured to interact with one or more financial entity machine states 618 may include a request for configuration of presentation hardware that to present a list of the last five transactions associated with the attributable account that contains the attributable funds and that is configured to interact with one or more financial entity machine states 620. For example, in an implementation, request for configuration of presentation hardware 620 may be implemented as a request for configuration of presentation hardware that to present a list of the last five transactions associated with the attributable account that contains the attributable funds and that is configured to interact with one or more financial entity machine states.

Referring again to FIG. 6B, in an embodiment, request for configuration of presentation hardware to present a transaction history of the attributable account that contains the attributable funds and that is configured to interact with one or more financial entity machine states 618 may include a request for configuration presentation hardware to present a list of the last five transactions associated with the attributable account that took place within the particular architecture that manages the attributable funds and that is configured to interact with one or more financial entity machine states 622. For example, in an implementation, request for configuration of presentation hardware 620 may be implemented as request for configuration of presentation hardware that to present a list of the last five transactions associated with the attributable account that contains the attributable funds and that is configured to interact with one or more financial entity machine states.

Referring now to FIG. 6C, in an embodiment, FIG. 6C shows further implementations of request for configuration of presentation hardware to present a transaction history of the attributable account that contains the attributable funds and that is configured to interact with one or more financial entity machine states 618. For example, in an embodiment, request for configuration of presentation hardware 618 may include request for configuration presentation hardware to present a list of the last five transactions associated with the attributable account that took place within the particular architecture that manages the attributable funds and that is configured to interact with one or more financial entity machine states. For example, in an implementation, request for configuration of presentation hardware 624 may be implemented as request for configuration presentation hardware to present a list of the last five transactions associated with the attributable account that took place within the particular architecture that manages the attributable funds and that is configured to interact with one or more financial entity machine states.

Referring again to FIG. 6C, in an embodiment, request for configuration of presentation hardware to present a transaction history of the attributable account that contains the attributable funds and that is configured to interact with one or more financial entity machine states 618 may include request for configuration presentation hardware to present a list of the last five transactions associated with the attributable account that represent offboarding of funds to outside control of the particular architecture that manages the attributable funds and that is configured to interact with one or more financial entity machine states 626. For example, in an implementation, request for configuration of presentation hardware 626 may be implemented as request for configuration presentation hardware to present a list of the last five transactions associated with the attributable account that represent offboarding of funds to outside control of the particular architecture that manages the attributable funds and that is configured to interact with one or more financial entity machine states.

Referring now to FIG. 6D, in an embodiment, request for configuration of presentation hardware to present a transaction history of the attributable account that contains the attributable funds and that is configured to interact with one or more financial entity machine states 618 may include request for configuration presentation hardware to present a distribution map of the attributable funds between the first downstream entity, the second downstream entity, and the third downstream entity 628.

Referring again to FIG. 6D, in an embodiment, request for configuration of presentation hardware to present a transaction history of the attributable account that contains the attributable funds and that is configured to interact with one or more financial entity machine states 618 may include request for configuration presentation hardware to present a real time or near-real time view of the attributable funds within the particular architecture 630.

Referring now to FIG. 6E, in an embodiment, FIG. 6E shows various implementations of electrical/magnetic/physical storage of at least one original machine state associated with a command directed to an engineering approximation of an attributable account that contains attributable funds and that is configured to interact with one or more financial entity machine states 605, according to various embodiments. For example, in an embodiment, electrical/magnetic/physical storage of at least one original machine state 605 may include a switched circuit having one or more switched states set at least in part by switch state logic specified to process the command directed to the engineering approximation of the attributable account that contains attributable funds and that is configured to interact with one or more financial entity machine states 650. In an embodiment, switched circuit 650 may be implemented such that wherein said engineering approximation of said attributable account is at least partly based on a switched circuit having one or more switched states that define the distribution rule set that specifies one or more conditions associated with said attributable funds of said attributable account 660.

Referring again to FIG. 6E, in an embodiment, switched circuit 660 may be implemented as a switched circuit having one or more switched states that retrieve the distribution rule set from a remote location associated with the particular architecture 662. For example, switched circuit 662 may be implemented as a switched circuit having one or more switched states that retrieve the distribution rule set (e.g., a rule set that allows for implementation of fraud detection using a vendor rating system) from a remote location (e.g., a server farm which implemented the architecture) associated with the particular architecture (e.g., the Daybreak architecture).

Referring again to FIG. 6E, in an embodiment, switched circuit 662 may be implemented as switched circuit having one or more switched states that retrieve one or more rules of the distribution rule set from the remote location associated with the particular architecture 664. For example, in an embodiment, switched circuit 664 may be implemented as a switched circuit having one or more switched states that retrieve one or more rules of the distribution rule set (e.g., transactions are forbidden on weekends after 5 pm with vendors that have fewer than four letters in their name) from the remote location (e.g., the server bank that stores the Daybreak architecture) associated with the particular architecture.

Referring again to FIG. 6E, in an embodiment, switched circuit 662 may be implemented as a switched circuit having one or more switched states that retrieve one or more rules of the distribution rule set from a server device associated with the particular architecture 666. For example, in an embodiment, switched circuit 666 may be implemented as switched circuit having one or more switched states that retrieve one or more rules of the distribution rule set from a server device associated with the particular architecture.

Referring again to FIG. 6E, in an embodiment, switched circuit 660 may be implemented as switched circuit having one or more switched states associated with the distribution rule set that is stored at a remote server device associated with the particular architecture and that specifies one or more conditions associated with said attributable funds of said attributable account 668. For example, in an embodiment, switched circuit 668 may be implemented as switched circuit having one or more switched states associated with the distribution rule set that is stored at a remote server device associated with the particular architecture and that specifies one or more conditions associated with said attributable funds of said attributable account (e.g., the funds must be spent with a particular percentage used for medical goods, food, plants, etc.).

Referring again to FIG. 6E, in an embodiment, switched circuit 668 may be implemented as a switched circuit having one or more switched states associated with the distribution rule set that links metadata to the account and to one or more transactions associated with the account 670. For example, in an embodiment, switched circuit 670 may be implemented as a switched circuit having one or more switched states associated with the distribution rule set that links metadata (e.g., pictoral evidence of the transaction taking place) to the account and to one or more transactions associated with the account.

Referring now to FIG. 6F, FIG. 6F shows various implementations of switched circuit 668, which is itself an implementation switched circuit 660 on which switched circuit 650 includes an engineering approximation of the attributable account based on switched circuit 668. For example, in an embodiment, switched circuit 668 may be implemented as switched circuit having one or more switched states associated with the distribution rule set that links identifier metadata to the attributable account and that links transaction information metadata to each transaction associated with the account 672. For example, in an embodiment, switched circuit 672 may be implemented as switched circuit having one or more switched states associated with the distribution rule set that links identifier metadata to the attributable account and that links transaction information metadata to each transaction associated with the account.

Referring again to FIG. 6F, in an embodiment, switched circuit 672 may be implemented as a switched circuit having one or more switched states associated with the distribution rule set that links identifier metadata to the attributable account and that links transaction information metadata to each transaction associated with the account, wherein the transaction information includes a receiving party name, a time of transaction, and an underlying bank data for each bank involved in the transaction 674. For example, FIG. 6, e.g., FIG. 6F, shows switched circuit having one or more switched states associated with the distribution rule set that links identifier metadata to the attributable account and that links transaction information metadata to each transaction associated with the account, wherein the transaction information includes a receiving party name, a time of transaction, and an underlying bank data for each bank involved in the transaction.

Referring now to FIG. 7, FIG. 7 shows various implementations of processor 251, e.g., processor 251, which may include one or more of said at least one first track data presentation machine 254 and at least one second track data presentation machine 256. For example, FIG. 7 shows at least one first track data presentation machine 254, which may, in various embodiments, be implemented as an at least one first track data presentation machine having state set at least in part by switch-state logic 702. Similarly, FIG. 7 shows at least one second track data presentation machine 256, which, in an embodiment, may be implemented as an at least one second track data presentation machine having state set at least in part by switch-state logic 704.

Referring again to FIG. 7, in an embodiment, at least one first track data presentation machine 254 may be specified to establish at least one first track data presentation machine state of said first-party-associated device, said at least one first track data presentation machine state set to a value 710. In an embodiment, the at least one first track data presentation machine state 710 may be set to a value responsive to at least one of tracked first transmission of particular funds within a particular architecture that are part of said attributable funds managed by the particular architecture, from a first downstream entity to a second downstream entity, wherein the tracked first transmission of particular funds is checked for compliance with the distribution rule set by the particular architecture 715.

Referring now to FIG. 8A, in an embodiment, at least one first track data presentation machine at least one first track data presentation machine 254 may be specified to establish at least one first track data presentation machine state of said first-party-associated device, said at least one first track data presentation machine state set to a value 710. In an implementation, at least one first track data presentation machine state 710 may be implemented as first track data presentation switched circuit having one or more switched states set at least in part by switch-state logic specified at least in part by said tracked first transmission of particular funds within a particular architecture that are part of said attributable funds managed by the particular architecture, from a first downstream entity to a second downstream entity 802.

Referring again to FIG. 8A, in an embodiment, first track data presentation switched circuit 802 may be implemented as first track data transistorized circuit having one or more switched states set at least in part by special purpose circuitry specified at least in part by said tracked first transmission of particular funds within a particular architecture that are part of said attributable funds managed by the particular architecture, from a first downstream entity to a second downstream entity 804. In another embodiment, referring again to FIG. 8A, first track data presentation switched circuit 802 may be implemented as first track data transistorized circuit having one or more switched states set at least in part by special purpose circuitry specified at least in part by one or more received signals translated into machine code that represent said tracked first transmission of particular funds within a particular architecture that are part of said attributable funds managed by the particular architecture, from a first downstream entity to a second downstream entity 806.

Referring now to FIG. 8B, FIG. 8B shows various implementations of the tracked first transmission of particular funds within the particular architecture 715 as shown in FIG. 7A. For example, in an embodiment, referring to FIG. 8B, tracked first transmission of particular funds within the particular architecture 715 may be implemented as tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission 820. In an exemplary implementation, the tracked first transmission of particular funds within the particular architecture from the first downstream entity (e.g., a U.S. bank) to the second downstream entity (e.g., a construction subcontractor in Egypt), wherein the tracked first transmission of particular funds is checked (e.g., verified against) for compliance with the distribution rule set, wherein the distribution rule set specifies a maximum allowable fraud score (e.g., a computer-generated score for the transaction that relates various factors (described elsewhere herein, e.g., with respect to FIGS. 4A and 4B) for the first transmission (e.g., the transmission of particular funds from the US bank to the construction subcontractor).

Referring again to FIG. 8B, in an embodiment, tracked first transmission of particular funds 820 may include tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is calculated by the particular architecture 822. For example, in an implementation, the tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is calculated by the particular architecture.

Referring again to FIG. 8B, an embodiment, tracked first transmission of particular funds 822 may include tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a phantom vendor determination scheme 824. For example, in an implementation, the tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a phantom vendor determination scheme, e.g., a scheme in which funds are transferred between “shell” or “phantom” vendors in an attempt to skim or steal money from an account, e.g., the attributable account, and whose presence may be detected using pattern recognition or other machine intelligence amplification techniques by the particular architecture, which also may control onboarding/offboarding of funds.

Referring again to FIG. 8B, in an embodiment, tracked first transmission of particular funds 824 may include tracked first transmission of particular funds within the particular architecture from the first downstream entity to the second downstream entity, wherein the phantom vendor determination scheme is at least partly based on one or more characteristics of the first downstream entity and the second downstream entity 826. For example, in an implementation, the tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a phantom vendor determination scheme, e.g., a scheme in which funds are transferred between “shell” or “phantom” vendors in an attempt to skim or steal money from an account, e.g., the attributable account, and whose presence may be detected using pattern recognition or other machine intelligence amplification techniques by the particular architecture, which also may control onboarding/offboarding of funds, and which may analyze the first downstream entity and the second downstream entity.

Referring again to FIG. 8B, in an embodiment, tracked first transmission of particular funds 826 may include tracked first transmission of particular funds within the particular architecture from the first downstream entity to the second downstream entity, wherein the phantom vendor determination scheme is at least partly based on one or more characteristics of the first downstream entity and the second downstream entity, said characteristics including an entity name length, a time in operation of the entity, a number of invoices to a same vendor by the entity 828. For example, in an implementation, the tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a phantom vendor determination scheme, e.g., a scheme in which funds are transferred between “shell” or “phantom” vendors in an attempt to skim or steal money from an account, e.g., the attributable account, and whose presence may be detected using pattern recognition or other machine intelligence amplification techniques by the particular architecture, which also may control onboarding/offboarding of funds, and which may analyze the first downstream entity and the second downstream entity for such factors as an entity name length, a time in operation of the entity, a number of invoices to a same vendor by the entity. Some description of these techniques is also present with respect to FIG. 4, which describes an implementation of the fraud detection scheme.

Referring now to FIG. 8C, in an embodiment, tracked first transmission of particular funds 822 may include tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a vendor reputation score managed by the particular architecture 830. For example, in an implementation, tracked first transmission of particular funds 830 may be a tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a vendor reputation score (e.g., a reputation score managed by the architecture, e.g., with input from other vendors that have interacted with that vendor, persons associated with attributable accounts, and objective reports) managed by the particular architecture (e.g., the Daybreak architecture).

Referring again to FIG. 8C, in an embodiment, tracked first transmission of particular funds 822 may include tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a transaction score managed by the particular architecture 832. For example, in an implementation, tracked first transmission of particular funds 832 may be implemented as tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a transaction score managed by the particular architecture.

Referring again to FIG. 8C, in an embodiment, tracked first transmission of particular funds 832 may include tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a transaction score that is based on one or more of a transaction time, an involved transaction entity identity, a transaction amount, a transaction location, and a transaction reputation score 834. For example, in an implementation, tracked first transmission of particular funds 834 may be implemented as tracked first transmission of particular funds within the particular architecture from the first downstream entity to the second downstream entity, wherein the tracked first transmission of particular funds is checked for compliance with the distribution rule set, wherein the distribution rule set specifies a maximum allowable fraud score for the first transmission that is at least partly based on a transaction score that is based on one or more of a transaction time, an involved transaction entity identity, a transaction amount, a transaction location, and a transaction reputation score.

Referring back to FIG. 7, e.g., FIG. 7A, in an embodiment, at least one second track data presentation machine 256 may include at least one second track data presentation machine having state set at least in part by switch-state logic 704.

Referring again to FIG. 7, e.g., FIG. 7, in an embodiment, at least one second track data presentation machine 256 may be specified to establish at least one second track data presentation machine state of said first-party-associated device, said at least one second track data presentation machine state set to a value 720.

Referring now to FIG. 9, e.g., FIG. 9A, in an implementation, at least one second track data presentation machine state of said first-party-associated device, said at least one second track data presentation machine state set to a value 720 may include a second track data presentation switched circuit having one or more switched states set at least in part by switch-state logic specified at least in part by said tracked second transmission of at least a portion of said particular funds within the particular architecture from said second downstream entity to a third downstream entity different than said first downstream entity 910. For example, in an embodiment, at least one second track data presentation switched circuit may be implemented as a second track data presentation switched circuit having one or more switched states set at least in part by switch-state logic specified at least in part by said tracked second transmission of at least a portion of said particular funds within the particular architecture from said second downstream entity to a third downstream entity different than said first downstream entity.

Referring again to FIG. 9, e.g., FIG. 9A, in an implementation, second track data presentation switched circuit 910 may include second track data transistorized circuit having one or more switched states set at least in part by special purpose circuitry specified at least in part by said tracked second transmission of at least a portion of said particular funds within the particular architecture from said second downstream entity to a third downstream entity different than said first downstream entity 912. For example, in an implementation, a second track data transistorized circuit may be implemented as a second track data transistorized circuit having one or more switched states set at least in part by special purpose circuitry specified at least in part by said tracked second transmission of at least a portion of said particular funds within the particular architecture from said second downstream entity to a third downstream entity different than said first downstream entity.

Referring again to FIG. 9, e.g., FIG. 9A, in an implementation, second track data transistorized circuit 912 may include second track data transistorized circuit having one or more switched states set at least in part by special purpose circuitry specified at least in part by one or more received signals translated into machine code that represent said tracked second transmission of at least a portion of said particular funds within the particular architecture from said second downstream entity to a third downstream entity different than said first downstream entity 914. For example, FIG. 9, e.g., FIG. 9, shows in an implementation, a second track data transistorized circuit may be implemented as a second track data transistorized circuit having one or more switched states set at least in part by part by one or more received signals translated into machine code that represent said tracked second transmission of at least a portion of said particular funds within the particular architecture from said second downstream entity to a third downstream entity different than said first downstream entity.

### Exemplary Operational Implementation of Processor 250 and Exemplary Variants

Further, in FIG. 14 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 14 as well as the other operations to be described herein may be performed by at least one of a machine, an article of manufacture, or a composition of matter.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

Referring now to FIG. 10, FIG. 10 shows an implementation of a first party machine/user machine 220B, similarly to as disclosed with respect to FIG. 2C-2. For example, in an embodiment, first party machine 220B may include one or more of electrical/magnetic/physical storage 222, processor 251B, and/or other optional machine circuits and components 260. In an embodiment, daybreak architecture 3100 may include a state machine, e.g., 1002, which, in an embodiment, may generate machine instructions 1004. Those program/machine instructions may be incorporated with processor 251B of first party machine 220B in order to form various implementations of input acceptance circuit 252B, first transaction data receiving circuit 254B, and second transaction data receiving circuit 256B.

FIGS. 11-13 illustrate exemplary embodiments of the various modules that form portions of processor 251B. In an embodiment, the modules represent hardware, either that is hard-coded, e.g., as in an application-specific integrated circuit (“ASIC”) or that is physically reconfigured through gate activation described by computer instructions, e.g., as in a central processing unit.

Referring now to FIG. 11, FIG. 11 illustrates an exemplary implementation of the input acceptance circuit 252B. As illustrated in FIG. 11, the input acceptance circuit 252B may include one or more sub-logic circuits in various alternative implementations and embodiments. For example, as shown in FIGS. 11A-11G, which make up part of a unified FIG. 12 as shown in the lower illustration of each sheet of FIG. 12.

Referring now to FIG. 12, FIG. 12 illustrates an exemplary implementation of first transaction data receiving circuit 254B. As illustrated in FIG. 12, the first transaction data receiving circuit 254B may include one or more sub-logic modules in various alternative implementations and embodiments. For example, as shown in FIGS. 12A-12H, which make up part of a unified FIG. 12 as shown in the lower illustration of each sheet of FIG. 12.

Referring now to FIG. 13, FIG. 13 illustrates an exemplary implementation of second transaction data receiving circuit 256B. As illustrated in FIG. 13A, the second transaction data receiving circuit 256B may include one or more sub-logic modules in various alternative implementations and embodiments, as shown in FIGS. 13A-13G, which make up part of a unified FIG. 13 as shown in the lower illustration of each sheet of FIG. 13.

Further, in FIG. 14 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 14 as well as the other operations to be described herein may be performed by at least one of a machine, an article of manufacture, or a composition of matter.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

Referring now to FIG. 14, FIG. 14 shows operation 1000, e.g., an example operation of message processing device 230 operating in an environment 200. In an embodiment, operation 1400 may include operation 1402 depicting input acceptance circuit configured to receive input that regards an attributable account that contains attributable funds and that is configured to interface with one or more financial entities, wherein the attributable funds are governed by a distribution rule set. For example, FIG. 10, e.g., FIG. 10, shows input acceptance circuit 252B accepting (e.g., receiving, retrieving, facilitating the reception of, interacting with an input/output interface) input (e.g., the input could take many forms, e.g., a person interacting with an input/output device, e.g., a keyboard, mouse, touchscreen, haptic interface, virtual reality interface, augmented reality interface, audio interface, body-motion interface, or similar, or in the form of one device sending a request to another device, for example a monitoring device sending a request for a particular image, or in the form of an internal communication in a device (e.g., a subroutine of a device inputs the request to a different portion of the device (which may use the same CPU and/or other components), or any other form) e.g., of a request (e.g., a command, suggestion, or description, which may be narrow or specific, e.g., “add X funds to this account,” or “transfer funds from part,” or “request showing all transactions that were denied for failure to comply with the distribution rule set,” or “show me an audit of the account,” or “show me real time transfers on this account for the next six hours”) that regards an attributable account (e.g., an account that has been designated for funds that have a distribution rule set, e.g., a set of rules specifying the use of the funds, attached to them) that contains attributable funds (e.g., funds that have a distribution rule set, e.g., a set of rules specifying the use of the funds, attached to them) and that is configured to interface with (e.g., the attributable account has at least a portion that can interface with, e.g., interact with, e.g., through various command protocols, e.g., FTP protocol), wherein the attributable funds are governed by a distribution rule set (e.g., a set of rules that governs the transactions that are managed by daybreak architecture 3100, e.g., for attributable funds and attributable accounts).

Referring again to FIG. 14, operation 1400 may include operation 1404 depicting first transaction data receiving circuit configured to receive first transaction data indicating a first transmission of particular funds from a first downstream entity to a second downstream entity, wherein the particular funds are part of the attributable funds. For example, FIG. 10, e.g., FIG. 10, shows first transaction data receiving circuit 254B receiving first transaction data (e.g., data that indicates a request has been made to move funds, either between two Daybreak architecture accounts, or to offboard some funds from the Daybreak architecture account, or any combination thereof) indicating a first transmission of particular funds from a first downstream entity (e.g., a governmental agency that assigns contracts to for-profit companies to do charitable work) to a second downstream entity (e.g., a solar power construction company), wherein the partiucalr frunds are part of the attributable funds.

Referring again to FIG. 14, operation 1400 may include operation 1406 depicting second transaction data receiving circuit configured to receive second transaction data indicating a second transmission of the particular funds from the second downstream entity to the third downstream entity. For example, FIG. 10 e.g., FIG. 10 shows second transaction data receiving circuit 256B receiving second transaction data indicatin a second transmission of the particular funds from the second downstream entity (e.g., the solar power construction company) to the third downstream entity (e.g., a local worker who installs the solar panels and has a bank account associated with her phone, e.g., through an app, or through a system such as M-Pesa or the like).

FIGS. 15A-15F depict various implementations of operation 1402, depicting input acceptance circuit configured to receive input that regards an attributable account that contains attributable funds and that is configured to interface with one or more financial entities, wherein the attributable funds are governed by a distribution rule set according to embodiments. Referring now to FIG. 15A, operation 1402 may include operation 1502 depicting presentation input acceptance circuit configured to accept input that regards that regards a request for presentation of a transaction history of the attributable account that contains attributable funds and that is configured to interface with one or more financial entities, wherein the attributable funds are governed by a distribution rule set. For example, FIG. 11, e.g., FIG. 11A shows presentation input acceptance circuit configured to accept input that regards that regards a request for presentation of a transaction history of the attributable account that contains attributable funds and that is configured to interface with one or more financial entities, wherein the attributable funds are governed by a distribution rule set 1102, accepting input (e.g., receiving a vocal order spoken into a microphone).

Referring again to FIG. 15A, operation 1402 may include operation 1504 depicting an input receiving circuit operably coupled to the input/output interface circuit and that is configured to receive input that regards the attributable account that contains attributable funds and that is configured to interface with one or more financial entities. For example, FIG. 11, e.g., FIG. 11A, shows input receiving circuit operably coupled to the input/output interface circuit and that is configured to receive input that regards the attributable account that contains attributable funds and that is configured to interface with one or more financial entities 1104 receiving input that regards the attributable account that contains attributable funds and that is configured to interface with one or more financial entities (e.g., banks, contractors, individuals, governments, NGOs, etc.)

Referring again to FIG. 15A, in an embodiment, operation 1504 may include operation 1506 depicting an input receiving circuit configured to receive input from a user, said input that regards the attributable account that contains attributable funds and that is configured to interface with one or more financial entities. For example, FIG. 11, e.g., FIG. 11A, shows input receiving circuit configured to receiving input from a user, said input that regards the attributable account that contains attributable funds and that is configured to interface with one or more financial entities 1106 receiving input from a user (e.g., a human, but not necessarily a human, could be a program, an artificial intelligence, an intelligence amplification, a robot, another entity, etc.), said input that regards the attributable account (e.g., an inputted request for an audit) that contains attributable funds and that is configured to interface with one or more financial entities (e.g., a local bank and a non-governmental entity that is a construction company).

Referring again to FIG. 15A, in an embodiment, operation 1504 may include operation 1508 depicting input receiving circuit configured to receive, at the device that is a first party device, said input that regards the attributable account that contains attributable funds and that is configured to interface with one or more financial entities. For example, FIG. 11, e.g., FIG. 11A, shows input receiving circuit configured to receive, at the device that is a first party device, said input that regards the attributable account that contains attributable funds and that is configured to interface with one or more financial entities 1108 receiving input at a first party device (e.g., an Apple-branded iPhone), said input that regards the attributable account (e.g., an inputted request to view the last five transactions and a detailed analysis of how the distribution rule set was applied to the last five transactions) and that is configured to interface with one or more financial entities (e.g., a remote foreign bank and a large multinational bank).

Referring again to FIG. 15A, in an embodiment, operation 1508 may include operation 1510 depicting input receiving circuit configured to receive input at the first party device, said input that regards the attributable account that contains attributable funds and that is configured to interface with one or more financial entities, wherein the first party device is one or more of a smartphone device, mobile device, laptop computer, desktop computer, wearable device, augmented reality device, in-vehicle device, heads up display, and a thin client. For example, FIG. 11, e.g., FIG. 11A, shows input receiving circuit configured to receive input at the first party device, said input that regards the attributable account that contains attributable funds and that is configured to interface with one or more financial entities, wherein the first party device is one or more of a smartphone device, mobile device, laptop computer, desktop computer, wearable device, augmented reality device, in-vehicle device, heads up display, and a thin client 1110 receiving input at the first party device, said input that regards the attributable account (e.g., a request to transfer funds to a specific recipient) hat contains attributable funds and that is configured to interface with one or more financial entities, wherein the first party device is one or more of a smartphone device, mobile device, laptop computer, desktop computer, wearable device, augmented reality device, in-vehicle device, heads up display, and a thin client.

Referring again to FIG. 15A, in an embodiment, operation 1508 may include operation 1512 depicting input receiving circuit configured to receive input from the user at an input/output interface of the first party device, said input that regards the attributable account that contains attributable funds and that is configured to interface with one or more financial entities. For example, FIG. 11, e.g., FIG. 11A, shows input receiving circuit configured to receive input from the user at an input/output interface of the first party device, said input that regards the attributable account that contains attributable funds and that is configured to interface with one or more financial entities 1112 receiving input from the user at an input/output interface (e.g., a touchscreen, keyboard, microphone/speaker, display, mouse, pointer, augmented reality display projection, motion detector, other sensor, or any combination thereof) of the first party device, said input that regards the attributable account that contains attributable funds and that is configured to interface with one or more financial entities.

Referring again to FIG. 15A, in an embodiment, operation 1512 may include operation 1514 depicting input receiving circuit configured to receive input from the user at a touchscreen interface of the first party device, said input that regards the attributable account that contains attributable funds and that is configured to interface with one or more financial entities. For example, FIG. 11, e.g., FIG. 11A, shows input receiving circuit configured to receive input from the user at a touchscreen interface of the first party device, said input that regards the attributable account that contains attributable funds and that is configured to interface with one or more financial entities 1114 receiving input from the user at a touchscreen interface of the first party device, said input that regards the attributable account that contains attributable funds and that is configured to interface with one or more financial entities (e.g., a medical supply guarantor working in a remote location with questionable access to supplies).

Referring now to FIG. 15B, in an embodiment, operation 1402 may include operation 1516 depicting input acceptance circuit configured to accept a request related to the attributable account that contains the attributable funds and that is configured to interface with one or more financial entities. For example, FIG. 11, e.g., FIG. 11B, shows input acceptance circuit configured to accept a request related to the attributable account that contains the attributable funds and that is configured to interface with one or more financial entities 1116 accepting a request related to the attributable account (e.g., a request to change one or more parameters of one or more rules of the distribution rule set, e.g., to change the percentage of a transaction that is allowed to be offboarded to the financial institution that is facilitating that transaction) that contains the attributable funds and that is configured to interface with one or more financial entities (e.g., a supermarket located in a third world country).

Referring again to FIG. 15B, in an embodiment, operation 1402 may include operation 1518 depicting attributable account view request accepting circuit configured to accept

a request to view at least a portion of the attributable account that contains the attributable funds and that is configured to interface with one or more financial entities. For example, FIG. 11, e.g., FIG. 11B, shows attributable account view request accepting circuit configured to accept a request to view at least a portion of the attributable account that contains the attributable funds and that is configured to interface with one or more financial entities 1118 accepting a request to view at least a portion of the attributable account (e.g., the portion being transactions from a specific financial entity, e.g., a specific vendor) that contains the attributable funds and that is configured to interface with one or more financial entities (e.g., one or more vendors).

Referring again to FIG. 15B, in an embodiment, operation 1518 may include operation 1520 depicting attributable account view request accepting circuit configured to accept the request to view the last ten transactions carried out in the attributable account that contains the attributable funds and that is configured to interface with one or more financial entities. For example, FIG. 11, e.g., FIG. 11B, shows attributable account view request accepting circuit configured to accept the request to view the last ten transactions carried out in the attributable account that contains the attributable funds and that is configured to interface with one or more financial entities 1120 accepting the request to view the last ten transactions carried out in the attributable account (e.g., two offboardings and eight internal transactions between entities that have accounts within the Daybreak architecture) that contains the attributable funds and that is configured to interface with one or more financial entities.

Referring again to FIG. 15B, in an embodiment, operation 1518 may include operation 1522 depicting attributable account view request accepting circuit configured to accept the request to view the last ten rejected transactions requested in the attributable account that contains the attributable funds and that is configured to interface with one or more financial entities, wherein the rejected transactions were rejected for failure to comply with the distribution rule set. For example, FIG. 11, e.g., FIG. 11B, shows attributable account view request accepting circuit configured to accept the request to view the last ten rejected transactions requested in the attributable account that contains the attributable funds and that is configured to interface with one or more financial entities, wherein the rejected transactions were rejected for failure to comply with the distribution rule set 1122 accepting the request to view the last ten rejected transactions requested in the attributable account that contains the attributable funds and that is configured to interface with one or more financial entities, wherein the rejected transactions were rejected for failure to comply with the distribution rule set (e.g., the distribution rule set required the vendor that was to receive the funds to be registered as a licensed medical supplies provider, and none of the transacitons featured a transfer of funds to a licensed medical supplies provider).

Referring again to FIG. 15B, in an embodiment, operation 1518 may include operation 1524 depicting attributable account view request accepting circuit configured to accept accepting the request to view an account balance of the attributable account that contains the attributable funds and that is configured to interface with one or more financial entities. For example, FIG. 11, e.g., FIG. 11B, shows attributable account view request accepting circuit configured to accept accepting the request to view an account balance of the attributable account that contains the attributable funds and that is configured to interface with one or more financial entities 1124 accepting the request to view an account balance of the attributable account (e.g., a virtual balance, e.g., managed within the daybreak architecture, because money is not specifically moved out of the attriubtalbe account (e.g., the real-world representation of the attributable account) until the funds are offboarded outside the control of the Daybreak architecture) and that is configured to interface (e.g., interact with, e.g., communicate with electronically, e.g., transfer data to and/or from, apply a distribution rule set to, and/or transfer funds to and/or from) with one or more financial entities (e.g., one or more entities that have registered with the Daybreak architecture).

Referring again to FIG. 15B, in an embodiment, operation 1518 may include operation 1526 depicting attributable account view request accepting circuit configured to accept the request to view a distribution map of the attributable funds between the first downstream entity, the second downstream entity, and the third downstream entity. For example, FIG. 11, e.g., FIG. 11B, shows attributable account view request accepting circuit configured to accept the request to view a distribution map of the attributable funds between the first downstream entity, the second downstream entity, and the third downstream entity 1126 accepting the request to view the distribution map (e.g., a visualization of various distributions, e.g., a bar chart, pie chart, or any other graphical or sensory representation in any medium, including virtual and augmented reality) of the attributable funds between the first downstream entity (e.g., a governmental agency of a foreign power), the second downstream entity (e.g., a royal family of a country with a symbolic oligarchy), and the third downstream entity (e.g., a government contractor, e.g., Booz Allen or Halliburton).

Referring again to FIG. 15B, in an embodiment, operation 1518 may include operation 1528 depicting attributable account view request accepting circuit configured to accept the request to view a real-time or near-real-time tracking of the attributable funds between the first downstream entity, the second downstream entity, and the third downstream entity. For example, FIG. 11, e.g., FIG. 11B, shows attributable account view request accepting circuit accepting the request to view a real-time or near-real-time tracking of the attributable funds between the first downstream entity, the second downstream entity, and the third downstream entity 1128 accepting the request to view a real time or near real time (e.g., close enough to real time so that it appears upon loose inspection to be a real-time system) tracking of the attributable funds between the first downstream entity (e.g., a domestic banking institution), the second downstream entity (e.g., a building subcontractor), and the third downstream entity (e.g., a cement mixer rental company).

Referring now to FIG. 15C, in an embodiment, operation 1518 may include operation 1530 depicting attributable account view request accepting circuit configured to accept the request to view a current location of the attributable funds between the first downstream entity, the second downstream entity, and the third downstream entity, within their representations in a particular architecture. For example, FIG. 11, e.g., FIG. 11C, shows attributable account view request accepting circuit configured to accept the request to view a current location of the attributable funds between the first downstream entity, the second downstream entity, and the third downstream entity, within their representations in a particular architecture 1130 accepting the request to view a current location of the attributable funds between the first downstream entity (e.g., a rural hospital), the second downstream entity (e.g., a medical supply provider), and the third downstream entity (e.g., a nurse contracting agency), within their representations (e.g., within the accounts that represent each entity within the Daybreak architecture) in a particular architecture (e.g., Daybreak architecture 3100 or similar).

Referring again to FIG. 15C, in an embodiment, operation 1530 may include operation 1532 depicting attributable account view request accepting circuit configured to accept the request to view the current location of the attributable funds between the first downstream entity, the second downstream entity, and the third downstream entity, within their individual account representations within the particular architecture that has an individual account associated with each downstream entity. For example, FIG. 11, e.g., FIG. 11C, shows attributable account view request accepting circuit configured to accept the request to view the current location of the attributable funds between the first downstream entity, the second downstream entity, and the third downstream entity, within their individual account representations within the particular architecture that has an individual account associated with each downstream entity 1132 accepting the request to view the current location of the attributable funds between the first downstream entity (e.g., a fresh food supplier), the second downstream entity (e.g., a commercial farm), and the third downstream entity (e.g., a refrigerated truck driving company), within their individual account representations within the particular architecture that has an individual account associated with each downstream entity.

Referring again to FIG. 15C, in an embodiment, operation 1518 may include operation 1534 depicting attributable account view request accepting circuit configured to accept the request to view at least a partial list of goods and/or services purchased or directed to purchase with the attributable funds by one or more of the first downstream entity, the second downstream entity, and the third downstream entity, and/or one or more agents of the first downstream entity, the second downstream entity, and the third downstream entity. For example, FIG. 11, e.g., FIG. 11C, shows attributable account view request accepting circuit configured to accept the request to view at least a partial list of goods and/or services purchased or directed to purchase with the attributable funds by one or more of the first downstream entity, the second downstream entity, and the third downstream entity, and/or one or more agents of the first downstream entity, the second downstream entity, and the third downstream entity 1134 accepting the request to view at least a partial list of goods and/or services (e.g., medical supplies; housing parts) purchased or directed to purchase with the attributable funds (e.g., the funds are moved around within the Daybreak architecture and then offboarded after compliance with the distribution rule set is confirmed and/or verified) by one or more of the first downstream entity (e.g., a large rural grocery provider), the second downstream entity (e.g., a contract labor union that supplies workers to grocery stores), and the third downstream entity (e.g., a dairy) and/or one or more agents of the first downstream entity, the second downstream entity, and the third downstream entity (e.g., the representative of those specific entities, or, in another embodiment, the accounts associated with those entities, whether within or without the daybreak architecture).

Referring again to FIG. 15C, in an embodiment, operation 1518 may include operation 1536 depicting attributable account view request accepting circuit configured to accept the request to view at least a partial list of goods and/or services distributed or directed to distribute with the attributable funds by one or more of the first downstream entity, the second downstream entity, and the third downstream entity, and/or one or more agents of the first downstream entity, the second downstream entity, and the third downstream entity. For example, FIG. 11, e.g., FIG. 11C, shows attributable account view request accepting circuit configured to accept the request to view at least a partial list of goods and/or services distributed or directed to distribute with the attributable funds by one or more of the first downstream entity, the second downstream entity, and the third downstream entity, and/or one or more agents of the first downstream entity, the second downstream entity, and the third downstream entity 1136 accepting the request to view at least a partial list of goods and/or services distributed or directed to distribute with the attributable funds by one or more of the first downstream entity (e.g., a hospital), the second downstream entity (e.g., an Ebola crisis response team), and the third downstream entity (e.g. a respirator distributor), and/or one or more agents of the first downstream entity (e.g., a hospital), the second downstream entity (e.g., an Ebola crisis response team), and the third downstream entity (e.g. a respirator distributor).

Referring again to FIG. 15C, in an embodiment, operation 1518 may include operation 1538 depicting attributable account view request accepting circuit configured to accept the request to view verification information of at least a partial list of goods and/or services associated with the attributable funds by one or more of the first downstream entity, the second downstream entity, and the third downstream entity, and/or one or more agents of the first downstream entity, the second downstream entity, and the third downstream entity. For example, FIG. 11, e.g., FIG. 11D, shows attributable account view request accepting circuit configured to accept the request to view verification information of at least a partial list of goods and/or services associated with the attributable funds by one or more of the first downstream entity, the second downstream entity, and the third downstream entity, and/or one or more agents of the first downstream entity, the second downstream entity, and the third downstream entity 1138 accepting the request to view verification information of at least a partial list of goods and/or services associated with the attributable funds by one or more of the first downstream entity (e.g., a school for underprivileged youth), the second downstream entity (e.g., a teachers' association), and the third downstream entity (e.g., a textbook supplier) and/or one or more agents of the first downstream entity (e.g., a school for underprivileged youth), the second downstream entity (e.g., a teachers' association), and the third downstream entity (e.g., a textbook supplier).

Referring now to FIG. 15D, in an embodiment, operation 1402 may include operation 1540 depicting input acceptance circuit configured to accept input that regards an attributable account that contains attributable funds that are governed by a distribution rule set that links metadata to the account and to one or more transactions associated with the account. For example, FIG. 11, e.g., FIG. 11E, shows input acceptance circuit configured to accept input that regards an attributable account that contains attributable funds that are governed by a distribution rule set that links metadata to the account and to one or more transactions associated with the account 1140 accepting input that regards an attributable account that contains attributable funds that are governed by a distribution rule set that links metadata (e.g., data about the entities) to the account and to one or more transactions associated with the account (e.g., a classification of the vendor and a reputation score are attached as metatdata).

Referring again to FIG. 15D, in an embodiment, operation 1540 may include operation 1542 depicting input acceptance circuit configured to accept input that regards the attributable account that contains attributable funds that are governed by the distribution rule set that links identifier metadata to the attributable account and that links transaction information metadata to each transaction associated with the account. For example, FIG. 11, e.g., FIG. 11E, shows input acceptance circuit configured to accept input that regards the attributable account that contains attributable funds that are governed by the distribution rule set that links identifier metadata to the attributable account and that links transaction information metadata to each transaction associated with the account 1142 accepting input that regards the attributable account that contains attributable funds that are governed by the distribution rule set that links identifier metadata to the attributable account and that links transaction information metadata (e.g., time of transaction, name of person who authorized, point of contact at the vendor, etc.) to each transaction associated with the account.

Referring again to FIG. 15D, in an embodiment, operation 1542 may include operation 1544 depicting input acceptance circuit configured to accept input accepting input that regards the attributable account that contains attributable funds that are governed by the distribution rule set that links identifier metadata to the attributable account and that links transaction information metadata to each transaction associated with the account, wherein the transaction information includes a receiving party name, a time of transaction, and an underlying bank data for each bank involved in the transaction. For example, FIG. 11, e.g., FIG. 11E, shows input acceptance circuit configured to accept input accepting input that regards the attributable account that contains attributable funds that are governed by the distribution rule set that links identifier metadata to the attributable account and that links transaction information metadata to each transaction associated with the account, wherein the transaction information includes a receiving party name, a time of transaction, and an underlying bank data for each bank involved in the transaction 1144 accepting input accepting input that regards the attributable account that contains attributable funds that are governed by the distribution rule set that links identifier metadata to the attributable account and that links transaction information metadata to each transaction associated with the account, wherein the transaction information includes a receiving party name, a time of transaction, and an underlying bank data for each bank involved in the transaction (e.g., a transfer of money to a dairy farm to provide milk to malnourished children).

Referring again to FIG. 15D, in an embodiment, operation 1402 may include operation 1546 depicting input acceptance circuit configured to accept input that regards an attributable account that contains attributable funds that are governed by a distribution rule set that links location data to one or more transactions associated with the account. For example, FIG. 11, e.g., FIG. 11E, shows input acceptance circuit configured to accept input that regards an attributable account that contains attributable funds that are governed by a distribution rule set that links location data to one or more transactions associated with the account 1146 accepting input that regards an attributable account that contains attributable funds that are governed by a distribution rule set that links location data to one or more transactions associated with the account (e.g., location of trucks that are leased for transporting concrete to a job site where a school will be built).

Referring again to FIG. 15D, in an embodiment, operation 1546 may include operation 1548 depicting input acceptance circuit configured to accept input that regards the attributable account that contains attributable funds that are governed by the distribution rule set that links location data obtained from a global positioning system to locations of one or more transactions associated with the account. For example, FIG. 11, e.g., FIG. 11E, shows input acceptance circuit configured to accept input that regards the attributable account that contains attributable funds that are governed by the distribution rule set that links location data obtained from a global positioning system to locations of one or more transactions associated with the account 1148 accepting input that regards the attributable account that contains attributable funds that are governed by the distribution rule set that links location data obtained from a global positioning system to locations of one or more transactions associated with the account (e.g., location of where specific vaccines that have remote transmitter tags in their bags are distributed).

Referring again to FIG. 15D, in an embodiment, operation 1548 may include operation 1550 depicting input acceptance circuit configured to accept input that regards the attributable account that contains attributable funds that are governed by the distribution rule set that links location data obtained from tracking beacons associated with one or more goods purchased from attributable funds of the attributable account. For example, FIG. 11, e.g., FIG. 11E, shows input acceptance circuit configured to accept input that regards the attributable account that contains attributable funds that are governed by the distribution rule set that links location data obtained from tracking beacons associated with one or more goods purchased from attributable funds of the attributable account 1150 accepting input that regards the attributable account that contains attributable funds that are governed by the distribution rule set that links location data obtained from tracking beacons (e.g., radio signals inside bags of concrete, or electronic devices configured to broadcast their location and usage pattern) associated with one or more goods (e.g., bags of concrete and portable electronics) purchased from attributable funds of the attributable account.

Referring now to FIG. 15E, in an embodiment, operation 1402 may include operation 1552 depicting input acceptance circuit configured to accept input that regards an attributable account that contains attributable funds that are governed by a distribution rule set that governs fees that are associated with one or more transactions associated with the attributable funds of the attributable account. For example, FIG. 11, e.g., FIG. 11F, shows input acceptance circuit configured to accept input that regards an attributable account that contains attributable funds that are governed by a distribution rule set that governs fees that are associated with one or more transactions associated with the attributable funds of the attributable account 1152 accepting input that regards an attributable account that contains attributable funds that are governed by a distribution rule set that governs fees that are associated with one or more transactions (e.g., a bank might take a percentage or a flat fee for processing the transaction, which can be controlled by the distribution rule set, or a primary contractor may take a percentage for themselves which is capped by the distribution rule set, or a governmental entity might have a certain percentage earmarked for their own costs in putting the infrastructure in place for the charitable work) associated with the attributable funds of the attributable account.

Referring again to FIG. 15E, in an embodiment, operation 1552 may include operation 1554 depicting input acceptance circuit configured to accept input that regards the attributable account that contains attributable funds that are governed by the distribution rule set that sets a percentage-of-transaction fee limit that is associated with the attributable funds of the attributable account. For example, FIG. 11, e.g., FIG. 11F, shows input acceptance circuit configured to accept input that regards the attributable account that contains attributable funds that are governed by the distribution rule set that sets a percentage-of-transaction fee limit that is associated with the attributable funds of the attributable account 1154 accepting input that regards the attributable account that contains attributable funds that are governed by the distribution rule set that sets a percentage-of-transaction fee limit that is associated with the attributable funds of the attributable account.

Referring again to FIG. 15E, in an embodiment, operation 1402 may include operation 1556 depicting input acceptance circuit configured to accept input that regards the attributable account that contains attributable funds that are governed by the distribution rule set that requires photographic evidence of spending associated with one or more transactions associated with the attributable funds of the attributable account. For example, FIG. 11, e.g., FIG. 11F, shows input acceptance circuit configured to accept input that regards the attributable account that contains attributable funds that are governed by the distribution rule set that requires photographic evidence of spending associated with one or more transactions associated with the attributable funds of the attributable account 1156 accepting input that regards the attributable account that contains attributable funds that are governed by the distribution rule set that requires photographic evidence of spending (e.g., pictures of goods, or pictures of persons at particular sites, or other photographic evidence that can be digitized (or is in digital form) and associated with the transaction and provided on demand to to the user, e.g., in an embodiment) associated with one or more transactions associated with the attributable funds of the attributable account.

Referring again to FIG. 15E, in an embodiment, operation 1156 may include operation 1158 depicting input acceptance circuit configured to accept input that regards the attributable account that contains attributable funds that are governed by the distribution rule set that requires digital photographic data of evidence of spending associated with one or more transactions associated with the attributable funds of the attributable account to be included with data of the attributable funds. For example, FIG. 11, e.g., FIG. 11F, shows input acceptance circuit configured to accept input that regards the attributable account that contains attributable funds that are governed by the distribution rule set that requires digital photographic data of evidence of spending associated with one or more transactions associated with the attributable funds of the attributable account to be included with data of the attributable funds 1158 accepting input that regards the attributable account that contains attributable funds that are governed by the distribution rule set that requires digital photographic data of evidence of spending associated with one or more transactions associated with the attributable funds of the attributable account to be included with data of the attributable funds (e.g., the data kept by the Daybreak architecture as a record of the transaction and how it was verified that the transaction complied with the distribution rule set).

Referring again to FIG. 15E, in an embodiment, operation 1402 may include operation 1560 depicting input acceptance circuit configured to accept input that regards an attributable account that contains attributable funds that are governed by a distribution rule set that specifies particular spending limits for one or more goods and/or services that are acquired through one or more transactions associated with the attributable funds of the attributable account. For example, FIG. 11, e.g., FIG. 11F, shows input acceptance circuit configured to accept input that regards an attributable account that contains attributable funds that are governed by a distribution rule set that specifies particular spending limits for one or more goods and/or services that are acquired through one or more transactions associated with the attributable funds of the attributable account 1160 accepting input that regards an attributable account that contains attributable funds that are governed by a distribution rule set that specifies particular spending limits for one or more goods and/or services that are acquired through one or more transactions (e.g., the purchase of concrete after money is transferred to construction subcontractor) associated with the attributable funds of the attributable account.

Referring again to FIG. 15E, in an embodiment, operation 1560 may include operation 1562 depicting input acceptance circuit configured to accept input that regards the attributable account that contains the attributable funds that are governed by the distribution rule set that specifies the particular spending limits for one or more classes of goods that are acquired through one or more transactions associated with the attributable funds of the attributable account. For example, FIG. 11, e.g., FIG. 11F, shows input acceptance circuit configured to accept input that regards the attributable account that contains the attributable funds that are governed by the distribution rule set that specifies the particular spending limits for one or more classes of goods that are acquired through one or more transactions associated with the attributable funds of the attributable account 1162 accepting input that regards the attributable account that contains the attributable funds that are governed by the distribution rule set that specifies the particular spending limits for one or more classes of goods (e.g., no more than $1000 on prescription drugs, no more than $ 50 on overhead costs, no more than $25/day per diems for contractors, etc.) that are acquired through one or more transactions associated with the attributable funds of the attributable account

Referring again to FIG. 15E, in an embodiment, operation 1560 may include operation 1564 depicting input acceptance circuit configured to accept input that regards the attributable account that contains the attributable funds that are governed by the distribution rule set that specifies the particular spending limits for one or more classes of goods, including food, medicine, construction costs, worker salaries, and concrete supplies. For example, FIG. 11, e.g., FIG. 11F, shows input acceptance circuit configured to accept input that regards the attributable account that contains the attributable funds that are governed by the distribution rule set that specifies the particular spending limits for one or more classes of goods that are acquired through one or more transactions associated with the attributable funds of the attributable account 1162 that may be implemented as input acceptance circuit configured to accept input that regards the attributable account that contains the attributable funds that are governed by the distribution rule set that specifies the particular spending limits for one or more classes of goods, including food, medicine, construction costs, worker salaries, and concrete supplies.

Referring again to FIG. 15E, in an embodiment, operation 1562 may include operation 1564 depicting input acceptance circuit configured to accept input that regards the attributable account that contains the attributable funds that are governed by the distribution rule set that specifies the particular spending limits for one or more classes of goods, including food, medicine, construction costs, worker salaries, and concrete supplies. For example, FIG. 11, e.g., FIG. 11F, shows input acceptance circuit configured to accept input that regards the attributable account that contains the attributable funds that are governed by the distribution rule set that specifies the particular spending limits for one or more classes of goods, including food, medicine, construction costs, worker salaries, and concrete supplies.

Referring now to FIG. 15F, in an embodiment, operation 1402 may include operation 1566 depicting input acceptance circuit configured to accept input that regards an attributable account that contains attributable funds that are governed by a distribution rule set that calculates a potential fraud score for each transaction and determines whether to allow access to the attributable funds of the attributable account at least partially based on the fraud score calculation. For example, FIG. 11, e.g., FIG. 11G, shows input acceptance circuit configured to accept input that regards an attributable account that contains attributable funds that are governed by a distribution rule set that calculates a potential fraud score for each transaction and determines whether to allow access to the attributable funds of the attributable account at least partially based on the fraud score calculation 1166 accepting input that regards an attributable account that contains attributable funds that are governed by a distribution rule set that calculates a potential fraud score for each transaction and determines whether to allow access to the attributable funds of the attributable account at least partially based on the fraud score calculation (e.g., which may be based on various characteristics of transactions, e.g., as described elsewhere).

FIGS. 16A-16H depict various implementations of operation 1404, depicting first transaction data receiving circuit configured to receive first transaction data indicating a first transmission of particular funds from a first downstream entity to a second downstream entity, wherein the particular funds are part of the attributable funds, according to embodiments. Referring now to FIG. 12A, operation 1404 may include operation 1602 depicting first transaction data receiving circuit configured to receive, from a particular architecture, first transaction data indicating the first transmission of particular funds from the first downstream entity to the second downstream entity, wherein the particular funds are part of the attributable funds. For example, FIG. 12, e.g., FIG. 12A, shows first transaction data receiving circuit configured to receive, from a particular architecture, first transaction data indicating the first transmission of particular funds from the first downstream entity to the second downstream entity, wherein the particular funds are part of the attributable funds 1202 receiving, from a particular architecture (e.g., the Daybreak architecture), first transaction data (e.g., authorizing a payment of 1,000,000 to a subcontractor) indicating the first transmission of particular funds from the first downstream entity (e.g., a bank in Africa) to the second downstream entity (e.g., a subcontractor building developer), wherein the particular funds are part of the attributable funds.

Referring again to FIG. 16A, in an embodiment, operation 1602 may include operation 1604 depicting first transaction data receiving circuit configured to receive, from the particular architecture that is configured to enable real-time tracking and accounting of transactions involving the attributable funds, first transaction data indicating the first transmission of particular funds from the first downstream entity to the second downstream entity, wherein the particular funds are part of the attributable funds. For example, FIG. 12, e.g., FIG. 12A, shows first transaction data receiving circuit configured to receive, from the particular architecture that is configured to enable real-time tracking and accounting of transactions involving the attributable funds, first transaction data indicating the first transmission of particular funds from the first downstream entity to the second downstream entity, wherein the particular funds are part of the attributable funds 1204 receiving, from the particular architecture (e.g., the Daybreak architecture) that is configured to enable real-time tracking and accounting of transactions involving the attributable funds, first transaction data indicating the first transmission of particular funds from the first downstream entity (e.g., a hospital) to the second downstream entity (e.g., a janitor working on contract with a bank account attached to a phone that is also registered with the Daybreak architecture), wherein the particular funds are part of the attributable funds.

Referring again to FIG. 16A, in an embodiment, operation 1602 may include operation 1606 depicting first transaction data receiving circuit configured to receive, from the particular architecture that is configured to handle the first transaction data and the second transaction data, first transaction data indicating the first transmission of particular funds from the first downstream entity to the second downstream entity, wherein the particular funds are part of the attributable funds. For example, FIG. 12, e.g., FIG. 12A, shows first transaction data receiving circuit configured to receive, from the particular architecture that is configured to handle the first transaction data and the second transaction data, first transaction data indicating the first transmission of particular funds from the first downstream entity to the second downstream entity, wherein the particular funds are part of the attributable funds 1206 receiving, from the particular architecture that is configured to handle the first transaction data (e.g., the data of the first transmission of funds, e.g., the bid amount for the contract for building a school from the governmental organization to the construction contractor) and the second transaction data (e.g., the contract amount to be paid to the concrete subcontractor to lay the foundation for the school, plus the costs to the construction contractor for the overhead in managing the subcontractor) transmission of funds, first transaction data indicating the first transmission of particular funds from the first downstream entity to the second downstream entity, wherein the particular funds are part of the attributable funds.

Referring again to FIG. 16A, in an embodiment, operation 1606 may include operation 1608 depicting first transaction data receiving circuit configured to receive, from the particular architecture that is configured to handle the first transaction data and the second transaction data entirely internally to the particular architecture, first transaction data indicating the first transmission of particular funds from the first downstream entity to the second downstream entity, wherein the particular funds are part of the attributable funds. For example, FIG. 12, e.g., FIG. 12A, shows first transaction data receiving circuit configured to receive, from the particular architecture that is configured to handle the first transaction data and the second transaction data entirely internally to the particular architecture, first transaction data indicating the first transmission of particular funds from the first downstream entity to the second downstream entity, wherein the particular funds are part of the attributable funds 1208 receiving, from the particular architecture that is configured to handle the first transaction data and the second transaction data entirely internally to the particular architecture (e.g., the transactions do not actually physically move the money, the money stays in an account associated with the Daybreak architecture, but the Daybreak architecture records and verifies the transacitons and the money is recorded at its new location where it can be “offboarded” at which time a transfer will take place directly from the Daybreak architecture account to the payee, who may or may not have an account registered with the Daybreak architecture), first transaction data indicating the first transmission of particular funds from the first downstream entity to the second downstream entity, wherein the particular funds are part of the attributable funds.

Referring now to FIG. 16B, in an embodiment, operation 1404 may include operation 1610 depicting first transaction data receiving circuit configured to receive first transaction data indicating the first transmission of particular funds from a representation of the first downstream entity to a representation of the second downstream entity. For example, FIG. 12, e.g., FIG. 12A, shows first transaction data receiving circuit configured to receive first transaction data indicating the first transmission of particular funds from a representation of the first downstream entity to a representation of the second downstream entity 1210 receiving first transaction data indicating the first transmission of particular funds from a representation of the first downstream entity (e.g., an account created by a charitable organization who wants to receive some of the particular funds) to a representation of the second downstream entity (e.g., a vaccine producer who registers an account with the Daybreak architecture because they want to participate in fund dispersal).

Referring again to FIG. 16B, in an embodiment, operation 1610 may include operation 1612 depicting first transaction data receiving circuit configured to receive first transaction data indicating the first transmission of particular funds from the representation of the first downstream entity to the representation of the second downstream entity, wherein the representation of the first downstream entity and the representation of the second downstream entity are part of a particular architecture. For example, FIG. 12, e.g., FIG. 12A, shows first transaction data receiving circuit configured to receive first transaction data indicating the first transmission of particular funds from the representation of the first downstream entity to the representation of the second downstream entity, wherein the representation of the first downstream entity and the representation of the second downstream entity are part of a particular architecture 1212 receiving first transaction data indicating the first transmission of particular funds from the representation of the first downstream entity (e.g., a hospital account registered with the Daybreak architecture that uses the Daybreak architecture and account to manage its payments to its doctors, who work on contract) to the representation of the second downstream entity (e.g., the account of a particular doctor who is contracted with the hospital to treat Ebola outbreaks in third world countries) wherein the representation of the first downstream entity (e.g., the account that is part of the Daybreak architecture that represents the hospital) and the representation of the second downstream entity (e.g., the account that is part of the Daybreak architecture that represents the doctor) are part of a particular architecture (e.g., the Daybreak architecture, e.g., Daybreak architecture 3100).

Referring again to FIG. 16B, in an embodiment, operation 1612 may include operation 1614 depicting first transaction data receiving circuit configured to receive first transaction data indicating the first transmission of particular funds from the representation of the first downstream entity to the representation of the second downstream entity, wherein the representation of the first downstream entity is an account associated with the first downstream entity, and the representation of the second downstream entity is an account associated with the second downstream entity. For example, FIG. 12, e.g., FIG. 12B, shows first transaction data receiving circuit configured to receive first transaction data indicating the first transmission of particular funds from the representation of the first downstream entity to the representation of the second downstream entity, wherein the representation of the first downstream entity is an account associated with the first downstream entity, and the representation of the second downstream entity is an account associated with the second downstream entity 1214 receiving first transaction data indicating the first transmission of particular funds from the representation of the first downstream entity to the representation of the second downstream entity, wherein the representation of the first downstream entity is an account associated with the first downstream entity, and the representation of the second downstream entity is an account associated with the second downstream entity (e.g., a schoolteacher who works for a remote school in an underdeveloped nation).

Referring again to FIG. 16B, in an embodiment, operation 1614 may include operation 1616 depicting first transaction data receiving circuit configured to receive first transaction data indicating the first transmission of particular funds from a first architecture account managed by the particular architecture and associated with the first downstream entity to a second architecture account managed by the particular architecture and associated with the second downstream entity. For example, FIG. 12, e.g., FIG. 12B, shows first transaction data receiving circuit configured to receive first transaction data indicating the first transmission of particular funds from a first architecture account managed by the particular architecture and associated with the first downstream entity to a second architecture account managed by the particular architecture and associated with the second downstream entity 1216 receiving first transaction data indicating the first transmission of particular funds from a first architecture account (e.g., an account associated with a homebuilding charity) managed by the particular architecture and associated with the first downstream entity (e.g., the homebuilding charity) to a second architecture account managed by the particular architecture (e.g., the Daybreak architecture) and associated with the second downstream entity (e.g., the tool supplier).

Referring now to FIG. 16C, in an embodiment, operation 1404 may include operation 1618 depicting first transaction data request receiving circuit configured to receive first transaction data indicating a received request to transmit particular funds from the first downstream entity to the second downstream entity. For example, FIG. 12, e.g., FIG. 12C, shows first transaction data request receiving circuit configured to receive first transaction data indicating a received request to transmit particular funds from the first downstream entity to the second downstream entity 1218 receiving first transaction data indicating a received request to transmit particular funds from the first downstream entity (e.g., a truck driving contractor) to the second downstream entity (e.g., truck drivers, e.g., where the third downstream entity might be the gas station where the truck drivers fill their trucks with gasoline).

Referring again to FIG. 16C, in an embodiment, operation 1404 may include operation 1620, which may appear in conjunction with operation 1618, operation 1620 depicting first transaction data receiving circuit configured to receive first transaction data indicating a first transmission of particular funds from a representation of the first downstream entity to a representation of the second downstream entity, wherein the particular funds are not transferred from the first downstream entity to the downstream entity. For example, FIG. 12, e.g., FIG. 12C, shows first transaction data receiving circuit configured to receive first transaction data indicating a first transmission of particular funds from a representation of the first downstream entity to a representation of the second downstream entity, wherein the particular funds are not transferred from the first downstream entity to the downstream entity 1220 receiving a first transaction data indicating a first transmission of particular funds from the representation (e.g., the Daybreak architecture account) of the first downstream entity (e.g., a government entity that assigns bid contracts to construction entities) to a representation (e.g., a different Daybreak architecture account) of the second downstream entity (e.g., a construction contractor).

Referring again to FIG. 16C, in an embodiment, operation 1620 may include operation 1622 depicting first transaction data receiving circuit configured to receive first transaction data indicating the first transmission of particular funds from the representation of the first downstream entity to the representation of the second downstream entity, wherein the representation of the first downstream entity and the representation of the second downstream entity are part of a particular architecture. For example, FIG. 12, e.g., FIG. 12C, shows first transaction data receiving circuit configured to receive first transaction data indicating the first transmission of particular funds from the representation of the first downstream entity to the representation of the second downstream entity, wherein the representation of the first downstream entity and the representation of the second downstream entity are part of a particular architecture 1222 receiving first transaction data indicating the first transmission of particular funds from the representation of the first downstream entity to the representation of the second downstream entity, wherein the representation of the first downstream entity and the representation of the second downstream entity are part of a particular architecture (e.g., the Daybreak architecture).

Referring again to FIG. 16C, in an embodiment, operation 1620 may include operation 1624 depicting first transaction data receiving circuit configured to receive first transaction data indicating the first transmission of particular funds from a first architecture account representation of the first downstream entity to a second architecture account representation of the second downstream entity. For example, FIG. 12, e.g., FIG. 12C, shows first transaction data receiving circuit configured to receive first transaction data indicating the first transmission of particular funds from a first architecture account representation of the first downstream entity to a second architecture account representation of the second downstream entity 1224 receiving first transaction data indicating the first transmission of particular funds from a first architecture account representation (e.g., an account registered with and tracked by the Daybreak architecture) of the first downstream entity (e.g., a charitable organization) to a second architecture account representation of the second downstream entity (e.g., a subsidiary of the charitable organization).

Referring again to FIG. 16C, in an embodiment, operation 1624 may include operation 1626 depicting first transaction data receiving circuit configured to receive first transaction data indicating the first transmission of particular funds from the first architecture account representation of the first downstream entity to the architecture account representation of the second downstream entity, wherein the first architecture account representation of the first downstream entity is an account that was registered with the architecture by the first downstream entity. For example, FIG. 12, e.g., FIG. 12C, shows first transaction data receiving circuit configured to receive first transaction data indicating the first transmission of particular funds from the first architecture account representation of the first downstream entity to the architecture account representation of the second downstream entity, wherein the first architecture account representation of the first downstream entity is an account that was registered with the architecture by the first downstream entity 1226 receiving first transaction data indicating the first transmission of particular funds from the first architecture account representation of the first downstream entity to the architecture account representation of the second downstream entity (e.g., a nurses' association), wherein the first architecture account representation of the first downstream entity is an account that was registered with the architecture by the first downstream entity (e.g., a hospital)

Referring again to FIG. 16C, in an embodiment, operation 1624 may include operation 1628 depicting first transaction data receiving circuit configured to receive first transaction data indicating the first transmission of particular funds from the first architecture account representation of the first downstream entity to the architecture account representation of the second downstream entity, wherein the second architecture account representation of the second downstream entity is an account that was registered with the architecture by the second downstream entity. For example, FIG. 12, e.g., FIG. 12C, shows first transaction data receiving circuit configured to receive first transaction data indicating the first transmission of particular funds from the first architecture account representation of the first downstream entity to the architecture account representation of the second downstream entity, wherein the second architecture account representation of the second downstream entity is an account that was registered with the architecture by the second downstream entity 1228 receiving first transaction data indicating the first transmission of particular funds from the first architecture account representation of the first downstream entity (e.g., a building contractor) to the architecture account representation of the second downstream entity, wherein the second architecture account representation of the second downstream entity is an account that was registered with the architecture by the second downstream entity (e.g., a landscaping company)

Referring now to FIG. 16D, operation 1404 may include operation 1630 depicting first transaction data receiving circuit configured to receive first transaction data indicating the first transmission of particular funds from the first downstream entity to the second downstream entity, wherein the particular funds represent a portion of the attributable funds. For example, FIG. 12, e.g., FIG. 12D, shows first transaction data receiving circuit configured to receive first transaction data indicating the first transmission of particular funds from the first downstream entity to the second downstream entity, wherein the particular funds represent a portion of the attributable funds 1230 receiving first transaction data indicating the first transmission of particular funds from the first downstream entity (e.g., a building subcontractor) to the second downstream entity (e.g., a lumber supplier), wherein the particular funds represent a portion of the attributable funds.

Referring again to FIG. 16D, operation 1404 may include operation 1632 depicting first transaction data receiving circuit configured to receive first transaction data indicating the first transmission of particular funds from the first downstream entity to the second downstream entity, wherein the particular funds represent a portion of the attributable funds, wherein the attributable funds are owned by a single entity. For example, FIG. 12, e.g., FIG. 12D, shows first transaction data receiving circuit configured to receive first transaction data indicating the first transmission of particular funds from the first downstream entity to the second downstream entity, wherein the particular funds represent a portion of the attributable funds, wherein the attributable funds are owned by a single entity 1232 receiving first transaction data indicating the first transmission of particular funds from the first downstream entity (e.g., a large government contractor) to the second downstream entity (e.g., a smaller contractor that makes weapons), wherein the particular funds represent a portion of the attributable funds, wherein the attributable funds are owned by a single entity (e.g., all of the attributable funds are owned by a single entity but each particular funds might have a different distribution rule set attached to it, e.g., 500,000 of the funds might be required for food spending, and 150,000 for medical spending, etc., with various conditions and limiters specified as described herein).

Referring again to FIG. 16D, operation 1404 may include operation 1634 depicting first transaction data receiving circuit configured to receive first transaction data indicating the first transmission of particular funds from the first downstream entity to the second downstream entity, wherein the particular funds represent a portion of the attributable funds that are owned by a single entity, and the attributable funds are owned by more than one entity. For example, FIG. 12, e.g., FIG. 12D, shows first transaction data receiving circuit configured to receive first transaction data indicating the first transmission of particular funds from the first downstream entity to the second downstream entity, wherein the particular funds represent a portion of the attributable funds that are owned by a single entity, and the attributable funds are owned by more than one entity 1234 receiving first transaction data indicating the first transmission of particular funds from the first downstream entity to the second downstream entity, wherein the particular funds represent a portion of the attributable funds that are owned by a single entity, and the attributable funds are owned by more than one entity (e.g., the attributable funds are several different persons' money, of which the particular funds are the portion of the attributable funds owned by a single person).

Referring again to FIG. 16D, operation 1634 may include operation 1636 depicting first transaction data receiving circuit configured to receive first transaction data indicating the first transmission of particular funds from the first downstream entity to the second downstream entity, wherein the particular funds represent a portion of the attributable funds that are owned by a single entity, and the attributable funds are owned by more than one entity but are stored in a single underlying bank account. For example, FIG. 12, e.g., FIG. 12D, shows first transaction data receiving circuit configured to receive first transaction data indicating the first transmission of particular funds from the first downstream entity to the second downstream entity, wherein the particular funds represent a portion of the attributable funds that are owned by a single entity, and the attributable funds are owned by more than one entity but are stored in a single underlying bank account 1236 receiving first transaction data indicating the first transmission of particular funds from the first downstream entity to the second downstream entity, wherein the particular funds represent a portion of the attributable funds that are owned by a single entity, and the attributable funds are owned by more than one entity but are stored in a single underlying bank account (e.g., all of the attributable funds for various clients are deposited into a single bank account which does not discriminate regarding its funds, and the disposition of the funds and their owners is managed entirely within the Daybreak architecture, except when funds are directly offboarded).

Referring now to FIG. 16E, operation 1404 may include operation 1638 depicting first transaction data receiving circuit configured to receive first transaction data that indicates the first transmission of the particular funds from the first downstream entity to the second downstream entity, wherein the first downstream entity is a local domestic bank and the second downstream entity is a national domestic bank. For example, FIG. 12, e.g., FIG. 12E, shows first transaction data receiving circuit configured to receive first transaction data that indicates the first transmission of the particular funds from the first downstream entity to the second downstream entity, wherein the first downstream entity is a local domestic bank and the second downstream entity is a national domestic bank 1238 receiving first transaction data indicating the first transmission of the particular funds from the first downstream entity to the second downstream entity, wherein the first downstream entity is a local domestic bank (e.g., Boeing Employees Credit Union) and the second downstream entity is a national domestic bank (e.g., Wells Fargo).

Referring again to FIG. 16E, operation 1404 may include operation 1640 depicting first transaction data receiving circuit configured to receive first transaction data that indicates the first transmission of the particular funds from the first downstream entity to the second downstream entity, wherein the first downstream entity is a national domestic bank and the second downstream entity is a European bank. For example, FIG. 12, e.g., FIG. 12E, shows first transaction data receiving circuit configured to receive first transaction data that indicates the first transmission of the particular funds from the first downstream entity to the second downstream entity, wherein the first downstream entity is a national domestic bank and the second downstream entity is a European bank 1240 receiving first transaction data indicating the first transmission of the particular funds from the first downstream entity to the second downstream entity, wherein the first downstream entity is a national domestic bank (e.g., Bank of America) and the second downstream entity is a European bank (e.g., Bank of London).

Referring again to FIG. 16E, operation 1404 may include operation 1642 depicting first transaction data receiving circuit configured to receive first transaction data indicating the first transmission of the particular funds from the first downstream entity to the second downstream entity, wherein the first downstream entity is a European bank and the second downstream entity is a foreign non-European bank. For example, FIG. 12, e.g., FIG. 12E, shows first transaction data receiving circuit configured to receive first transaction data indicating the first transmission of the particular funds from the first downstream entity to the second downstream entity, wherein the first downstream entity is a European bank and the second downstream entity is a foreign non-European bank 1242 receiving first transaction data indicating the first transmission of the particular funds from the first downstream entity to the second downstream entity, wherein the first downstream entity is a European bank and the second downstream entity is a foreign non-European bank.

Referring again to FIG. 16E, operation 1404 may include operation 1644 depicting first transaction data receiving circuit configured to receive first transaction data indicating the first transmission of the particular funds from the first downstream entity to the second downstream entity, wherein the first downstream entity is a foreign non-European bank and the second downstream entity is a foreign organization. For example, FIG. 12, e.g., FIG. 12E, shows first transaction data receiving circuit configured to receive first transaction data indicating the first transmission of the particular funds from the first downstream entity to the second downstream entity, wherein the first downstream entity is a foreign non-European bank and the second downstream entity is a foreign organization 1244 receiving first transaction data indicating the first transmission of the particular funds from the first downstream entity to the second downstream entity, wherein the first downstream entity is a foreign non-European bank and the second downstream entity is a foreign organization (e.g., a charitable institution based in Iraq).

Referring again to FIG. 16E, operation 1404 may include operation 1646 depicting first transaction data receiving circuit configured to receive first transaction data indicating the first transmission of the particular funds from the first downstream entity to the second downstream entity, wherein the first downstream entity is a first foreign organization and the second downstream entity is a second foreign organization. For example, FIG. 12, e.g., FIG. 12E, shows first transaction data receiving circuit configured to receive first transaction data indicating the first transmission of the particular funds from the first downstream entity to the second downstream entity, wherein the first downstream entity is a first foreign organization and the second downstream entity is a second foreign organization 1246 receiving first transaction data indicating the first transmission of the particular funds from the first downstream entity to the second downstream entity, wherein the first downstream entity is a first foreign organization and the second downstream entity is a second foreign organization.

Referring now to FIG. 16F, operation 1404 may include operation 1648 depicting first transaction data receiving circuit configured to receive first transaction data indicating the first transmission of particular funds from the first downstream entity to the second downstream entity, wherein the first transmission of particular funds occurs within a particular architecture. For example, FIG. 12, e.g., FIG. 12E, shows first transaction data receiving circuit configured to receive first transaction data indicating the first transmission of particular funds from the first downstream entity to the second downstream entity, wherein the first transmission of particular funds occurs within a particular architecture 1248 receiving first transaction data indicating the first transmission of particular funds form the first downstream entity to the second downstream entity, wherein the first transmission of particular funds occurs within a particular architecture (e.g., the first transmission of funds takes place within the Daybreak architecture, e.g., from a first Daybreak account to a second Daybreak account).

Referring again to FIG. 16F, operation 1648 may include operation 1650 depicting first transaction data receiving circuit configured to receive first transaction data indicating the first transmission of particular funds from the first downstream entity to the second downstream entity, wherein the first transmission of particular funds occurs within the particular architecture that performs verification of the first transmission before allowing the first transmission. For example, FIG. 12, e.g., FIG. 12E, shows first transaction data receiving circuit configured to receive first transaction data indicating the first transmission of particular funds from the first downstream entity to the second downstream entity, wherein the first transmission of particular funds occurs within the particular architecture that performs verification of the first transmission before allowing the first transmission 1250 receiving first transaction data indicating the first transmission of particular funds from the first downstream entity to the second downstream entity, wherein the first transmission of particular funds occurs within the particular architecture that performs verification of the first transmission (e.g., that the transaction complies with the distribution rule set, e.g., the vendor is registered, the timing of the transaction is proper, the amount is not too large, the funds have been earmarked for that specific purpose, the vendor is a trusted vendor, the vendor is on an approved list, the vendor is registered as an approved type) before allowing the first transmission.

Referring again to FIG. 16F, operation 1650 may include operation 1652 depicting first transaction data receiving circuit configured to receive first transaction data indicating the first transmission of particular funds from the first downstream entity to the second downstream entity, wherein the first transmission of particular funds occurs within the particular architecture that performs verification of the first transmission for compliance with the distribution rule set before allowing the first transmission. For example, FIG. 12, e.g., FIG. 12F, shows first transaction data receiving circuit configured to receive first transaction data indicating the first transmission of particular funds from the first downstream entity to the second downstream entity, wherein the first transmission of particular funds occurs within the particular architecture that performs verification of the first transmission for compliance with the distribution rule set before allowing the first transmission 1252 receiving first transaction data indicating the first transmission of particular funds from the first downstream entity (e.g., a national bank) to the second downstream entity (e.g., a non-profit organization dedicated to erecting schools), wherein the first transmission of particular funds occurs within the particular architecture (e.g., the transfer of funds takes place from an account within the particular architecture, e.g., the Daybreak architecture, to another account within the Daybreak architecture, without actually physically moving the money from various accounts that may be set up at various banks and across city, state, national, or international lines) that performs verification of the first transmission for compliance with the distribution rule set before allowing the first transmission (e.g., the transmission of funds to the non-profit for use in purchasing textbooks for the schools).

Referring now to FIG. 12G, operation 1404 may include operation 1654 depicting first transaction data receiving circuit configured to receive first transaction data indicating that the first transmission of particular funds is compliant with the distribution rule set. For example, FIG. 12, e.g., FIG. 12G, shows first transaction data receiving circuit configured to receive first transaction data indicating that the first transmission of particular funds is compliant with the distribution rule set 1254 receiving first transaction data indicating that the first transmission of particular funds is compliant with the distribution rule set.

Referring again to FIG. 12G, operation 1654 may include operation 1656 depicting first transaction data receiving circuit configured to receive first transaction data indicating that the first transmission of the particular funds is compliant with the distribution rule set that specifies real time reporting associated with actions taken on the particular funds. For example, FIG. 12, e.g., FIG. 12G, shows first transaction data receiving circuit configured to receive first transaction data indicating that the first transmission of the particular funds is compliant with the distribution rule set that specifies real time reporting associated with actions taken on the particular funds 1256 receiving first transaction data indicating that the first transmission of the particular funds is compliant with the distribution rule set that specifies real time reporting (e.g., the funds are to be reported back to the daybreak architecture as spent as they are being spent) associated with actions taken on the particular funds).

Referring again to FIG. 12G, operation 1654 may include operation 1658 depicting first transaction data receiving circuit configured to receive first transaction data indicating that the first transmission of particular funds has passed compliance with the distribution rule set that specifies one or more permissible identities of the second downstream entity. For example, FIG. 12, e.g., FIG. 12G, shows first transaction data receiving circuit configured to receive first transaction data indicating that the first transmission of particular funds has passed compliance with the distribution rule set that specifies one or more permissible identities of the second downstream entity 1258 receiving first transaction data indicating that the first transmission of particular funds has passed compliance with the distribution rule set that specifies one or more permissible identities (e.g., hospital, school, food bank, homeless shelter) of the second downstream entity.

Referring again to FIG. 12G, operation 1654 may include operation 1660 depicting first transaction data receiving circuit configured to receive first transaction data indicating that the first transmission of particular funds has passed compliance with the distribution rule set that specifies an amount of data to be collected regarding the first transmission of the particular funds. For example, FIG. 12, e.g., FIG. 12G, shows first transaction data receiving circuit configured to receive first transaction data indicating that the first transmission of particular funds has passed compliance with the distribution rule set that specifies an amount of data to be collected regarding the first transmission of the particular funds 1260 receiving first transaction data indicating that the first transmission of particular funds has passed compliance with the distribution rule set that specifies an amount of data to be collected regarding the first transmission of the particular funds.

Referring again to FIG. 12G, operation 1660 may include operation 1662 depicting first transaction data receiving circuit configured to receive first transaction data indicating that the first transmission of particular funds has passed compliance with the distribution rule set that specifies photographic evidence and location tracking evidence data to be collected regarding the first transmission of the particular funds. For example, FIG. 12, e.g., FIG. 12G, shows first transaction data receiving circuit configured to receive first transaction data indicating that the first transmission of particular funds has passed compliance with the distribution rule set that specifies photographic evidence and location tracking evidence data to be collected regarding the first transmission of the particular funds 1262 receiving first transaction data indicating that the first transmission of particular funds has passed compliance with the distribution rule set that specifies phographic evidence (e.g., pictures of the employees that were hired for the building of the hospital) and location tracking evidence (e.g., RFID location tags on the bags of concrete brought into the site for use in building the hospital, but which may have been stolen or misappropriated for personal projects by bad actors) regarding the first transmission of the particular funds.

Referring now to FIG. 12H, operation 1404 may include operation 1664 depicting first transaction data receiving circuit configured to receive first transaction data indicating that the first transmission of particular funds is compliant with the distribution rule set that requires that one or more of the first, second, and third downstream entities are trusted entities. For example, FIG. 12, e.g., FIG. 12G, shows first transaction data receiving circuit configured to receive first transaction data indicating that the first transmission of particular funds is compliant with the distribution rule set that requires that one or more of the first, second, and third downstream entities are trusted entities 1264 receiving first transaction data indicating that the first transmission of particular funds is compliant with the distribution rule set that requires one or more of the first, second, and third downstream entities are trusted entities (e.g., they are listed by the distribution rule set as trusted entities or they meet the conditions specified in the distribution rule set (e.g., length of time in business) to be a trusted entity.

Referring again to FIG. 12H, operation 1664 may include operation 1666 depicting first transaction data receiving circuit configured to receive first transaction data indicating that the first transmission of particular funds is compliant with the distribution rule set that requires that one or more of the first, second, and third downstream entities are trusted entities as established by a particular architecture that tracks one or more reputation scores of the one or more of the first, second, and third downstream entities. For example, FIG. 12, e.g., FIG. 12H, shows first transaction data receiving circuit configured to receive first transaction data indicating that the first transmission of particular funds is compliant with the distribution rule set that requires that one or more of the first, second, and third downstream entities are trusted entities as established by a particular architecture that tracks one or more reputation scores of the one or more of the first, second, and third downstream entities 1266 receiving first transaction data indicating that the first transmission of particular funds is compliant with the distribution rule set that requires that one or more of the first, second, and third downstream entities are trusted entities as established by a particular architecture (e.g., the Daybreak architecture) that tracks one or more reputation scores (e.g., scores based on compliance with distribution rule set, or feedback of entities associated with the Daybreak architecture, or feedback of entities not associated with the Daybreak architecture).

FIGS. 17A-17C depict various implementations of operation 1406, depicting second transaction data receiving circuit configured to receive second transaction data indicating a second transmission of the particular funds from the second downstream entity to the third downstream entity, according to embodiments. Referring now to FIG. 13A, operation 1406 may include operation 1702 depicting second transaction data receiving circuit configured to receive, from a particular architecture, second transaction data indicating the second transmission of particular funds from the second downstream entity to the third downstream entity, wherein the particular funds are part of the attributable funds. For example, FIG. 13, e.g., FIG. 13A, shows second transaction data receiving circuit configured to receive, from a particular architecture, second transaction data indicating the second transmission of particular funds from the second downstream entity to the third downstream entity, wherein the particular funds are part of the attributable funds 802 receiving, from a particular architecture (e.g., from an account registered with the Daybreak architecture), second transaction data indicating the second transmission (e.g., a viewable second transmission of the same or partially the same funds) from the second downstream entity (e.g., a subcontractor) to the third downstream entity (e.g., a concrete supplier), wherein the particular funds are part of the attributable funds.

Referring again to FIG. 13A, in an embodiment, operation 1702 may include operation 1704 depicting second transaction data receiving circuit configured to receive, from the particular architecture that is configured to implement a reward unit, second transaction data indicating the second transmission of particular funds from the second downstream entity to the third downstream entity. For example, FIG. 13, e.g., FIG. 13A, shows second transaction data receiving circuit configured to receive, from the particular architecture that is configured to implement a reward unit, second transaction data indicating the second transmission of particular funds from the second downstream entity to the third downstream entity 1704 receiving, from the particular architecture (e.g., the Daybreak architecture), that is configured to implement a reward unit (e.g., part of the architecture can modify the distribution rule set or provide cash or incentive rewards to vendors who follow specific guidelines for the distribution rule set), second transaction data indicating the second transmission of particular funds from the second downstream entity (e.g., a school) to the third downstream entity (e.g., a school computer supplier).

Referring again to FIG. 13A, in an embodiment, operation 1704 may include operation 1706 depicting second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of transaction-related data within a particular timeframe. For example, FIG. 13, e.g., FIG. 13A, shows second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of transaction-related data within a particular timeframe 1306 receiving, from the particular architecture (e.g., the Daybreak architecture) that is configured to implement the reward unit (e.g., part of the architecture can modify the distribution rule set or provide cash or incentive rewards to vendors who follow specific guidelines for the distribution rule set, or increase the reputation score in various tracking mechanisms for that vendor to increase the likelihood that that vendor will get repeat business in other transacitons with potentially unrelated entities), second transaction data indicating that second transmission of the particular funds from the second downstream entity (e.g., a church) to the third downstream entity (e.g., a food kitchen), wherein the reward unit is configured to reward inclusion of transaction-related data (e.g., photographic evidence of the food being purchased by the food kitchen and/or distributed to the needy) within a particular timeframe (e.g., within twenty-four hours).

Referring again to FIG. 17A, in an embodiment, operation 1706 may include operation 1708 depicting second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of photographic evidence of effect of the second transmission of particular funds. For example, FIG. 13, e.g., FIG. 13A, shows second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of photographic evidence of effect of the second transmission of particular funds 1308 receiving, from the particular architecture that is configured to implement the reward unit (e.g., part of the architecture can modify the distribution rule set or provide cash or incentive rewards to vendors who follow specific guidelines for the distribution rule set, or increase the reputation score in various tracking mechanisms for that vendor to increase the likelihood that that vendor will get repeat business in other transacitons with potentially unrelated entities), second transaction data indicating that second transmission of particular funds from the second downstream entity (e.g., a grocery supplier) to the third downstream entity (e.g., a dairy supplier), wherein the reward unit is configured to reward inclusion of photographic evidence (e.g., photos of the milk that was purchased that are uploaded of the Daybreak architecture and associated with the attributable funds for verification and to complete the rules, e.g., specified by the Distribution rule set) of effect of the second transmission of particular funds.

Referring again to FIG. 17A, in an embodiment, operation 1706 may include operation 1710 depicting second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of photographic evidence of goods that were purchased as a result of the second transmission of particular funds. For example, FIG. 13, e.g., FIG. 13A, shows second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of photographic evidence of goods that were purchased as a result of the second transmission of particular funds 1310 receiving, from the particular architecture that is configured to implement the reward unit (e.g., part of the architecture can modify the distribution rule set or provide cash or incentive rewards to vendors who follow specific guidelines for the distribution rule set, or increase the reputation score in various tracking mechanisms for that vendor to increase the likelihood that that vendor will get repeat business in other transacitons with potentially unrelated entities), second transaction data indicating that second transmission of particular funds from the second downstream entity (e.g., a grocery supplier) to the third downstream entity (e.g., a cereal box supplier), wherein the reward unit is configured to reward inclusion of photographic evidence (e.g., photos of the cereal that was purchased that are uploaded to the Daybreak architecture and associated with the attributable funds for verification and requested by the distribution rule set with an additional bonus of allowing a higher percentage of the funds to be offloaded by the entities that facilitated the transaction, e.g., the representatives in charge at the location) of effect of the second transmission of particular funds.

Referring now to FIG. 17B, in an embodiment, operation 1706 may include operation 1712 depicting second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of location tracking data of effect of the second transmission of particular funds. For example, FIG. 13, e.g., FIG. 13B, shows second transaction data receiving circuit configured to receive, from the particular architecture that is configured to implement the reward unit, second transaction data indicating that second transmission of particular funds from the second downstream entity to the third downstream entity, wherein the reward unit is configured to reward inclusion of location tracking data of effect of the second transmission of particular funds 1312 receiving, from the particular architecture (e.g., a non-Daybreak architecture that is implemented directly by a bank that wishes to more tightly control how the money is spent within that bank's jurisdiction) that is configured to implement the reward unit, second transaction data indicating that second transmission of particular funds from the second downstream entity (e.g., a hospital) to the third downstream entity (e.g., a vaccine supplier), wherein the reward unit is configured to reward inclusion of location tracking data (e.g., RFID tags on the various vaccine packs) of effect of the second transmission of particular funds.

Referring now to FIG. 17C, in an embodiment, operation 1406 may include operation 1714 depicting second transaction data receiving circuit configured to receive, from the particular architecture that is configured to implement a penalty unit, second transaction data indicating the second transmission of particular funds from the second downstream entity to the third downstream entity. For example, FIG. 13, e.g., FIG. 13C, shows second transaction data receiving circuit configured to receive, from the particular architecture that is configured to implement a penalty unit, second transaction data indicating the second transmission of particular funds from the second downstream entity to the third downstream entity 1314 receiving, from the particular architecture (e.g., a non-Daybreak architecture that is implemented directly by a charitable organization that wishes to more tightly control how the money is spent within that charitable organization's jurisdiction) that is configured to implement a penalty unit (e.g., an implementation that penalizes, in the form of decreased score or reputation, decrease in amount of business done, decrease in preferential treatment, decrease in percentage of transaction fees, or actual monetary penalties), second transaction data indicating the second transmission of particular funds from the second downstream entity (e.g., a labor organization) to the third downstream entity (e.g., a day laborer who has an account through his phone with an M-PESA system).

Referring again to FIG. 17C, in an embodiment, operation 1714 may include operation 1716 depicting second transaction data receiving circuit configured to receive, from the particular architecture that is configured to implement the penalty unit, second transmission data indicating the second transmission of particular funds from the second downstream entity to the third downstream entity, wherein the penalty unit is configured to penalize one or more of the second downstream entity and the third downstream entity based on the distribution rule set. For example, FIG. 13, e.g., FIG. 13B, shows second transaction data receiving circuit configured to receive, from the particular architecture that is configured to implement the penalty unit, second transmission data indicating the second transmission of particular funds from the second downstream entity to the third downstream entity, wherein the penalty unit is configured to penalize one or more of the second downstream entity and the third downstream entity based on the distribution rule set 1316 receiving, from the particular architecture (e.g., the Daybreak architecture), that is configured of implement the penalty unit, second transmission data indicating the second transmission of particular funds form the second downstream entity (e.g., a trucking company) to the third downstream entity (e.g., a trucker employee of the trucking company that has her bank account tied to her mobile phone), wherein the penalty unit is configured to penalize one or more of the second downstream entity and the third downstream entity based on the distribution rule set (e.g., if GPS data shows the trucker employee left after four hours but collected eight hours of pay, the distribution rule set specifies the penalty, e.g., it may be a first-offense warning).

Referring again to FIG. 17C, in an embodiment, operation 1716 may include operation 1718 depicting second transaction data receiving circuit configured to receive, from the particular architecture that is configured to implement the penalty unit, second transmission data indicating the second transmission of particular funds from the second downstream entity to the third downstream entity, wherein the penalty unit is configured to penalize one or more of the second downstream entity and the third downstream entity for failure to comply with one or more conditions of the distribution rule set. For example, FIG. 13, e.g., FIG. 13B, shows second transaction data receiving circuit configured to receive, from the particular architecture that is configured to implement the penalty unit, second transmission data indicating the second transmission of particular funds from the second downstream entity to the third downstream entity, wherein the penalty unit is configured to penalize one or more of the second downstream entity and the third downstream entity for failure to comply with one or more conditions of the distribution rule set 1318 receiving, from the particular architecture that is configured to implement the penalty unit, second transmission data indicating the second transmission of particular funds from the second downstream entity to the third downstream entity, wherein the penalty unit is configured to penalize one or more of the second downstream entity (e.g., a hospital) and the third downstream entity (e.g., a doctor employee of the hospital) for failure to comply with one or more conditions of the distribution rule set (e.g., the doctor was paid too much money for the services rendered).

Referring again to FIG. 17C, in an embodiment, operation 1718 may include operation 1720 depicting second transaction data receiving circuit configured to receive, from the particular architecture that is configured to implement the penalty unit, second transmission data indicating the second transmission of particular funds from the second downstream entity to the third downstream entity, wherein the penalty unit is configured to penalize one or more of the second downstream entity and the third downstream entity for failure to provide photographic and/or location data within a time period specified by the distribution rule set. For example, FIG. 13, e.g., FIG. 13C, shows second transaction data receiving circuit configured to receive, from the particular architecture that is configured to implement the penalty unit, second transmission data indicating the second transmission of particular funds from the second downstream entity to the third downstream entity, wherein the penalty unit is configured to penalize one or more of the second downstream entity and the third downstream entity for failure to provide photographic and/or location data within a time period specified by the distribution rule set 1320 receiving, from the particular architecture (e.g., the Daybreak architecture or similar other embodiments) that is configured to implement the penalty unit (e.g., a portion of the architecture, which, in an embodiment, may be part of the distribution rules set), second transmission data indicating the second transmission (e.g., movement within accounts under the control and management of the daybreak architecture) of particular funds from the second downstream entity (e.g., a government contractor) to the third downstream entity (e.g., a building supply contractor), wherein the penalty unit is configured to penalize one or more of the second downstream entity and the third downstream entity for failure to provide photographic and/or location data (e.g., photographic data of the supply contractor that is going to provide the building supplies) and/or location data (e.g., location data of the building supply contractor's offices and construction sites, or GPS tags of its trucks, or RFID tags of its building supplies) within a time period (e.g., seventy two hours) specified by the distribution rule set.

Referring now to FIG. 17D, in an embodiment, operation 1406 may include operation 1722 depicting second transaction data receiving circuit configured to receive second transaction data indicating that the second transmission of the particular funds from the second downstream entity to the third downstream entity has been approved. For example, FIG. 13, e.g., FIG. 13D, shows second transaction data receiving circuit configured to receive second transaction data indicating that the second transmission of the particular funds from the second downstream entity to the third downstream entity has been approved 1322 receiving second transaction data indicating that the second transmission of the particular funds from the second downstream entity (e.g., a medical supply middle man) to the third downstream entity (e.g., a generic drug supplier) has been approved.

Referring again to FIG. 17D, in an embodiment, operation 1406 may include operation 1724, which may appear in conjunction with operation 1722, operation 1724 depicting second transmission data receiving circuit configured to receive second transmission data indicating the second transmission of the particular funds from the second downstream entity to the third downstream entity has been carried out. For example, FIG. 13, e.g., FIG. 13D, shows second transmission data receiving circuit configured to receive second transmission data indicating the second transmission of the particular funds from the second downstream entity to the third downstream entity has been carried out 1324 receiving second transmission data indicating the second transmission of the particular funds from the second downstream entity (e.g., a food supplies vendor) to the third downstream entity (e.g., a beef supplier) has been carried out (e.g., the transaction has occurred in the Daybreak architecture and is ready for offboarding, which will involve a direct debiting of the particular funds as a real transaction but will appear in the Daybreak architecture as flowing through the various vendors.

Referring again to FIG. 17D, in an embodiment, operation 1722 may include operation 1726 depicting second transaction data receiving circuit configured to receive second transaction data indicating that the second transmission of the particular funds from the second downstream entity to the third downstream entity has been approved by a particular architecture. For example, FIG. 13, e.g., FIG. 13D, shows second transaction data receiving circuit configured to receive second transaction data indicating that the second transmission of the particular funds from the second downstream entity to the third downstream entity has been approved by a particular architecture 1326 receiving second transaction data indicating that the second transmission of the particular funds (e.g., funds earmarked for penicillin) from the second downstream entity (e.g., a hospital) to the third downstream entity (e.g., a medical supplier) has been approved by a particular architecture (e.g., the daybreak architecture).

Referring again to FIG. 17D, in an embodiment, operation 1726 may include operation 1728 depicting second transaction data receiving circuit configured to receive second transaction data indicating that the second transmission of the particular funds from the second downstream entity to the third downstream entity has been approved by the particular architecture configured to manage the second transmission internally. For example, FIG. 13, e.g., FIG. 13D, shows second transaction data receiving circuit configured to receive second transaction data indicating that the second transmission of the particular funds from the second downstream entity to the third downstream entity has been approved by the particular architecture configured to manage the second transmission internally 1328 receiving second transaction data indicating that the second transmission of the particular funds from the second downstream entity to the third downstream entity has been approved by the particular architecture configured to manage the second transmission internally (e.g., the transmission occurs solely within the accounts of the Daybreak architecture).

Referring again to FIG. 17D, in an embodiment, operation 1728 may include operation 1730 depicting second transaction data receiving circuit configured to receive second transaction data indicating that the second transmission of the particular funds from the second downstream entity to the third downstream entity has been approved by the particular architecture configured to manage the second transmission internally and to carry out the second transaction internally to the particular architecture. For example, FIG. 13, e.g., FIG. 13D, shows second transaction data receiving circuit configured to receive second transaction data indicating that the second transmission of the particular funds from the second downstream entity to the third downstream entity has been approved by the particular architecture configured to manage the second transmission internally and to carry out the second transaction internally to the particular architecture 1330 receiving second transaction data indicating that the second transmission of the particular funds from the second downstream entity to the third downstream entity has been approved by the particular architecture (e.g., the Daybreak architecture or an embodiment that manages accounts) configured to manage the second transmission internally and to carry out the second transaction internally to the particular architecture (e.g., to a non-Daybreak architecture provided by a government of a foreign country that requires its use to distribute funds within the borders of its country).

Referring now to FIG. 17E, in an embodiment, operation 1722 may include operation 1732 depicting second transaction data receiving circuit configured to receive second transaction data indicating that the second transmission of the particular funds from the second downstream entity has been approved by a particular architecture configured to carry out transaction analysis of the second transaction data. For example, FIG. 13, e.g., FIG. 13E, shows second transaction data receiving circuit configured to receive second transaction data indicating that the second transmission of the particular funds from the second downstream entity has been approved by a particular architecture configured to carry out transaction analysis of the second transaction data 1332 receiving second transaction data indicating that the second transmission of the particular funds from the second downstream entity has been approved by a particular architecture configured to carry out transaction analysis (e.g., an analysis of whether the transaction is likely to be fraudulent, or an analysis to determine whether the transaction complies with a specific part of the distribution rule set, e.g., does the vendor meet the criteria specified in the distribution rule set for a transfer of over ten thousand dollars on a weekday).

Referring again to FIG. 17E, in an embodiment, operation 1722 may include operation 1734 depicting second transaction data receiving circuit configured to receive second transaction data indicating that the second transmission of the particular funds from the second downstream entity has been approved by the particular architecture configured to carry out fraud analysis of the second transaction data. For example, FIG. 13, e.g., FIG. 13E, shows second transaction data receiving circuit configured to receive second transaction data indicating that the second transmission of the particular funds from the second downstream entity has been approved by the particular architecture configured to carry out fraud analysis of the second transaction data 1334 receiving second transaction data indicating that the second transmission of the particular funds from the second downstream entity has been approved by the particular architecture configured to carry out fraud analysis (e.g., an analysis of whether the transaction is likely to be fraudulent, with possible outcomes of “PASS,” which allows the transaction, “DENY,” which denies the transaction, or “FLAG” which holds up the transaction until another system can evaluate the transaction, e.g., a more complex or different fraud analysis that may use more information or apply in a different manner, or a human intervention to manually approve or deny the transaction) of the second transaction data (e.g., a transaction to pay a hospital for syringes and cold storage).

Referring again to FIG. 17E, in an embodiment, operation 1734 may include operation 1736 depicting second transaction data receiving circuit configured to receive second transaction data indicating that the second transmission of the particular funds from the second downstream entity has been approved by the particular architecture configured to carry out fraud analysis of the second transaction data that detects whether any of the first downstream entity, the second downstream entity, and the third downstream entity, are phantom vendors. For example, FIG. 13, e.g., FIG. 13E, shows second transaction data receiving circuit configured to receive second transaction data indicating that the second transmission of the particular funds from the second downstream entity has been approved by the particular architecture configured to carry out fraud analysis of the second transaction data that detects whether any of the first downstream entity, the second downstream entity, and the third downstream entity, are phantom vendors 1336 receiving second transaction data indicating that the second transmission of the particular funds from the second downstream entity has been approved by the particular architecture configured to carry out fraud analysis of the second transaction data that detects whether any of the first downstream entity, the second downstream entity, and the third downstream entity, are phantom vendors (e.g., shell vendors that do not actually exist except as vehicles by which bad actors can siphon off money and/or funds that are earmarked for specific projects, e.g., charitable work)

Referring now to FIG. 17F, in an embodiment, operation 1734 may include operation 1738 depicting second transaction data receiving circuit configured to receive second transaction data indicating that the second transmission of the particular funds from the second downstream entity has been approved by the particular architecture configured to detect one or more phantom vendors. For example, FIG. 13, e.g., FIG. 13F, shows second transaction data receiving circuit configured to receive second transaction data indicating that the second transmission of the particular funds from the second downstream entity has been approved by the particular architecture configured to detect one or more phantom vendors 1338 receiving second transaction data indicating that the second transmission of the particular funds from the second downstream entity has been approved by the particular architecture (e.g., the Daybreak architecture) configured to detect one or more phantom vendors.

Referring again to FIG. 17F, in an embodiment, operation 1738 may include operation 1740 depicting second transaction data receiving circuit configured to receive second transaction data indicating that the second transmission of the particular funds from the second downstream entity has been approved by the particular architecture configured to detect one or more phantom vendors through generation of a suspicion score for each transaction. For example, FIG. 13, e.g., FIG. 13F, shows second transaction data receiving circuit configured to receive second transaction data indicating that the second transmission of the particular funds from the second downstream entity has been approved by the particular architecture configured to detect one or more phantom vendors through generation of a suspicion score for each transaction 1340 receiving second transaction data indicating that the second transmission of the particular funds from the second downstream entity has been approved by the particular architecture configured to detect one or more phantom vendors (e.g., shell vendors that do not actually exist except as vehicles by which bad actors can siphon off money and/or funds that are earmarked for specific projects, e.g., charitable work) through generation of a suspicion score for each transaction.

Referring again to FIG. 17F, in an embodiment, operation 1740 may include operation 1742 depicting second transaction data receiving circuit configured to receive second transaction data indicating that the second transmission of the particular funds from the second downstream entity has been approved by the particular architecture configured to detect one or more phantom vendors through generation of a suspicion score for each transaction based on one or more of time of establishment of vendor, vendor mailing address, single invoice, vendor name characteristics, vendor invoice characteristics, time of transaction, date of transaction, approver credential, and reputation score. For example, FIG. 13, e.g., FIG. 13E, shows second transaction data receiving circuit configured to receive second transaction data indicating that the second transmission of the particular funds from the second downstream entity has been approved by the particular architecture configured to detect one or more phantom vendors through generation of a suspicion score for each transaction based on one or more of time of establishment of vendor, vendor mailing address, single invoice, vendor name characteristics, vendor invoice characteristics, time of transaction, date of transaction, approver credential, and reputation score 1342 receiving second transaction data indicating that the second transmission of the particular funds from the second downstream entity has been approved by the particular architecture configured to detect one or more phantom vendors through generation of a suspicion score for each transaction based on one or more of time of establishment of vendor (e.g., the shorter amount of time a vendor has been in business, the more suspect the vendor is), vendor mailing address (e.g., a nonverifiable address is more suspect), single invoice, vendor name characteristics (e.g., a shorter name is more suspect), vendor invoice characteristics, time of transaction, date of transaction, approver credential, and reputation score

Referring again to FIG. 6, FIG. 6 shows that, in an embodiment, at least one input acceptance machine 252, may be specified to establish at least one track data presentation machine state, which, in an embodiment, may be implemented as at least one second track data presentation machine state of said first-party-associated device, said at least one second track data presentation machine state set to a value 620. In an exemplary implementation, at least one first track data presentation machine 254, may be specified to establish at least one track data presentation machine state, which, in an embodiment, may be implemented as at least one second track data presentation machine state of said first-party-associated device (e.g., a wearable computer, e.g., Apple Watch, Microsoft HoloLens, etc.), said at least one second track data presentation machine state set to a value (e.g., a value set responsive to one or more machine states, as described in more detail herein).

### Multi-Jurisdictional/Single Entity Operations Notice Clause

Multi-Jurisdictional/Single Entity Operations Notice Clause to Provide Legal Notice that Multi-Entity/Multi-Sovereign Gambits are Contemplated and Claims are Directed to United States Jurisdiction Over the Persons and Acts via Electronic/Electrical Engineering Subject Matter.

A multi-jurisdictional/multi-entity infringement operations notice clause including, but not limited to: creating one or more machine states that link at least two parts of at least one input acceptance machine, said at least one input acceptance machine specified to establish: at least one input acceptance machine state defined by at least one machine state of at least one first-party-associated device triggered by detection of at least one machine-state pecuniary flag vector for at least one of: an electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account; at least one first track data presentation machine, said at least one first track data presentation machine specified to establish: at least one first track data presentation machine state of said first-party-associated device, said at least one first track data presentation machine state set to a value responsive to at least one of: a tracked first transmission of particular funds within a particular architecture that are part of said attributable funds managed by the particular architecture, from a first downstream entity to a second downstream entity, wherein the tracked first transmission of particular funds is checked for compliance with the distribution rule set by the particular architecture; and at least one second track data presentation machine, said at least one second track data presentation machine specified to establish; (b) at least one second track data presentation machine state of said first-party-associated device, said at least one second track data presentation machine state set to a value responsive to at least one of: (i) tracked second transmission of at least a portion of said particular funds within the particular architecture from said second downstream entity to a third downstream entity different than said first downstream entity, wherein the tracked second transmission of particular funds is checked for compliance with the distribution rule set by the particular architecture.

Operations Notice Clause 1. The operations of clause 1, wherein said clause 1 includes, but is not limited to:

driving a change of matter or energy within a domestic (United States) jurisdiction.

Operations Notice Clause 2. The operations of clause 2, wherein said driving a change of matter or energy within a domestic (United States) jurisdiction includes, but is not limited to:

at least one of (a) driving a state change of a data presentation device within a domestic (United States) jurisdiction; (b) driving a state change of a data communication device within a domestic (United States) jurisdiction; and (c) driving a state change of a data computation device within a domestic (United States) jurisdiction.

Operations Notice Clause 3. The operations of clause 3, wherein said at least one of (a) driving a state change of a data presentation device within a domestic (United States) jurisdiction; (b) driving a state change of a data communication device within a domestic (United States) jurisdiction; and (c) driving a state change of a data computation device within a domestic (United States) jurisdiction includes, but is not limited to:

receiving a signal of at least one state change outside United States jurisdiction; and

in response to the signal of at least one state change outside United States jurisdiction driving a state change of a data presentation device within United States jurisdiction, (b) driving a state change of a data communication device within United States jurisdiction, or (c) driving a state change of a data computation device within United States jurisdiction.

Operations Notice Clause 4. The operations of clause 1, wherein said clause 1 includes, but is not limited to:

driving a change of matter or energy within the ownership or control of a single legal entity.

Operations Notice Clause 5. The operations of clause 5 wherein said driving a change of matter or energy within the ownership or control of a single legal entity includes, but is not limited to:

connecting first-legal-entity-owned automation with second-legal-entity-owned automation, where the first-legal entity-owned automation and second-legal entity-owned automation collectively form creating one or more machine states that link at least two parts of at least one input acceptance machine, said at least one input acceptance machine specified to establish: at least one input acceptance machine state defined by at least one machine state of at least one first-party-associated device triggered by detection of at least one machine-state pecuniary flag vector for at least one of: an electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account; at least one first track data presentation machine, said at least one first track data presentation machine specified to establish: at least one first track data presentation machine state of said first-party-associated device, said at least one first track data presentation machine state set to a value responsive to at least one of: a tracked first transmission of particular funds within a particular architecture that are part of said attributable funds managed by the particular architecture, from a first downstream entity to a second downstream entity, wherein the tracked first transmission of particular funds is checked for compliance with the distribution rule set by the particular architecture; and at least one second track data presentation machine, said at least one second track data presentation machine specified to establish; (b) at least one second track data presentation machine state of said first-party-associated device, said at least one second track data presentation machine state set to a value responsive to at least one of: (i) tracked second transmission of at least a portion of said particular funds within the particular architecture from said second downstream entity to a third downstream entity different than said first downstream entity, wherein the tracked second transmission of particular funds is checked for compliance with the distribution rule set by the particular architecture.

Operations Notice Clause 6. The operations of clause 6 wherein said connecting first-legal-entity-owned automation with second-legal-entity-owned automation includes, but is not limited to:

connecting at least one of a first-legal-entity-owned hand-held computer, a first-legal-entity-owned desktop computer, a first-legal-entity-owned mini-computer, a first-legal-entity-owned mainframe computer, or a first-legal-entity-owned computer cloud services computer with at least one of a second-legal-entity-owned hand-held computer, a second-legal-entity-owned desktop computer, a second-legal-entity-owned mini-computer, a second-legal-entity-owned mainframe computer, or a second-legal-entity-owned computer cloud services computer.

### Concluding Language

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in some embodiments,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A machine, comprising:
at least one input acceptance machine, said at least one input acceptance machine specified to establish:
at least one input acceptance machine state defined by at least one machine state of at least one first-party-associated device triggered by detection of at least one machine-state pecuniary flag vector for at least one of:
an electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account;
at least one first track data presentation machine, said at least one first track data presentation machine specified to establish:
at least one first track data presentation machine state of said first-party-associated device, said at least one first track data presentation machine state set to a value responsive to at least one of:
a tracked first transmission of particular funds within a particular architecture that are part of said attributable funds managed by the particular architecture, from a first downstream entity to a second downstream entity, wherein the tracked first transmission of particular funds is checked for compliance with the distribution rule set by the particular architecture; and
at least one second track data presentation machine, said at least one second track data presentation machine specified to establish:
at least one second track data presentation machine state of said first-party-associated device, said at least one second track data presentation machine state set to a value responsive to at least one of:
a tracked second transmission of at least a portion of said particular funds within the particular architecture from said second downstream entity to a third downstream entity different than said first downstream entity, wherein the tracked second transmission of particular funds is checked for compliance with the distribution rule set by the particular architecture.

2. The machine of claim 1, wherein said at least one input acceptance machine comprises:
an at least one input acceptance machine having state set at least in part by switch-state logic.

3. The machine of claim 2, wherein said at least one input acceptance machine having state set at least in part by switch-state logic comprises:
an input-processing-and-acceptance-circuit that transitions to at last one voltage which an integrated circuit data sheet equates to LOGIC TRUE when:
(1) one or more voltages forming an engineering approximation of a particular input acceptance machine state that includes at least one of a first party input coordinatable with the at least one machine-state pecuniary flag vector encoded as at least one machine state
(2) constitute an engineering equivalent of one or more voltages forming an engineering approximation of the electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account.

4. The machine of claim 1, wherein said at least one input acceptance machine state defined by at least one machine state of at least one first-party-associated device triggered by detection of at least one machine-state pecuniary flag vector comprises:
a switched circuit having one or more switched states set at least in part by switch-state logic of the at least one first-party-associated device and triggered by detection of the at least one machine-state pecuniary flag vector.

5. The machine of claim 4, wherein said switched circuit having one or more switched states set at least in part by switch-state logic of the at least one first-party-associated device and triggered by detection of the at least one machine-state pecuniary flag vector comprises:
a transistorized circuit having one or more transistor states set at least in part by special purpose circuitry of the at least one first-party-associated device and triggered by detection of the at least one machine-state pecuniary flag vector.

6. The machine of claim 5, wherein said transistorized circuit having one or more transistor states set at least in part by special purpose circuitry of the at least one first-party-associated device and triggered by detection of the at least one machine-state pecuniary flag vector comprises:
a transistorized circuit having one or more transistor states set at least in part by special purpose logical circuitry specified at least in part by at least one computer program compatible with at least one operating system, the at least one computer program at least partially operably linked to the at least one first-party-associated device and triggered by detection of the at least one machine-state pecuniary flag vector.

7. The machine of claim 6, wherein said transistorized circuit having one or more transistor states set at least in part by special purpose logical circuitry, specified at least in part by at least one computer program compatible with at least one operating system, the at least one computer program at least partially operably linked to the at least one first-party-associated device and triggered by detection of the at least one machine-state pecuniary flag vector comprises:
a transistorized circuit having one or more transistor states set at least in part by special purpose logical circuitry specified at least in part by at least one computer program compatible with at least one cloud-based or cloud-affiliated operating system.

8. The machine of claim 6, wherein said transistorized circuit having one or more transistor states set at least in part by special purpose logical circuitry specified at least in part by at least one computer program compatible with at least one operating system, the at least one computer program at least partially operably linked to the at least one first-party-associated device and triggered by detection of the at least one machine-state pecuniary flag vector comprises:
a transistorized circuit having one or more transistor states set at least in part by special purpose logical circuitry specified at least in part by at least one computer program compatible with at least one desktop operating system.

9-62. (canceled)

63. A process including, but not limited to:
creating one or more machine states that link:
at least one input acceptance machine, said at least one input acceptance machine specified to establish:
at least one input acceptance machine state defined by at least one machine state of at least one first-party-associated device triggered by detection of at least one machine-state pecuniary flag vector for at least one of:
an electrical/magnetic/physical storage of at least one original machine state associated with a command directed to an engineering approximation of an attributable account that contains attributable funds and that is configured to interact with one or more financial entity machine states, wherein said engineering approximation of said attributable account is at least partly based on an engineering approximation of a distribution rule set that specifies one or more conditions associated with said attributable funds of said attributable account;
at least one first track data presentation machine, said at least one first track data presentation machine specified to establish:
at least one first track data presentation machine state of said first-party-associated device, said at least one first track data presentation machine state set to a value responsive to at least one of:
a tracked first transmission of particular funds within a particular architecture that are part of said attributable funds managed by the particular architecture, from a first downstream entity to a second downstream entity, wherein the tracked first transmission of particular funds is checked for compliance with the distribution rule set by the particular architecture; and
at least one second track data presentation machine, said at least one second track data presentation machine specified to establish:
at least one second track data presentation machine state of said first-party-associated device, said at least one second track data presentation machine state set to a value responsive to at least one of:
a tracked second transmission of at least a portion of said particular funds within the particular architecture from said second downstream entity to a third downstream entity different than said first downstream entity, wherein the tracked second transmission of particular funds is checked for compliance with the distribution rule set by the particular architecture.

64. The process of clause 63, wherein said creating one or more machine states that link comprises:
driving a change of matter or energy within United States jurisdiction,

65. The process of clause 64, wherein said driving a change of matter or energy within United States jurisdiction comprises:
at least one of (a) driving a state change of a data presentation device within United States jurisdiction, (b) driving a state change of a data communication device within United States jurisdiction, or (c) driving a state change of a data computation device within United States jurisdiction.

66. The process of clause 65, wherein said at least one of (a) driving a state change of a data presentation device within United States jurisdiction, (b) driving a state change of a data communication device within United States jurisdiction, or (c) driving a state change of a data computation device within United States jurisdiction comprises:
receiving a signal of at least one state change outside United States jurisdiction; and
in response to the signal of at least one state change outside United States jurisdiction driving a state change of a data presentation device within United States jurisdiction, (b) driving a state change of a data communication device within United States jurisdiction, or (c) driving a state change of a data computation device within United States jurisdiction.

67. A device, comprising:
a memory; and
a processor operably coupled to the memory, said processor including:
an input acceptance circuit configured to receive input that regards an attributable account that contains attributable funds and that is configured to interface with one or more financial entities, wherein the attributable funds are governed by a distribution rule set;
a first transaction data receiving circuit configured to receive first transaction data indicating a first transmission of particular funds from a first downstream entity to a second downstream entity, wherein the particular funds are part of the attributable funds; and
a second transaction data receiving circuit configured to receive second transaction data indicating a second transmission of the particular funds from the second downstream entity to the third downstream entity.

68. The computationally-implemented method of claim 67, wherein said input acceptance circuit configured to receive input that regards an attributable account that contains attributable funds and that is configured to interface with one or more financial entities, wherein the attributable funds are governed by a distribution rule set comprises:
a presentation input acceptance circuit configured to accept input that regards that regards a request for presentation of a transaction history of the attributable account that contains attributable funds and that is configured to interface with one or more financial entities, wherein the attributable funds are governed by a distribution rule set.

69. The computationally-implemented method of claim 67, wherein said input acceptance circuit configured to receive input that regards an attributable account that contains attributable funds and that is configured to interface with one or more financial entities, wherein the attributable funds are governed by a distribution rule set comprises:
a device interface circuit that includes:
an input/output interface circuit; and
an input receiving circuit operably coupled to the input/output interface circuit and that is configured to receive input that regards the attributable account that contains attributable funds and that is configured to interface with one or more financial entities.

70. The computationally-implemented method of claim 69, wherein said an input receiving circuit operably coupled to the input/output interface circuit and that is configured to receive input that regards the attributable account that contains attributable funds and that is configured to interface with one or more financial entities comprises:
an input receiving circuit configured to receive input from a user, said input that regards the attributable account that contains attributable funds and that is configured to interface with one or more financial entities.

71. The computationally-implemented method of claim 69, wherein said an input receiving circuit operably coupled to the input/output interface circuit and that is configured to receive input that regards the attributable account that contains attributable funds and that is configured to interface with one or more financial entities comprises:
an input receiving circuit configured to receive, at the device that is a first party device, said input that regards the attributable account that contains attributable funds and that is configured to interface with one or more financial entities.

72. The computationally-implemented method of claim 71, wherein said input receiving circuit configured to receive, at the device that is a first party device, said input that regards the attributable account that contains attributable funds and that is configured to interface with one or more financial entities comprises:
an input receiving circuit configured to receive input at the first party device, said input that regards the attributable account that contains attributable funds and that is configured to interface with one or more financial entities, wherein the first party device is one or more of a smartphone device, mobile device, laptop computer, desktop computer, wearable device, augmented reality device, in-vehicle device, heads up display, and a thin client.

73. The computationally-implemented method of claim 71, wherein said input receiving circuit configured to receive, at the device that is a first party device, said input that regards the attributable account that contains attributable funds and that is configured to interface with one or more financial entities comprises:
an input receiving circuit configured to receive input from the user at an input/output interface of the first party device, said input that regards the attributable account that contains attributable funds and that is configured to interface with one or more financial entities.

74. The computationally-implemented method of claim 73, wherein said input receiving circuit configured to receive input from the user at an input/output interface of the first party device, said input that regards the attributable account that contains attributable funds and that is configured to interface with one or more financial entities comprises:
an input receiving circuit configured to receive input from the user at a touchscreen interface of the first party device, said input that regards the attributable account that contains attributable funds and that is configured to interface with one or more financial entities.

75-152. (canceled)
